(19) United States
(12) Patent Application Publication
(10) Pub. No.: US 2022/0006089 A1
(43) Pub. Date: Jan. 6, 2022

(54) IMPROVED ORGANIC ELECTRODE MATERIAL

(71) Applicant: Evonik Operations GmbH, Essen (DE)

(72) Inventors: Andreas WILD, Haltern am See (DE); Vadym Bakumov, Marl (DE); Michael Korell, Bochum (DE)

(73) Assignee: Evonik Operations GmbH, Essen (DE)

(21) Appl. No.: 15/733,707

(22) PCT Filed: Jun. 18, 2019
(86) PCT No.: PCT/EP2019/065922

§ 371 Date: Sep. 30, 2020

(30) Foreign Application Priority Data
Jun. 27, 2018 (EP) 18180017.8

(51) Int. Cl. H01M 4/60; H01M 4/62; H01M 4/137; H01M 10/0569; H01M 10/0568

(52) U.S. Cl. CPC H01M 4/608; H01M 4/624; H01M 10/0568; H01M 10/0569; H01M 4/137

(57) ABSTRACT

A novel electrode material features improved capacity compared to conventional electrode materials. This electrode material includes an organic redox polymer non-conjugated in the main chain, a conductivity additive, and an ionic liquid. Also, a process is for producing an electrode from this novel electrode material. The electrode obtainable by the process also features improved capacity.

The present invention relates to a novel electrode material which features improved capacity compared to conventional electrode materials.

The present invention also relates to a process for producing an electrode and to the electrode obtained by the process.

### BACKGROUND OF THE INVENTION

Organic batteries are electrochemical cells which use an organic charge storage material as active electrode material for storing electrical charge. These batteries have a number of advantages and a fundamentally different mechanism of action from metal-based charge storage materials.

The literature describes a multitude of organic storage materials. An overview is given by the article S. Muench, A. Wild, C. Friebe, B. Haupter, T. Janoschka, U. S. Schubert, Chem. Rev. 2016, 116, 9438-9484 (“Muench et al.” hereinafter).

In the production of electrodes from these organic storage materials, the electrode material is typically mixed with a conductivity additive, for example a carbon material, and optionally a binder additive, and applied to a substrate.

The electrodes thus obtained are subsequently incorporated into a battery together with a counterelectrode. The construction of such a battery is known to the person skilled in the art (Muench et al.). In these batteries, it is possible to use a multitude of electrolytes, including metal salts (e.g. lithium salts) or ionic liquids.

Even though the electrodes thus obtained have good capacities, there is still a need in this technical field to improve the capacities of electrodes based on organic charge storage material.

The problem addressed by the present invention was accordingly that of providing electrode materials that are made from organic storage materials and have elevated capacity compared to comparable electrodes.

It has now been found that, surprisingly, a distinct increase in capacity was achievable in electrodes that have been produced from particular organic polymeric charge storage materials.

Specifically, it was found that capacity was improved in organic redox polymers non-conjugated in the main chain when an ionic liquid is added as a further constituent as well as the conductivity additive in the production of the electrode.

Application US 2017/0222232 A1 and U.S. Pat. Nos. 9,397,341 B2, 9,520,598 B2 and 9,276,292 B1 describe electrodes in Zn/MnCO₂ batteries, i.e. metal-based and hence non-organic charge storage means, in which ionic liquids are present.

This observation was completely surprising particularly because a corresponding addition of ionic liquids to organic charge storage material in which the corresponding polymer is conjugated in the main chain, for example to the polymers described in Example 1 or 2 of WO 2017/220965 A1, does not have any comparable effect.

### DETAILED DESCRIPTION OF THE INVENTION

### I. First Aspect of the Invention: Electrode Material

The invention relates, in a first aspect, to an electrode material comprising at least one conductivity additive, at least one ionic liquid and at least one organic redox polymer P which is non-conjugated in the main chain.

The electrode material according to the invention is especially an electrode slurry or a surface coating of electrode elements for electrical charge storage means.

### I.1 Redox Polymer P

The organic redox polymer P non-conjugated in the main chain which is encompassed by the electrode material in the first aspect of the present invention, for the purposes of the invention, is composed of two structural features:

(1) a polymer backbone (the ‘main chain’) in which there is no conjugation,
(2) redox-active organic radicals bonded regularly or irregularly to the polymer backbone, within which there is conjugation or no conjugation.

I.1.α) For the purposes of the invention, the organic redox polymer P non-conjugated in the main chain which is encompassed by the electrode material in the first aspect of the invention especially comprises n¹ mutually joined repeat units of the chemical structure (I) and/or n² mutually joined repeat units of the chemical structure (II) and/or n³ mutually joined repeat units of the chemical structure (III), preferably n¹ mutually joined repeat units of the chemical structure (I) and/or n³ mutually joined repeat units of the chemical structure (III), more preferably n¹ mutually joined repeat units of the chemical structure (I)

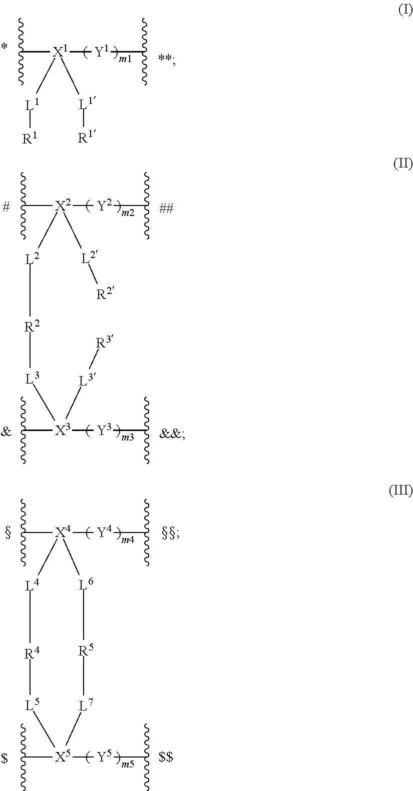

where n¹, n² and n³ are each independently an integer ≥4, preferably an integer in the range of 4 to 10⁶, more preferably an integer in the range of 10 to 10⁵, even more preferably an integer in the range of 100 to 10⁴,
where m¹, m², m³, m⁴ and m⁵ are each independently an integer ≥0, preferably an integer in the range of 0 to 10⁶, more preferably an integer in the range of 0 to 10⁵, more preferably an integer in the range of 0 to 10⁴, more preferably an integer in the range from 0 to 10, and most preferably are each 0,
where the repeat units of the chemical structure (I) within the polymer P are the same or at least partly different from one another,
where the repeat units of the chemical structure (II) within the polymer P are the same or at least partly different from one another,
where the repeat units of the chemical structure (III) within the polymer P are the same or at least partly different from one another,
where the repeat units of the chemical structure (I) within the polymer are bonded to one another in such a way that the bond indicated by “**” in a particular repeat unit is joined by the bond indicated by “*” in the adjacent repeat unit,
where the repeat units of the chemical structure (II) within the polymer are joined to one another in such a way that the bond indicated by “##” in a particular repeat unit is joined by the bond indicated by “#” in the adjacent repeat unit and the bond indicated by “&&” in a particular repeat unit is joined by the bond indicated by “*” in the adjacent repeat unit,
where the repeat units of the chemical structure (III) within the polymer are joined to one another in such a way that the bond indicated by “§§” in a particular repeat unit is joined by the bond indicated by “§” in the adjacent repeat unit and the bond indicated by “$$” in a particular repeat unit is joined by the bond indicated by “$” in the adjacent repeat unit,
where X¹, X², X³, X⁴, X⁵ are each independently a non-conjugated organic group formed by polymerization reaction from a group consisting of an organic double bond, an organic triple bond, an oxirane or an aziridine, or a non-conjugated organic group which is formed by a polymer-analogous reaction,
where Y¹, Y², Y³, Y⁴, Y⁵ are each independently a non-conjugated organic spacer unit,
where L¹, L², L³, L⁴, L⁵, L⁶, L⁷ are each independently selected from the group consisting of direct bond, organic linker unit,
and where L^{1′}, L^{2′}, L³¹ are each independently selected from the group consisting of direct bond, organic linker unit, and L^{1′}, L^{2′}, L^{3′} are preferably direct bonds,
and where R¹, R², R⁴, R⁵, R^{1′}, R^{2′}, R^{3′} are each independently an organic redox-active group preferably selected from the group consisting of redox-active aromatic imide function (A), redox-active organic function comprising at least one stable oxygen radical (B), redox-active anthraquinone/carbazole function (C), redox-active dialkoxybenzene function (D), redox-active benzoquinone function (E), redox-active triphenylamine function (G), redox-active viologen function (H), redox-active ferrocene function (J) and R^{1′}, R^{2′}, R^{3′} may also each be a hydrogen radical,
and where, more preferably, R¹, R², R⁴, R⁵ are each independently an organic redox-active group preferably selected from the group consisting of redox-active aromatic imide function (A), redox-active organic function comprising at least one stable oxygen radical (B), redox-active anthraquinone/carbazole function (C), redox-active dialkoxybenzene function (D), redox-active benzoquinone function (E), redox-active triphenylamine function (G), redox-active viologen function (H), redox-active ferrocene function (J) and R^{1′}, R^{2′}, R^{3′} are each a hydrogen radical,
and where, even more preferably, R¹, R², R⁴, R⁵ are each independently an organic redox-active group selected from the group consisting of redox-active organic function comprising at least one stable oxygen radical (B), redox-active anthraquinone/carbazole function (C), and R^{1′}, R^{2′}, R^{3′} are each a hydrogen radical.

The repeat units of the chemical structure (I) within the polymer P according to point I.1.α) are the same or at least partly different from one another. The repeat units of the chemical structure (II) within the polymer P according to point I.1.α) are the same or at least partly different from one another. The repeat units of the chemical structure (III) within the polymer P according to point I.1.α) are the same or at least partly different from one another.

“At least partly different from one another” means that at least two repeat units differ from one another.

This means more particularly, in the case of the chemical structure (I), that at least two of the n¹ mutually joined repeat units encompassed by the polymer P differ in at least one of the R¹, R^{1′}, L¹, L^{1′}, X¹, Y¹ radicals and/or in the value of m¹.

This means more particularly, in the case of the chemical structure (II), that at least two of the n² mutually joined repeat units encompassed by the polymer P differ in at least one of the R², R^{2′}, R^{3′}, L², L^{2′}, L³, L^{3′}, X², X³, Y², Y³ radicals and/or in the value of m² or m³.

This means more particularly, in the case of the chemical structure (III), that at least two of the n³ mutually joined repeat units encompassed by the polymer P differ in at least one of the R⁴, R⁵, L⁴, L⁵, L⁶, L⁷, X⁴, X⁵, Y⁴, Y⁵ radicals and/or in the value of m⁴ or m⁵.

The end group of the first repeat unit of the redox polymer P according to the invention which is present therefor in the chemical structure (I) at the bond indicated by and the end group of the n¹th repeat unit of the redox polymer P according to the invention which is present therefor in the chemical structure (I) at the bond indicated by “**”, are not particularly restricted and are a result of the polymerization method used in the method for preparing the redox polymer P according to the invention. Thus, they may be termination fragments of an initiator or a repeat unit. Preferably, these end groups are selected from hydrogen, halogen, hydroxyl, unsubstituted radical or aliphatic radical substituted by —CN, —OH, halogen (which may especially be an unsubstituted or correspondingly substituted alkyl group), (hetero)aromatic radical, which is preferably a phenyl radical, benzyl radical or α-hydroxybenzyl.

The end groups of the first repeat unit of the redox polymer P according to the invention which is present therefor in the chemical structure (II) at the bonds indicated by “#” and “&”, and the end groups of the n²th repeat unit of the redox polymer P according to the invention which is present therefor in the chemical structure (II) at the bonds indicated by “##” and “&&”, are not particularly restricted and are a result of the polymerization method used in the method for preparing the redox polymer P according to the invention. Thus, they may be termination fragments of an initiator or a repeat unit. Preferably, these end groups are selected from hydrogen, halogen, hydroxyl, unsubstituted radical or aliphatic radical substituted by —CN, —OH, halogen (which may especially be an unsubstituted or correspondingly substituted alkyl group), (hetero)aromatic radical, which is preferably a phenyl radical, benzyl radical or α-hydroxybenzyl.

The end groups of the first repeat unit of the redox polymer P according to the invention which is present therefor in the chemical structure (III) at the bonds indicated by “§” and “$”, and the end groups of the n³th repeat unit of the redox polymer P according to the invention which is present therefor in the chemical structure (III) at the bonds indicated by “§§” and “$$”, are not particularly restricted and are a result of the polymerization method used in the method for preparing the redox polymer P according to the invention. Thus, they may be termination fragments of an initiator or a repeat unit. Preferably, these end groups are selected from hydrogen, halogen, hydroxyl, unsubstituted radical or aliphatic radical substituted by —CN, —OH, halogen (which may especially be an unsubstituted or correspondingly substituted alkyl group), (hetero)aromatic radical, which is preferably a phenyl radical, benzyl radical or α-hydroxybenzyl.

I.1.β) In a preferred embodiment of the first aspect of the invention as defined in point I.1.α), the organic redox polymer P non-conjugated in the main chain which is encompassed by the electrode material in the first aspect of the invention comprises n¹ mutually joined repeat units of the chemical structure (I)

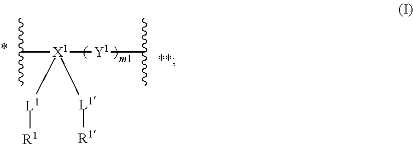

where n¹ is an integer ≥4, preferably an integer in the range of 4 to 10⁶, more preferably an integer in the range of 10 to 10⁵, more preferably an integer in the range of 100 to 10⁴,
where m¹ is an integer ≥0, preferably an integer in the range of 0 to 10⁶, more preferably an integer in the range of 0 to 10⁵, more preferably an integer in the range of 0 to 10⁴, even more preferably an integer in the range of 0 to 10, and most preferably is in each case 0,
where the repeat units of the chemical structure (I) within the polymer P are the same or at least partly different from one another,
where the repeat units of the chemical structure (I) within the polymer are joined to one another in such a way that the bond indicated by “**” in a particular repeat unit is joined by the bond indicated by “*” in the adjacent repeat unit,
where X¹ is a non-conjugated organic group which is formed by polymerization reaction from a group consisting of an organic double bond, an organic triple bond, an oxirane or an aziridine, or is a non-conjugated organic group which is formed by a polymer-analogous reaction,
where Y¹ is a non-conjugated organic spacer unit,
where L¹, L^{1′} are each independently selected from the group consisting of direct bond, organic linker unit,
and where, preferably, L¹ is selected from the group consisting of direct bond, organic linker unit, and L^{1′} is a direct bond,
and where R¹, R^{1′} are each independently an organic redox-active group preferably selected from the group consisting of redox-active aromatic imide function (A), redox-active organic function comprising at least one stable oxygen radical (B), redox-active anthraquinone/carbazole function (C), redox-active dialkoxybenzene function (D), redox-active benzoquinone function (E), redox-active triphenylamine function (G), redox-active viologen function (H), redox-active ferrocene function (J), and R^{1′} may also be a hydrogen radical,
and where, more preferably, R¹ is an organic redox-active group preferably selected from the group consisting of redox-active aromatic imide function (A), redox-active organic function comprising at least one stable oxygen radical (B), redox-active anthraquinone/carbazole function (C), redox-active dialkoxybenzene function (D), redox-active benzoquinone function (E), redox-active triphenylamine function (G), redox-active viologen function (H), redox-active ferrocene function (J), and R^{1′} is a hydrogen radical,
and where, even more preferably, R¹ is an organic redox-active group selected from the group consisting of redox-active organic function comprising at least one stable oxygen radical (B), redox-active anthraquinone/carbazole function (C), and R^{1′} is a hydrogen radical.

The repeat units of the chemical structure (I) within the polymer P according to point I.1.β) are the same or at least partly different from one another.

“At least partly different from one another” means that at least two repeat units differ from one another.

This means more particularly, in the case of the chemical structure (I), that at least two of the n¹ mutually joined repeat units encompassed by the polymer P differ in at least one of the R¹, R^{1′}, L¹, L^{1′}, X¹, Y¹ radicals and/or in the value of m¹.

The end group of the first repeat unit of the redox polymer P according to the invention which is present therefor in the chemical structure (I) at the bond indicated by and the end group of the n¹th repeat unit of the redox polymer P according to the invention which is present therefor in the chemical structure (II) at the bond indicated by “**”, are not particularly restricted and are a result of the polymerization method used in the method for preparing the redox polymer P according to the invention. Thus, they may be termination fragments of an initiator or a repeat unit. Preferably, these end groups are selected from hydrogen, halogen, hydroxyl, unsubstituted radical or aliphatic radical substituted by —CN, —OH, halogen (which may especially be an unsubstituted or correspondingly substituted alkyl group), (hetero)aromatic radical, which is preferably a phenyl radical, benzyl radical or α-hydroxybenzyl.

### I.1.1 Redox-Active Groups

The organic redox-active groups selectable for R¹, R², R⁴, R⁵, R^{1′}, R^{2′}, R^{3′} in the structures (I), (II) and (III), in the first aspect of the invention, preferably as defined in point I.1.α) and more preferably in point I.1.β), are not subject to any further restriction. The person skilled in the art is aware of organic redox-active groups that can be used in organic batteries, and they are described, for example, in Muench et at, together with the synthesis of the respective polymers. As described in point I.1.α) and point I.1.β), the organic redox-active groups are preferably selected from the group consisting of redox-active aromatic imide function (A), redox-active organic function comprising at least one stable oxygen radical (B), redox-active anthraquinone/carbazole function (C), redox-active dialkoxybenzene function (D), redox-active benzoquinone function (E), redox-active triphenylamine function (G), redox-active viologen function (H), redox-active ferrocene function (J), and more preferably selected from the group consisting of redox-active aromatic imide function (A), redox-active organic function comprising at least one stable oxygen radical (B), redox-active anthraquinone/carbazole function (C), and even more preferably from the group consisting of redox-active organic function comprising at least one stable oxygen radical (B), redox-active anthraquinone/carbazole function (C), and the organic redox-active group is most preferably a redox-active organic function comprising at least one stable oxygen radical (B).

### I.1.1.1 Redox-Active Aromatic Imide Function (A)

For the purposes of the invention, “redox-active aromatic imide function” means a redox-active organic radical in which an imide function forms a ring with the carbon atoms of one or two aromatic rings.

A.1 In the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the first aspect of the invention as defined in point I.1.α) and point I.1.β) are in each case a redox-active aromatic imide function (A), this means more particularly in accordance with the invention that the R¹, R², R⁴, R⁵, R^{1′}, R^{2′}, R^{3′} radicals or the R¹, R², R⁴, R⁵ radicals or the R¹, R^{1′} radicals or the R¹ radical may each independently have the following structure (A1) and, in the case of R², R⁴, R⁵, may also each independently have the following structure (A2):

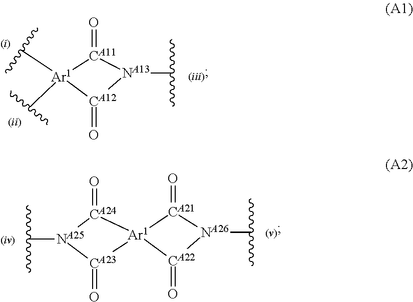

where the Ar¹ radical in (A1) or the Ar² radical in (A2) is in each case independently a (hetero)aromatic radical comprising one or more, preferably 1 to 6, (hetero)aromatic rings, where the (hetero)aromatic rings of Ar¹ in (A1) or the (hetero)aromatic rings of Ar² in (A2) may each independently be substituted by at least one radical selected from the group consisting of (halo)alkyl group, alkenyl group, alkynyl group, (halo)alkoxy group, cycloalkyl group, carbonylalkyl group, —C(═O)—H, carboxylic ester radical, carboxamide, carboxylic ester, sulfonic ester, phosphoric ester, amine, mono(halo)alkylamino, di(halo)alkylamino, cyano, hydroxyl, halogen, preferably from the group consisting of halogen, (halo)alkyl group, (halo)alkoxy group, carboxylic acid radical, carboxylic ester,
where, in (A1), two of the ring atoms of Ar¹, in each case together with the two carbon atoms C^{A11} and C^{A12} and the nitrogen atom N^{A13}, form a five-membered ring, six-membered ring or seven-membered ring, preferably a five-membered ring or six-membered ring,
where, in (A2), two of the ring atoms of Ar², in each case together with the two carbon atoms C^{A21} and C^{A22} and the nitrogen atom N^{A26}, form a five-membered ring, six-membered ring or seven-membered ring, preferably a five-membered ring or six-membered ring, and two different ring atoms of Ar², in each case together with the two carbon atoms C^{A23} and C^{A24} and the nitrogen atom N^{A25}, form a five-membered ring, six-membered ring or seven-membered ring, preferably a five-membered ring or six-membered ring,
and where two aromatic carbon atoms in the same (hetero)aromatic ring in Ar¹ or two aromatic carbon atoms in the same (hetero)aromatic ring in Ar² may also be bridged via a divalent aliphatic radical which is preferably alkylene, (thio)ether or a divalent radical of the formula ˜(CH₂)_{pA11}—C(═O)—(NR^{AP1})—C(═O)—(CH₂)_{pA12}˜ where R^{AP1}=hydrogen radical, halogen radical, (halo)alkyl group or (halo)alkoxy group and p^{A11}=0 or 1 and p^{A12}=0 or 1,
and where, in the case that the Ar¹ radical comprises multiple (hetero)aromatic rings, these may be at least partly fused to one another in Ar¹,
and where, in the case that the Ar² radical comprises multiple (hetero)aromatic rings, these may be at least partly fused to one another in Ar²,
and where, in the case that the Ar¹ radical comprises multiple (hetero)aromatic rings, two aromatic carbon atoms from different (hetero)aromatic rings in Ar¹ may also be bridged via a direct bond or a radical selected from the group consisting of
heteroatom, which is preferably —O— or —S— and more preferably —O—,
divalent aliphatic radical, which is preferably alkylene, (thio)ether or a divalent radical of the formula ˜(CH₂)_{pA13}—C(═O)—(NR^{AP2})—C(═OHCH₂)_{pA14}˜,
where R^{AP2}=hydrogen radical, halogen radical, (halo)alkyl group or (halo)alkoxy group, preferably R^{AP2}=hydrogen radical, alkyl group, and p^{A13}=0 or 1 and p^{A14}=0 or 1,
and where, in the case that the Ar² radical comprises multiple (hetero)aromatic rings, two aromatic carbon atoms from different (hetero)aromatic rings in Ar² may also be bridged via a direct bond selected from the group consisting of
heteroatom, which is preferably —O— or —S— and more preferably —O—,
divalent aliphatic radical, which is preferably alkylene, (thio)ether or a divalent radical of the formula ˜(CH₂)_{pA23}—C(═O)—(NR^{AP4})—C(═O)—(CH₂)_{pA24}˜ where R^{AP4}=hydrogen radical, halogen radical, (halo)alkyl group or (halo)alkoxy group, preferably R^{AP4}=hydrogen radical, alkyl group and p^{A23}=0 or 1 and p^{A24}=0 or 1,
where the bonds indicated by (i) and (ii) proceed from aromatic carbon atoms of Ar¹,
and where, in the case that R¹=(A1), one of the bonds indicated by (i), (ii), (iii) is the bond to L¹,
in the case that R^{1′}=(A1), one of the bonds indicated by (i), (ii), (iii) is the bond to L^{1′},
in the case that R^{2′}=(A1), one of the bonds indicated by (i), (ii), (iii) is the bond to L^{2′},
in the case that R^{3′}=(A1), one of the bonds indicated by (i), (ii), (iii) is the bond to L^{3′},
in the case that R²=(A1), one of the bonds indicated by (i), (ii), (iii) is the bond to L² and another of the bonds indicated by (i), (ii), (iii) is the bond to L³,
in the case that R⁴=(A1), one of the bonds indicated by (i), (ii), (iii) is the bond to L⁴ and another of the bonds indicated by (i), (ii), (iii) is the bond to L⁵,
in the case that R⁵=(A1), one of the bonds indicated by (i), (ii), (iii) is the bond to L⁶ and another of the bonds indicated by (i), (ii), (iii) is the bond to L⁷,
in the case that R²=(A2), the bond indicated by (iv) is the bond to L² and the bond indicated by (v) is the bond to L³,
in the case that R⁴=(A2), the bond indicated by (iv) is the bond to L⁴ and the bond indicated by (v) is the bond to L⁵,
in the case that R⁵=(A2), the bond indicated by (iv) is the bond to L⁶ and the bond indicated by (v) is the bond to L⁷
and in that case each of the bonds indicated by (i) and (ii) that are not a bond to L¹, L², L³, L⁴, L⁵, L⁶, L⁷, L^{1′}, L^{2′} or L³¹ are each independently bonded to a radical selected from the group consisting of hydrogen, (halo)alkyl group, alkenyl group, alkynyl group, (halo)alkoxy group, cycloalkyl group, carbonylalkyl, —C(═O)—H, carboxylic acid radical, carboxamide, carboxylic ester, sulfonic ester, phosphoric ester, amine, mono(halo)alkylamino, di(halo)alkylamino, cyano, hydroxyl, halogen, preferably from the group consisting of hydrogen, halogen, (halo)alkyl group, (halo)alkoxy group, carboxylic acid radical, carboxylic ester,
and the bond indicated by (iii), if it is not a bond to L¹, L², L³, L⁴, L⁵, L⁶, L⁷, L^{1′}, L^{2′} or L^{3′}, is bonded to a radical selected from the group consisting of hydrogen, (halo)alkyl group, alkenyl group, alkynyl group, (halo)alkoxy group, cycloalkyl group, carbonylalkyl, —C(═O)—H, carboxylic acid radical, carboxamide, carboxylic ester, cyano, hydroxyl, halogen, preferably from the group consisting of hydrogen, halogen, (halo)alkyl group, (halo)alkoxy group, carboxylic acid radical, carboxylic ester.

A.2 In a preferred embodiment of the aforementioned point A.1, Ar¹ has a structure selected from the group consisting of (A11), (A12), (A13), (A14), (A15), (A16), (A17), (A18), (A19), (A20), (A21)

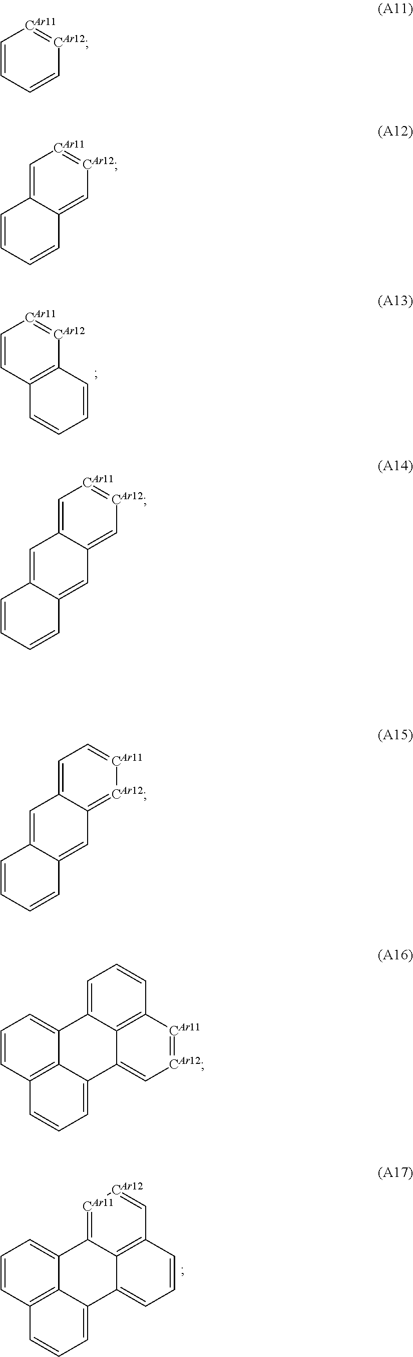

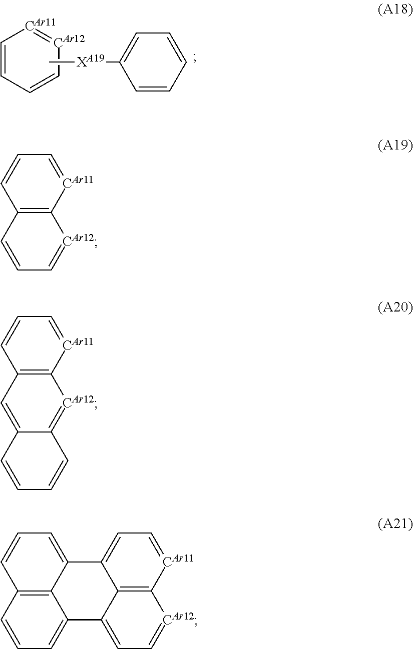

where the aromatic carbon atom labelled C^{Ar11} in the structures (A11), (A12), (A13), (A14), (A15), (A16), (A17), (A18), (A19), (A20), (A21) has a direct bond to the carbon atom labelled C^{A11} in the structure (A1),
where the aromatic carbon atom labelled C^{Ar12} in the structures (A11), (A12), (A13), (A14), (A15), (A16), (A17), (A18), (A19), (A20), (A21) has a direct bond to the carbon atom labelled C^{A12} in the structure (A1),
where X^{A19} in (A18) is a radical selected from the group consisting of direct bond, heteroatom which is preferably —O— or —S— and more preferably —O—,
divalent aliphatic radical, which is preferably alkylene, (thio)ether or a divalent radical of the formula ˜(CH₂)_{pA13}—C(═O)—(NR^{AP2})—C(═O)—(CH₂)_{pA14}˜,
where R^{AP2}=hydrogen radical, halogen radical, (halo)alkyl group or (halo)alkoxy group, preferably R^{AP2}=hydrogen radical, alkyl group, and p^{A13}=0 or 1 and p^{A14}=0 or 1,
and X^{A19} is more preferably selected from the group consisting of —O—, alkylene, direct bond and X^{A19} is most preferably —O—,
where the bonds indicated by (i) and (ii) in the structure (A1), in the case of the structures (A11), (A12), (A13), (A14), (A15), (A16), (A17), (A19), (A20) and (A21), proceed from two aromatic carbon atoms in the structures (A11), (A12), (A13), (A14), (A15), (A16), (A17), (A19), (A20) and (A21) other than the carbon atoms labelled C^{A11} and C^{A12},
or, in the case of structure (A18), proceed in each case from two aromatic carbon atoms in the structure (A18) other than both the carbon atoms labelled C^{A11} and C^{A12} and the aromatic carbon atoms bonded to X^{A19},
and the aromatic carbon atoms in the structures (A11), (A12), (A13), (A14), (A15), (A16), (A17), (A18), (A19), (A20), (A21) that do not have a bond to C^{A11}, C^{A12}, X^{A19}, L¹, L^{1′}, L^{2′}, L^{3′}, L², L³, L⁴, L⁵, L⁶ or L⁷ are bonded to a radical selected from the group consisting of hydrogen, (halo)alkyl group, alkenyl group, alkynyl group, (halo)alkoxy group, cycloalkyl group, carbonylalkyl, —C(═O)—H, carboxylic acid radical, carboxamide, carboxylic ester, sulfonic ester, phosphoric ester, amine, mono(halo)alkylamino, di(halo)alkylamino, cyano, hydroxyl, halogen, preferably to a radical selected from the group consisting of hydrogen, halogen, (halo)alkyl group, (halo)alkoxy group, carboxylic acid radical, carboxylic ester,
and where two aromatic carbon atoms in the same or different aromatic rings within the structures (A11), (A12), (A13), (A14), (A15), (A16), (A17), (A18), (A19), (A20), (A21) may also be bridged via a divalent radical of the formula ˜(CH₂)_{pA15}—C(═O)—(NR^{AP3})—C(═OHCH₂)_{pA16}˜ where R^{AP3}=hydrogen radical, halogen radical, (halo)alkyl group or (halo)alkoxy group, preferably R^{AP3}=hydrogen radical, alkyl group, and p^{A15}=0 or 1 and p^{A16}=0 or 1,
and Ar² has a structure selected from the group consisting of (A22), (A23), (A24), (A25), (A26), (A27), (A28), (A29), (A30), (A31), (A32)

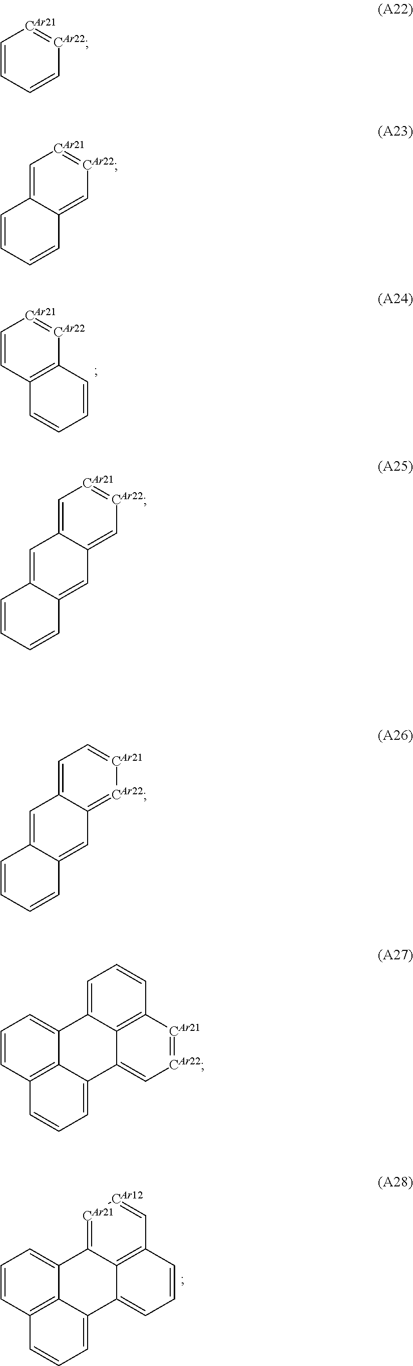

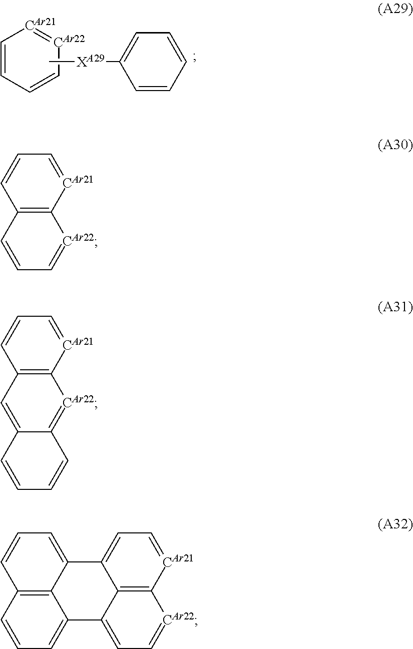

where the aromatic carbon atom labelled C^{Ar21} in the structures (A22), (A23), (A24), (A25), (A26), (A27), (A28), (A29), (A30), (A31) or (A32) has a direct bond to the carbon atom labelled C^{A21} in the structure (A2),
where the aromatic carbon atom labelled C^{Ar22} in the structures (A22), (A23), (A24), (A25), (A26), (A27), (A28), (A29), (A30), (A31) or (A32) has a direct bond to the carbon atom labelled C^{A22} in the structure (A2),
and in that case two further aromatic carbon atoms other than C^{Ar21} and C^{Ar22} in the structures (A22), (A23), (A24), (A25), (A26), (A27), (A28), (A29), (A30), (A31), (A32) that are ortho or meta to one another, and, in the case of the structure (A29), also other than the aromatic carbon atoms bonded to X^{A29}, are each bonded directly to the carbon atoms labelled C^{A23} or C^{A24} in the structure (A2),
where X^{A29} in (A29) is selected from the group consisting of direct bond, heteroatom, which is preferably —O— or —S— and more preferably —O—,
divalent aliphatic radical, which is preferably alkylene, (thio)ether or a divalent radical of the formula ˜(CH₂)_{pA17}—C(═O)—(NR^{AP4})—C(═O)—(CH₂)_{pA18}˜,
where R^{AP4}=hydrogen radical, halogen radical, (halo)alkyl group, (halo)alkoxy group, preferably R^{AP4}=hydrogen radical, alkyl group, and p^{A17}=0 or 1 and p^{A18}=0 or 1,
   and X^{A29} is more preferably selected from the group consisting of —O—, alkylene, direct bond and X^{A29} is most preferably —O—,
   and the aromatic carbon atoms in the structures (A22), (A23), (A24), (A25), (A26), (A27), (A28), (A29), (A30), (A31), (A32) that do not have a bond to C^{A21}, C^{A22}, C^{A23}, C^{A24}, X^{A29} are bonded to a radical selected from the group consisting of hydrogen, (halo)alkyl group, alkenyl group, alkynyl group, (halo)alkoxy group, cycloalkyl group, carbonylalkyl, —C(═O)—H, carboxylic acid radical, carboxamide, carboxylic ester, sulfonic ester, phosphoric ester, amine, mono(halo)alkylamino, di(halo)alkylamino, cyano, hydroxyl, halogen, preferably to a radical selected from the group consisting of hydrogen, halogen, (halo)alkyl group, (halo)alkoxy group, carboxylic add radical, carboxylic ester.

A.3 In a preferred embodiment of the aforementioned point A.1 or A.2, what is meant in accordance with the invention in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) or (III) in the first aspect of the invention as defined in point I.1.α) and point I.1.β) is in each case a redox-active aromatic imide function (A) is that R¹, R^{1′}, R^{2′}, R^{3′} are in that case each independently selected from the group consisting of the following structures (A101), (A102), (A103), (A104):

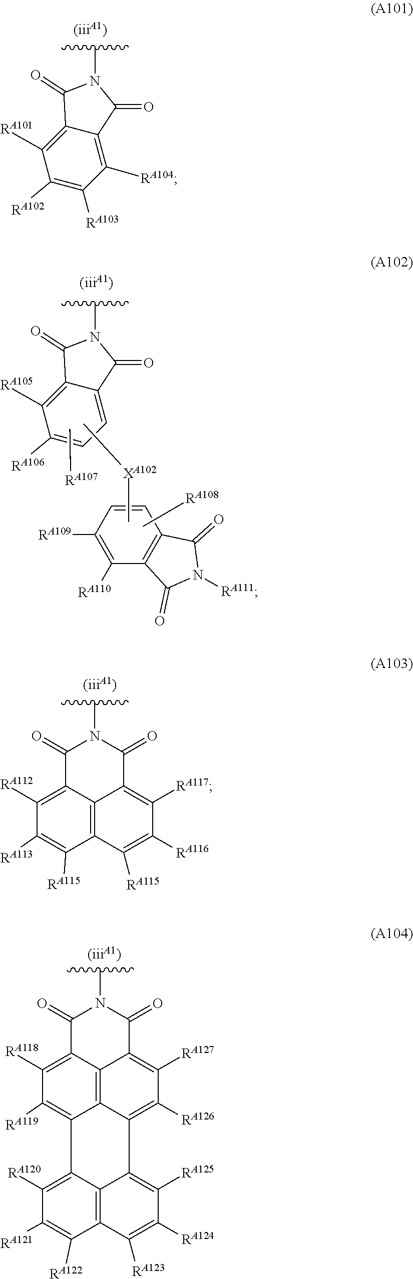

where the bond indicated by (ii^{A1}) for R¹ is the bond to L¹, for R^{1′} is the bond to L^{1′}, for R^{2′} is the bond to L^{2′}, for R³¹ is the bond to L^{3′},
where X^{A102} is selected from the group consisting of direct bond, heteroatom, which is preferably —O— or —S—, more preferably —O—,
divalent aliphatic radical, which is preferably alkylene, (thio)ether or a divalent radical of the formula ˜(CH₂)_{pA11}—C(═O)—(NR^{AP1})—C(═OHCH₂)_{pA12}˜ where R^{AP1}=hydrogen radical, halogen radical, (halo)alkyl group or (halo)alkoxy group, preferably R^{AP1}=hydrogen radical, alkyl group and p^{A11}=0 or 1 and p^{A12}=0 or 1,
and X^{A102} is more preferably selected from the group consisting of —O—, alkylene, direct bond and X^{A102} is most preferably —O—,
and where R^{A101}, R^{A102}, R^{A103}, R^{A104}, R^{A105}, R^{A106}, R^{A107}, R^{A108}, R^{A109}, R^{A110}, R^{A112}, R^{A113}, R^{A114}, R^{A115}, R^{A116}, R^{A117}, R^{A118}, R^{A119}, R^{A120}, R^{A121}, R^{A122}, R^{A123}, R^{A124}, R^{A125}, R^{A126}, R^{A127} are each independently selected from the group consisting of hydrogen, (halo)alkyl group, alkenyl group, alkynyl group, (halo)alkoxy group, cycloalkyl group, carbonylalkyl, —C(═O)—H, carboxylic acid radical, carboxamide, carboxylic ester, cyano, hydroxyl, halogen, preferably from the group consisting of hydrogen, halogen, (halo)alkyl group, (halo)alkoxy group, carboxylic acid radical, carboxylic ester, more preferably from the group consisting of hydrogen, halogen, (halo)alkyl group, (halo)alkoxy group, carboxylic ester, even more preferably from the group consisting of hydrogen, halogen, (halo)alkyl group, (halo)alkoxy group, even more preferably from the group consisting of hydrogen, alkyl group, and are most preferably each hydrogen,
and where R^{A111} is selected from the group consisting of hydrogen, (halo)alkyl group, alkenyl group, alkynyl group, (halo)alkoxy group, cycloalkyl group, carbonylalkyl, —C(═O)—H, carboxylic acid radical, carboxamide, carboxylic ester, cyano, hydroxyl, halogen, preferably from the group consisting of hydrogen, halogen, (halo)alkyl group, (halo)alkoxy group, carboxylic acid radical, carboxylic ester, preferably from the group consisting of hydrogen, halogen, (halo)alkyl group, (halo)alkoxy group, carboxylic acid radical, carboxylic ester, more preferably from the group consisting of hydrogen, halogen, (halo)alkyl group, (halo)alkoxy group, carboxylic ester, even more preferably from the group consisting of hydrogen, halogen, (halo)alkyl group, (halo)alkoxy group, even more preferably from the group consisting of hydrogen, alkyl group, and is most preferably hydrogen,
and R², R⁴, R⁵ in that case are each independently selected from the group consisting of the following structures (A201), (A202), (A203), (A204):

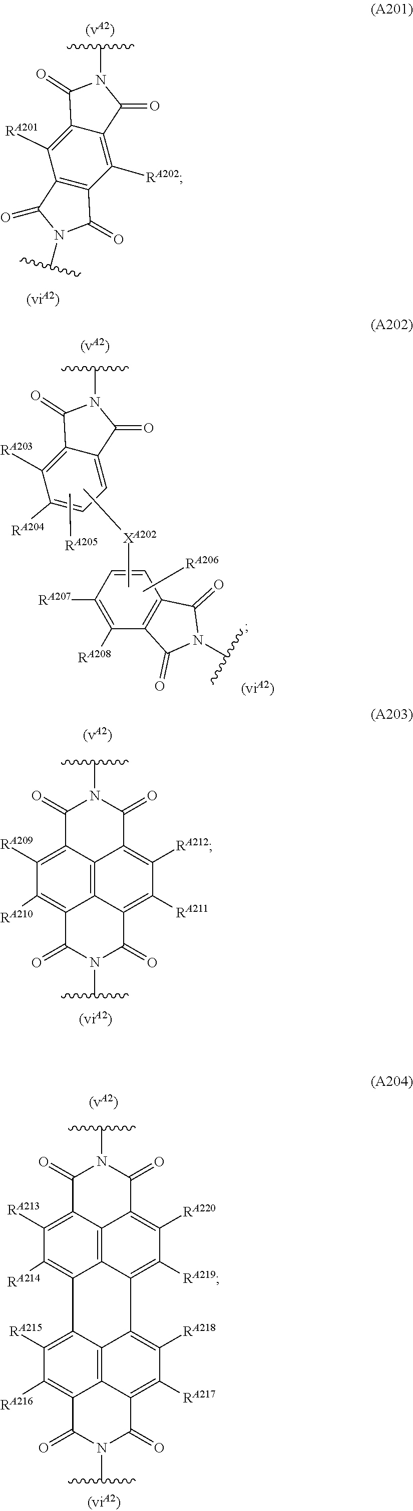

where the bond indicated by (v^{A2}) for R² denotes the bond to L², for R⁴ denotes the bond to L⁴, for R⁵ denotes the bond to L⁶,
where the bond indicated by (vi^{A2}) for R² denotes the bond to L³, for R⁴ denotes the bond to L⁵, for R⁵ denotes the bond to L⁷,
where X^{A202} in (A202) is a radical selected from the group consisting of direct bond, heteroatom, which is preferably —O— or —S— and more preferably —O—,
divalent aliphatic radical, which is preferably alkylene, (thio)ether or a divalent radical of the formula ˜(CH₂)_{pA17}—C(═O)—(NR^{AP4})—C(═O)—(CH₂)_{pA18}˜,
where R^{AP4}=hydrogen radical, halogen radical, (halo)alkyl group or (halo)alkoxy group, preferably R^{AP4}=hydrogen radical, alkyl group, and p^{A17}=0 or 1 and p^{A18}=0 or 1,
and X^{A202} is more preferably selected from the group consisting of —O—, alkylene, direct bond and X^{A202} is most preferably —O—,
and where R^{A201}, R^{A202}, R^{A203}, R^{A204}, R^{A205}, R^{A206}, R^{A207}, R^{A208}, R^{A209}, R^{A210}, R^{A211}, R^{A212}, R^{A213}, R^{A214}, R^{A215}, R^{A216}, R^{A217}, R^{A218}, R^{A219}, R^{A220} are each independently selected from the group consisting of hydrogen, (halo)alkyl group, alkenyl group, alkynyl group, (halo)alkoxy group, cycloalkyl group, carbonylalkyl, —C(═O)—H, carboxylic acid radical, carboxamide, carboxylic ester, cyano, hydroxyl, halogen, preferably from the group consisting of hydrogen, halogen, (halo)alkyl group, (halo)alkoxy group, carboxylic acid radical, carboxylic ester, more preferably from the group consisting of hydrogen, halogen, alkyl group, even more preferably from the group consisting of hydrogen, alkyl group, and are most preferably each hydrogen.

A.4 In a preferred embodiment of the aforementioned point A.3, what is meant in accordance with the invention in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) or (III) in the first aspect of the invention as defined in point I.1.α) and point I.1.β) is in each case a redox-active aromatic imide function (A) is that the R¹, R^{1′}, R^{2′}, R^{3′} radicals or the R¹, R^{1′} radicals or the R¹ radical are in that case each independently selected from the group consisting of the structures (A101), (A103) defined in A.3, and preferably each have a structure (A101), where the definitions of (iii^{A1}), R^{A101}, R^{A102}, R^{A103}, R^{A104}, R^{A112}, R^{A113}, R^{A114}, R^{A115}, R^{A118}, R^{A117} are defined in point A.3,

and the R², R⁴, R⁵ radicals in that case are each independently selected from the group consisting of the structures (A201), (A202) defined in A.3, and preferably each have a structure (201), where the definitions of (v^{A2}), (vi^{A2}), X^{A202}, R^{A201}, R^{A202}, R^{A203}, R^{A204}, R^{A205}, R^{A206}, R^{A207}, R^{A208} are as defined in point A.3.

A.5 In a particularly preferred embodiment of the first aspect of the invention as defined in I.1.β) or point A.4, the organic redox polymer P non-conjugated in the main chain which is encompassed by the electrode material in the first aspect of the invention especially comprises n¹ mutually joined repeat units of the chemical structure (I)

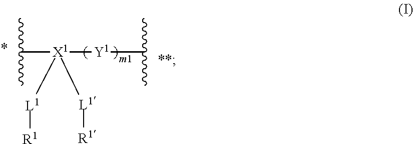

where n¹ is an integer ≥4, more preferably an integer in the range of 4 to 10⁶, more preferably an integer in the range of 10 to 10⁵, more preferably an integer in the range of 100 to 10⁴,
where m¹ is an integer ≥0, preferably an integer in the range of 0 to 10⁶, more preferably an integer in the range of 0 to 10⁵, more preferably an integer in the range of 0 to 10⁴, even more preferably an integer in the range from 0 to 10, and most preferably is in each case 0,
where the repeat units of the chemical structure (I) within the polymer P are the same or at least partly different from one another,
where the repeat units of the chemical structure (I) within the polymer are bonded to one another in such a way that the bond indicated by “**” in a particular repeat unit is joined by the bond indicated by “*” in the adjacent repeat unit,
where X¹ is a non-conjugated organic group which is formed by polymerization reaction from a group consisting of an organic double bond, an organic triple bond, an oxirane or an aziridine, or is a non-conjugated organic group which is formed by a polymer-analogous reaction,
where Y¹ is a non-conjugated organic spacer unit,
where L¹, L^{1′} are each independently selected from the group consisting of direct bond, organic linker unit,
and, preferably, L¹ is selected from the group consisting of direct bond, organic linker unit, and L^{1′} is a direct bond,
where R¹, R^{1′} are each independently a redox-active aromatic imide function (A), and R^{1′} may also be a hydrogen radical, and, preferably, R¹ is a redox-active aromatic imide function (A) and R^{1′} is a hydrogen radical,
where the redox-active aromatic imide function (A) preferably has the structure (A101)

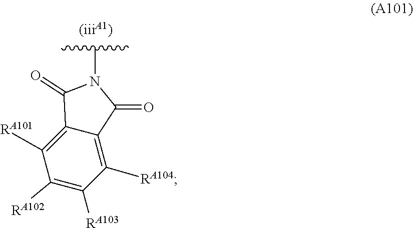

where the bond indicated by (ii^{A1}) for R¹ is the bond to L¹ and for R^{1′} is the bond to L^{1′},
and where R^{A101}, R^{A102}, R^{A103}, R^{A104} are each independently selected from the group consisting of hydrogen, (halo)alkyl group, alkenyl group, alkynyl group, (halo)alkoxy group, cycloalkyl group, carbonylalkyl, —C(═O)—H, carboxylic acid radical, carboxamide, carboxylic ester, cyano, hydroxyl, halogen, preferably from the group consisting of hydrogen, halogen, (halo)alkyl group, (halo)alkoxy group, carboxylic acid radical, carboxylic ester, more preferably from the group consisting of hydrogen, halogen, (halo)alkyl group, (halo)alkoxy group, carboxylic acid radical, carboxylic ester, even more preferably from the group consisting of hydrogen, halogen, (halo)alkyl group, even more preferably from the group consisting of hydrogen, alkyl group, and where R^{A101}, R^{A102}, R^{A103}, R^{A104} are most preferably each hydrogen.

### I.1.1.2 Redox-Active Organic Function Comprising at Least One Stable Oxygen Radical (B)

For the purposes of the invention, “redox-active organic function comprising at least one stable oxygen radical” means a redox-active oxygen radical comprising a stable oxygen radical (O.).

B.1 In the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the first aspect of the invention as defined in point I.1.α) and point I.1.β) are in each case a redox-active organic function comprising at least one stable oxygen radical (B), this means more particularly in accordance with the invention that the R¹, R², R⁴, R⁵, R^{1′}, R^{2′}, R^{3′} radicals or the R¹, R², R⁴, R⁵ radicals or the R¹, R^{1′} radicals or the R¹ radical are each independently selected from one of the following structures (B1), (B2):

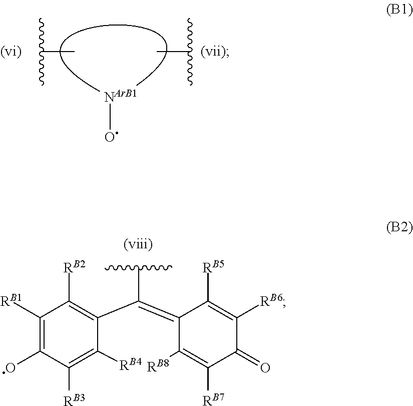

where, in the structure (B1), the nitrogen atom N^{ArB1} is part of an aliphatic ring Ar^{B1} which, as well as the nitrogen atom N^{ArB1}, may comprise further heteroatoms, preferably N, and groups comprising heteroatoms, preferably selected from the group consisting of —N(alkyl)-, —NH—, —N(O.)—, and which may be fused to one or more further aliphatic or aromatic rings and bonded via a spiro bond to one or more further aliphatic rings, each of which in turn optionally have further heteroatoms, preferably N, and groups containing heteroatoms, preferably selected from the group consisting of —N(alkyl)-, —NH—, —N(O.)—,
where at least one ring carbon atom of Ar^{B1} may be substituted by a group selected from (halo)alkyl group, alkenyl group, alkynyl group, (halo)alkoxy group, cycloalkyl group, carbonylalkyl, —C(═O)—H, carboxylic acid, carboxamide, carboxylic ester, sulfonic ester, phosphoric ester, amine, mono(halo)alkylamino, di(halo)alkylamino, cyano, hydroxyl, halogen, preferably by a group selected from (halo)alkyl group, cycloalkyl group,
where the bonds indicated by (vi) and (vii) proceed from ring carbon atoms of Ar^{B1} and/or from ring carbon atoms of the rings fused to Ar^{B1} or bonded via a spiro bond,
where, in the case that R¹=(B1), the bond indicated by (vi) is the bond to L¹ and the bond indicated by (vii) is a bond to hydrogen,
where, in the case that R^{1′}=(B1), the bond indicated by (vi) is the bond to L^{1′} and the bond indicated by (vii) is a bond to hydrogen,
where, in the case that R^{2′}=(B1), the bond indicated by (vi) is the bond to L^{2′} and the bond indicated by (vii) is a bond to hydrogen,
where, in the case that R^{3′}=(B1), the bond indicated by (vi) is the bond to L³¹ and the bond indicated by (vii) is a bond to hydrogen,
and where, in the case that R²=(B1), the bond indicated by (vi) is the bond to L² and the bond indicated by (vii) is the bond to L³,
and where, in the case that R⁴=(B1), the bond indicated by (vi) is the bond to L⁴ and the bond indicated by (vii) is the bond to L⁵,
and where, in the case that R⁵=(B1), the bond indicated by (vi) is the bond to L⁶ and the bond indicated by (vii) is the bond to L⁷,
where, in the case that R¹, R^{1′}, R^{2′} or R^{3′}=(B2), the bond indicated by (viii) is the bond to L¹, L^{1′}, L²′ or L³¹ and R^{B1}, R^{B2}, R^{B3}, R^{B4}, R^{B5}, R^{B8}, R^{B7}, R^{B8} are each independently selected from the group consisting of hydrogen, (halo)alkyl group, alkenyl group, alkynyl group, (halo)alkoxy group, cycloalkyl group, carbonylalkyl, —C(═O)—H, carboxylic acid, carboxamide, carboxylic ester, sulfonic ester, phosphoric ester, amine, mono(halo)alkylamino, di(halo)alkylamino, cyano, hydroxyl, halogen, preferably from the group consisting of hydrogen, (halo)alkyl, cycloalkyl,
and where, in the case that R², R⁴ or R⁵=(B2), the bond indicated by (viii) is the bond to L², L⁴ or L⁸ and one of the R^{B7}, R^{B8} radicals is a direct bond to L³, L⁵ or L⁷, where in that case the R^{B1}, R^{B2}, R^{B3}, R^{B4}, R^{B5}, R^{B8} radicals and that of the two R^{B7}, R^{B8} radicals that is not a direct bond to L³, L⁵ or L⁷ is in each case independently selected from the group consisting of hydrogen, (halo)alkyl group, alkenyl group, alkynyl group, (halo)alkoxy group, cycloalkyl group, carbonylalkyl, —C(═O)—H, carboxylic acid, carboxamide, carboxylic ester, sulfonic ester, phosphoric ester, amine, mono(halo)alkylamino, di(halo)alkylamino, cyano, hydroxyl, halogen, preferably from the group consisting of hydrogen, (halo)alkyl, cycloalkyl.

B.2 In a preferred embodiment of the aforementioned point B.1, the structure (B1) has a structure selected from the group consisting of the following structures (B11), (B12), (B13), preferably from the following structure (B11):

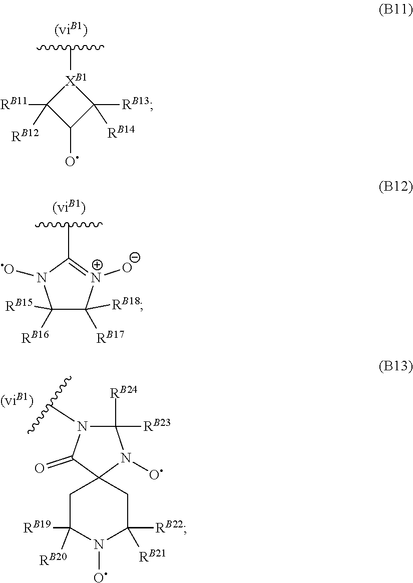

where
X^{B1} is a divalent radical selected from the group consisting of phenylene, preferably 1,2-phenylene, (α^{B11})-CR^{XB11}R^{XB12}—C′H—CR^{XB13}R^{XB14}-(β^{B11}), (α^{B11})-C′H—CR^{XB15}R^{XB18}-(β^{B11}), (α^{B11})-C′═CR^{XB17}-(β^{B11}),
where R^{XB11}, R^{XB12}, R^{XB13}, R^{XB14}, R^{XB15}, R^{XB18}, R^{XB17} are each independently selected from the group consisting of hydrogen, (halo)alkyl, and are preferably all hydrogen,
where “(α^{B11})” in each case indicates the bond to the carbon atom bonded to R^{B11} and R^{B12},
where “(β^{B11})” in each case indicates the bond to the carbon atom bonded to R^{B13} and R^{B14},
where “C′” indicates the carbon atom from which the bond (vi^{B1}) proceeds,
and where, in the case in which X^{B1}=phenylene, the bond indicated by (vi^{B1}) proceeds from one of the aromatic ring carbon atoms of the phenylene radical,
   and where, in the case that R¹, R^{1′}, R^{2′}, R^{3′} are selected from the group consisting of (B11), (B12), (B13), the bond indicated by (vi^{B1}) is the bond to L¹, L^{2′}, L^{3′} or L^{4′},
   and the R^{B11}, R^{B12}, R^{B13}, R^{B14}, R^{B15}, R^{B16}, R^{B17}, R^{B18}, R^{B19}, R^{B20}, R^{B21}, R^{B22}, R^{B23}, R^{B24} radicals are each independently selected from the group consisting of hydrogen, (halo)alkyl group, alkenyl group, alkynyl group, (halo)alkoxy group, cycloalkyl group, carbonylalkyl, —C(═O)—H, carboxylic add, carboxamide, carboxylic ester, sulfonic ester, phosphoric ester, amine, mono(halo)alkylamino, di(halo)alkylamino, cyano, hydroxyl, halogen, preferably from the group consisting of hydrogen, (halo)alkyl, cycloalkyl, alkyl, more preferably from the group consisting of hydrogen, methyl, ethyl, n-propyl, iso-propyl, even more preferably from the group consisting of hydrogen, methyl, and they are most preferably all methyl,
   and where, in the case that R², R⁴, R⁵ are selected from the group consisting of (B11), (B12), (B13), the bond indicated by (vi) is the bond to L², L⁴ or L⁸,
   and, in the case that R² is a structure of the formula (B11), (B12) or (B13), R^{B11}, R^{B15} or R^{B19} is in each case the bond to L³,
   and, in the case that R⁴ is a structure of the formula (B11), (B12) or (B13), R^{B11}, R^{B15} or R^{B19} is in each case the bond to L⁵,
   and, in the case that R⁵ is a structure of the formula (B11), (B12) or (B13), R^{B11}, R^{B15} or R^{B19} is in each case the bond to L⁷,
   and in that case those of the R^{B11}, R^{B15} and R^{B19} radicals that are not bonded to L³, L⁵ or L⁷ and the R^{B12}, R^{B13}, R^{B14}, R^{B18}, R^{B17}, R^{B18}, R^{B20}, R^{B21}, R^{B22}, R^{B23}, R^{B24} radicals are each independently selected from the group consisting of hydrogen, (halo)alkyl group, alkenyl group, alkynyl group, (halo)alkoxy group, cycloalkyl group, carbonylalkyl, —C(═O)—H, carboxylic add, carboxamide, carboxylic ester, sulfonic ester, phosphoric ester, amine, mono(halo)alkylamino, di(halo)alkylamino, cyano, hydroxyl, halogen, preferably from the group consisting of hydrogen, (halo)alkyl, cycloalkyl, alkyl, more preferably from the group consisting of hydrogen, methyl, ethyl, n-propyl, iso-propyl, even more preferably from the group consisting of hydrogen, methyl, and they are most preferably all methyl.

B.3 In a particularly preferred embodiment of the first aspect of the invention as defined in I.1.β), the organic redox polymer P non-conjugated in the main chain which is encompassed by the electrode material in the first aspect of the invention especially comprises n¹ mutually joined repeat units of the chemical structure (I)

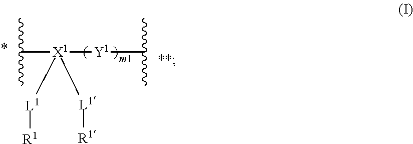

where n¹ is an integer ≥4, more preferably an integer in the range of 4 to 10⁶, more preferably an integer in the range of 10 to 10⁵, more preferably an integer in the range of 100 to 10⁴,
where m¹ is an integer ≥0, preferably an integer in the range of 0 to 10⁶, more preferably an integer in the range of 0 to 10⁵, more preferably an integer in the range of 0 to 10⁴, even more preferably an integer in the range of 0 to 10, and most preferably is in each case 0,
where the repeat units of the chemical structure (I) within the polymer P are the same or at least partly different from one another,
where the repeat units of the chemical structure (I) within the polymer are bonded to one another in such a way that the bond indicated by “**” in a particular repeat unit is joined by the bond indicated by “*” in the adjacent repeat unit,
where X¹ is a non-conjugated organic group which is formed by polymerization reaction from a group consisting of an organic double bond, an organic triple bond, an oxirane or an aziridine, or is a non-conjugated organic group which is formed by a polymer-analogous reaction,
where Y¹ is a non-conjugated organic spacer unit,
where L¹, L^{1′} are each independently selected from the group consisting of direct bond, organic linker unit, and, preferably, L¹ is selected from the group consisting of direct bond, organic linker unit, L^{1′} is a direct bond,
where R¹, R^{1′} are each independently a redox-active organic function comprising at least one stable oxygen radical (B), and R^{1′} may also be a hydrogen radical, and, preferably, R¹ is a redox-active organic function comprising at least one stable oxygen radical (B) and R^{1′} is a hydrogen radical,
where the redox-active organic function comprising at least one stable oxygen radical (B) is more preferably selected from the group consisting of the following structures (B111), (B112), (B113), (B114), (B115), (B116), (B117), even more preferably from the group consisting of the following structures (B111), (B112), (B113), (B114), (B115), and is most preferably a compound of the structure (B111):

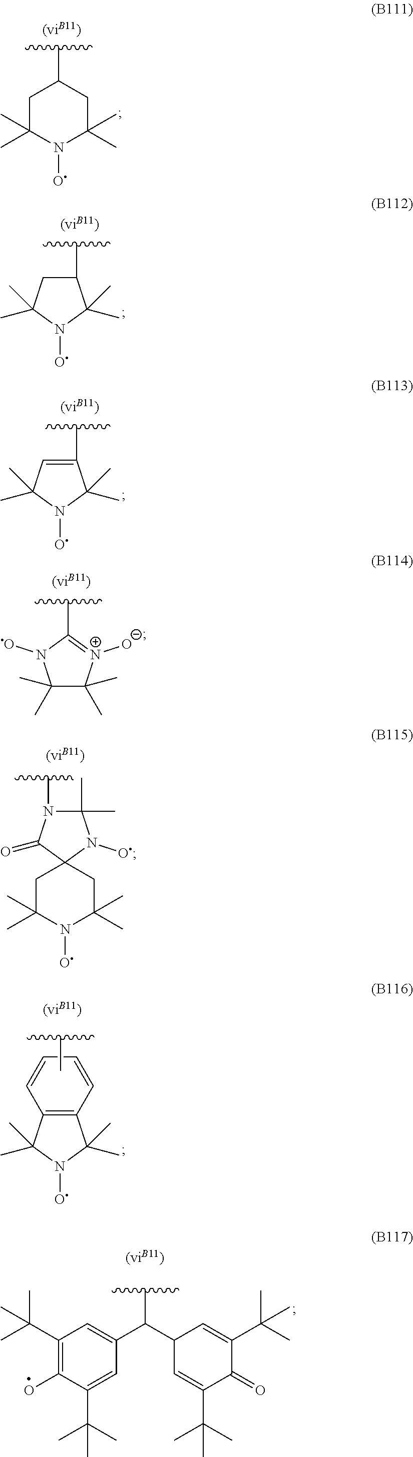

where, in each case, the bond indicated by (vi^{B11}) for R¹ is the bond to L¹ and for R^{1′} is the bond to L^{1′}.

### I.1.1.3 Redox-Active Anthraquinone/Carbazole Function (C)

In the context of the invention, “redox-active anthraquinone/carbazole function” means a redox-active organic radical comprising a base skeleton derived from anthraquinone or carbazole.

C.1 In the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the first aspect of the invention as defined in point I.1.α) and point I.1.β) are in each case a redox-active anthraquinone/carbazole function (C), this means more particularly in accordance with the invention that the R¹, R^{1′}, R^{2′}, R^{3′} or R¹, R^{1′} or R¹ radicals are each independently selected from the group consisting of the following structures (C1), (C2) and the R², R⁴, R⁵ radicals are each independently selected from the group consisting of the following structures (C3), (C4):

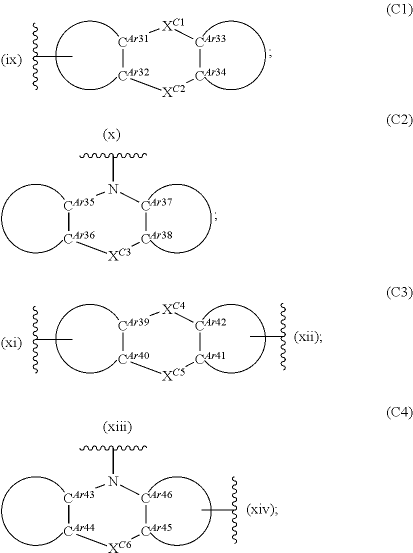

where, in the structure (C1), the carbon atoms represented by C^{Ar31} and C^{Ar32} are part of a (hetero)aromatic five-membered ring or six-membered ring, where at least one of the carbon atoms other than C^{Ar31} and C^{Ar32} and, if present, at least one nitrogen atom in this ring may be substituted by a substituent selected from the group consisting of (halo)alkyl group, alkenyl group, alkynyl group, (halo)alkoxy group, cycloalkyl group, carbonylalkyl, —C(═O)—H, carboxylic acid, carboxamide, carboxylic ester, sulfonic ester, phosphoric ester, amine, mono(halo)alkylamino, di(halo)alkylamino, cyano, hydroxyl, halogen, preferably by a group selected from halogen, (halo)alkyl group, (halo)alkoxy group,
where, in the structure (C1), the carbon atoms represented by C^{Ar33} and C^{Ar34} are part of a (hetero)aromatic five-membered ring or six-membered ring, where at least one of the carbon atoms other than C^{Ar33} and C^{Ar34} and, if present, at least one nitrogen atom in this ring may be substituted by a substituent selected from the group consisting of (halo)alkyl group, alkenyl group, alkynyl group, (halo)alkoxy group, cycloalkyl group, carbonylalkyl, —C(═O)—H, carboxylic acid, carboxamide, carboxylic ester, sulfonic ester, phosphoric ester, amine, mono(halo)alkylamino, di(halo)alkylamino, cyano, hydroxyl, halogen, preferably by a group selected from halogen, (halo)alkyl group, (halo)alkoxy group,
where, in the structure (C2), the carbon atoms represented by C^{Ar35} and C^{Ar38} or by C^{Ar37} and C^{Ar38} are each part of a (hetero)aromatic five-membered ring or six-membered ring, where at least one of the carbon atoms other than C^{Ar35}, C^{Ar38}, C^{Ar37}, C^{Ar38} and, if present, at least one nitrogen atom in this ring may be substituted by a substituent selected from the group consisting of (halo)alkyl group, alkenyl group, alkynyl group, (halo)alkoxy group, cycloalkyl group, carbonylalkyl, —C(═O)—H, carboxylic acid, carboxamide, carboxylic ester, sulfonic ester, phosphoric ester, amine, mono(halo)alkylamino, di(halo)alkylamino, cyano, hydroxyl, halogen, preferably by a group selected from halogen, (halo)alkyl group, (halo)alkoxy group,
where, in the structure (C3), the carbon atoms represented by C^{Ar39} and C^{Ar40} or by C^{Ar41} and C^{Ar42} are each part of a (hetero)aromatic five-membered ring or six-membered ring, where at least one of the carbon atoms other than C^{Ar39}, C^{Ar40}, C^{Ar41} and C^{Ar42} and, if present, at least one nitrogen atom in the two rings may be substituted by a substituent selected from the group consisting of (halo)alkyl group, alkenyl group, alkynyl group, (halo)alkoxy group, cycloalkyl group, carbonylalkyl, —C(═O)—H, carboxylic acid, carboxamide, carboxylic ester, sulfonic ester, phosphoric ester, amine, mono(halo)alkylamino, di(halo)alkylamino, cyano, hydroxyl, halogen, preferably by a group selected from halogen, (halo)alkyl group, (halo)alkoxy group,
where, in the structure (C4), the carbon atoms represented by C^{Ar43} and C^{Ar44} are part of a (hetero)aromatic five-membered ring or six-membered ring, where at least one of the carbon atoms other than C^{Ar43} and C^{Ar44} and, if present, at least one nitrogen atom in this ring may be substituted by a substituent selected from the group consisting of (halo)alkyl group, alkenyl group, alkynyl group, (halo)alkoxy group, cycloalkyl group, carbonylalkyl, —C(═O)—H, carboxylic acid, carboxamide, carboxylic ester, sulfonic ester, phosphoric ester, amine, mono(halo)alkylamino, di(halo)alkylamino, cyano, hydroxyl, halogen, preferably by a group selected from halogen, (halo)alkyl group, (halo)alkoxy group,
where, in the structure (C4), the carbon atoms represented by C^{Ar45} and C^{Ar46} are part of a (hetero)aromatic five-membered ring or six-membered ring, where at least one of the carbon atoms other than C^{Ar45} and C^{Ar46} and, if present, at least one nitrogen atom in this ring may be substituted by a substituent selected from the group consisting of (halo)alkyl group, alkenyl group, alkynyl group, (halo)alkoxy group, cycloalkyl group, carbonylalkyl, —C(═O)—H, carboxylic acid, carboxamide, carboxylic ester, sulfonic ester, phosphoric ester, amine, mono(halo)alkylamino, di(halo)alkylamino, cyano, hydroxyl, halogen, preferably by a group selected from halogen, (halo)alkyl group, (halo)alkoxy group,
where X^{C1}, X^{C2}, X^{C3}, X^{C4}, X^{C5}, X^{C6} are each independently selected from the group consisting of —C(═Y^{C1})—, —O—, —S—, —NH—, —N(haloalkyl)-, —N(alkyl)-,
and X^{C2}, X^{C3}, X^{C5}, X^{C6} may also each be a direct bond,
and where X^{C1}, X^{C4} may also be a group of the general formula (α^{C1})-C(═O)—C(═O)-(β^{C1}).
where (α^{C1}) indicates the bond to C^{Ar31} or C^{Ar39} and (β^{C1}) indicates the bond to C^{Ar33} or C^{Ar42}, where Y^{C1} is selected from the group consisting of O, S, and one of the following structures (Y^{C11}), (Y^{C12}), (Y^{C13}):

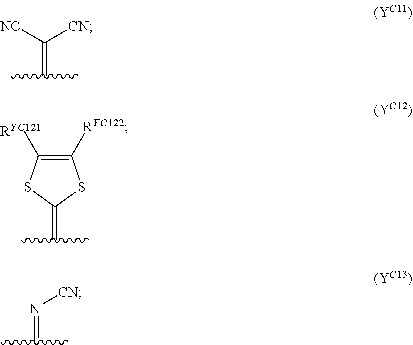

where R^{YC121}, R^{YC122} are independently selected from the group consisting of hydrogen, (halo)alkyl group, alkenyl group, alkynyl group, (halo)alkoxy group, cycloalkyl group, carbonylalkyl, —C(═O)—H, carboxylic acid, carboxamide, carboxylic ester, sulfonic ester, phosphoric ester, amine, mono(halo)alkylamino, di(halo)alkylamino, cyano, hydroxyl, halogen, preferably selected from the group consisting of hydrogen, halogen, (halo)alkyl group, (halo)alkoxy group, more preferably from the group consisting of hydrogen, alkyl group, alkoxy group, even more preferably from the group consisting of hydrogen, alkyl group, and are most preferably both hydrogen,
where the (hetero)aromatic five-membered ring or six-membered ring comprising C^{Ar31} and C^{Ar32} may be bridged to the (hetero)aromatic five-membered ring or six-membered ring comprising C^{Ar33} and C^{Ar34}, in addition to X^{C1} and X^{C2}, via a further divalent organic radical which is preferably an alkylene radical or a radical of the formula —C(═O)—C(═O)—,
where the (hetero)aromatic five-membered ring or six-membered ring comprising C^{Ar39} and C^{Ar40} may be bridged to the (hetero)aromatic five-membered ring or six-membered ring comprising C^{Ar41} and C^{A142}, in addition to X^{C4} and X^{C5}, via a further divalent organic radical which is preferably an alkylene radical or a radical of the formula —C(═O)—C(═O)—,
where the bond indicated by (ix) proceeds from one of the atoms that form the (hetero)aromatic five-membered or six-membered ring including C^{Ar31} and C^{Ar32},
where the bond indicated by (xi) proceeds from one of the atoms that form the (hetero)aromatic five-membered or six-membered ring including C^{Ar39} and C^{Ar40},
where the bond indicated by (xii) proceeds from one of the atoms that form the (hetero)aromatic five-membered or six-membered ring including C^{Ar41} and C^{Ar42},
where the bond indicated by (xiv) proceeds from one of the atoms that form the (hetero)aromatic five-membered or six-membered ring including C^{Ar45} and C^{Ar46},
and where
in the case that R¹=(C1) or (C2), the bonds indicated by (ix) or (x) are in each case the bond to L¹,
in the case that R^{1′}=(C1) or (C2), the bonds indicated by (ix) or (x) are in each case the bond to L¹
in the case that R^{2′}=(C1) or (C2), the bonds indicated by (ix) or (x) are in each case the bond to L^{2′},
in the case that R^{3′}=(C1) or (C2), the bonds indicated by (ix) or (x) are in each case the bond to L^{3′},
in the case that R²=(C3) or (C4), the bonds indicated by (xi) or (xiii) are in each case the bond to L² and the bonds indicated by (xii) or (xiv) are in each case the bond to L³,
in the case that R⁴=(C3) or (C4), the bonds indicated by (xi) or (xiii) are in each case the bond to L⁴ and the bonds indicated by (xii) or (xiv) are in each case the bond to L⁵,
in the case that R⁵=(C3) or (C4), the bonds indicated by (xi) or (xiii) are in each case the bond to
L⁶ and the bonds indicated by (xii) or (xiv) are in each case the bond to L⁷.

C.2 In a preferred embodiment of the aforementioned point C.1, what is meant in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the first aspect of the invention as defined in point I.1.α) and point I.1.β) are each a redox-active anthraquinone/carbazole function (C) is that the R¹, R², R⁴, R⁵, R^{1′}, R^{2′}, R^{3′} radicals or the R¹, R², R⁴, R⁵ radicals or the R¹, R^{1′} radicals or the R¹ radical are each independently selected from one of the following structures (C11), (C12), (C13), (C14), (C15), (C16), (C17), (C18), (C19), (C20):

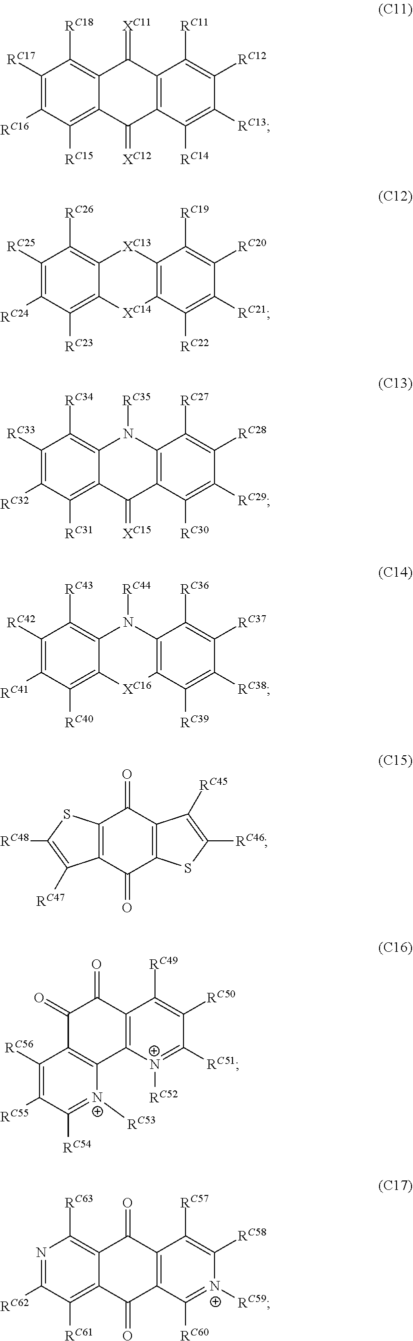

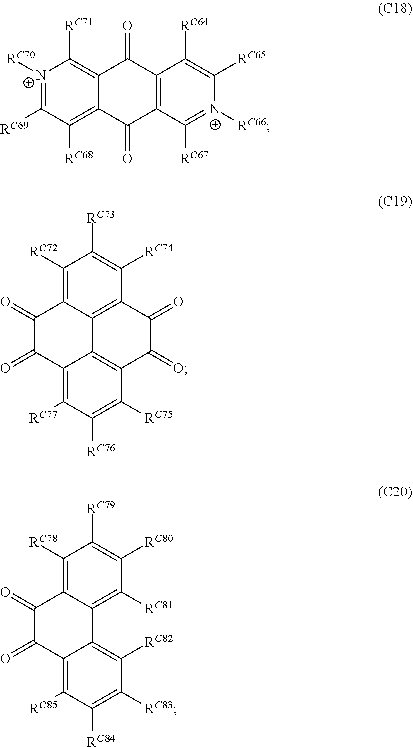

where X^{C11}, X^{C12}, X^{C15} is selected from the group consisting of O, S, and one of the structures (Y^{C11}), (Y^{C12}), (Y^{C13}) defined in point C.1,
where X^{C13}, X^{C14}, X^{C16} are selected from the group consisting of —O—, —S—, —NH—, —N(haloalkyl)-, —N(alkyl)-, preferably from the group consisting of —O—, —S—, —NH—, —N(alkyl)-, even more preferably from the group consisting of —O—, —S—, —NH—,
and X^{C14}, X^{C16} may also each be a direct bond,
where, when R¹, R^{1′}, R^{2′} or R^{3′} have the structure (C11), one of the R^{C11}, R^{C12} radicals is the bond to L¹, L^{1′}, L^{2′} or L^{3′},
and where, when R², R⁴, R⁵ have the structure (C11), one of the R^{C11}, R^{C12}, R^{C13}, R^{C14}, R^{C15}, R^{C16}, R^{C17}, R^{C18} radicals is the bond to L², L⁴ or L⁶ and another of the R^{C11}, R^{C12}, R^{C13}, R^{C14}, R^{C15}, R^{C16}, R^{C17}, R^{C18} radicals is the bond to L³, L⁵ or L⁷,
where, when R¹, R^{1′}, R^{2′} or R^{3′} have the structure (C12), one of the R^{C19}, R^{C20} radicals is the bond to L¹, L^{1′}, L^{2′} or L^{3′},
and where, when R², R⁴, R⁵ have the structure (C12), one of the R^{C19}, R^{C20}, R^{C21}, R^{C22}, R^{C23}, R^{C24}, R^{C25}, R^{C26} radicals is the bond to L², L⁴ or L⁸ and another of the R^{C19}, R^{C20}, R^{C21}, R^{C22}, R^{C23}, R^{C24}, R^{C25}, R^{C26} radicals is the bond to L³, L⁵ or L⁷,
where, when R¹, R^{1′}, R^{2′} or R^{3′} have the structure (C13), one of the R^{C27}, R^{C28}, R^{C29}, R^{C30}, R^{C35} radicals is the bond to L¹, L^{1′}, L^{2′} or L^{3′}, and where, when R², R⁴, R⁵ have the structure (C13), one of the R^{C27}, R^{C28}, R^{C29}, R^{C30}, R^{C31}, R^{C32}, R^{C33}, R^{C34}, R^{C35} radicals is the bond to L², L⁴ or L⁸ and another of the R^{C27}, R^{C28}, R^{C29}, R^{C30}, R^{C31}, R^{C32}, R^{C33}, R^{C34}, R^{C35} radicals is the bond to L³, L⁵ or L⁷,
where, when R¹, R^{1′}, R^{2′} or R^{3′} have the structure (C14), one of the R^{C38}, R^{C37}, R^{C38}, R^{C39}, R^{C44} radicals is the bond to L¹, L^{1′}, L^{2′} or L^{3′},
and where, when R², R⁴, R⁵ have the structure (C14), one of the R^{C38}, R^{C37}, R^{C38}, R^{C39}, R^{C40}, R^{C41}, R^{C42}, R^{C43}, R^{C44} radicals is the bond to L², L⁴ or L⁸ and another of the R^{C38}, R^{C37}, R^{C38}, R^{C39}, R^{C40}, R^{C41}, R^{C42}, R^{C43}, R^{C44} radicals is the bond to L³, L⁵ or L⁷,
where, when R¹, R^{1′}, R^{2′} or R^{3′} have the structure (C15), one of the R^{C45}, R^{C48} radicals is the bond to L¹, L^{1′}, L^{2′} or L^{3′},
and where, when R², R⁴, R⁵ have the structure (C15), one of the R^{C45}, R^{C48}, R^{C47}, R^{C48} radicals is the bond to L², L⁴ or L⁸ and another of the R^{C45}, R^{C48}, R^{C47}, R^{C48} radicals is the bond to L³, L⁵ or L⁷,
where, when R¹, R^{1′}, R^{2′} or R^{3′} have the structure (C16), one of the R^{C49}, R^{C50}, R^{C51}, R^{C52} radicals is the bond to L¹, L^{1′}, L^{2′} or L^{3′},
and where, when R², R⁴, R⁵ have the structure (C16), one of the R^{C49}, R^{C50}, R^{C51}, R^{C52}, R^{C53}, R^{C54}, R^{C55}, R^{C58} radicals is the bond to L², L⁴ or L⁶ and another of the R^{C49}, R^{C50}, R^{C51}, R^{C52}, R^{C53}, R^{C54}, R^{C55}, R^{C58} radicals is the bond to L³, L⁵ or L⁷,
where, when R¹, R^{1′}, R^{2′} or R^{3′} have the structure (C17), one of the R^{C57}, R^{C58}, R^{C59}, R^{C80}, R^{C81}, R^{C82}, R^{C83} radicals is the bond to L¹, L^{1′}, L^{2′} or L^{3′},
and where, when R², R⁴, R⁵ have the structure (C17), one of the R^{C57}, R^{C58}, R^{C59}, R^{C80}, R^{C81}, R^{C82}, R^{C83} radicals is the bond to L², L⁴ or L⁸ and another of the R^{C57}, R^{C58}, R^{C59}, R^{C80}, R^{C81}, R^{C82}, R^{C83} radicals is the bond to L³, L⁵ or L⁷,
where, when R¹, R^{1′}, R^{2′} or R^{3′} have the structure (C18), one of the R^{C84}, R^{C85}, R^{C88}, R^{C87} radicals is the bond to L¹, L^{1′}, L^{2′} or L^{3′},
and where, when R², R⁴, R⁵ have the structure (C18), one of the R^{C84}, R^{C85}, R^{C88}, R^{C87}, R^{C88}, R^{C89}, R^{C70}, R^{C71} radicals is the bond to L², L⁴ or L⁸ and another of the R^{C84}, R^{C85}, R^{C88}, R^{C87}, R^{C88}, R^{C89}, R^{C70}, R^{C71} radicals is the bond to L³, L⁵ or L⁷,
where, when R¹, R^{1′}, R^{2′} or R^{3′} have the structure (C19), one of the R^{C72}, R^{C73} radicals is the bond to L¹, L^{1′}, L^{2′} or L^{3′},
and where, when R², R⁴, R⁵ have the structure (C19), one of the R^{C72}, R^{C73}, R^{C74}, R^{C75}, R^{C78}, R^{C77} radicals is the bond to L², L⁴ or L⁸ and another of the R^{C72}, R^{C73}, R^{C74}, R^{C75}, R^{C76}, R^{C77} radicals is the bond to L³, L⁵ or L⁷,
where, when R¹, R^{1′}, R^{2′} or R^{3′} have the structure (C20), one of the R^{C78}, R^{C79}, R^{C80}, R^{C81} radicals is the bond to L¹, L^{1′}, L^{2′} or L^{3′},
and where, when R², R⁴, R⁵ have the structure (C20), one of the R^{C78}, R^{C79}, R^{C80}, R^{C81}, R^{C82}, R^{C83}, R^{C84}, R^{C85} radicals is the bond to L², L⁴ or L⁸ and another of the R^{C78}, R^{C79}, R^{C80}, R^{C81}, R^{C82}, R^{C83}, R^{C84}, R^{C85} radicals is the bond to L³, L⁵ or L⁷,
and where those of the R^{C11}, R^{C12}, R^{C13}, R^{C14}, R^{C15}, R^{C18}, R^{C17}, R^{C18}, R^{C19}, R^{C20}, R^{C21}, R^{C22}, R^{C23}, R^{C24}, R^{C25}, R^{C26}, R^{C27}, R^{C28}, R^{C29}, R^{C30}, R^{C31}, R^{C32}, R^{C33}, R^{C34}, R^{C36}, R^{C37}, R^{C38}, R^{C39}, R^{C40}, R^{C41}, R^{C42}, R^{C43}, R^{C45}, R^{C46}, R^{C47}, R^{C48}, R^{C49}, R^{C50}, R^{C51}, R^{C54}, R^{C55}, R^{C56}, R^{C57}, R^{C58}, R^{C60}, R^{C61}, R^{C62}, R^{C63}, R^{C64}, R^{C65}, R^{C67}, R^{C66}, R^{C69}, R^{C71}, R^{C72}, R^{C73}, R^{C74}, R^{C75}, R^{C76}, R^{C77}, R^{C78}, R^{C79}, R^{C80}, R^{C81}, R^{C82}, R^{C83}, R^{C84}, R^{C85} radicals that are not a bond to L¹, L^{1′}, L^{2′}, L^{3′}, L², L³, L⁴, L⁵, L⁸ or L⁷ are each independently selected from the group consisting of hydrogen, (halo)alkyl group, alkenyl group, alkynyl group, (halo)alkoxy group, cycloalkyl group, carbonylalkyl, —C(═O)—H, carboxylic acid, carboxamide, carboxylic ester, sulfonic ester, phosphoric ester, amine, mono(halo)alkylamino, di(halo)alkylamino, cyano, hydroxyl, halogen, preferably selected from the group consisting of hydrogen, halogen, (halo)alkyl group, (halo)alkoxy group,
and where those of the R^{C35}, R^{C44}, R^{C52}, R^{C53}, R^{C59}, R^{C86}, R^{C70} radicals that are not a bond to L¹, L^{1′}, L^{2′}, L³⁺, L², L³, L⁴, L⁵, L⁶ or L⁷ are each independently selected from the group consisting of hydrogen, (halo)alkyl group, alkenyl group, alkynyl group, (halo)alkoxy group, cycloalkyl group, carbonylalkyl, —C(═O)—H, carboxylic acid radical, carboxamide, carboxylic ester, cyano, hydroxyl, halogen, preferably selected from the group consisting of hydrogen, halogen, (halo)alkyl group, (halo)alkoxy group.

C.3 In a preferred embodiment of the aforementioned point C.2, what is meant in accordance with the invention in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the first aspect of the invention as defined in point I.1.α) and point I.1.β) are each a redox-active anthraquinone/carbazole function (C) is that the R¹, R^{1′}, R^{2′}, R^{3′} radicals or the R¹, R^{1′} radicals or the R¹ radical are selected from the following structures (C101), (C102), (C103), (C104), (C105), (C106), (C107), (C108), (C109), (C110), (C111), (C112), (C113), (C114), preferably from the group consisting of the following structures (C101), (C102), (C103), (C104), (C105), (C113):

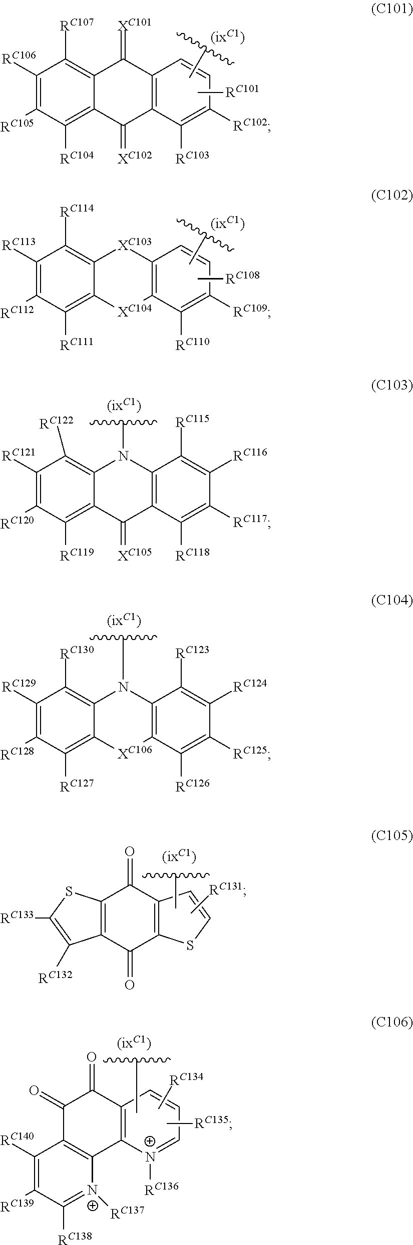

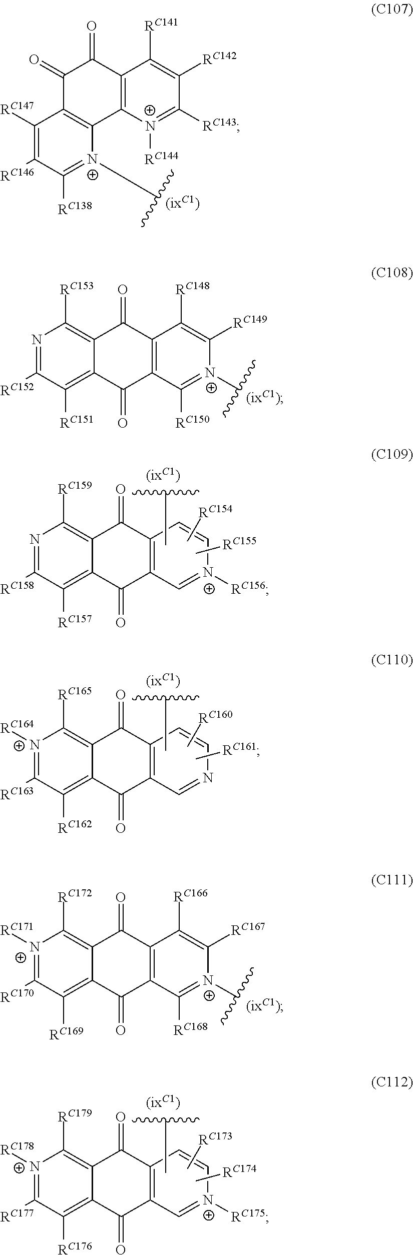

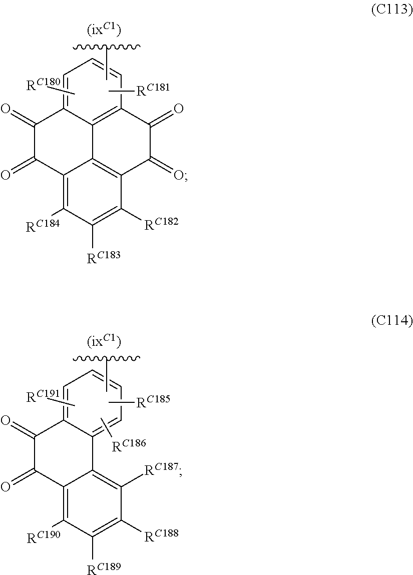

where the bond indicated by (ix^{C1}) denotes the bond to L¹, L^{1′}, L^{2′} or L^{3′},
where X^{C101}, X^{C102}, X^{C105} is selected from the group consisting of O, S, and one of the structures (Y^{C11}), (Y^{C12}), (Y^{C13}) defined in point C.1,
where X^{C103}, X^{C104}, X^{C106} are selected from the group consisting of —O—, —S—, —NH—, —N(haloalkyl)-, —N(alkyl)-, preferably from the group consisting of —O—, —S—, —NH—, —N(alkyl)-, even more preferably from the group consisting of —O—, —S—, —NH—,
and X^{C104}, X^{C106} may also each be a direct bond,
and where the R^{C101}, R^{C102}, R^{C103}, R^{C104}, R^{C105}, R^{C106}, R^{C107}, R^{C108}, R^{C109}, R^{C110}, R^{C111}, R^{C112}, R^{C113}, R^{C114}, R^{C115}, R^{C116}, R^{C117}, R^{C118}, R^{C119}, R^{C120}, R^{C121}, R^{C122}, R^{C123}, R^{C124}, R^{C125}, R^{C126}, R^{C127}, R^{C128}, R^{C129}, R^{C130}, R^{C131}, R^{C132}, R^{C133}, R^{C134}, R^{C135}, R^{C138}, R^{C139}, R^{C140}, R^{C141}, R^{C142}, R^{C143}, R^{C145}, R^{C146}, R^{C147}, R^{C148}, R^{C149}, R^{C150}, R^{C151}, R^{C152}, R^{C153}, R^{C154}, R^{C155}, R^{C157}, R^{C158}, R^{C159}, R^{C180}, R^{C161}, R^{C162}, R^{C163}, R^{C165}, R^{C168}, R^{C167}, R^{C168}, R^{C189}, R^{C170}, R^{C172}, R^{C173}, R^{C174}, R^{C176}, R^{C177}, R^{C179}, R^{C180}, R^{C181}, R^{C182}, R^{C183}, R^{C184}, R^{C185}, R^{C188}, R^{C187}, R^{C188}, R^{C189}, R^{C190}, R^{C191} radicals are each independently selected from the group consisting of hydrogen, (halo)alkyl group, alkenyl group, alkynyl group, (halo)alkoxy group, cycloalkyl group, carbonylalkyl, —C(═O)—H, carboxylic acid, carboxamide, carboxylic ester, sulfonic ester, phosphoric ester, amine, mono(halo)alkylamino, di(halo)alkylamino, cyano, hydroxyl, halogen, preferably selected from the group consisting of hydrogen, halogen, (halo)alkyl group, (halo)alkoxy group,
and where the R^{C138}, R^{C137}, R^{C144}, R^{C158}, R^{C184}, R^{C171}, R^{C175}, R^{C178} radicals are each independently selected from the group consisting of hydrogen, (halo)alkyl group, alkenyl group, alkynyl group, (halo)alkoxy group, cycloalkyl group, carbonylalkyl, —C(═O)—H, carboxylic acid radical, carboxamide, carboxylic ester, cyano, hydroxyl, halogen, preferably selected from the group consisting of hydrogen, halogen, (halo)alkyl group, (halo)alkoxy group,
and R², R⁴, R⁵ are selected from the group consisting of the following structures (C201), (C202), (C203), (C204), (C205), (C206), (C207), (C208), (C209), (C210), (C211), (C212), (C213), preferably from the group consisting of the following structures (C201), (C202), (C203), (C204), (C205) (C212):

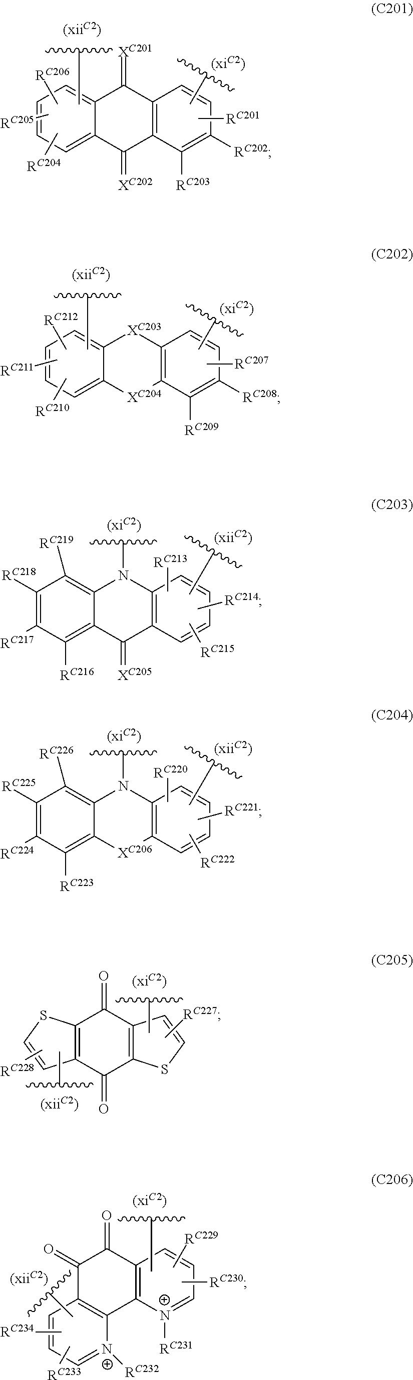

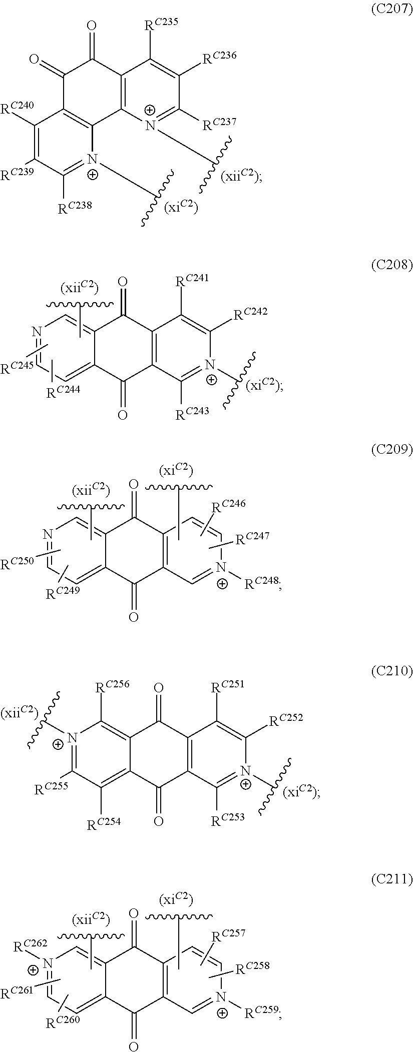

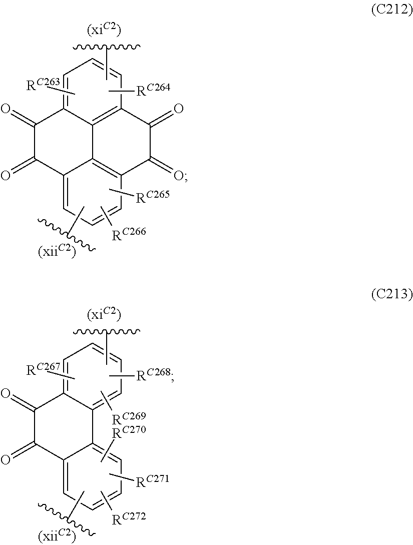

where the bond indicated by (xi^{C2}) denotes the bond to L², L⁴ or L⁶, and the bond indicated by (xii^{C2}) denotes the bond to L³, L⁵ or L⁷,
where X^{C201}, X^{C202}, X^{C205} is selected from the group consisting of O, S, and one of the structures (Y^{C11}), (Y^{C12}), (Y^{C13}) defined in point C.1,
where X^{C203}, X^{C204}, X^{C206} are selected from the group consisting of —O—, —S—, —NH—, —N(haloalkyl)-, —N(alkyl)-, preferably from the group consisting of —O—, —S—, —NH—, —N(alkyl)-, even more preferably from the group consisting of —O—, —S—, —NH—,
and X^{C204}, X^{C208} may also each be a direct bond,
and where the R^{C201}, R^{C202}, R^{C203}, R^{C204}, R^{C205}, R^{C208}, R^{C207}, R^{C208}, R^{C209}, R^{C210}, R^{C211}, R^{C212}, R^{C213}, R^{C214}, R^{C215}, R^{C218}, R^{C217}, R^{C218}, R^{C219}, R^{C220}, R^{C221}, R^{C222}, R^{C223}, R^{C224}, R^{C225}, R^{C226}, R^{C227}, R^{C228}, R^{C229}, R^{C230}, R^{C233}, R^{C234}, R^{C235}, R^{C236}, R^{C237}, R^{C238}, R^{C239}, R^{C240}, R^{C241}, R^{C242}, R^{C243}, R^{C244}, R^{C245}, R^{C246}, R^{C247}, R^{C249}, R^{C250}, R^{C251}, R^{C252}, R^{C253}, R^{C254}, R^{C255}, R^{C256}, R^{C257}, R^{C258}, R^{C260}, R^{C261}, R^{C263}, R^{C264}, R^{C285}, R^{C288}, R^{C287}, R^{C288}, R^{C289}, R^{C270}, R^{C271}, R^{C272} radicals are each independently selected from the group consisting of hydrogen, (halo)alkyl group, alkenyl group, alkynyl group, (halo)alkoxy group, cycloalkyl group, carbonylalkyl, —C(═O)—H, carboxylic acid, carboxamide, carboxylic ester, sulfonic ester, phosphoric ester, amine, mono(halo)alkylamino, di(halo)alkylamino, cyano, hydroxyl, halogen, preferably selected from the group consisting of hydrogen, halogen, (halo)alkyl group, (halo)alkoxy group,
and where the R^{C231}, R^{C232}, R^{C248}, R^{C259}, R^{C282} radicals are each independently selected from the group consisting of hydrogen, (halo)alkyl group, alkenyl group, alkynyl group, (halo)alkoxy group, cycloalkyl group, carbonylalkyl, —C(═O)—H, carboxylic acid radical, carboxamide, carboxylic ester, cyano, hydroxyl, halogen, preferably selected from the group consisting of hydrogen, halogen, (halo)alkyl group, (halo)alkoxy group.

C.4 In a more preferred embodiment of the aforementioned point C.3, what is meant in accordance with the invention in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) or (III) in the first aspect of the invention as defined in point I.1.α) and point I.1.β) is in each case a redox-active anthraquinone/carbazole function (C) is that the R¹, R^{1′}, R^{2′}, R^{3′} radicals or the R¹, R^{1′} radicals or the R¹ radical are each independently selected from the group consisting of the following structures (C301), (C302), (C303), (C304), (C305), (C306), (C307):

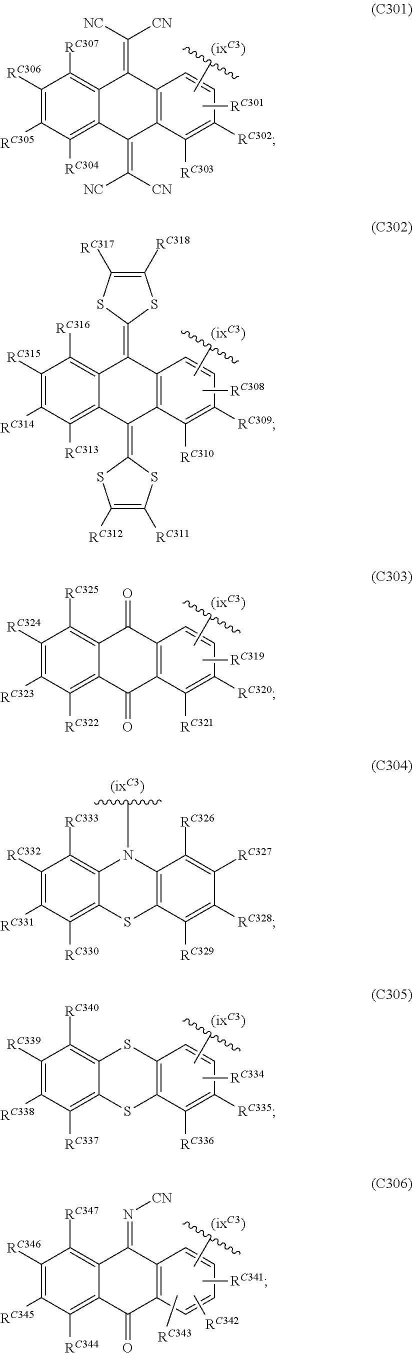

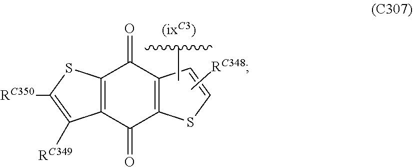

where R^{C301}, R^{C302}, R^{C303}, R^{C304}, R^{C305}, R^{C308}, R^{C307}, R^{C308}, R^{C309}, R^{C310}, R^{C311}, R^{C312}, R^{C313}, R^{C314}, R^{C315}, R^{C316}, R^{C317}, R^{C318}, R^{C319}, R^{C320}, R^{C321}, R^{C322}, R^{C323}, R^{C324}, R^{C325}, R^{C326}, R^{C327}, R^{C328}, R^{C329}, R^{C330}, R^{C331}, R^{C332}, R^{C333}, R^{C334}, R^{C335}, R^{C336}, R^{C337}, R^{C338}, R^{C339}, R^{C340}, R^{C341}, R^{C342}, R^{C343}, R^{C344}, R^{C345}, R^{C346}, R^{C347}, R^{C349}, R^{C350} are each independently selected from the group consisting of hydrogen, halogen, (halo)alkyl group, (halo)alkoxy group, preferably from the group consisting of hydrogen, alkyl group, and are even more preferably all hydrogen,
and where the bond indicated by (ix^{C3}) in each case denotes the bond to L¹, L^{1′}, L^{2′} or L^{3′},
and the R², R⁴, R⁵ radicals are selected from the group consisting of the structures (C401), (C402), (C403), (C404), (C405), (C406), (C407) defined below

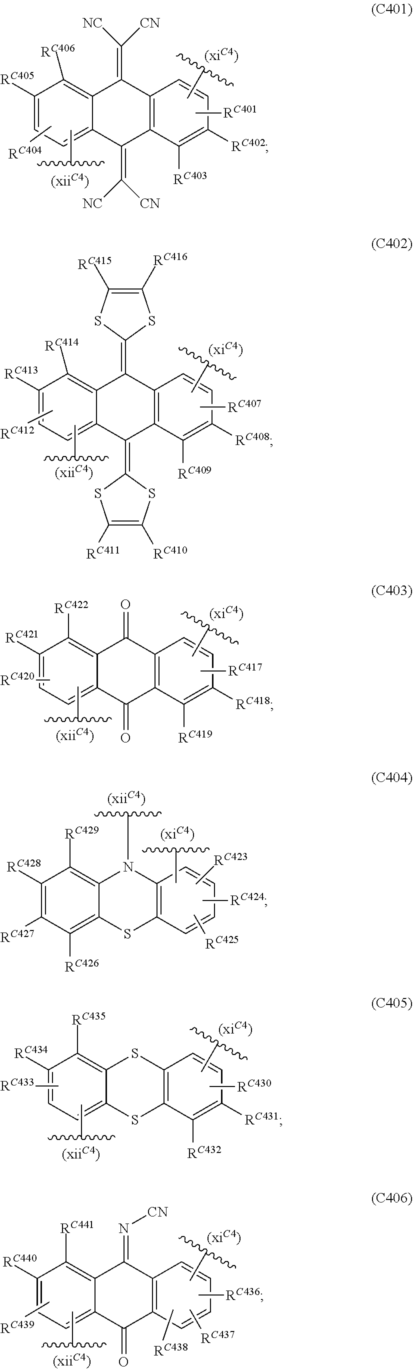

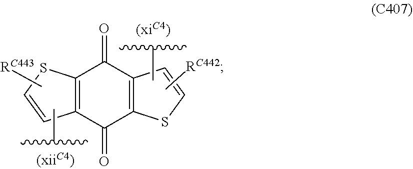

and where the bond indicated by (xi^{C4}) in each case denotes the bond to L², L⁴ or L⁶,
and where the bond indicated by (xii^{C4}) denotes the bond to L³, L⁵ ex L⁷,
where R^{C401}, R^{C402}, R^{C403}, R^{C404}, R^{C405}, R^{C406}, R^{C407}, R^{C408}, R^{C409}, R^{C410}, R^{C411}, R^{C412}, R^{C413}, R^{C414}, R^{C415}, R^{C416}, R^{C417}, R^{C418}, R^{C419}, R^{C420}, R^{C421}, R^{C422}, R^{C423}, R^{C424}, R^{C425}, R^{C426}, R^{C427}, R^{C428}, R^{C429}, R^{C430}, R^{C431}, R^{C432}, R^{C433}, R^{C434}, R^{C435}, R^{C436}, R^{C437}, R^{C438}, R^{C439}, R^{C440}, R^{C441}, R^{C442}, R^{C443} are independently selected from the group consisting of hydrogen, halogen, (halo)alkyl group, (halo)alkoxy group, and more preferably from the group consisting of hydrogen, alkyl group, and are even more preferably all hydrogen.

C.5 In a more preferred embodiment of the aforementioned point C.4, what is meant in accordance with the invention in the cases in which the R¹, R², R⁴, R⁵, R¹R^{2′}, R^{3′} radicals or the R¹, R², R⁴, R⁵ radicals or the R¹, R^{1′} radicals or the R¹ radical in the structures (I), (II) or (III) in the first aspect of the invention as defined in point I.1.α) and point I.1.β) are each a redox-active anthraquinone/carbazole function (C) is that R¹, R^{1′}, R^{2′}, R^{3′} radicals or the R¹, R^{1′} radicals or the R¹ radicals are selected from the group consisting of the structures (C301), (C302), (C303), (C304) defined in point C.4, and the R², R⁴, R⁵ radicals are selected from the group consisting of the structures (C401), (C402), (C403), (C404) defined in point C.4, where (ix^{C3}), (xi^{C4}), (xii^{C4}) and the R^{C301}, R^{C302}, R^{C303}, R^{C304}, R^{C305}, R^{C306}, R^{C307}, R^{C306}, R^{C309}, R^{C310}, R^{C311}, R^{C312}, R^{C313}, R^{C314}, R^{C315}, R^{C316}, R^{C317}, R^{C318}, R^{C319}, R^{C320}, R^{C321}, R^{C322}, R^{C323}, R^{C324}, R^{C325}, R^{C326}, R^{C327}, R^{C328}, R^{C329}, R^{C330}, R^{C331}, R^{C332}, R^{C333}, R^{C401}, R^{C402}, R^{C403}, R^{C404}, R^{C405}, R^{C406}, R^{C407}, R^{C406}, R^{C409}, R^{C410}, R^{C411}, R^{C412}, R^{C413}, R^{C414}, R^{C415}, R^{C416}, R^{C417}, R^{C418}, R^{C419}, R^{C420}, R^{C421}, R^{C422}, R^{C423}, R^{C424}, R^{C425}, R^{C426}, R^{C427}, R^{C428}, R^{C429} radical have the definition given in point C.4.

C.6 In a particularly preferred embodiment of the first aspect of the invention as defined in I.1.β) or point C.5, the organic redox polymer P non-conjugated in the main chain which is encompassed by the electrode material in the first aspect of the invention especially comprises n¹ mutually joined repeat units of the chemical structure (I)

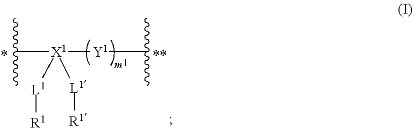

where n¹ is an integer ≥4, more preferably an integer in the range of 4 to 10⁶, more preferably an integer in the range of 10 to 10⁵, more preferably an integer in the range of 100 to 10⁴,

where m¹ is an integer ≥0, preferably an integer in the range of 0 to 10⁶, more preferably an integer in the range of 0 to 10⁵, more preferably an integer in the range of 0 to 10⁴, even more preferably an integer in the range of 0 to 10, and most preferably is in each case 0,
where the repeat units of the chemical structure (I) within the polymer P are the same or at least partly different from one another,
where the repeat units of the chemical structure (I) within the polymer are bonded to one another in such a way that the bond indicated by “**” in a particular repeat unit is joined by the bond indicated by “*” in the adjacent repeat unit,
where X¹ is a non-conjugated organic group which is formed by polymerization reaction from a group consisting of an organic double bond, an organic triple bond, an oxirane or an aziridine, or is a non-conjugated organic group which is formed by a polymer-analogous reaction,
where Y¹ is a non-conjugated organic spacer unit,
where L¹, L^{1′} are each independently selected from the group consisting of direct bond, organic linker unit, and, preferably, L¹ is selected from the group consisting of direct bond, organic linker unit, L^{1′} is a direct bond,
where R¹, R^{1′} are each independently a redox-active anthraquinone/carbazole function (C), and R^{1′} may also be a hydrogen radical, and, preferably, R¹ is a redox-active anthraquinone/carbazole function (C) and R^{1′} is a hydrogen radical,
and where the redox-active anthraquinone/carbazole function (C) more preferably has one of the structures (C301), (C302), (C303), (C304) defined in point C.4, even more preferably one of the structures (C301), (C302) defined in point C.4, and even more preferably still is a compound of the structure (C301) defined in point C.4,
where, in the structures (C301), (C302), (C303), (C304), the R^{C301}, R^{C302}, R^{C303}, R^{C304}, R^{C305}, R^{C306}, R^{C307}, R^{C306}, R^{C309}, R^{C310}, R^{C311}, R^{C312}, R^{C313}, R^{C314}, R^{C315}, R^{C318}, R^{C317}, R^{C318}, R^{C319}, R^{C320}, R^{C321}, R^{C322}, R^{C323}, R^{C324}, R^{C325}, R^{C326}, R^{C327}, R^{C328}, R^{C329}, R^{C330}, R^{C331}, R^{C332}, R^{C333} radicals are each independently selected from the group consisting of hydrogen, halogen, (halo)alkyl group, (halo)alkoxy group, and more preferably from the group consisting of hydrogen, alkyl group, and are even more preferably all hydrogen, and where the bond indicated by (ix^{C3}) in each case denotes the bond to L¹ or L^{1′}.

C.7 In a most preferred embodiment of the aforementioned point C.6, R^{1′} is hydrogen and R¹ is selected from the group consisting of the structures (C501), (C502):

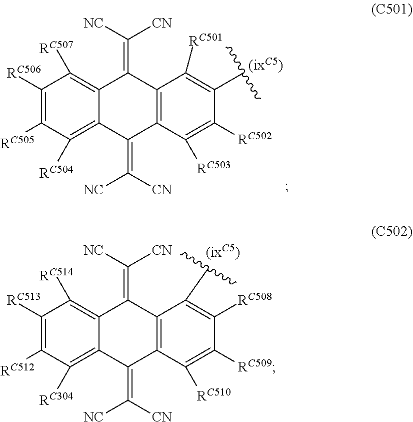

even more preferably, R¹ is a compound of the structure (C501)
where R^{C501}, R^{C502}, R^{C503}, R^{C504}, R^{C505}, R^{C506}, R^{C507}, R^{C508}, R^{C509}, R^{C510}, R^{C511}, R^{C512}, R^{C513}, R^{C514} are each independently selected from the group consisting of hydrogen, halogen, (halo)alkyl group, (halo)alkoxy group, more preferably from the group consisting of hydrogen, alkyl group, and are even more preferably all hydrogen, and where the bond indicated by (ix^{C5}) denotes the bond to L¹.

### I.1.1.4 Redox-Active Dialkoxybenzene Function (D)

In the context of the invention, “redox-active dialkoxybenzene function” means a redox-active organic radical comprising a base skeleton derived from a phenoxy radical.

D.1 In the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the first aspect of the invention as defined in point I.1.α) and point I.1.β) are in each case a redox-active dialkoxybenzene function (D), this means more particularly in accordance with the invention that the R¹, R^{1′}, R^{2′}, R^{3′} or R¹, R^{1′} or R¹ radicals each independently have the following structure (D1) and the R², R⁴, R⁵ radicals each independently have the following structure (D2):

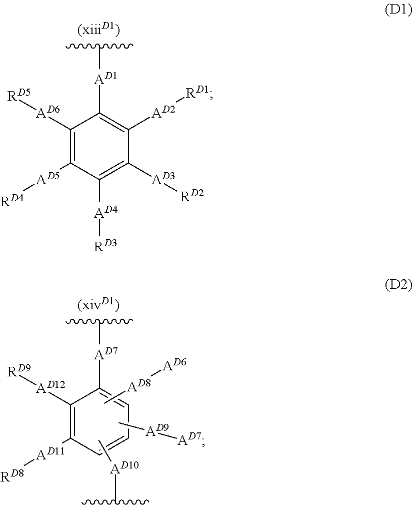

where, in the case that R¹=(D1), the bond indicated by (xii^{D1}) is the bond to L¹,
where, in the case that R^{1′}=(D1), the bond indicated by (xii^{D1}) is the bond to L^{1′},
in the case that R^{2′}=(D1), the bond indicated by (xiii^{D1}) is the bond to L^{2′},
in the case that R^{3′}=(D1), the bond indicated by (xiii^{D1}) is the bond to L^{3′},
in the case that R²=(D2), the bond indicated by (xiv^{D1}) is the bond to L², and that indicated by (xv^{D1}) is the bond to L³,
in the case that R⁴=(D2), the bond indicated by (xiv^{D1}) is the bond to L⁴, and that indicated by (xv^{D1}) is the bond to L⁵,
in the case that R⁵=(D2), the bond indicated by (xiv^{D1}) is the bond to L⁶, and that indicated by (xv^{C1}) is the bond to L⁷,
and where at least two, preferably exactly two, of the A^{D1}, A^{D2}, A^{D3}, A^{D4}, A^{D5}, A^{D6} radicals are each independently selected from the group consisting of —O—, —S— and the others of the A^{D1}, A^{D2}, A^{D3}, A^{D4}, A^{D5}, A^{D6} radicals are each a direct bond,
and where at least two, preferably exactly two, of the A^{D7}, A^{D8}, A^{D9}, A^{D10}, A^{D11}, A^{D12} radicals are each independently selected from the group consisting of —O—, —S— and the others of the A^{D7}, A^{D8}, A^{D9}, A^{D10}, A^{D11}, A^{D12} radicals are each a direct bond,
and where the R^{D1}, R^{D2}, R^{D3}, R^{D4}, R^{D5}, R^{D8}, R^{D7}, R^{D8}, R^{D9} radicals are each independently selected from the group consisting of hydrogen, (hetero)aromatic radical, alkyl group, alkenyl group, alkynyl group, cycloalkyl group, preferably from the group consisting of hydrogen, (halo)alkyl group, cycloalkyl group,
where the (hetero)aromatic radical, the alkyl group, the alkenyl group, the alkynyl group, the cycloalkyl group may each be substituted by at least one radical which is selected from the group consisting of nitro group, —NH₂, —CN, —SH, —OH, halogen, and is preferably halogen, and where the alkyl group, the alkenyl group, the alkynyl group, the cycloalkyl group may have at least one group selected from the group consisting of ether, thioether, amino ether, carbonyl group, carboxylic ester, carboxamide group, sulfonic ester, phosphoric ester, preferably from the group consisting of ether, thioether,
and where at least two radicals, preferably in ortho positions to one another, of the R^{D1}, R^{D2}, R^{D3}, R^{D4}, R^{D5} radicals or the R^{D8}, R^{D7}, R^{D8}, R^{D9} radicals may each also be bridged by a divalent aliphatic radical, where the aliphatic radical may be substituted by at least one group selected from the group consisting of nitro group, —NH₂, —CN, —SH, —OH, halogen, alkyl group and may have at least one group selected from the group consisting of ether, thioether, amino ether, carbonyl group, carboxylic ester, carboxamide group, sulfonic ester, phosphoric ester, preferably selected from the group consisting of ether, thioether,
and where the R^{D1} radical in the case that A^{D2}=direct bond, the R^{D2} radical in the case that A^{D3}=direct bond, the R^{D3} radical in the case that A^{D4}=direct bond, the R^{D4} radical in the case that A^{D5}=direct bond, the R^{D5} radical in the case that A^{D8}=direct bond, the R^{D8} radical in the case that A^{D8}=direct bond, the R^{D7} radical in the case that A^{D9}=direct bond, the R^{D8} radical in the case that A^{D11}=direct bond, the R^{D9} radical in the case that A^{D12}=direct bond may each independently be selected from the group consisting of nitro group, —CN, —F, —Cl, —Br, —I, —C(═O)NHR^{D13}, —NR^{D14}R^{D15}, —COOR^{D18}, —COR^{D17},
where R^{D13}, R^{D14}, R^{D15}, R^{D18}, R^{D17} are each independently selected from the group consisting of hydrogen, (hetero)aromatic radical, aliphatic radical optionally substituted by at least one group selected from nitro group, —NH₂, —CN, —SH, —OH, halogen and optionally having at least one group selected from ether, thioether, amino ether, carbonyl group, carboxylic ester, carboxamide group, sulfonic ester, phosphoric ester.

D.2 In a preferred embodiment of the aforementioned point D.1, what is meant in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the first aspect of the invention as defined in point I.1.α) and point I.1.β) are in each case a redox-active dialkoxybenzene function (D) is that the R¹, R¹, R², R³, R^{1′}, R^{1′}, R^{1′} radicals each independently have the structure (D1) defined in point D.1 and the R², R⁴, R⁵ radicals each independently have the structure (D2) defined in point D.1,

where (xii^{D1}), (xiv^{D1}), (xv^{D1}) have the meaning defined in point D.1,
and where at least two, preferably exactly two, of the A^{D1}, A^{D2}, A^{D3}, A^{D4}, A^{D5}, A^{D6} radicals are each —O— and the others of A^{D1}, A^{D2}, A^{D3}, A^{D4}, A^{D5}, A^{D6} are each a direct bond,
and where at least two, preferably exactly two, of the A^{D7}, A^{D8}, A^{D9}, A^{D10}, A^{D11}, A^{D12} radicals are each —O— and the others of A^{D7}, A^{D8}, A^{D9}, A^{D10}, A^{D11}, A^{D12} are each a direct bond,
and where the R^{D1}, R^{D2}, R^{D3}, R^{D4}, R^{D5}, R^{D8}, R^{D7}, R^{D8}, R^{D9} radicals are each independently selected from the group consisting of hydrogen, phenyl radical, benzyl radical, alkyl group, cycloalkyl group,
where the phenyl radical, benzoyl radical, alkyl group, cycloalkyl group may each be substituted by halogen,
and where the alkyl group and the cycloalkyl group may each have at least one group selected from ether, thioether,
and where at least two radicals, preferably in ortho positions to one another, of the R^{D1}, R^{D2}, R^{D3}, R^{D4}, R^{D5} radicals and of the R^{D8}, R^{D7}, R^{D8}, R^{D9} radicals may each also be bridged by a divalent alkylene radical which may have at least one group selected from ether, thioether,
and where the R^{D1} radical in the case that A^{D2}=direct bond, the R^{D2} radical in the case that A^{D3}=direct bond, the R^{D3} radical in the case that A^{D4}=direct bond, the R^{D4} radical in the case that A^{D5}=direct bond, the R^{D5} radical in the case that A^{D8}=direct bond, the R^{D8} radical in the case that A^{D8}=direct bond, the R^{D7} radical in the case that A^{D9}=direct bond, the R^{D8} radical in the case that A^{D11}=direct bond, the R^{D9} radical in the case that A^{D12}=direct bond may each independently be selected from the group consisting of nitro group, —CN, —F, —Cl, —Br, —I, —C(═O)NHR^{D18}, —NR^{D19}R^{D20}, —COOR^{D21}, —COR^{D22},
where R^{D18}, R^{D19}, R^{D20}, R^{D21}, R^{D22} are each independently selected from the group consisting of hydrogen, (hetero)aromatic radical, alkyl radical optionally substituted by at least one group selected from nitro group, —NH₂, —CN, —SH, —OH, halogen and optionally having at least one group selected from ether, thioether.

D.3 In a preferred embodiment of the aforementioned point D.2, what is meant in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the first aspect of the invention as defined in point I.1.α) and point I.1.β) are in each case a redox-active dialkoxybenzene function (D) is that the R¹, R¹, R², R³, R^{1′}, R^{1′}, R^{1′} radicals each independently have the structure (D3) defined below and the R², R⁴, R⁵ radicals each independently have the structure (D4) defined below,

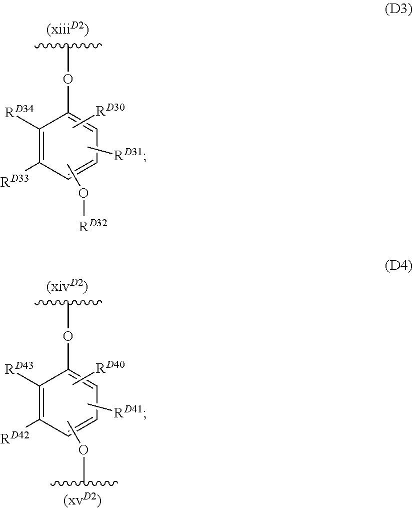

where, in the case that R¹=(D3), the bond indicated by (xii^{D2}) is the bond to L¹,
in the case that R^{1′}=(D3), the bond indicated by (xiii^{D2}) is the bond to L^{1′},
in the case that R^{2′}=(D3), the bond indicated by (xiii^{D2}) is the bond to L^{2′},
in the case that R^{3′}=(D3), the bond indicated by (xiii^{D2}) is the bond to L^{3′},
in the case that R²=(D4), the bond indicated by (xiv^{D2}) is the bond to L², and the bond indicated by (xv^{D2}) is the bond to L³,
in the case that R⁴=(D4), the bond indicated by (xiv^{D2}) is the bond to L⁴, and the bond indicated by (xv^{D2}) is the bond to L⁵,
in the case that R⁵=(D4), the bond indicated by (xiv^{D2}) is the bond to L⁶, and the bond indicated by (xv^{D2}) is the bond to L⁷,
and where R^{D30}, R^{D31}, R^{D32}, R^{D33}, R^{D34}, R^{D40}, R^{D41}, R^{D42}, R^{D43} are each independently selected from the group consisting of hydrogen, phenyl radical, benzyl radical, (halo)alkyl group, cycloalkyl group, preferably from the group consisting of hydrogen, alkyl group, cycloalkyl group,
and where the R^{D30}, R^{D31}, R^{D33}, R^{D34}, R^{D40}, R^{D41}, R^{D42}, R^{D43} radicals may each also be hydroxyl,
and where at least two radicals, preferably in ortho positions to one another, of the R^{D30}, R^{D31}, R^{D32}, R^{D33}, R^{D34} radicals and of the R^{D40}, R^{D41}, R^{D42}, R^{D43} radicals may each also be bridged by a divalent alkylene radical which may have at least one ether.

D.4 In a preferred embodiment of the aforementioned point D.3, what is meant in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the first aspect of the invention as defined in point I.1.α) and point I.1.β) are in each case a redox-active dialkoxybenzene function (D) is that the R¹, R¹, R², R³, R^{1′}, R^{1′}, R^{1′} radicals independently have the structure (D3) defined in point D.3 and the R², R⁴, R⁵ radicals each independently have the structure (D4) defined in point D.3,

where (xii^{D2}), (xiv^{D2}) and (xv^{D2}) have the definition given in point D.3,
and where R^{D30}, R^{D31}, R^{D33}, R^{D34}, R^{D40}, R^{D41}, R^{D42}, R^{D43} are each independently selected from the group consisting of hydrogen, alkyl group, cycloalkyl group, hydroxyl,
and R^{D32} is selected from the group consisting of hydrogen, alkyl group, cycloalkyl group,
and, preferably, R^{D30}, R^{D31}, R^{D32}, R^{D33}, R^{D34}, R^{D40}, R^{D41}, R^{D42}, R^{D43} are each independently selected from the group consisting of hydrogen, alkyl group, cycloalkyl group.

D.5 In a preferred embodiment of the aforementioned point D.4, what is meant in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the first aspect of the invention as defined in point I.1.α) and point I.1.β) are in each case a redox-active dialkoxybenzene function (D) is that the R¹, R¹, R², R³, R^{1′}, R^{1′}, R^{1′} radicals each independently have the structure (D5) specified below and the R², R⁴, R⁵ radicals each independently have the structure (D6) specified below,

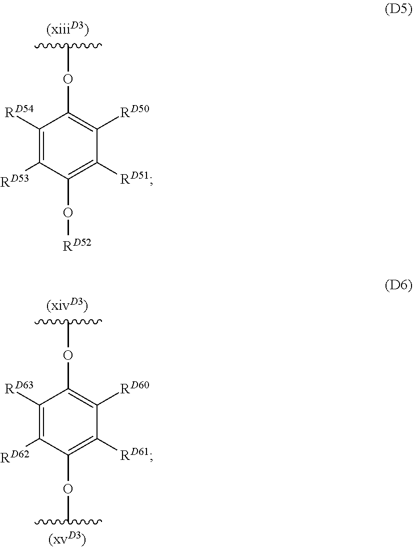

where, in the case that R¹=(D5), the bond indicated by (xii^{D3}) is the bond to L¹,
in the case that R^{1′}=(D5), the bond indicated by (xiii^{D3}) is the bond to L^{1′},
in the case that R^{2′}=(D5), the bond indicated by (xiii^{D3}) is the bond to L^{2′},
in the case that R^{3′}=(D5), the bond indicated by (xiii^{D3}) is the bond to L^{3′},
in the case that R²=(D6), the bond indicated by (xiv^{D3}) is the bond to L², and the bond indicated by (xv^{D3}) is the bond to L³,
in the case that R⁴=(D6), the bond indicated by (xiv^{D3}) is the bond to L⁴, and the bond indicated by (xv^{D3}) is the bond to L⁵,
in the case that R⁵=(D6), the bond indicated by (xiv^{D3}) is the bond to L⁶, and the bond indicated by (xv^{D3}) is the bond to L⁷,
and where R^{D50}, R^{D51}, R^{D52}, R^{D53}, R^{D54}, R^{D80}, R^{D81}, R^{D82}, R^{D83} are each independently selected from the group consisting of hydrogen, alkyl group having 1 to 6 carbon atoms, cycloalkyl group having 3 to 10 carbon atoms.

D.6 In a preferred embodiment of the aforementioned point D.5, what is meant in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the first aspect of the invention as defined in point I.1.α) and point I.1.β) are in each case a redox-active dialkoxybenzene function (D) is that the R¹, R¹, R², R³, R^{1′}, R^{1′}, R^{1′} radicals independently have the structure (D5) specified in point D.5 and R², R⁴, R⁵ each independently have the structure (D6) specified in point D.5,

where (xii^{D3}), (xiv^{D3}) and (xv^{D3}) have the meaning defined in point D.5,
and where R^{D50}, R^{D53}, R^{D80}, R^{D82} are each independently selected from the group consisting of hydrogen, alkyl group having 1 to 6 carbon atoms, cycloalkyl group having 3 to 10 carbon atoms, and R^{D50}, R^{D53}, R^{D80}, R^{D82} are preferably all hydrogen,
and where R^{D51}, R^{D54}, R^{D81}, R^{D83} are each independently selected from the group consisting of hydrogen, alkyl group having 1 to 6 carbon atoms, cycloalkyl group having 3 to 10 carbon atoms, preferably from the group consisting of alkyl group having 1 to 6 carbon atoms, cycloalkyl group having 3 to 10 carbon atoms, more preferably from the group consisting of alkyl group having 1 to carbon atoms, cycloalkyl group having 3 to 10 carbon atoms, and R^{D51}, R^{D54}, R^{D81}, R^{D83} are more preferably each an alkyl group having 3 to 10 carbon atoms, and even more preferably all tert-butyl,
and where R^{D52} is selected from the group consisting of hydrogen, alkyl group having 1 to 10 carbon atoms, preferably methyl.

D.7 In a particularly preferred embodiment of the first aspect of the invention as defined in I.1.β) or point D.6, the organic redox polymer P non-conjugated in the main chain which is encompassed by the electrode material in the first aspect of the invention especially comprises n¹ mutually joined repeat units of the chemical structure (I)

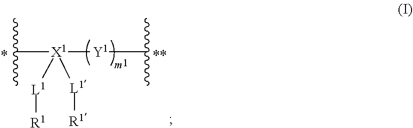

where n¹ is an integer ≥4, more preferably an integer in the range of 4 to 10⁶, more preferably an integer in the range of 10 to 10⁵, more preferably an integer in the range of 100 to 10⁴,
where m¹ is an integer ≥0, preferably an integer in the range of 0 to 10⁶, more preferably an integer in the range of 0 to 10⁵, more preferably an integer in the range of 0 to 10⁴, even more preferably an integer in the range of 0 to 10, and most preferably is in each case 0,
where the repeat units of the chemical structure (I) within the polymer P are the same or at least partly different from one another,
where the repeat units of the chemical structure (I) within the polymer are bonded to one another in such a way that the bond indicated by “**” in a particular repeat unit is joined by the bond indicated by “*” in the adjacent repeat unit,
where X¹ is a non-conjugated organic group which is formed by polymerization reaction from a group consisting of an organic double bond, an organic triple bond, an oxirane or an aziridine, or is a non-conjugated organic group which is formed by a polymer-analogous reaction,
where Y¹ is a non-conjugated organic spacer unit,
where L¹, L^{1′} are each independently selected from the group consisting of direct bond, organic linker unit, and, preferably, L¹ is selected from the group consisting of direct bond, organic linker unit and L^{1′} is a direct bond,
where R¹, R^{1′} are each independently a redox-active dialkoxybenzene function (D), and R^{1′} may also be a hydrogen radical, and, preferably, R¹ is a redox-active dialkoxybenzene function (D) and R^{1′} is a hydrogen radical,
and where the redox-active dialkoxybenzene function (D) more preferably has the structure (D5) defined in point D.5,
in which R^{D50}, R^{D53} are each independently selected from the group consisting of hydrogen, alkyl group having 1 to 6 carbon atoms, cycloalkyl group having 3 to 10 carbon atoms, and R^{D50}, R^{D53} are preferably both hydrogen,
and in which R^{D51}, R^{D54} are each independently selected from the group consisting of hydrogen, alkyl group having 1 to 6 carbon atoms, cycloalkyl group having 3 to 10 carbon atoms, preferably from the group consisting of alkyl group having 1 to 6 carbon atoms, cycloalkyl group having 3 to carbon atoms, even more preferably from the group consisting of alkyl group having 1 to 10 carbon atoms, cycloalkyl group having 3 to 10 carbon atoms, and R^{D5}, R^{D54} are more preferably each independently an alkyl group having 3 to 10 carbon atoms, and R^{D51}, R^{D54} are more preferably both tert-butyl,
and where R^{D52} is selected from the group consisting of hydrogen, alkyl group having 1 to 10 carbon atoms, preferably methyl,
and where the bond indicated by (xiii^{D3}) for R¹ denotes the bond to L¹ and for R^{1′} the bond to L^{1′}.

### I.1.1.5 Redox-Active Benzoquinone Function (E)

In the context of the invention, “redox-active benzoquinone function” means a redox-active organic radical comprising a base skeleton derived from benzoquinone.

E.1 In the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the first aspect of the invention as defined in point I.1.α) and point I.1.β) are in each case a redox-active benzoquinone function (E), this means more particularly in accordance with the invention that the R¹, R^{1′}, R^{2′}, R^{3′} or R¹, R^{1′} or R¹ radicals are each independently selected from the following structures (E1), (E2), (E3):

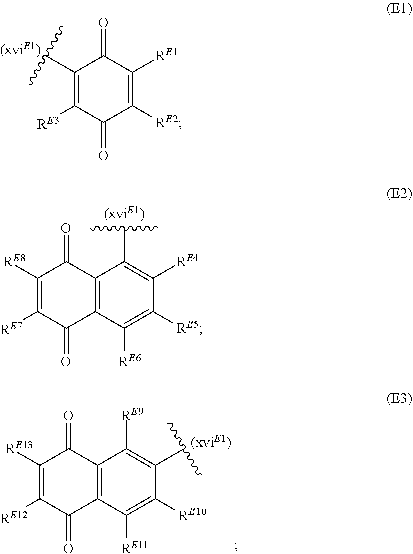

and the R², R⁴, R⁵ radicals are each independently selected from the group consisting of the following structures (E4), (E5), (E6), (E7), (E8), (E9):

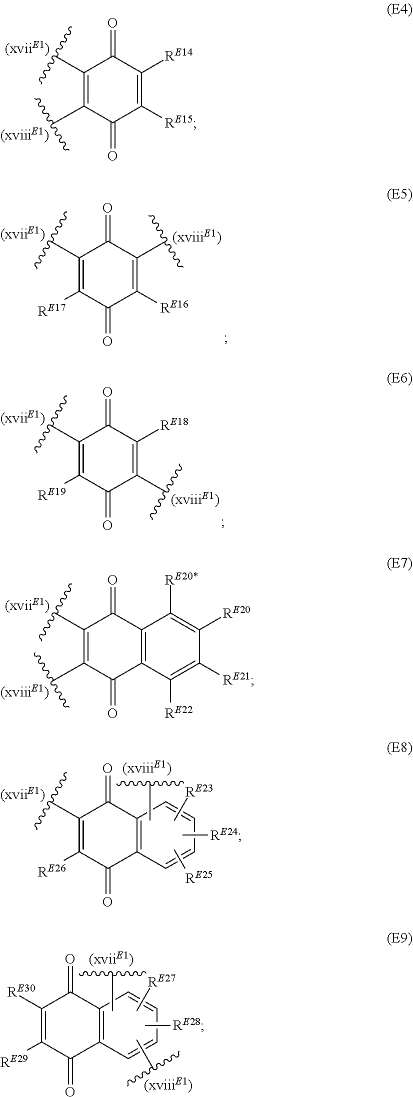

where,
in the case that R¹=(E1), (E2) or (E3), the bond indicated by (xvi^{E1}) is the bond to L¹,
in the case that R^{1′}=(E1), (E2) or (E3), the bond indicated by (xvi^{E1}) is the bond to L^{1′},
in the case that R^{2′}=(E1), (E2) or (E3), the bond indicated by (xvi^{E1}) is the bond to L^{2′},
in the case that R^{3′}=(E1), (E2) or (E3), the bond indicated by (xvi^{E1}) is the bond to L^{3′},
in the case that R²=(E4), (E5), (E6), (E7), (E8) or (E9), the bond indicated by (xvii^{E1}) is the bond to L² and the bond indicated by (xviii^{E1}) is the bond to L³,
in the case that R⁴=(E4), (E5), (E6), (E7), (E8) or (E9), the bond indicated by (xvii^{E1}) is the bond to L⁴ and the bond indicated by (xviii^{E1}) is the bond to L⁵,
in the case that R⁵=(E4), (E5), (E6), (E7), (E8) or (E9), the bond indicated by (xvii^{E1}) is the bond to L⁶ and the bond indicated by (xviii^{E1}) is the bond to L⁷,
and where the R^{E1}, R^{E2}, R^{E3}, R^{E4}, R^{E5}, R^{E6}, R^{E7}, R^{E8}, R^{E9}, R^{E10}, R^{E11}, R^{E12}, R^{E13}, R^{E14}, R^{E15}, R^{E16}, R^{E17}, R^{E18}, R^{E19}, R^{E20}, R^{E20*}, R^{E21}, R^{E22}, R^{E23}, R^{E24}, R^{E25}, R^{E26}, R^{E27}, R^{E28}, R^{E29}, R^{E30} radicals are each independently selected from the group consisting of hydrogen, —OH, —SH, nitro group, —CN, —F, —Cl, —Br, —I, —C(═O)NHR^{E31}, —NR^{E32}R^{E33}, —COOR^{E34}, —COR^{E35}, sulfonic ester, phosphoric ester, (hetero)aromatic radical, alkyl group, alkenyl group, alkynyl group, preferably from the group consisting of hydrogen, alkyl group, —OH, —NR^{E32}R^{E33}, —COOR^{E34}, —COR^{E35}, sulfonic ester, even more preferably from the group consisting of hydrogen, —OH, —COOR^{E34}, —COR^{E35}, sulfonic ester,
where the (hetero)aromatic radical, the alkyl group, the alkenyl group, the alkynyl group may each be substituted by at least one group selected from nitro group, —NH₂, —CN, —SH, —OH, halogen and where the alkyl group, the alkenyl group, the alkynyl group may have at least one group selected from ether, thioether, amino ether, carbonyl group, carboxylic ester, carboxamide group, sulfonic ester, phosphoric ester,
and where R^{E31}, R^{E32}, R^{E33}, R^{E3}R^{E35} are each independently selected from the group consisting of hydrogen, (hetero)aromatic radical, aliphatic radical optionally substituted by at least one group selected from nitro group, —NH₂, —CN, —SH, —OH, halogen and optionally having at least one group selected from ether, thioether, amino ether, carbonyl group, carboxylic ester, carboxamide group, sulfonic ester, phosphoric ester, preferably from the group consisting of hydrogen, alkyl group,
   and where two radicals in ortho positions to one another among the R^{E1}, R^{E2}, R^{E4}, R^{E5}, R^{E6}, R^{E7}, R^{E8}, R^{E10}, R^{E11}, R^{E12}, R^{E13}, R^{E14}, R^{E15}, R^{E20}, R^{E20*}, R^{E21}, R^{E22}, R^{E23}, R^{E24}, R^{E25}, R^{E27}, R^{E28}, R^{E29}, R^{E30}, radicals may be bridged by a divalent aliphatic radical, preferably alkylene radical, optionally substituted by at least one group selected from the group consisting of nitro group, —NH₂, —CN, —SH, —OH, halogen, alkyl group and optionally having at least one group selected from the group consisting of ether, thioether, amino ether, carbonyl group, carboxylic ester, carboxamide group, sulfonic ester, phosphoric ester.

E.2 In a preferred embodiment of the aforementioned point E.1, what is meant in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the first aspect of the invention as defined in point I.1.α) and point I.1.β) are in each case a redox-active benzoquinone function (E) is that the R¹, R¹, R², R³, R^{1′}, R^{1′}, R^{1′} radicals are each independently selected from the structures (E1), (E2), (E3) defined in point E.1 and the R², R⁴, R⁵ radicals are each independently selected from the structures (E4), (E5), (E6), (E7), (E8), (E9) defined in point E.1,

where (xvi^{E1}), (xvii^{E1}), (xviii^{E1}) have the meaning defined in point E.1, and where the R^{E1}, R^{E2}, R^{E3}, R^{E4}, R^{E5}, R^{E6}, R^{E7}, R^{E8}, R^{E9}, R^{E10}, R^{E11}, R^{E12}, R^{E13}, R^{E14}, R^{E15}, R^{E16}, R^{E17}, R^{E18}, R^{E19}, R^{E20}, R^{E20*}, R^{E21}, R^{E22}, R^{E23}, R^{E24}, R^{E25}, R^{E26}, R^{E27}, R^{E28}, R^{E29}, R^{E30} radicals are selected from the group consisting of hydrogen, alkyl group, —OH, —SH, —NR^{E38}R^{E37}, —COOR^{E38}, —COR^{E39}, sulfonic ester, more preferably from the group consisting of hydrogen, —OH, —COOR^{E38}, —COR^{E39}, sulfonic ester, and are more preferably all hydrogen,
where the alkyl group may be substituted by at least one group selected from nitro group, —NH₂, —CN, —SH, —OH, halogen and may have at least one group selected from ether, thioether, amino ether, carbonyl group, carboxylic ester, carboxamide group, sulfonic ester, phosphoric ester,
and where the R^{E38}, R^{E37}, R^{E38}, R^{E39} radicals are each independently selected from the group consisting of hydrogen, aliphatic radical optionally substituted by at least one group selected from nitro group, —NH₂, —CN, —SH, —OH, halogen and optionally having at least one group selected from ether, thioether, amino ether, carbonyl group, carboxylic ester, carboxamide group, sulfonic acid, phosphoric ester, preferably from the group consisting of hydrogen, alkyl group, which is preferably an alkyl group having 1 to 6 carbon atoms, more preferably an alkyl group selected from the group consisting of methyl, ethyl, n-propyl, iso-propyl.

E.3 In a preferred embodiment of the aforementioned point E.2, what is meant in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the first aspect of the invention as defined in point I.1, a) and point I.1.β) are in each case a redox-active benzoquinone function (E) is that the R¹, R¹, R², R³, R^{1′}, R^{1′}, R^{1′} radicals are each independently selected from the structures (E1), (E2), (E3) defined in point E.1 and the R², R⁴, R⁵ radicals are each independently selected from the structures (E4), (E5), (E6), (E7), (E8), (E9) defined in point E. 1

where (xvi^{E1}), (xvii^{E1}), (xviii^{E1}) have the meaning defined in point E.1,
and where the R^{E1}, R^{E2}, R^{E3}, R^{E4}, R^{E5}, R^{E6}, R^{E7}, R^{E8}, R^{E9}, R^{E10}, R^{E11}, R^{E12}, R^{E13}, R^{E14}, R^{E15}, R^{E16}, R^{E17}, R^{E18}, R^{E19}, R^{E20}, R^{E20*}, R^{E21}, R^{E22}, R^{E23}, R^{E24}, R^{E25}, R^{E26}, R^{E27}, R^{E28}, R^{E29}, R^{E30} radicals are selected from the group consisting of hydrogen, —OH, —COOR^{E40}, —COR^{E41}, sulfonic ester, and are more preferably all hydrogen,
and where the R^{E40}, R^{E41} radicals are each independently selected from the group consisting of hydrogen, alkyl group, which is preferably an alkyl group having 1 to 6 carbon atoms, more preferably an alkyl group selected from the group consisting of methyl, ethyl, n-propyl, iso-propyl.

E.4 In a preferred embodiment of the aforementioned point E.3, what is meant in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the first aspect of the invention as defined in point I.1, a) and point I.1.β) are in each case a redox-active benzoquinone function (E) is that the R¹, R¹, R², R³, R^{1′}, R^{1′}, R^{1′} radicals are each independently selected from the structures (E1), (E2), (E3) defined in point E.1 and the R², R⁴, R⁵ radicals are each independently selected from the structures (E4), (E5), (E6), (E8), (E9) defined in point E.1,

where (xvi^{E1}), (xvii^{E1}), (xviii^{E1}) have the meaning defined in point E.1,
and where the R^{E1}, R^{E2}, R^{E3}, R^{E4}, R^{E5}, R^{E6}, R^{E7}R^{E8}, R^{E9}, R^{E10}, R^{E11}, R^{E12}, R^{E13}, R^{E14}, R^{E15}, R^{E16}, R^{E17}, R^{E18}, R^{E19}, R^{E23}, R^{E24}, R^{E25}, R^{E26}, R^{E27}, R^{E28}, R^{E29}, R^{E30} radicals are selected from the group consisting of hydrogen, —OH, —COOR^{E50}, —COR^{E51}, sulfonic ester, and are more preferably all hydrogen,
and where the R^{E50}, R^{E51} radicals are each independently selected from the group consisting of hydrogen, alkyl group, which is preferably an alkyl group having 1 to 6 carbon atoms, more preferably an alkyl group selected from the group consisting of methyl, ethyl, n-propyl, iso-propyl.

E.5 In a preferred embodiment of the aforementioned point E.4, what is meant in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the first aspect of the invention as defined in point I.1.α) and point I.1.β) are in each case a redox-active benzoquinone function (E) is that the R¹, R¹, R², R³, R^{1′}, R^{1′}, R^{1′} radicals are each independently selected from the structures (E1), (E2), (E3) defined in point E.1 and the R², R⁴, R⁵ radicals are each independently selected from the structures (E6), (E9) defined in point E.1,

where (xvi^{E1}), (xvii^{E1}), (xviii^{E1}) have the meaning defined in point E.1,
and where, in (E9), the two bonds indicated by (xvii^{E1}) and (xviii^{E1}) are preferably in para position to one another,
and where the R^{E1}, R^{E2}, R^{E3}, R^{E4}, R^{E5}, R^{E6}, R^{E7}, R^{E8}, R^{E9}, R^{E10}, R^{E11}, R^{E12}, R^{E13}, R^{E18}, R^{E19}, R^{E27}, R^{E28}, R^{E29}, R^{E30}, R^{E23}, R^{E24} radicals are selected from the group consisting of hydrogen, —OH, —COOR^{E60}, —COR^{E61}, sulfonic ester, and are more preferably all hydrogen, and where the R^{E60}, R^{E61} radicals are each independently selected from the group consisting of hydrogen, alkyl group, which is preferably an alkyl group having 1 to 6 carbon atoms, more preferably an alkyl group selected from the group consisting of methyl, ethyl, n-propyl, iso-propyl.

E.6 In a particularly preferred embodiment of the first aspect of the invention as defined in I.1.β), the organic redox polymer P non-conjugated in the main chain which is encompassed by the electrode material in the first aspect of the invention especially comprises n¹ mutually joined repeat units of the chemical structure (I)

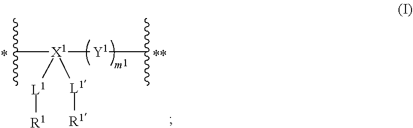

where n¹ is an integer ≥4, more preferably an integer in the range of 4 to 10⁶, more preferably an integer in the range of 10 to 10⁵, more preferably an integer in the range of 100 to 10⁴,
where m¹ is an integer ≥0, preferably an integer in the range of 0 to 10⁶, more preferably an integer in the range of 0 to 10⁵, more preferably an integer in the range of 0 to 10⁴, even more preferably an integer in the range of 0 to 10, and most preferably is in each case 0,
where the repeat units of the chemical structure (I) within the polymer P are the same or at least partly different from one another,
where the repeat units of the chemical structure (I) within the polymer are bonded to one another in such a way that the bond indicated by “**” in a particular repeat unit is joined by the bond indicated by “*” in the adjacent repeat unit,
where X¹ is a non-conjugated organic group which is formed by polymerization reaction from a group consisting of an organic double bond, an organic triple bond, an oxirane or an aziridine, or is a non-conjugated organic group which is formed by a polymer-analogous reaction,
where Y¹ is a non-conjugated organic spacer unit,
where L¹, L^{1′} are each independently selected from the group consisting of direct bond, organic linker unit, and, preferably, L¹ is selected from the group consisting of direct bond, organic linker unit and L^{1′} is a direct bond,
where R¹, R^{1′} are each independently a redox-active benzoquinone function (E), and R^{1′} may also be a hydrogen radical, and, preferably, R¹ is a redox-active benzoquinone function (E) and R^{1′} is a hydrogen radical,
and where the redox-active benzoquinone function (E) more preferably has one of the structures (E1), (E2), (E3) shown in point E.1,
where, in the case that R¹=(E1), (E2) or (E3), the bond indicated by (xvi^{E1}) is the bond to L¹,
and, in the case that R^{1′}=(E1), (E2) or (E3), the bond indicated by (xvi^{E1}) is the bond to L^{1′},
and where the R^{E1}, R^{E2}, R^{E3}, R^{E4}, R^{E5}, R^{E6}, R^{E7}, R^{E8}, R^{E9}, R^{E10}, R^{E11}, R^{E12}, R^{E13} radicals are each independently selected from the group consisting of hydrogen, —OH, —COOR^{E70}, —COR^{E71}, sulfonic ester, and are more preferably all hydrogen,
and where the R^{E70}, R^{E71} radicals are each independently selected from the group consisting of hydrogen, alkyl group, which is preferably an alkyl group having 1 to 6 carbon atoms, more preferably an alkyl group selected from the group consisting of methyl, ethyl, n-propyl, iso-propyl.

### I.1.1.6 Redox-Active Triphenylamine Function (G)

In the context of the invention, “redox-active triphenylamine function” means a redox-active organic radical comprising a base skeleton derived from triphenylamine.

G.1 In the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the first aspect of the invention as defined in point I.1.α) and point I.1.β) are in each case a redox-active triphenylamine function (G), this means more particularly in accordance with the invention that the R¹, R^{1′}, R^{2′}, R^{3′} or R¹, R^{1′} or R¹ radicals each independently have the following structure (G1) and the R², R⁴, R⁵ radicals are each independently selected from the group consisting of the following structures (G2), (G3):

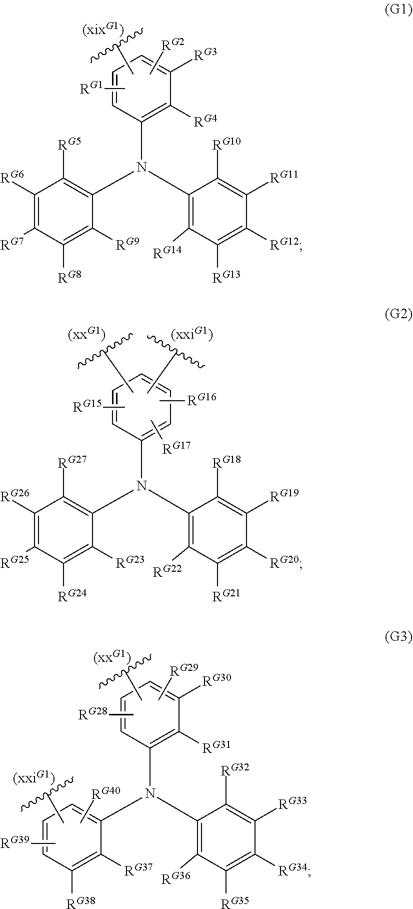

where,
in the case that R¹=(G1), the bond indicated by (xix^{G1}) is the bond to L¹,
in the case that R^{1′}=(G1), the bond indicated by (xix^{G1}) is the bond to L^{1′},
in the case that R^{2′}=(G1), the bond indicated by (xix^{G1}) is the bond to L^{2′},
in the case that R^{3′}=(G1), the bond indicated by (xix^{G1}) is the bond to L^{3′},
in the case that R²=(G2) or (G3), the bond indicated by (xx^{G1}) is the bond to L² and the bond indicated by (xxi^{G1}) is the bond to L³,
in the case that R⁴=(G2) or (G3), the bond indicated by (xx^{G1}) is the bond to L⁴ and the bond indicated by (xxi^{G1}) is the bond to L⁵,
in the case that R⁵=(G2) or (G3), the bond indicated by (xx^{G1}) is the bond to L^{G} and the bond indicated by (xxi^{G1}) is the bond to L⁷,
where the R^{G1}, R^{G2}, R^{G3}, R^{G4}, R^{G5}, R^{G6}, R^{G7}, R^{G8}, R^{G9}, R^{G10}, R^{G11}, R^{G12}, R^{G13}, R^{G14}, R^{G15}, R^{G16}, R^{G17}, in R^{G18}, R^{G19}, R^{G20}, R^{G21}, R^{G22}, R^{G23}, R^{G24}, R^{G25}, R^{G26}, R^{G27}, R^{G28}, R^{G29}, R^{G30}, R^{G31}, R^{G32}, R^{G33}, R^{G34}, R^{G35}, R^{G38}, R^{G37}, R^{G38}, R^{G39}, R^{G40} radicals are each independently selected from the group consisting of hydrogen, (halo)alkyl group, alkenyl group, alkynyl group, (halo)alkoxy group, cycloalkyl group, carbonylalkyl, —C(═O)—H, carboxylic acid, carboxamide, carboxylic ester, sulfonic ester, phosphoric ester, amine, mono(halo)alkylamino, di(halo)alkylamino, cyano, hydroxyl, halogen, (hetero)aromatic radical, where the (hetero)aromatic radical may be substituted by at least one group selected from halogen, (halo)alkyl, (halo)alkoxy, cyano, carboxylic ester,
preferably from the group consisting of hydrogen, (halo)alkyl group, (halo)alkoxy group, (halo)cycloalkyl group, cyano, carboxylic ester, thiophene, preferably from the group consisting of hydrogen, cyano, alkyl group,
more preferably from the group consisting of hydrogen, alkoxy group, cyano,
where, even more preferably, the R¹, R^{1′}, R^{2′}, R^{3′} or R¹, R^{1′} or R¹ radicals each independently have the structure (G1) and the R², R⁴, R⁵ radicals each independently have the structure (G2), where the R^{G7}, R^{G12}, R^{G20}, R^{G25} radicals are each independently selected from the group consisting of hydrogen, alkoxy, cyano, alkyl group and the R^{G1}, R^{G2}, R^{G3}, R^{G4}, R^{G6}, R^{G8}, R^{G9}, R^{G10}, R^{G11}, R^{G13}, R^{G14}, R^{G15}, R^{G18}, R^{G17}, R^{G18}, R^{G19}, R^{G21}, R^{G22}, R^{G23}, R^{G24}, R^{G28}, R^{G27} radicals are each hydrogen.

G.2 In a particularly preferred embodiment of the first aspect of the invention as defined in I.1.β), the organic redox polymer P non-conjugated in the main chain which is encompassed by the electrode material in the first aspect of the invention especially comprises n¹ mutually joined repeat units of the chemical structure (I)

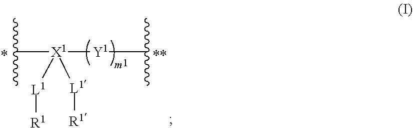

where n¹ is an integer ≥4, more preferably an integer in the range of 4 to 10^{G}, more preferably an integer in the range of 10 to 10⁵, more preferably an integer in the range of 100 to 10⁴,
where m¹ is an integer ≥0, preferably an integer in the range of 0 to 10^{G}, more preferably an integer in the range of 0 to 10⁵, more preferably an integer in the range of 0 to 10⁴, even more preferably an integer in the range of 0 to 10, and most preferably is in each case 0,
where the repeat units of the chemical structure (I) within the polymer P are the same or at least partly different from one another,
where the repeat units of the chemical structure (I) within the polymer are bonded to one another in such a way that the bond indicated by “**” in a particular repeat unit is joined by the bond indicated by “*” in the adjacent repeat unit,
where X¹ is a non-conjugated organic group which is formed by polymerization reaction from a group consisting of an organic double bond, an organic triple bond, an oxirane or an aziridine, or is a non-conjugated organic group which is formed by a polymer-analogous reaction,
where Y¹ is a non-conjugated organic spacer unit,
where L¹, L^{1′} are each independently selected from the group consisting of direct bond, organic linker unit, and, preferably, L¹ is selected from the group consisting of direct bond, organic linker unit and L^{1′} is a direct bond,
where R¹, R^{1′} are each independently a redox-active triphenylamine function (G), and R^{1′} may also be a hydrogen radical, and, preferably, R¹ is a redox-active triphenylamine function (G) and R^{1′} is a hydrogen radical,
and where the redox-active triphenylamine function (G) more preferably has the structure (G1) defined in point G.1,
in which the R^{G1}, R^{G2}, R^{G3}, R^{G4}, R^{G5}, R^{G6}, R^{G7}, R^{G8}, R^{G9}, R^{G10}, R^{G11}, R^{G12}, R^{G13}, R^{G14} radicals are independently selected from the group consisting of hydrogen, (halo)alkyl group, alkenyl group, alkynyl group, (halo)alkoxy group, cycloalkyl group, carbonylalkyl, —C(═O)—H, carboxylic add, carboxamide, carboxylic ester, sulfonic ester, phosphoric ester, amine, mono(halo)alkylamino, di(halo)alkylamino, cyano, hydroxyl, halogen, (hetero)aromatic radical, where the (hetero)aromatic radical may be substituted by at least one group selected from halogen, (halo)alkyl, (halo)alkoxy, cyano, carboxylic ester,
preferably from the group consisting of hydrogen, (halo)alkyl group, (halo)alkoxy group, (halo)cycloalkyl group, cyano, carboxylic ester, thiophene,
more preferably from the group consisting of hydrogen, alkyl group, cyano, alkoxy group,
and, more preferably, the R^{G7}, R^{G12} radicals are each independently selected from the group consisting of alkoxy, cyano, hydrogen, alkyl group, and the R^{G1}, R^{G2}, R^{G3}, R^{G4}, R^{G5}, R^{G6}, R^{G8}, R^{G9}, R^{G10}, R^{G11}, R^{G13}, R^{G14} radicals are each hydrogen, and where, in the case that R¹=(G1), the bond indicated by (xix^{G1}) is the bond to L¹, in the case that R^{1′}=(G1), the bond indicated by (xix^{G1}) is the bond to L^{1′}.

G.3 In a preferred embodiment of the aforementioned point G., the redox-active triphenylamine function (G) is selected from the structures (G4), (G5), (G6)

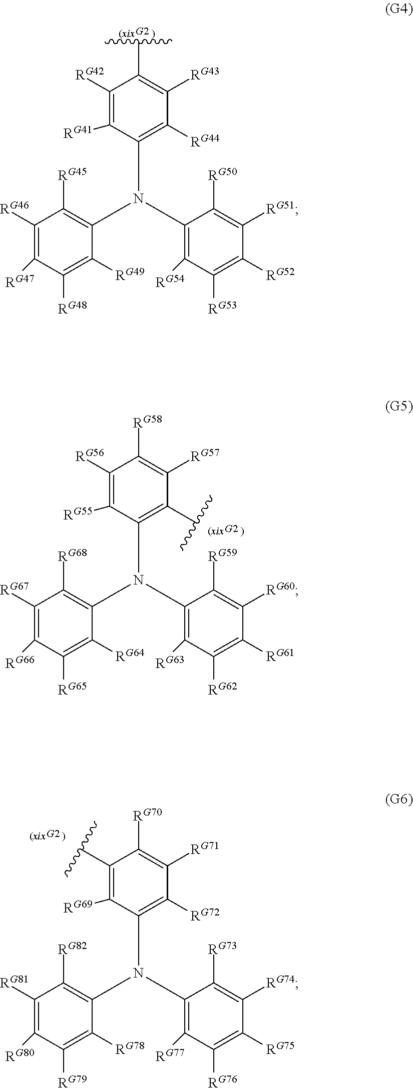

where R^{G41}, R^{G42}, R^{G43}, R^{G44}, R^{G45}, R^{G48}, R^{G47}, R^{G48}, R^{G49}, R^{G50}, R^{G51}, R^{G52}, R^{G53}, R^{G54}, R^{G55}, R^{G58}, R^{G57}, R^{G58}, R^{G59}, R^{G60}, R^{G61}, R^{G62}, R^{G63}, R^{G64}, R^{G65}, R^{G66}, R^{G67}, R^{G68}, R^{G69}, R^{G70}, R^{G71}, R^{G72}, R^{G73}, R^{G74}, R^{G75}, R^{G78}, R^{G77}, R^{G78}, R^{G79}, R^{G80}, R^{G81}, R^{G82} are each independently selected from the group consisting of hydrogen, (halo)alkyl group, alkenyl group, alkynyl group, (halo)alkoxy group, cycloalkyl group, carbonylalkyl, —C(═O)—H, carboxylic add, carboxamide, carboxylic ester, sulfonic ester, phosphoric ester, amine, mono(halo)alkylamino, di(halo)alkylamino, cyano, hydroxyl, halogen, (hetero)aromatic radical, where the (hetero)aromatic radical may be substituted by at least one group selected from halogen, (halo)alkyl, (halo)alkoxy, cyano, carboxylic ester,
preferably from the group consisting of hydrogen, (halo)alkyl group, (halo)alkoxy group, (halo)cycloalkyl group, cyano, carboxylic ester, thiophene,
more preferably from the group consisting of hydrogen, cyano, alkyl group, alkoxy group, and are even more preferably all hydrogen,
even more preferably, the R^{G47}, R^{G52}, R^{G61}, R^{G66}, R^{G75}, R^{G80} radicals are each independently selected from the group consisting of alkoxy, cyano, hydrogen, alkyl group, and R^{G41}, R^{G42}, R^{G43}, R^{G44}, R^{G45}, R^{G46}, R^{G48}, R^{G49}, R^{G50}, R^{G51}, R^{G53}, R^{G54}, R^{G55}, R^{G56}, R^{G57}, R^{G58}, R^{G59}, R^{G60}, R^{G62}, R^{G63}, R^{G64}, R^{G65}, R^{G67}, R^{G68}, R^{G69}, R^{G70}, R^{G71}, R^{G72}, R^{G73}, R^{G74}, R^{G76}, R^{G77}, R^{G78}, R^{G79}, R^{G61}, R^{G62} are each hydrogen,
and where the bond indicated by (xix^{G2}) in each case is the bond to L¹.

G.4 In a preferred embodiment of the aforementioned point G.3, the redox active triphenylamine function (G) has the structure (G4) defined in point G.3 where the R^{G41}, R^{G42}, R^{G43}, R^{G44}, R^{G45}, R^{G46}, R^{G47}, R^{G48}, R^{G49}, R^{G50}, R^{G51}, R^{G52}, R^{G53}, R^{G54} radicals are independently selected from the group consisting of hydrogen, (halo)alkyl group, alkenyl group, alkynyl group, (halo)alkoxy group, cycloalkyl group, carbonylalkyl, —C(═O)—H, carboxylic acid, carboxamide, carboxylic ester, sulfonic ester, phosphoric ester, amine, mono(halo)alkylamino, di(halo)alkylamino, cyano, hydroxyl, halogen, (hetero)aromatic radical, where the (hetero)aromatic radical may be substituted by at least one group selected from halogen, (halo)alkyl, (halo)alkoxy, cyano, carboxylic ester,

preferably from the group consisting of hydrogen, (halo)alkyl group, (halo)alkoxy group, (halo)cycloalkyl group, cyano, carboxylic ester, thiophene,
more preferably from the group consisting of hydrogen, cyano, alkyl group, alkoxy group, and are even more preferably all hydrogen,
even more preferably, the R^{G47}, R^{G52} radicals are each independently selected from the group consisting of alkoxy, cyano, hydrogen, alkyl group, and the R^{G41}, R^{G42}, R^{G43}, R^{G44}, R^{G45}, R^{G46}, R^{G48}, R^{G49}, R^{G50}, R^{G51}, R^{G53}, R^{G54} radicals are each hydrogen,
and where the bond indicated by (xix^{G2}) in each case is the bond to L¹.

### I.1.1.7 Redox-Active Viologen Function (H)

In the context of the invention, “redox-active viologen function” means a redox-active organic radical comprising a base skeleton derived from viologen.

H.1 In the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the first aspect of the invention as defined in point I.1.α) and point I.1.β) are in each case a redox-active viologen function (H), this means more particularly in accordance with the invention that the R¹, R^{1′}, R^{2′}, R^{3′} or R¹, R^{1′} or R¹ radicals are each independently selected from the group consisting of the structures (H1), (H2),

and the R², R⁴, R⁵ radicals are each independently selected from the group consisting of the structures (H3), (H4), (H5), (H6), (H7)

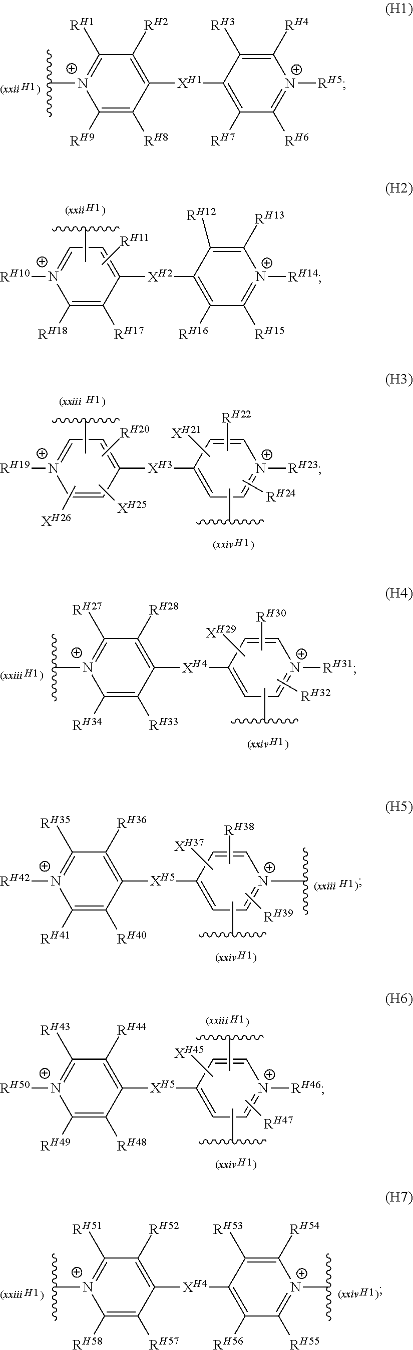

wherein,
in the case that R¹=(H1) or (H2), the bond indicated by (xxii^{H1}) is the bond to L¹,
in the case that R^{1′}=(H1) or (H2), the bond indicated by (xxii^{H1}) is the bond to L^{1′},
in the case that R^{2′}=(H1) or (H2), the bond indicated by (xxii^{H1}) is the bond to L^{2′},
in the case that R^{3′}=(H1) or (H2), the bond indicated by (xxii^{H1}) is the bond to L^{3′},
in the case that R²=(H3), (H4), (H5), (H6) or (H7), the bond indicated by (xxiii^{H1}) is the bond to L² and the bond indicated by (xxiv^{H1}) is the bond to L³,
in the case that R⁴=(H3), (H4), (H5), (H6) or (H7), the bond indicated by (xxiii^{H1}) is the bond to L⁴ and the bond indicated by (xxiv^{H1}) is the bond to L⁵,
in the case that R⁵=(H3), (H4), (H5), (H6) or (H7), the bond indicated by (xxiii^{H1}) is the bond to L⁶ and the bond indicated by (xxiv^{H1}) is the bond to L⁷,
and where the R^{H1}, R^{H2}, R^{H3}, R^{H4}, R^{H5}, R^{H6}, R^{H7}, R^{H8}, R^{H9}, R^{H11}, R^{H12}, R^{H13}, R^{H15}, R^{H18}, R^{H17}, R^{H18}, R^{H20}, R^{H21}, R^{H22}, R^{H24}, R^{H25}, R^{H28}, R^{H27}, R^{H28}, R^{H29}, R^{H30}, R^{H32}, R^{H33}, R^{H34}, R^{H35}, R^{H36}, R^{H37}, R^{H38}, R^{H39}, R^{H40}, R^{H41}, R^{H43}, R^{H44}, R^{H45}, R^{H47}, R^{H48}, R^{H49}, R^{H51}, R^{H52}, R^{H53}, R^{H54}, R^{H55}, R^{H56}, R^{H57}, R^{H58} radicals are each independently selected from the group consisting of hydrogen, (halo)alkyl group, alkenyl group, alkynyl group, (halo)alkoxy group, cycloalkyl group, carbonylalkyl, —C(═O)—H, carboxylic acid, carboxamide, carboxylic ester, sulfonic ester, phosphoric ester, amine, mono(halo)alkylamino, di(halo)alkylamino, cyano, hydroxyl, halogen, preferably selected from the group consisting of hydrogen, (halo)alkyl, halogen, and are more preferably all hydrogen,
and where the R^{H5}, R^{H10}, R^{H14}, R^{H19}, R^{H23}, R^{H31}, R^{H42}, R^{H48}, R^{H50} radicals are each independently selected from the group consisting of hydrogen, (halo)alkyl group, alkenyl group, alkynyl group, (halo)alkoxy group, cycloalkyl group, carbonylalkyl, preferably from the group consisting of hydrogen, (halo)alkyl, halogen, and are more preferably all hydrogen,
and where the X^{H1}, X^{H2}, X^{H3}, X^{H4}, X^{H5}, X^{H6}, X^{H7} radicals are each independently selected from the group consisting of direct bond, divalent conjugated aliphatic radical, divalent conjugated (hetero)aromatic radical, preferably from direct bond, divalent (hetero)aromatic radical, more preferably from the group consisting of direct bond, phenylene, and are more preferably each a direct bond.

H.2 In a preferred embodiment of the aforementioned point H.1, what is meant in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the first aspect of the invention as defined in point I.1.α) and point I.1.β) are each a redox-active viologen function (H) is that the R¹, R^{1′}, R^{2′}, R^{3′} or R¹, R^{1′} or R¹ radicals each independently have the structure (H1) defined in point H.1 with the meanings of X^{H1}, R^{H1}, R^{H2}, R^{H3}, R^{H4}, R^{H5}, R^{H6}, R^{H7}, R^{H8}, R^{H9} defined in point H.1, and R², R⁴, R⁵ each independently have the structure (H7) defined in point H.1 with the meanings X^{H7}, R^{H51}, R^{H52}, R^{H53}, R^{H54}, R^{H55}, R^{H56}, R^{H57}, R^{H58} specified in point H.1.

H.3 In a particularly preferred embodiment of the first aspect of the invention as defined in I.1.β), the organic redox polymer P non-conjugated in the main chain which is encompassed by the electrode material in the first aspect of the invention especially comprises n¹ mutually joined repeat units of the chemical structure (I)

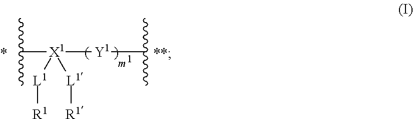

where n¹ is an integer ≥4, more preferably an integer in the range of 4 to 10⁶, more preferably an integer in the range of 10 to 10⁵, more preferably an integer in the range of 100 to 10⁴,
where m¹ is an integer ≥0, preferably an integer in the range of 0 to 10⁶, more preferably an integer in the range of 0 to 10⁵, more preferably an integer in the range of 0 to 10⁴, even more preferably an integer in the range of 0 to 10, and most preferably is in each case 0,
where the repeat units of the chemical structure (I) within the polymer P are the same or at least partly different from one another,
where the repeat units of the chemical structure (I) within the polymer are bonded to one another in such a way that the bond indicated by “**” in a particular repeat unit is joined by the bond indicated by “*” in the adjacent repeat unit,
where X¹ is a non-conjugated organic group which is formed by polymerization reaction from a group consisting of an organic double bond, an organic triple bond, an oxirane or an aziridine, or is a non-conjugated organic group which is formed by a polymer-analogous reaction,
where Y¹ is a non-conjugated organic spacer unit,
where L¹, L^{1′} are each independently selected from the group consisting of direct bond, organic linker unit, and, preferably, L¹ is selected from the group consisting of direct bond, organic linker unit and L^{1′} is a direct bond,
where R¹, R^{1′} are each independently a redox-active viologen function (H), and R^{1′} may also be a hydrogen radical, and, preferably, R¹ is a redox-active viologen function (H) and R^{1′} is a hydrogen radical,
and where the redox-active viologen function (H) more preferably has the structure (H1) shown in point H.1,
where R^{H1}, R^{H2}, R^{H3}, R^{H4}, R^{H5}, R^{H6}, R^{H7}, R^{H8}, R^{H9} are each independently selected from the group consisting of hydrogen, (halo)alkyl group, alkenyl group, alkynyl group, (halo)alkoxy group, cycloalkyl group, carbonylalkyl, —C(═O)—H, carboxylic acid, carboxamide, carboxylic ester, sulfonic ester, phosphoric ester, amine, mono(halo)alkylamino, di(halo)alkylamino, cyano, hydroxyl, halogen, preferably from the group consisting of hydrogen, (halo)alkyl, halogen, and are more preferably all hydrogen,
and where the X^{H1} radical is selected from the group consisting of direct bond, divalent conjugated aliphatic radical, divalent conjugated (hetero)aromatic radical, preferably from the group consisting of direct bond, divalent (hetero)aromatic radical, more preferably from the group consisting of direct bond, phenylene, and is more preferably a direct bond,
and where,
in the case that R¹=(H1), the bond indicated by (xxii^{H1}) is the bond to L¹,
in the case that R^{1′}=(H1), the bond indicated by (xxii^{H1}) is the bond to L^{1′}.

### I. 1.1.8 Redox-Active Ferrocene Function (J)

In the context of the invention, “redox-active ferrocene function” means a redox-active organic radical comprising a base skeleton derived from ferrocene.

J. 1 In the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the first aspect of the invention as defined in point I.1.α) and point I.1.β) are in each case a redox-active ferrocene function (J), this means more particularly in accordance with the invention that the R¹, R^{1′}, R^{2′}, R^{3′} or R¹, R^{1′} or R¹ radicals each independently have the following structure (J1) and the R², R⁴, R⁵ radicals are each independently selected from the group consisting of the following structures (J2), (J3), (J4):

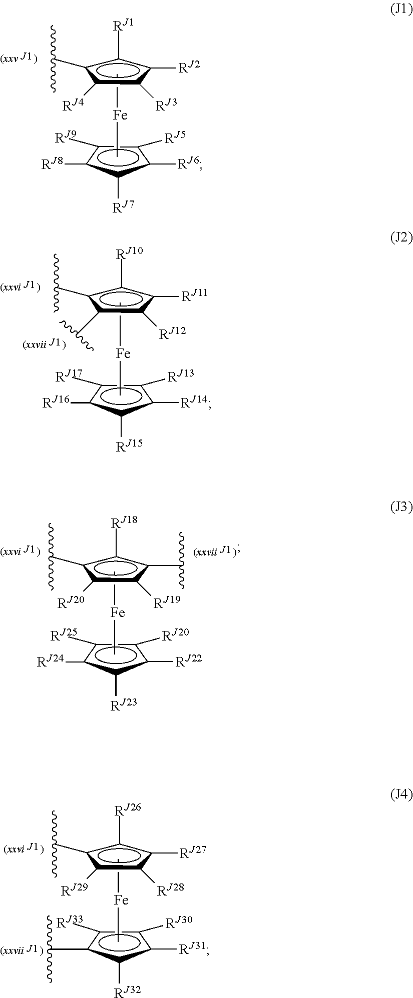

where,
in the case that R¹=(J1), the bond indicated by (xxv^{J1}) is the bond to L¹,
in the case that R^{1′}=(J1), the bond indicated by (xxv^{J1}) is the bond to L^{1′},
in the case that R^{2′}=(J1), the bond indicated by (xxv^{J1}) is the bond to L^{2′},
in the case that R^{3′}=(J1), the bond indicated by (xxv^{J1}) is the bond to L³¹,
in the case that R²=(J2), (J3) or (J4), the bond indicated by (xxvi^{J1}) is the bond to L² and the bond indicated by (xxvii^{J1}) is the bond to L³,
in the case that R⁴=(J2), (J3) or (J4), the bond indicated by (xxvi^{J1}) is the bond to L⁴ and the bond indicated by (xxvii^{J1}) is the bond to L⁵,
in the case that R⁵=(J2), (J3) or (J4), the bond indicated by (xxvi^{J1}) is the bond to L⁶ and the bond indicated by (xxvii^{J1}) is the bond to L⁷,
and where the R^{J1}, R^{J2}, R^{J3}, R^{J4}, R^{J5}, R^{J6}, R^{J7}, R^{J8}, R^{J9}, R^{J10}, R^{J11}, R^{J12}, R^{J13}, R^{J14}, R^{J15}, R^{J16}, R^{J17}, R^{J18}, R^{J19}, R^{J20}, R^{J21}, R^{J22}, R^{J23}, R^{J24}, R^{J25}, R^{J26}, R^{J27}, R^{J28}, R^{J29}, R^{J30}, R^{J31}, R^{J32}, R^{J33} are each independently selected from the group consisting of hydrogen, (halo)alkyl group, alkenyl group, alkynyl group, (halo)alkoxy group, cycloalkyl group, carbonylalkyl, —C(═O)—H, carboxylic acid, carboxamide, carboxylic ester, sulfonic ester, phosphoric ester, amine, mono(halo)alkylamino, di(halo)alkylamino, cyano, hydroxyl, halogen, more preferably from the group consisting of hydrogen, alkyl group, which is preferably methyl, and are especially preferably all hydrogen.

J.2 In a particularly preferred embodiment of the first aspect of the invention as defined in I.1.β), the organic redox polymer P non-conjugated in the main chain which is encompassed by the electrode material in the first aspect of the invention especially comprises n¹ mutually joined repeat units of the chemical structure (I)

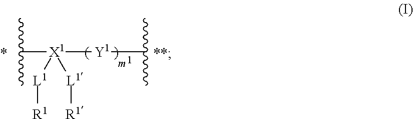

where n¹ is an integer ≥4, more preferably an integer in the range of 4 to 10⁶, more preferably an integer in the range of 10 to 10⁵, more preferably an integer in the range of 100 to 10⁴,
where m¹ is an integer ≥0, preferably an integer in the range of 0 to 10⁶, more preferably an integer in the range of 0 to 10⁵, more preferably an integer in the range of 0 to 10⁴, even more preferably an integer in the range from 0 to 10, and most preferably is in each case 0,
where the repeat units of the chemical structure (I) within the polymer P are the same or at least partly different from one another,
where the repeat units of the chemical structure (I) within the polymer are bonded to one another in such a way that the bond indicated by “**” in a particular repeat unit is joined by the bond indicated by “*” in the adjacent repeat unit,
where X¹ is a non-conjugated organic group which is formed by polymerization reaction from a group consisting of an organic double bond, an organic triple bond, an oxirane or an aziridine, or is a non-conjugated organic group which is formed by a polymer-analogous reaction,
where Y¹ is a non-conjugated organic spacer unit,
where L¹, L^{1′} are each independently selected from the group consisting of direct bond, organic linker unit, and, preferably, L¹ is selected from the group consisting of direct bond, organic linker unit and L^{1′} is a direct bond,
where R¹, R^{1′} are each independently a redox-active ferrocene function (J), and R^{1′} may also be a hydrogen radical, and, preferably, R¹ is a redox-active ferrocene function (J) and R^{1′} is a hydrogen radical,
and where the redox-active ferrocene function (J) more preferably has the structure (J1) defined in point J.1,
where the R^{J1}, R^{J2}, R^{J3}, R^{J4}, R^{J5}, R^{J6}, R^{J7}, R^{J8}, R^{J9} radicals are each independently selected from the group consisting of hydrogen, (halo)alkyl group, alkenyl group, alkynyl group, (halo)alkoxy group, cycloalkyl group, carbonylalkyl, —C(═O)—H, carboxylic acid, carboxamide, carboxylic ester, sulfonic ester, phosphoric ester, amine, mono(halo)alkylamino, di(halo)alkylamino, cyano, hydroxyl, halogen, preferably from the group consisting of hydrogen, (halo)alkyl group, more preferably from the group consisting of hydrogen, alkyl group, which is preferably methyl, and are especially preferably all hydrogen,
and where,
in the case that R¹=(J1), the bond indicated by (xxv^{J1}) is the bond to L¹,
and, in the case that R^{1′}=(J1), the bond indicated by (xxv^{J1}) is the bond to L^{1′}.

### I.1.2 Linker Units

L¹, L², L³, L⁴, L⁵, L⁶, L⁷, L^{1′}, L^{2′}, L^{3′} or L¹, L^{1′}, in the first aspect of the invention as defined in point I.1.α) or point I.1.β), in the structures (I), (II) and (III), are each independently selected from the group consisting of direct bond, organic linker unit. Organic linker units of this kind are not subject to any further restriction and are known to those skilled in the art.

In the cases in which L¹, L², L³, L⁴, L⁵, L⁶, L⁷, L^{1′}, L^{2′}, L^{3′} or L¹, L^{1′}, in the first aspect of the invention as defined in point I.1.α) or point I.1.β), in the structures (I), (II) and (III), are each an organic linker unit, this means more particularly in accordance with the invention that L¹, L², L³, L⁴, L⁵, L⁶, L⁷, L^{1′}, L^{2′}, L^{3′} or L¹, L^{1′} in that case are each independently selected from the group consisting of (L11), (L12):

[symbol]

-(X^{L1})ₚ₁—[C═X^{L2}]ₚ₂—(X^{L3})ₚ₃-B^{L1}-(Y^{L1})_{q1}—[C═Y^{L2}]_{q2}—(Y^{L3})_{q3}- [symbol] , (L11):

[symbol]

-(Y^{L4})_{q4}—[C═Y^{L5}]_{q5}—(Y^{L6})_{q6}- [symbol] (L12):

where p1, p2, p3 are each 0 or 1, excluding the case that “p2=0, p1=p3=1”,
where q1, q2, q3 are each 0 or 1, excluding the case that “q2=0, q1=q3=1”,
where q4, q5, q6 are each 0 or 1, where at least one of q4, q5, q6=1 and excluding the case that “q5=0, q4=q6=1”,
where X^{L2}, Y^{L2}, Y^{L5} are each independently selected from the group consisting of O, S,
where X^{L1}, X^{L3}, Y^{L1}, Y^{L3}, Y^{L4}, Y^{L6} are each independently selected from the group consisting of O, S, NH, N[(halo)alkyl],
where B^{L1} is selected from the group consisting of divalent (hetero)aromatic radical, divalent aliphatic radical optionally substituted by at least one group selected from nitro group, —NH₂, —CN, —SH, —OH, halogen and optionally having at least one group selected from ether, thioether, amino ether, carbonyl group, carboxylic ester, carboxamide group, sulfonic ester, phosphoric ester,
and where, in the cases in which L¹, L², L³, L⁴, L⁵, L⁶, L⁷, L^{1′}, L^{2′} or L³¹ binds to a non-carbon atom in the respective redox-active R¹, R², R⁴, R⁵, R^{1′}, R^{2′} or R^{3′} group, for the structure (L11) the additional condition is applicable that “q3=0, q2=1, q1=1 or q3=q2=q1=0 or q3=0, q2=1, q1=0”, preferably the condition that “q3=q2=q1=0”, and for the structure (L12) the additional condition is applicable that “q6=0, q5=1, q4=1 or q6=0, q5=1, q4=0”,
and where “ [symbol] ” for L¹ denotes the bond pointing toward R¹, for L^{1′} denotes the bond pointing toward R^{1′}, for L² denotes the bond pointing toward R², for L^{2′} denotes the bond pointing toward R^{2′}, for L³ denotes the bond pointing toward R², for L³¹ denotes the bond pointing toward R^{3′}, for L⁴ denotes the bond pointing toward R⁴, for L⁵ denotes the bond pointing toward R⁴, for L⁶ denotes the bond pointing toward R⁵, for L⁷ denotes the bond pointing toward R⁵,
and where “ [symbol] ” for L¹ denotes the bond pointing toward X¹, for L^{1′} denotes the bond pointing toward X^{1′}, for L² denotes the bond pointing toward X², for L^{2′} denotes the bond pointing toward X^{2′}, for L³ denotes the bond pointing toward X³, for L³¹ denotes the bond pointing toward X^{3′}, for L⁴ denotes the bond pointing toward X⁴, for L⁵ denotes the bond pointing toward X⁵, for L⁶ denotes the bond pointing toward X⁴, for L⁷ denotes the bond pointing toward X⁵.

The condition “where at least one of q4, q5, q6=1” relates here merely to the definition of the respective variables in the structure (L12), and is not intended to rule out the possibility that L¹, L², L³, L⁴, L⁵, L⁶, L⁷, L^{1′}, L^{2′}, L^{3′} may each also be direct bonds.

### I.1.2.1 Preferred Linker Units in Redox-Active Aromatic Imide Functions (A)

LA.1 In a preferred embodiment, in the first aspect of the present invention, in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the first aspect of the invention as defined in point I.1.α) and point I.1.β) are each a redox-active aromatic imide function (A), and especially in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical have the structures defined in the above point A.1, more preferably A.2, even more preferably A.3, even more preferably still A.4, and also in the case in which the organic redox polymer P non-conjugated in the main chain, in the first aspect of the invention, comprises a structure as defined in point A.5,

L¹, L², L³, L⁴, L⁵, L⁶, L⁷, L^{1′}, L^{2′}, L^{3′} in that case are preferably selected from the group consisting of direct bond, (LA11), (LA12)

[symbol]

-(X^{LA1})_{pA1}—[C═X^{LA2}]_{pA2}—(X^{LA3})_{pA3}-B^{LA1}-(Y^{LA1})_{qA1}—[C═Y^{LA2}]_{qA2}—(Y^{LA3})_{qA3}- [symbol] (LA11):

[symbol]

-(Y^{LA4})_{qA4}—[C═Y^{LA5}]_{qA5}—(Y^{LA6})_{qA6}- [symbol] (LA12):
where pA1, pA2, pA3 are each 0 or 1, excluding the case that “pA2=0, pA1=pA3=1”,
where qA1, qA2, qA3 are each 0 or 1, excluding the case that “qA2=0, qA1=qA3=1”,
where qA4, qA5, qA6 are each 0 or 1, where at least one of qA4, qA5, qA6=1 and where the case that “qA5=0, qA4=qA6=1” is excluded,
where X^{LA2}, Y^{LA2}, Y^{LA5} are each independently selected from the group consisting of O, S,
where X^{LA1}, X^{LA3}, Y^{LA1}, Y^{LA3}, Y^{LA4}, Y^{LA6} are each independently selected from the group consisting of O, S, NH, N[(halo)alkyl],
where B^{LA1} is selected from the group consisting of
divalent (hetero)aromatic radical,
divalent aliphatic radical optionally substituted by at least one group selected from nitro group, —NH₂, —ON, —SH, —OH, halogen and optionally having at least one group selected from ether, thioether, amino ether, carbonyl group, carboxylic ester, carboxamide group, sulfonic ester, phosphoric ester,
   and where, in the cases in which L¹, L², L³, L⁴, L⁵, L⁶, L⁷, L^{1′}, L^{2′}, L^{3′} binds to a non-carbon atom in the respective redox-active R¹, R², R⁴, R⁵, R^{1′}, R^{2′}, R^{3′} group, for the structure (LA11) the additional condition is applicable that “qA3=0, qA2=1, qA1=1 or qA3=qA2=qA1=0 or qA3=0, qA2=1, qA1=0”, preferably the condition that “qA3=qA2=qA1=0”, and for the structure (LA12) the additional condition is applicable that “qA6=0, qA5=1, qA4=1 or qA6=0, qA5=1, qA4=0”,
   and where “ [symbol] ” for L¹ denotes the bond pointing toward R¹, for L^{1′} denotes the bond pointing toward R^{1′}, for L² denotes the bond pointing toward R², for L^{2′} denotes the bond pointing toward R^{2′}, for L³ denotes the bond pointing toward R², for L³¹ denotes the bond pointing toward R^{3′}, for L⁴ denotes the bond pointing toward R⁴, for L⁵ denotes the bond pointing toward R⁴, for L⁶ denotes the bond pointing toward R⁵, for L⁷ denotes the bond pointing toward R⁵,
   and where “ [symbol] ” for L¹ denotes the bond pointing toward X¹, for L^{1′} denotes the bond pointing toward X^{1′}, for L² denotes the bond pointing toward X², for L^{2′} denotes the bond pointing toward X^{2′}, for L³ denotes the bond pointing toward X³, for L³¹ denotes the bond pointing toward X^{3′}, for L⁴ denotes the bond pointing toward X⁴, for L⁵ denotes the bond pointing toward X⁵, for L⁶ denotes the bond pointing toward X⁴, for L⁷ denotes the bond pointing toward X⁵.

The condition “where at least one of qA4, qA5, qA6=1” relates here merely to the definition of the respective variables in the structure (LA12), and is not intended to rule out the possibility that L¹, L², L³, L⁴, L⁵, L⁶, L⁷, L^{1′}, L^{2′}, L^{3′} may each also be direct bonds.

LA.2 In a preferred embodiment of the aforementioned point LA.1, X^{LA2}, Y^{LA2}, Y^{LA5} are each independently selected from the group consisting of O, S, preferably O, and X^{LA1}, X^{LA3}, Y^{LA1}, Y^{LA3}, Y^{LA4}, Y^{LA6} are each independently selected from the group consisting of O, S, NH, N(alkyl), preferably from the group consisting of O, S, and B^{LA1} is selected from the group consisting of benzylene, phenylene, divalent anthraquinone radical, divalent alkylene radical optionally having at least one group selected from ether, thioether.

LA.3 In a preferred embodiment of the aforementioned point LA.2, L¹, L², L³, L⁴, L⁵, L⁶, L⁷, L^{1′}, L^{2′}, L^{3′} are each independently selected from the group consisting of direct bond, benzylene, phenylene, divalent anthraquinone radical, alkylene radical, which is preferably a methylene radical, [symbol] -C(═O)- [symbol] , [symbol] -(NR^{LA3})-B^{LA2}- [symbol] ,

where, in the cases in which L¹, L², L³, L⁴, L⁵, L⁶, L⁷, L^{1′}, L^{2′}, L^{3′} binds to a carbon atom in the respective redox-active R¹, R², R⁴, R⁵, R^{1′}, R^{2′}, R^{3′} group, the linker units L¹, L², L³, L⁴, L⁵, L⁶, L⁷, L^{1′}, L^{2′}, L³¹ may also be selected from the group consisting of [symbol]
-O- [symbol] , [symbol] -(NR^{LA3})-B^{LA2}-(NR^{LA4})- [symbol] , [symbol] -B^{LA2}-(NR^{LM})- [symbol]
where R^{LA3}, R^{LA4} are each independently selected from hydrogen, alkyl, and are preferably both hydrogen, and B^{LA2} is an alkylene radical optionally having ether groups,
and where, more preferably, L¹, L², L³, L⁴, L⁵, L⁶, L⁷, L^{1′}, L^{2′}, L^{3′} are each independently selected from the group consisting of direct bond, [symbol] -C(═O)- [symbol] , methylene radical, and where “ [symbol] ” and “ [symbol] ” have the definition given in point LA.1.

### I.1.2.2 Preferred Linker Units for Redox-Active Organic Functions Comprising at Least One Stable Oxygen Radical (B)

LB.1 In a preferred embodiment of the first aspect of the present invention, in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the first aspect of the invention as defined in point I.1.α) and point I.1.β) are each a redox-active organic function comprising at least one stable oxygen radical (B), and especially in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical have the structures defined in the above point B.1, more preferably B.2, and also in the case in which the organic redox polymer P non-conjugated in the main chain, in the first aspect of the invention, comprises a structure as defined in point B.3,

L¹, L², L³, L⁴, L⁵, L⁶, L⁷, L^{1′}, L^{2′}, L^{3′} in that case are preferably selected from the group consisting of direct bond, (LB11), (LB12)

[symbol]

-(X^{LB1})_{pB1}—[C═X^{LB2}]_{pB2}—(X^{LB3})_{pB3}-B^{LB1}-(Y^{LB1})_{qB1}—[C═Y^{LB2}]^{qB2}—(Y^{LB3})_{qB3}- [symbol] , (LB11):

[symbol]

-(Y^{LB4})_{qB4}—[C═Y^{LB5}]_{qB5}—(Y^{LB6})_{qB6}- [symbol] (LB12):
where pB1, pB2, pB3 are each 0 or 1, excluding the case that “pB2=0, pB1=pB3=1”,
where qB1, qB2, qB3 are each 0 or 1, excluding the case that “qB2=0, qB1=qB3=1”,
where qB4, qB5, qB6 are each 0 or 1, where at least one of qB4, qB5, qB6=1 and where the case that “qB5=0, qB4=qB6=1” is excluded,
where X^{L2}, Y^{LB2}, Y^{LB5} are each independently selected from the group consisting of O, S,
where X¹³¹, X^{LB3}, Y^{LB1}, Y^{LB3}, Y^{LB4}, Y^{LB6} are each independently selected from the group consisting of O, S, NH, N[(halo)alkyl],
where B^{LB1} is selected from the group consisting of
divalent (hetero)aromatic radical,
divalent aliphatic radical optionally substituted by at least one group selected from nitro group, —NH₂, —CN, —SH, —OH, halogen and optionally having at least one group selected from ether, thioether, amino ether, carbonyl group, carboxylic ester, carboxamide group, sulfonic ester, phosphoric ester,
   and where, in the cases in which L¹, L², L³, L⁴, L⁵, L⁶, L⁷, L^{1′}, L^{2′}, L^{3′} binds to a non-carbon atom in the respective redox-active R¹, R², R⁴, R⁵, R^{1′}, R^{2′}, R^{3′} group, for the structure (LB11) the additional condition is applicable that “qB3=0, qB2=1, qB1=1 or qB3=qB2=qB1=0 or qB3=0, qB2=1, qB1=0”, preferably the condition that “qB3=qB2=qB1=0”, and for the structure (LB12) the additional condition is applicable that “qB6=0, qB5=1, qB4=1 or qB6=0, qB5=1, qB4=0”,
   and where “ [symbol] ” for L¹ denotes the bond pointing toward R¹, for L^{1′} denotes the bond pointing toward R^{1′}, for L² denotes the bond pointing toward R², for L^{2′} denotes the bond pointing toward R^{2′}, for L³ denotes the bond pointing toward R², for L³¹ denotes the bond pointing toward R^{3′}, for L⁴ denotes the bond pointing toward R⁴, for L⁵ denotes the bond pointing toward R⁴, for L⁶ denotes the bond pointing toward R⁵, for L⁷ denotes the bond pointing toward R⁵,
   and where “ [symbol] ” for L¹ denotes the bond pointing toward X¹, for L^{1′} denotes the bond pointing toward X^{1′}, for L² denotes the bond pointing toward X², for L^{2′} denotes the bond pointing toward X^{2′}, for L³ denotes the bond pointing toward X³, for L³¹ denotes the bond pointing toward X^{3′}, for L⁴ denotes the bond pointing toward X⁴, for L⁵ denotes the bond pointing toward X⁵, for L⁶ denotes the bond pointing toward X⁴, for L⁷ denotes the bond pointing toward X⁵.

The condition “where at least one of qB4, qB5, qB6=1” relates here merely to the definition of the respective variables in the structure (LB12), and is not intended to rule out the possibility that L¹, L², L³, L⁴, L⁵, L⁶, L⁷, L^{1′}, L^{2′}, L^{3′} may each also be direct bonds.

LB.2 In a preferred embodiment of the aforementioned point LB.1, X^{L2}, Y^{LB2}, Y^{LB5} are each O, and X^{LB1}, X^{LB3}, Y^{LB1}, Y^{LB3}, Y^{LB4}, Y^{LB6} are each independently selected from the group consisting of O, NH, N(alkyl), preferably O, and B^{LA2} is a divalent alkylene radical optionally having at least one ether group.

LB.3 In a preferred embodiment of the aforementioned point LB.2, L¹, L², L³, L⁴, L⁵, L⁶, L⁷, L^{1′}, L^{2′}, L^{3′} are selected from the group consisting of

direct bond, alkylene radical which is preferably methylene,
phenylene, [symbol] -C(═O)- [symbol] , [symbol] -O—C(═O)- [symbol] , [symbol] -(NH)—C(═O)- [symbol] , [symbol] -(Nalkyl)-C(═O)- [symbol] ,
an alkylene radical that has ether groups and is preferably a radical of the formula [symbol] -(CH₂CH₂O)_{mLB1}- [symbol] with m^{LB1}=1-1000, preferably m¹⁸¹=1-10, or a radical of the formula [symbol] -(CH₂O)_{mB2}- [symbol] with m^{LB2}=1-1000, preferably m¹⁸²=1-10,
and, in the cases in which L¹, L², L³, L⁴, L⁵, L⁶, L⁷, L^{1′}, L^{2′}, L^{3′} binds to a carbon in the respective redox-active R¹, R², R⁴, R⁵, R^{1′}, R^{2′}, R^{3′} group, L¹, L², L³, L⁴, L⁵, L⁶, L⁷, L^{1′}, L^{2′}, L³¹ may also be selected from the group consisting of [symbol] -C(═O)—O- [symbol] , [symbol] -C(═O)—(NH)- [symbol] , [symbol] -C(═O)—(Nalkyl)- [symbol] , [symbol] -O- [symbol] , [symbol] -(CH₂CH₂O)_{mLB3}- [symbol] with m^{LB3}=1-1000, preferably m^{LB3}=1-10, [symbol]
-(CH₂O)_{mLB4}- [symbol] with m^{LB4}=1-1000, preferably m^{LB4}=1-10,
particular preference being given to [symbol] -C(═O)—O- [symbol] , especially when R¹, R^{1′} are a compound of the structure (B111),
and where “ [symbol] ” and “ [symbol] ” have the definition given in point LB.1.

### I.1.2.3 Preferred Linker Units for Redox-Active Anthraquinone/Carbazole Function (C)

LC.1 In a more preferred embodiment of the first aspect of the present invention, in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the first aspect of the invention as defined in point I.1.α) and point I.1.β) are each a redox-active anthraquinone/carbazole function (C), and especially in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical have the structures defined in the above point C.1, preferably C.2, more preferably C.3, even more preferably C.4, even more preferably still C.5, and also in the case in which the organic redox polymer P non-conjugated in the main chain, in the first aspect of the invention, comprises a structure as defined in point C.6, preferably C.7,

L¹, L², L³, L⁴, L⁵, L⁶, L⁷, L^{1′}, L^{2′}, L^{3′} in that case are preferably selected from the group consisting of direct bond, (LC11), (LC12)

[symbol]

-(X^{LC1})_{pC1}—[C═X^{LC2}]_{pC2}—(X^{LC3})_{pC3}-B^{LC1}-(Y^{LC1})_{qC1}—[C═Y^{LC2}]_{qC2}—(Y^{LC3})_{qC3}- [symbol] , (LC11):

[symbol]

-(Y^{LC4})_{qC4}—[C═Y^{LC5}]_{qC5}—(Y^{LC6})_{qC6}- [symbol] (LC12):
where pC1, pC2, pC3 are each 0 or 1, excluding the case that “pC2=0, pC1=pC3=1”,
where qC1, qC2, qC3 are each 0 or 1, excluding the case that “qC2=0, qC1=qC3=1”,
where qC4, qC5, qC6 are each 0 or 1, where at least one of qC4, qC5, qC6=1 and
where the case that “qC5=0, qC4=qC6=1” is excluded,
where X^{LC2}, Y^{LC2}, Y^{LC5} are each independently selected from the group consisting of O, S,
where X¹⁰¹, X^{LC3}, Y^{LC1}, Y^{LC3}, Y^{LC4}, Y^{LC6} are each independently selected from the group consisting of O, S, NH, N[(halo)alkyl],
where B^{LC1} is selected from the group consisting of
divalent (hetero)aromatic radical,
divalent aliphatic radical optionally substituted by at least one group selected from nitro group, —NH₂, —ON, —SH, —OH, halogen and optionally having at least one group selected from ether, thioether, amino ether, carbonyl group, carboxylic ester, carboxamide group, sulfonic ester, phosphoric ester,
   and where, in the cases in which L¹, L², L³, L⁴, L⁵, L⁶, L⁷, L^{1′}, L^{2′}, L^{3′} binds to a non-carbon atom in the respective redox-active R¹, R², R⁴, R⁵, R^{1′}, R^{2′}, R^{3′} group, for the structure (LC11) the additional condition is applicable that “qC3=0, qC2=1, qC1=1 or qC3=qC2=qC1=0 or qC3=0, qC2=1, qC1=0”, preferably the condition that “qC3=qC2=qC1=0”, and for the structure (LC12) the additional condition is applicable that “qC6=0, qC5=1, qC4=1 or qC6=0, qC5=1, qC4=0”,
   and where “ [symbol] ” for L¹ denotes the bond pointing toward R¹, for L^{1′} denotes the bond pointing toward R^{1′}, for L² denotes the bond pointing toward R², for L^{2′} denotes the bond pointing toward R^{2′}, for L³ denotes the bond pointing toward R², for L³¹ denotes the bond pointing toward R^{3′}, for L⁴ denotes the bond pointing toward R⁴, for L⁵ denotes the bond pointing toward R⁴, for L⁶ denotes the bond pointing toward R⁵, for L⁷ denotes the bond pointing toward R⁵,
   and where “ [symbol] ” for L¹ denotes the bond pointing toward X¹, for L^{1′} denotes the bond pointing toward X^{1′}, for L² denotes the bond pointing toward X², for L^{2′} denotes the bond pointing toward X^{2′}, for L³ denotes the bond pointing toward X³, for L³¹ denotes the bond pointing toward X^{3′}, for L⁴ denotes the bond pointing toward X⁴, for L⁵ denotes the bond pointing toward X⁵, for L⁶ denotes the bond pointing toward X⁴, for L⁷ denotes the bond pointing toward X⁵.

The condition “where at least one of qC4, qC5, qC6=1” relates here merely to the definition of the respective variables in the structure (LC12), and is not intended to rule out the possibility that L¹, L², L³, L⁴, L⁵, L⁶, L⁷, L^{1′}, L^{2′}, L^{3′} may each also be direct bonds.

LC.2 In a preferred embodiment of the aforementioned point LC.1, X^{LC2}, Y^{LC2}, Y^{LC5} are each O, and #^{c}Y^{LC1}, Y^{LC3}, Y^{LC4}, Y^{LC6} are each independently selected from the group consisting of O, NH, N(alkyl), preferably O, and B^{LC1} is a divalent alkylene radical optionally having at least one ether group.

LC.3 In a preferred embodiment of the aforementioned point LC.2, L¹, L², L³, L⁴, L⁵, L⁶, L⁷, L^{1′}, L^{2′}, L^{3′} are selected from the group consisting of direct bond, alkylene radical, which is preferably methylene, phenylene, [symbol] -C(═O)- [symbol] , [symbol] -O—C(═O)- [symbol] , [symbol] -(NH)—C(═O)- [symbol] , [symbol] -(Nalkyl)-C(═O)- [symbol] , an alkylene radical that has ether groups and is preferably a radical of the formula [symbol] -(CH₂CH₂O)_{mLC1}- [symbol] with m^{LC1}=integer from 2 to 1000, preferably 3 to 500, more preferably 10 to 100,

and where, in the cases in which L¹, L², L³, L⁴, L⁵, L⁶, L⁷, L^{1′}, L^{2′}, L^{3′} binds to a carbon atom in the respective redox-active R¹, R², R⁴, R⁵, R^{1′}, R^{2′}, R^{3′} group, the linker units L¹, L², L³, L⁴, L⁵, L⁶, L⁷, L^{1′}, L^{2′}, L^{3′} may also be selected from [symbol] -(CH₂CH₂O)_{mLC2}- [symbol] with m^{LC2}=integer from 2 to 1000, preferably 3 to 500, more preferably 10 to 100, [symbol] -C(═O)—O- [symbol] , [symbol] -C(═O)—(NH)- [symbol] , [symbol] -C(═O)—(Nalkyl)- [symbol] , particular preference being given to direct bond, especially when R¹, R^{1′} are a compound of the structure (C501) or (C502),
and where “ [symbol] ” and “ [symbol] ” have the definition given in point LC.1.

### I.1.2.4 Preferred Linker Units for Redox-Active Dialkoxybenzene Function (D)

LD.1 In a more preferred embodiment of the first aspect of the present invention, in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the first aspect of the invention as defined in point I.1.α) and point I.1.β) are each a redox-active phenoxy compound (D), and especially in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical have the structures defined in the above point D.1, preferably D.2, more preferably D.3, even more preferably D.4, yet more preferably D.5, even more preferably still D.6, and also in the case in which the polymer P, in the first aspect of the invention, comprises a structure as defined in point D.7,

L¹, L², L³, L⁴, L⁵, L⁶, L⁷, L^{1′}, L^{2′}, L^{3′} in that case are preferably selected from the group consisting of direct bond, (LD11), (LD12)

[symbol]

-(X^{LD1})_{pD1}—[C═X^{LD2}]_{pD2}—(X^{LD3})_{pD3}-B^{LD1}-(Y^{LD1})_{qLD1}—[C═Y^{LD2}]_{qLD2}—(Y^{LD3})_{qLD3}- [symbol] , (LD-11):

[symbol]

-(Y^{LD4})_{qD4}—[C═Y^{LD5}]_{qD5}—(Y^{LD6})_{qD6}- [symbol] (LD12):
where pD1, pD2, pD3 are each 0 or 1, excluding the case that “pD2=0, pD1=pD3=1”,
where qD1, qD2, qD3 are each 0 or 1, excluding the case that “qD2=0, qD1=qD3=1”,
where qD4, qD5, qD6 are each 0 or 1, where at least one of qD4, qD5, qD6=1 and
where the case II that “qD5=0, qD4=qD6=1” is excluded,
where X^{LD2}, Y^{LD2}, Y^{LD5} are each independently selected from the group consisting of O, S,
where X^{LD1}, X^{LD3}, Y^{LD1}, Y^{LD3}, Y^{LD4}, Y^{LD6} are each independently selected from the group consisting of O, S, NH, N[(halo)alkyl],
where B¹⁰¹ is selected from the group consisting of
divalent (hetero)aromatic radical,
divalent aliphatic radical optionally substituted by at least one group selected from nitro group, —NH₂, —ON, —SH, —OH, halogen and optionally having at least one group selected from ether, thioether, amino ether, carbonyl group, carboxylic ester, carboxamide group, sulfonic ester, phosphoric ester,
   and where, in the cases in which L¹, L², L³, L⁴, L⁵, L⁶, L⁷, L^{1′}, L^{2′}, L^{3′} binds to a non-carbon atom in the respective redox-active R¹, R², R⁴, R⁵, R^{1′}, R^{2′}, R^{3′} group, for the structure (LD11) the additional condition is applicable that “qD3=0, qD2=1, qD1=1 or qD3=qD2=qD1=0 or qD3=0, qD2=1, qD1=0”, preferably the condition that “qD3=qD2=qD1=0”, and for the structure (LD12) the additional condition is applicable that “qD6=0, qD5=1, qD4=1 or qD6=0, qD5=1, qD4=0”,
   and where “ [symbol] ” for L¹ denotes the bond pointing toward R¹, for L^{1′} denotes the bond pointing toward R^{1′}, for L² denotes the bond pointing toward R², for L^{2′} denotes the bond pointing toward R^{2′}, for L³ denotes the bond pointing toward R², for L³¹ denotes the bond pointing toward R^{3′}, for L⁴ denotes the bond pointing toward R⁴, for L⁵ denotes the bond pointing toward R⁴, for L⁶ denotes the bond pointing toward R⁵, for L⁷ denotes the bond pointing toward R⁵,
   and where “ [symbol] ” for L¹ denotes the bond pointing toward X¹, for L^{1′} denotes the bond pointing toward X^{1′}, for L² denotes the bond pointing toward X², for L^{2′} denotes the bond pointing toward X^{2′}, for L³ denotes the bond pointing toward X³, for L³¹ denotes the bond pointing toward X^{3′}, for L⁴ denotes the bond pointing toward X⁴, for L⁵ denotes the bond pointing toward X⁵, for L⁶ denotes the bond pointing toward X⁴, for L⁷ denotes the bond pointing toward X⁵.

The condition “where at least one of qD4, qD5, qD6=1” relates here merely to the definition of the respective variables in the structure (LD12), and is not intended to rule out the possibility that L¹, L², L³, L⁴, L⁵, L⁶, L⁷, L^{1′}, L^{2′}, L^{3′} may each also be direct bonds.

LD.2 In a preferred embodiment of the aforementioned point LD.1, X^{LD2}, Y^{LD2}, Y^{LD5} are each O, and X^{LD1}, X^{LD3}, Y^{LD1}, Y^{LD3}, Y^{LD4}, Y^{LD6} are each independently selected from the group consisting of O, NH, N(alkyl), preferably O, and B¹⁰¹ is selected from the group consisting of divalent (hetero)aromatic radical, divalent aliphatic radical optionally substituted by at least one group selected from nitro group, —NH₂, —ON, —SH, —OH, halogen and optionally having at least one group selected from ether, thioether, amino ether, carbonyl group, carboxylic ester, carboxamide group, sulfonic acid, phosphoric ester.

LD.3 In a more preferred embodiment of the aforementioned point LD.2, L¹, L², L³, L⁴, L⁵, L⁶, L⁷, L^{1′}, L^{2′}, L^{3′} are selected from the group consisting of direct bond, alkylene radical, which is preferably methylene, phenylene, benzylene, [symbol] -C(═O)- [symbol] , [symbol] -O—C(═O)- [symbol] , [symbol] -(NH)—C(═O)- [symbol] , [symbol] -(Nalkyl)-C(═O)- [symbol] , alkylene radical having at least one group selected from ether, carbonyl group, carboxylic ester, carboxamide group,

[symbol]

-[X^{LD4}]_{pD4}—[C(═O)]_{pD5}—[X^{LD5}]_{pD6}-B^{LD4}-[X^{LD6}]_{qD6}—[C(═O)]_{qD7}- [symbol] where X^{LD4}, X^{LD5}, X^{LD6} are independently selected from the group consisting of O, S, NH, Nalkyl, N(haloalkyl), preferably O,
and where p_{D4}, p_{D5}, p_{D6} are each 0 or 1, excluding the case that “p_{D5}=0, p_{D4}=p_{D6}=1”,
and where q_{D6}, q_{D7} are each 0 or 1, excluding the case that “q_{D7}=0, q_{D6}=1”,
and where B^{LD4} is an alkylene group that may have ether groups and/or carbonyl groups, preferably an alkylene group, and is more preferably selected from the group consisting of methylene group, ethylene group, n-propylene group, n-butylene group, n-pentylene group, n-hexylene group,
   and where “ [symbol] ” and “ [symbol] ” have the definition given in point LD.1.

LD. 4 In an even more preferred embodiment of the aforementioned point LD.3, L¹, L², L³, L⁴, L⁵, L⁶, L⁷, L^{1′}, L^{2′}, L^{3′} are selected from the group consisting of direct bond, alkylene radical, which is preferably methylene, phenylene, benzylene, [symbol] -(═O)- [symbol] , [symbol] -O—C(═O)- [symbol] , [symbol] -(NH)—C(═O)- [symbol] , [symbol] -(Nalkyl)-C(═O)- [symbol] , alkylene radical having at least one group selected from ether, carbonyl group, carboxylic ester, carboxamide group, or [symbol] -O—C(═O)-B^{LD5}- [symbol] , and is most preferably selected from the group consisting of direct bond, methylene, [symbol] -O—C(═O)-B^{LD5}- [symbol] , phenylene,

where B^{LD5} is an alkylene group, preferably a methylene group, ethylene group, propylene group, butylene group, pentylene group, hexylene group, and is most preferably selected from the group consisting of methylene, ethylene, propylene,
and where “ [symbol] ” and “ [symbol] ” have the definition given in point LD.1.

### I.1.2.5 Preferred Linker Units for Redox-Active Benzoquinone Function (E)

LE.1 In an even more preferred embodiment of the first aspect of the present invention, in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the first aspect of the invention as defined in point I.1.α) and point I.1.β) are each a redox-active benzoquinone function (E), and especially in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical have the structures defined in the above point E.1, preferably E.2, more preferably E.3, even more preferably E.4, even more preferably still E.5, and also in the case in which the organic redox polymer P non-conjugated in the main chain, in the first aspect of the invention, comprises a structure as defined in point E.6,

L¹, L², L³, L⁴, L⁵, L⁶, L⁷, L^{1′}, L^{2′}, L^{3′} in that case are preferably selected from the group consisting of direct bond, (LE11), (LE12)

[symbol]

-(X_{LE1})_{pE1}—[C═X^{LE2}]_{pE2}—(X^{LE3})_{pE3}-B^{LE1}-(Y^{LE1})_{qE1}—[C═Y^{LE2}]_{qE2}—(Y^{LE3})_{qE3}- [symbol] , (LE11):

[symbol]

-(Y^{LE4})_{qE4}—[C═Y^{LE5}]_{qE5}—(Y^{LE6})_{qE6}- [symbol] (LE12):
where pE1, pE2, pE3 are each 0 or 1, excluding the case that “pE2=0, pE1=pE3=1”,
where qE1, qE2, qE3 are each 0 or 1, excluding the case that “qE2=0, qE1=qE3=1”,
where qE4, qE5, qE6 are each 0 or 1, where at least one of qE4, qE5, qE6=1 and where the case that “qE5=0, qE4=qE6=1” is excluded,
where X^{LE2}, Y^{LE2}, Y^{LE5} are each independently selected from the group consisting of O, S,
where X^{LE1}, X^{LE3}, Y^{LE1}, Y^{LE3}, Y^{LE4}, Y^{LE6} are each independently selected from the group consisting of O, S, NH, N[(halo)alkyl],
where B^{LE1} is selected from the group consisting of
divalent (hetero)aromatic radical,
divalent aliphatic radical optionally substituted by at least one group selected from nitro group, —NH₂, —CN, —SH, —OH, halogen and optionally having at least one group selected from ether, thioether, amino ether, carbonyl group, carboxylic ester, carboxamide group, sulfonic ester, phosphoric ester,
   and where, in the cases in which L¹, L², L³, L⁴, L⁵, L⁶, L⁷, L^{1′}, L^{2′}, L^{3′} binds to a non-carbon atom in the respective redox-active R¹, R², R⁴, R⁵, R^{1′}, R^{2′}, R^{3′} group, for the structure (LE11) the additional condition is applicable that “qE3=0, qE2=1, qE1=1 or qE3=qE2=qE1=0 or qE3=0, qE2=1, qE1=0”, preferably the condition that “qE3=qE2=qE1=0”, and for the structure (LE12) the additional condition is applicable that “qE6=0, qE5=1, qE4=1 or qE6=0, qE5=1, qE4=0”,
   and where “ [symbol] ” for L¹ denotes the bond pointing toward R¹, for L^{1′} denotes the bond pointing toward R^{1′}, for L² denotes the bond pointing toward R², for L^{2′} denotes the bond pointing toward R^{2′}, for L³ denotes the bond pointing toward R², for L³¹ denotes the bond pointing toward R^{3′}, for L⁴ denotes the bond pointing toward R⁴, for L⁵ denotes the bond pointing toward R⁴, for L⁶ denotes the bond pointing toward R⁵, for L⁷ denotes the bond pointing toward R⁵,
   and where “ [symbol] ” for L¹ denotes the bond pointing toward X¹, for L^{1′} denotes the bond pointing toward X^{1′}, for L² denotes the bond pointing toward X², for L^{2′} denotes the bond pointing toward X^{2′}, for L³ denotes the bond pointing toward X³, for L³¹ denotes the bond pointing toward X^{3′}, for L⁴ denotes the bond pointing toward X⁴, for L⁵ denotes the bond pointing toward X⁵, for L⁶ denotes the bond pointing toward X⁴, for L⁷ denotes the bond pointing toward X⁵.

The condition “where at least one of qE4, qE5, qE6=1” relates here merely to the definition of the respective variables in the structure (LE12), and is not intended to rule out the possibility that L¹, L², L³, L⁴, L⁵, L⁶, L⁷, L^{1′}, L^{2′}, L^{3′} may each also be direct bonds.

LE.2 In a preferred embodiment of the aforementioned point LE.1, X^{L2}, Y^{LE2}, Y^{LE5} are each O and X^{LE1}, X^{LE3}, Y^{LE1}, Y^{LE3}, Y^{LE4}, Y^{LE6} are each independently selected from the group consisting of O, NH, N(alkyl), preferably O, and B^{L1} is a divalent alkylene radical optionally having at least one ether group.

LE.3 In a more preferred embodiment of the aforementioned point LE.2, L¹, L², L³, L⁴, L⁵, L⁶, L⁷, L^{1′}, L^{2′}, L^{3′} are selected from the group consisting of direct bond, alkylene radical, which is preferably methylene, phenylene, [symbol] -C(═O)- [symbol] , [symbol] -O—C(═O)- [symbol] , [symbol] -(NH)—C(═O)- [symbol] , [symbol] -(Nalkyl)-C(═O)- [symbol] , an alkylene radical that has ether groups and is preferably a radical of the formula [symbol] -(CH₂CH₂O)_{mLE1}- [symbol] with m^{LE1}=integer from 2 to 1000, preferably 3 to 500, more preferably 10 to 100,

and where, in the cases in which L¹, L², L³, L⁴, L⁵, L⁶, L⁷, L^{1′}, L^{2′}, L^{3′} binds to a carbon in the respective redox-active R¹, R², R⁴, R⁵, R^{1′}, R^{2′}, R^{3′} group, L¹, L², L³, L⁴, L⁵, L⁶, L⁷, L^{1′}, L^{2′}, L³¹ may also be selected from [symbol] -(CH₂CH₂O)_{mLE2}- [symbol] with m^{LE2}=integer from 2 to 1000, preferably 3 to 500, more preferably 10 to 100, [symbol] -C(═O)—O- [symbol] , [symbol] -C(═O)—(NH)- [symbol] , [symbol] -C(═O)—(Nalkyl)- [symbol] , [symbol] -O- [symbol] , [symbol] -S- [symbol] ,
and where V and have the definition given in point LE.1.

### I.1.2.6 Preferred Linker Units for Redox-Active Triphenylamine Function (G)

LG.1 In an even more preferred embodiment of the first aspect of the present invention, in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the first aspect of the invention as defined in point I.1.α) and point I.1.β) are each a redox-active triphenylamine function (G), and especially in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical have the structures defined in the above point G.1, and also in the case in which the organic redox polymer P non-conjugated in the main chain, in the first aspect of the invention, comprises a structure as defined in point G.2, preferably G.3, more preferably G.4,

L¹, L², L³, L⁴, L⁵, L⁶, L⁷, L^{1′}, L^{2′}, L^{3′} in that case are preferably selected from the group consisting of direct bond, (LG11), (LG12)

[symbol]

-(X^{LG1})_{pG1}—[C═X^{LG2}]_{pG2}—(X^{LG3})_{pG3}-B^{LG1}-(Y^{LG1})_{qG1}—[C═Y^{LG2}]_{qG2}—(Y^{L63})_{qG3}- [symbol] , (LG11):

[symbol]

-(Y^{LG4})_{qG4}—[C═Y^{LG6}]_{qG5}—(Y^{LC6})_{qG6}- [symbol] (LG12):
where pG1, pG2, pG3 are each 0 or 1, excluding the case that “pG2=0, pG1=pG3=1”,
where qG1, qG2, qG3 are each 0 or 1, excluding the case that “qG2=0, qG1=qG3=1”,
where qG4, qG5, qG6 are each 0 or 1, where at least one of qG4, qG5, qG6=1 and
where the case that “qG5=0, qG4=qG6=1” is excluded,
where X^{LG2}, Y^{LG2}, Y^{LG5} are each independently selected from the group consisting of O, S,
where X^{LG1}, X^{LG3}, Y^{LG1}, Y^{LG3}, Y^{LG4}, Y^{LG6} are each independently selected from the group consisting of O, S, NH, N[(halo)alkyl],
where B^{LG1} is selected from the group consisting of
divalent (hetero)aromatic radical,
divalent aliphatic radical optionally substituted by at least one group selected from nitro group, —NH₂, —CN, —SH, —OH, halogen and optionally having at least one group selected from ether, thioether, amino ether, carbonyl group, carboxylic ester, carboxamide group, sulfonic ester, phosphoric ester,
   and where, in the cases in which L¹, L², L³, L⁴, L⁵, L⁶, L⁷, L^{1′}, L^{2′}, L^{3′} binds to a non-carbon atom in the respective redox-active R¹, R², R⁴, R⁵, R^{1′}, R^{2′}, R^{3′} group, for the structure (LG11) the additional condition is applicable that “qG3=0, qG2=1, qG1=1 or qG3=qG2=qG1=0 or qG3=0, qG2=1, qG1=0”, preferably the condition that “qG3=qG2=qG1=0”, and for the structure (LG12) the additional condition is applicable that “qG6=0, qG5=1, qG4=1 or qG6=0, qG5=1, qG4=0”,
   and where “ [symbol] ” for L¹ denotes the bond pointing toward R¹, for L^{1′} denotes the bond pointing toward R^{1′}, for L² denotes the bond pointing toward R², for L^{2′} denotes the bond pointing toward R^{2′}, for L³ denotes the bond pointing toward R², for L³¹ denotes the bond pointing toward R^{3′}, for L⁴ denotes the bond pointing toward R⁴, for L⁵ denotes the bond pointing toward R⁴, for L⁶ denotes the bond pointing toward R⁵, for L⁷ denotes the bond pointing toward R⁵,
   and where “ [symbol] ” for L¹ denotes the bond pointing toward X¹, for L^{1′} denotes the bond pointing toward X^{1′}, for L² denotes the bond pointing toward X², for L^{2′} denotes the bond pointing toward X^{2′}, for L³ denotes the bond pointing toward X³, for L³¹ denotes the bond pointing toward X^{3′}, for L⁴ denotes the bond pointing toward X⁴, for L⁵ denotes the bond pointing toward X⁵, for L⁶ denotes the bond pointing toward X⁴, for L⁷ denotes the bond pointing toward X⁵.

The condition “where at least one of qG4, qG5, qG6=1” relates here merely to the definition of the respective variables in the structure (LG12), and is not intended to rule out the possibility that L¹, L², L³, L⁴, L⁵, L⁶, L⁷, L^{1′}, L^{2′}, L^{3′} may each also be direct bonds.

LG.2 In a preferred embodiment of the aforementioned point LG.1, X^{LG2}, Y^{LG2}, Y^{LG5} are each O and X^{LG1}, X^{LG3}, Y^{LG1}, Y^{LG3}, Y^{LG4}, Y^{LG6} are each independently selected from the group consisting of O, NH, N(alkyl), preferably O and B^{LG1} is selected from the group consisting of a divalent alkylene radical optionally having at least one ether group, divalent (hetero)aromatic radical.

LG.3 In a more preferred embodiment of the aforementioned point LG.2, L¹, L², L³, L⁴, L⁵, L⁶, L⁷, L^{1′}, L^{2′}, L^{3′} are selected from the group consisting of direct bond, alkylene radical, which is preferably methylene, phenylene [symbol] -C(═O)- [symbol] , [symbol] -O—C(═O)- [symbol] , [symbol] -(NH)—C(═O)- [symbol] , [symbol] -(Nalkyl)-C(═O)- [symbol] ,

alkylene radical having at least one group selected from ether, carbonyl group, carboxylic ester, carboxamide group,

[symbol]

-[X^{LG4}]_{pG4}—[C(═O)]_{pG5}—[X^{LG5}]_{pG6}-B^{LG4}-[X^{LG6}]_{qG6}—[C(═O)]_{qG7}-

[symbol]

where X^{LG4}, X^{LG5}, X^{LG6} are each independently selected from the group consisting of O, S, NH, Nalkyl, N(haloalkyl), preferably O,
and where p_{G4}, P_{G5}, P_{G6} are each 0 or 1, excluding the case that “P_{G5}=0, p_{G4}=p_{G6}=1”,
and where q_{G6}, q_{G7} are each 0 or 1, excluding the case that “q_{G7}=0, q_{G6}=1”,
and where B^{L64} is selected from the group consisting of divalent (hetero)aromatic group,
which is preferably benzylene or phenylene,
alkylene group which may have ether groups and/or carbonyl groups,
and B^{L64} is preferably a phenylene group or an alkylene group, more preferably a methylene group, ethylene group, propylene group, butylene group, pentylene group or hexylene group,
   and even more preferably, in the more preferred embodiment of the aforementioned point LG.2, L¹, L², L³, L⁴, L⁵, L⁶, L⁷, L^{1′}, L^{2′}, L^{3′} are selected from the group consisting of direct bond, alkylene radical, which is preferably methylene, phenylene, [symbol] -C(═O)- [symbol] , [symbol] -O—C(═O)- [symbol] , [symbol] -(NH)—C(═O)- [symbol] , [symbol] -(Nalkyl)-C(═O)- [symbol] , most preferably from direct bond, methylene,
   and where “ [symbol] ” and “ [symbol] ” have the definition given in point LG.1.

### I.1.2.7 Preferred Linker Units for Redox-Active Viologen Function (H)

LH.1 In an even more preferred embodiment of the first aspect of the present invention, in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the first aspect of the invention as defined in point I.1.α) and point I.1.β) are each a redox-active viologen function (H), and especially in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical have the structures defined in the above point H.1, preferably in the above point H.2, and also in the case in which the organic redox polymer P non-conjugated in the main chain, in the first aspect of the invention, comprises a structure as defined in point H.3,

L¹. L², L³, L⁴, L⁵, L⁶, L⁷, L^{1′}, L^{2′}, L^{3′} in that case are preferably selected from the group consisting of direct bond, (LH11), (LH12)

[symbol]

-(X^{LH1})_{pH1}—[C═X^{LH2}]_{pH2}—(X^{LH3})_{pH3}-B^{LH1}-(Y^{LH1})_{qH1}—[C═Y^{LH2}]_{qH2}—(Y^{LH3})_{qH3}- [symbol] , (LH11):

[symbol]

-(Y^{LH4})_{qH4}—[C═Y^{LH5}]_{qH5}—(Y^{LH6})_{qH6}- [symbol] (LH12):
where pH1, pH2, pH3 are each 0 or 1, excluding the case that “pH2=0, pH1=pH3=1”,
where qH1, qH2, qH3 are each 0 or 1, excluding the case that “qH2=0, qH1=qH3=1”,
where qH4, qH5, qH6 are each 0 or 1, where at least one of qH4, qH5, qH6=1 and
where the case that “qH5=0, qH4=qH6=1” is excluded,
where X^{LH2}, Y^{LH2}, Y^{LH5} are each independently selected from the group consisting of O, S,
where X^{LH1}, X^{LH3}, Y^{LH1}, Y^{LH3}, Y^{LH4}, Y^{LH6} are each independently selected from the group consisting of O, S, NH, N[(halo)alkyl],
where B^{LH1} is selected from the group consisting of
divalent (hetero)aromatic radical,
divalent aliphatic radical optionally substituted by at least one group selected from nitro group, —NH₂, —ON, —SH, —OH, halogen and optionally having at least one group selected from ether, thioether, amino ether, carbonyl group, carboxylic ester, carboxamide group, sulfonic ester, phosphoric ester,
   and where, in the cases in which L¹, L², L³, L⁴, L⁵, L⁶, L⁷, L^{1′}, L^{2′}, L^{3′} binds to a non-carbon atom in the respective redox-active R¹, R², R⁴, R⁵, R^{1′}, R^{2′}, R^{3′} group, for the structure (LH11) the additional condition is applicable that “qH3=0, qH2=1, qH1=1 or qH3=qH2=qH1=0 or qH3=0, qH2=1, qH1=0”, preferably the condition that “qH3=qH2=qH1=0”, and for the structure (LH12) the additional condition is applicable that “qH6=0, qH5=1, qH4=1 or qH6=0, qH5=1, qH4=0”,
   and where “ [symbol] ” for L¹ denotes the bond pointing toward R¹, for L^{1′} denotes the bond pointing toward R^{1′}, for L² denotes the bond pointing toward R², for L^{2′} denotes the bond pointing toward R^{2′}, for L³ denotes the bond pointing toward R², for L³¹ denotes the bond pointing toward R^{3′}, for L⁴ denotes the bond pointing toward R⁴, for L⁵ denotes the bond pointing toward R⁴, for L⁶ denotes the bond pointing toward R⁵, for L⁷ denotes the bond pointing toward R⁵,
   and where “ [symbol] ” for L¹ denotes the bond pointing toward X¹, for L^{1′} denotes the bond pointing toward X^{1′}, for L² denotes the bond pointing toward X², for L^{2′} denotes the bond pointing toward X^{2′}, for L³ denotes the bond pointing toward X³, for L³¹ denotes the bond pointing toward X^{3′}, for L⁴ denotes the bond pointing toward X⁴, for L⁵ denotes the bond pointing toward X⁵, for L⁶ denotes the bond pointing toward X⁴, for L⁷ denotes the bond pointing toward X⁵.

The condition “where at least one of qH4, qH5, qH6=1” relates here merely to the definition of the respective variables in the structure (LH12), and is not intended to rule out the possibility that L¹, L², L³, L⁴, L⁵, L⁶, L⁷, L^{1′}, L^{2′}, L^{3′} may each also be direct bonds.

LH.2 In a preferred embodiment of the aforementioned point LH.1, X^{LH2}, Y^{LH2}, Y^{LH5} are each O and X^{LH1}, X^{LH3}, Y^{LH1}, Y^{LH3}, Y^{LH4}, Y^{LH6} are each independently selected from the group consisting of O, NH, N(alkyl), preferably O and B^{LH1} is selected from the group consisting of divalent alkylene radical optionally having at least one ether group, divalent (hetero)aromatic radical.

LH.3 In a more preferred embodiment of the aforementioned point LH.2, especially when R¹, R^{1′} have the structure (H1) shown in point H.1, L¹, L², L³, L⁴, L⁵, L⁶, L⁷, L^{1′}, L^{2′}, L^{3′} are selected from the group consisting of direct bond, alkylene radical, which is preferably methylene, ethylene, propylene, butylene, pentylene, hexylene, more preferably propylene, divalent (hetero)aromatic group, which is preferably benzylene or phenylene, and is at the very most preferably phenylene.

### I.1.2.8 Preferred Linker Units for Redox-Active Ferrocene Function (J)

LJ.1 In an even more preferred embodiment of the first aspect of the present invention, in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the first aspect of the invention as defined in point I.1.α) and point I.1.β) are each a redox-active ferrocene function (J), and especially in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical have the structures defined in the above point J.1, and also in the case in which the organic redox polymer P non-conjugated in the main chain, in the first aspect of the invention, comprises a structure as defined in point J.2,

L¹, L², L³, L⁴, L⁵, L⁶, L⁷, L^{1′}, L^{2′}, L^{3′} in that case are preferably selected from the group consisting of direct bond, (LJ11), (LJ12)

[symbol]

-(X^{LJ1})_{pJ1}—[C═X^{LJ2}]_{pJ2}—(X^{LJ3})_{pJ3}-B^{LJ1}-(Y^{LJ1})_{qJ1}—[C═Y^{LJ2}]_{qJ2}—(Y^{LJ3})_{qJ3}- [symbol] , (LJ12):

[symbol]

-(Y^{LJ4})_{qJ4}—[C═Y^{LJ5}]_{qJ5}—(Y^{LJ6})_{qJ6}- [symbol] (LJ12):
where pJ1, pJ2, pJ3 are each 0 or 1, excluding the case that “pJ2=0, pJ1=pJ3=1”,
where qJ1, qJ2, qJ3 are each 0 or 1, excluding the case that “qJ2=0, qJ1=qJ3=1”,
where qJ4, qJ5, qJ6 are each 0 or 1, where at least one of qJ4, qJ5, qJ6=1 and where the case that “qJ5=0, qJ4=qJ6=1” is excluded,
where X^{LJ2}, Y^{LJ2}, Y^{LJ5} are each independently selected from the group consisting of O, S,
where X^{LJ1}, X^{LJ3}, Y^{LJ1}, Y^{LJ3}, Y^{LJ4}, Y^{LJ6} are each independently selected from the group consisting of O, S, NH, N[(halo)alkyl],
where B^{LJ1} is selected from the group consisting of
divalent (hetero)aromatic radical,
divalent aliphatic radical optionally substituted by at least one group selected from nitro group, —NH₂, —CN, —SH, —OH, halogen and optionally having at least one group selected from ether, thioether, amino ether, carbonyl group, carboxylic ester, carboxamide group, sulfonic ester, phosphoric ester,
   and where, in the cases in which L¹, L², L³, L⁴, L⁵, L⁶, L⁷, L^{1′}, L^{2′}, L^{3′} binds to a non-carbon atom in the respective redox-active R¹, R², R⁴, R⁵, R^{1′}, R^{2′}, R^{3′} group, for the structure (LJ11) the additional condition is applicable that “qJ3=0, qJ2=1, qJ1=1 or qJ3=qJ2=qJ1=0 or qJ3=0, qJ2=1, qJ1=0”, preferably the condition that “qJ3=qJ2=qJ1=0”, and for the structure (LJ12) the additional condition is applicable that “qJ6=0, qJ5=1, qJ4=1 or qJ6=0, qj5=1, qH4=0”,
   and where “ [symbol] ” for L¹ denotes the bond pointing toward R¹, for L^{1′} denotes the bond pointing toward R^{1′}, for L² denotes the bond pointing toward R², for L^{2′} denotes the bond pointing toward R^{2′}, for L³ denotes the bond pointing toward R², for L³¹ denotes the bond pointing toward R^{3′}, for L⁴ denotes the bond pointing toward R⁴, for L⁵ denotes the bond pointing toward R⁴, for L⁶ denotes the bond pointing toward R⁵, for L⁷ denotes the bond pointing toward R⁵,
   and where “ [symbol] ” for L¹ denotes the bond pointing toward X¹, for L^{1′} denotes the bond pointing toward X^{1′}, for L² denotes the bond pointing toward X², for L^{2′} denotes the bond pointing toward X^{2′}, for L³ denotes the bond pointing toward X³, for L³¹ denotes the bond pointing toward X^{3′}, for L⁴ denotes the bond pointing toward X⁴, for L⁵ denotes the bond pointing toward X⁵, for L⁶ denotes the bond pointing toward X⁴, for L⁷ denotes the bond pointing toward X⁵.

The condition “where at least one of qJ4, qJ5, qJ6=1” relates here merely to the definition of the respective variables in the structure (LJ12), and is not intended to rule out the possibility that L¹, L², L³, L⁴, L⁵, L⁶, L⁷, L^{1′}, L^{2′}, L^{3′} may each also be direct bonds.

LJ.2 In a preferred embodiment of the aforementioned point LJ.1, X^{LJ2}, Y^{LJ2}, Y^{LJ5} are each O and X^{LJ1}, X^{LJ3}, Y^{LJ1}, Y^{LJ3}, Y^{LJ4}, Y^{LJ6} are each independently selected from the group consisting of O, NH, N(alkyl), preferably O, and B^{LJ1} is a divalent alkylene radical optionally having at least one ether group.

LJ.3 In a more preferred embodiment of the aforementioned point LJ.2, L¹, L², L³, L⁴, L⁵, L⁶, L⁷, L^{1′}, L^{2′}, L³¹ are selected from the group consisting of direct bond, alkylene radical, which is preferably methylene, phenylene, [symbol] -C(═O)- [symbol] , [symbol] -O—C(═O)- [symbol] , [symbol] -(NH)—C(═O)- [symbol] , [symbol] -(Nalkyl)-C(═O)- [symbol] , [symbol] -C(═O)—O- [symbol] , [symbol] -C(═O)—(NH)- [symbol] , [symbol] -C(═O)—(Nalkyl)- [symbol] , [symbol] -O- [symbol] , [symbol] -S- [symbol] ,

[symbol]

even more preferably each independently selected from the group consisting of direct bond, [symbol] -O—C(═O)- [symbol] , [symbol] -C(═O)—O- [symbol] .

### I.1.2.9 Preferred Linker Units if R^{1′}, R^{2′}, R^{3′} are Each Hydrogen

LK.1 In an even more preferred embodiment of the first aspect of the present invention, in the cases in which the R^{1′}, R^{2′}, R^{3′} radicals or the R^{1′} radical in the structures (I), (II) and (III) in the first aspect of the present invention as defined in point I.1.α) and point I.1.β), and especially in the above-described cases A.5, B.3, C.6, C.7, D.7, E.6, G.2, G.3, G.4, H.3, J.2, are each a hydrogen radical, L^{1′}, L^{2′}, L^{3′} in that case are preferably selected from the group consisting of direct bond, (LK11), (LK12):

[symbol]

-(X^{LK1})_{pK1}—[C═X^{LK2}]_{pK2}—(X^{LK3})_{pK3}-B^{LK1}-(Y^{LK1})_{qK1}—[C═Y^{LK2}]_{qK2}—(Y^{LK3})_{qK3}- [symbol] , (LK11):

[symbol]

-(Y^{LK4})_{qK4}—[C═Y^{LK5}]_{qK5}—(Y^{LK6})_{qK6}- [symbol] (LK12):
where pK1, pK2, pK3 are each 0 or 1, excluding the case that “pK2=0, pK1=pK3=1”,
where qK1, qK2, qK3 are each 0 or 1, excluding the case that “qK2=0, qK1=qK3=1”,
where qK4, qK5, qK6 are each 0 or 1, where at least one of qK4, qK5, qK6=1 and where the case that “qK5=0, qK4=qK6=1” is excluded,
where X^{LK2}, Y^{LK2}, Y^{LK5} are each independently selected from the group consisting of O, S,
where X^{LK1}, X^{LK3}, Y^{LK1}, Y^{LK3}, Y^{LK4}, Y^{LK6} are each independently selected from the group consisting of O, S, NH, N[(halo)alkyl],
where B^{LK1} is selected from the group consisting of
divalent (hetero)aromatic radical,
divalent aliphatic radical optionally substituted by at least one group selected from nitro group, —NH₂, —ON, —SH, —OH, halogen and optionally having at least one group selected from ether, thioether, amino ether, carbonyl group, carboxylic ester, carboxamide group, sulfonic ester, phosphoric ester,
   and where “ [symbol] ” for L^{1′} denotes the bond pointing toward R^{1′}, for L^{2′} the bond pointing toward R^{2′}, for L³¹ the bond pointing toward R^{3′},
   and where “ [symbol] ” for L^{1′} denotes the bond pointing toward X^{1′}, for L^{2′} the bond pointing toward X^{2′}, for L^{3′} the bond pointing toward X³.

The condition “where at least one of qK4, qK5, qK6=1” relates here merely to the definition of the respective variables in the structure (LK12), and is not intended to rule out the possibility that L^{1′}, L^{2′}, L³¹ may each also be direct bonds.

LK.2 In a preferred embodiment of the aforementioned point LK.1, X^{LK2}, Y^{LK2}, are each O and X^{LK1}, X^{LK2}, Y^{LK1}, Y^{LK3}, Y^{LK4}, Y^{LK6} are each O, and B^{LK1} is selected from the group consisting of phenylene radical, benzylene radical, divalent alkylene radical optionally having at least one group selected from ether.

LK.3 In a preferred embodiment of the aforementioned points LK.1 and LK.2, L^{1′}, L^{2′}, L^{3′} are each a direct bond.

### I.1.3 Polymerized X¹, X², X³, X⁴, X⁵ Groups

The non-conjugated organic groups selectable for X¹, X², X³, X⁴, X⁵ in the structures (I), (II) and (III) in the first aspect of the invention as defined in point I.1.α) and point I.1.β), and especially in the above-described cases A.5, B.3, C.6, C.7, D.7, E.6, G.2, G.3, G.4, H.3, J.2, are not subject to any further restriction except that no conjugation must occur in the backbone formed by these groups. The person skilled in the art is aware of such groups. They are formed by polymerization reaction from a group consisting of an organic double bond, an organic triple bond, an oxirane or an aziridine, or are each a non-conjugated organic group which is formed by a polymer-analogous reaction. Such groups are described, for example, in WO 2015/003725 A1.

What is essential in the context of the invention is that no conjugation, i.e. no TT electron delocalization, takes place in the main chain, i.e. the polymer backbone of P. This can be assured in that only sp³ bonds occur in the main chain or sp and sp² bonds are in such isolated form that no conjugation occurs.

The person skilled in the art knows how to distinguish conjugated systems from non-conjugated systems. For example, poly(thiophene), poly(pyridine), poly(pyrrolidine), poly(imide) are conjugated within the polymer backbone and form conjugation in the main chain, and so cannot form non-conjugated organic redox polymers. It has been found that, surprisingly, polyacetylene derivatives are also usable in the polymer backbone in the context of the invention since, although there are adjacent double bonds within this backbone, no conjugation takes place owing to the Peierls distortion.

In the context of the invention, this prerequisite with regard to non-conjugation relates merely to the backbone of the polymer P which is formed in the structures (I), (II) and (III) by the X¹, X², X³, X⁴ or X⁵ radicals and, if present, the spacer units Y¹, Y², Y³, Y⁴ or Y⁵ (defined below in section 1.1.4). Within the redox-active functions encompassed by the polymer, i.e. within the radicals represented by the R¹, R², R⁴ or R⁵ radicals in the structures (I), (II) and (III), and, if R^{1′}, R^{2′} or R^{3′} is a redox-active radical, within these as well, it is of course possible for conjugation to occur, i.e. delocalization of the TT electrons.

### I.1.3.1

In a preferred embodiment of the first aspect of the present invention, the X¹, X², X³, X⁴, X⁵ radicals in the structures (I), (II) and (III) in the first aspect of the invention as defined in point I.1.α) and point I.1.β), and especially in the above-described cases A.5, B.3, C.6, C.7, D.7, E.6, G.2, G.3, G.4, H.3, J.2, are each independently non-conjugated organic groups that are selected from the following structures (X1), (X2), (X3), (X4), (X5), preferably from the structures (X1), (X2), (X3), (X5), even more preferably from the structures (X1), (X2), (X5):

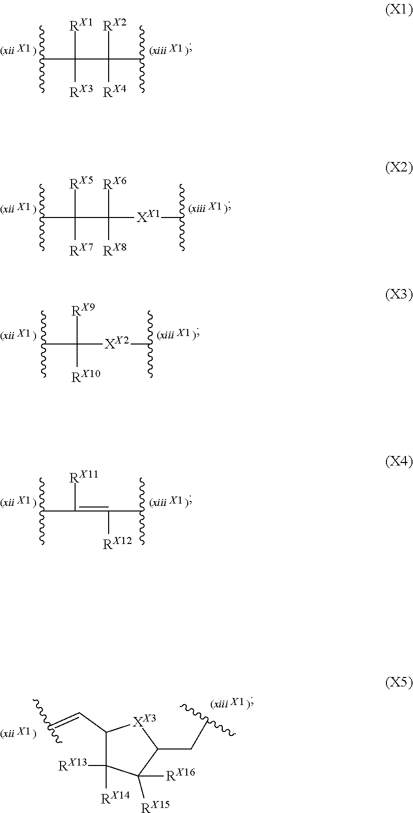

where, in the case that (X1)=X¹, one of R^{X1}, R^{X2}, R^{X3}, R^{X4} denotes the bond to L¹ and another of R^{X1}, R^{X2}, R^{X3}, R^{X4} the bond to L^{1′},
where, in the case that (X1)=X², one of R^{X1}, R^{X2}, R^{X3}, R^{X4} denotes the bond to L² and another of R^{X1}, R^{X2}, R^{X3}, R^{X4} the bond to L^{2′},
where, in the case that (X1)=X³, one of R^{X1}, R^{X2}, R^{X3}, R^{X4} denotes the bond to L³ and another of R^{X1}, R^{X2}, R^{X3}, R^{X4} the bond to L^{3′},
where, in the case that (X1)=X⁴, one of R^{X1}, R^{X2}, R^{X3}, R^{X4} denotes the bond to L⁴ and another of R^{X1}, R^{X2}, R^{X3}, R^{X4} the bond to L⁶,
where, in the case that (X1)=X⁵, one of R^{X1}, R^{X2}, R^{X3}, R^{X4} denotes the bond to L⁵ and another of R^{X1}, R^{X2}, R^{X3}, R^{X4} the bond to L⁷,
where, in the case that (X2)=X¹, one of R^{X5}, R^{X6}, R^{X7}, R^{X8} denotes the bond to L¹ and another of R^{X5}, R^{X6}, R^{X7}, R^{X8} the bond to L^{1′},
where, in the case that (X2)=X², one of R^{X5}, R^{X6}, R^{X7}, R^{X8} denotes the bond to L² and another of R^{X5}, R^{X6}, R^{X7}, R^{X8} the bond to L^{1′}.
where, in the case that (X2)=X³, one of R^{X5}, R^{X6}, R^{X7}, R^{X8} denotes the bond to L³ and another of R^{X5}, R^{X6}, R^{X7}, R^{X8} the bond to L^{3′},
where, in the case that (X2)=X⁴, one of R^{X5}, R^{X6}, R^{X7}, R^{X8} denotes the bond to L⁴ and another of R^{X5}, R^{X6}, R^{X7}, R^{X8} the bond to L⁶,
where, in the case that (X2)=X⁵, one of R^{X5}, R^{X6}, R^{X7}, R^{X8} denotes the bond to L⁵ and another of R^{X5}, R^{X6}, R^{X7}, R^{X8} the bond to L⁷,
where, in the case that (X3)=X¹, R^{X9} denotes the bond to L¹ and R^{X10} the bond to L^{1′},
where, in the case that (X3)=X², R^{X9} denotes the bond to L² and R^{X10} the bond to L^{2′},
where, in the case that (X3)=X³, R^{X9} denotes the bond to L³ and R^{X10} the bond to L^{3′},
where, in the case that (X3)=X⁴, R^{X9} denotes the bond to L⁴ and R^{X10} the bond to L⁶,
where, in the case that (X3)=X⁵, R^{X9} denotes the bond to L⁵ and R^{X10} the bond to L⁷,
where, in the case that (X4)=X¹, one of R^{X11}, R^{X12} denotes the bond to L¹ and another of R^{X11}, R^{X12} the bond to L^{1′},
where, in the case that (X4)=X², one of R^{X11}, R^{X12} denotes the bond to L² and another of R^{X11}, R^{X12} the bond to L^{2′},
where, in the case that (X4)=X³, one of R^{X11}, R^{X12} denotes the bond to L³ and another of R^{X11}, R^{X12} the bond to L^{3′},
where, in the case that (X4)=X⁴, one of R^{X11}, R^{X12} denotes the bond to L⁴ and another of R^{X11}, R^{X12} the bond to L⁶,
where, in the case that (X4)=X⁵, one of R^{X11}, R^{X12} denotes the bond to L⁵ and another of R^{X11}, R^{X12} the bond to L⁷,
where, in the case that (X5)=X¹, one of R^{X13}, R^{X14}, R^{X15}, R^{X16} denotes the bond to L¹ and another of R^{X13}, R^{X14}, R^{X15}, R^{X16} denotes the bond to L^{1′},
where, in the case that (X5)=X², one of R^{X13}, R^{X14}, R^{X15}, R^{X16} denotes the bond to L² and another of R^{X13}, R^{X14}, R^{X15}, R^{X16} denotes the bond to L^{2′},
where, in the case that (X5)=X³, one of R^{X13}, R^{X14}, R^{X15}, R^{X16} denotes the bond to L³ and another of R^{X13}, R^{X14}, R^{X15}, R^{X16} denotes the bond to L^{3′},
where, in the case that (X5)=X⁴, one of R^{X13}, R^{X14}, R^{X15}, R^{X16} denotes the bond to L⁴ and another of R^{X13}, R^{X14}, R^{X15}, R^{X16} denotes the bond to L⁶,
where, in the case that (X5)=X⁵, one of R^{X13}, R^{X14}, R^{X15}, R^{X16} denotes the bond to L⁵ and another of R^{X13}, R^{X14}, R^{X15}, R^{X16} denotes the bond to L⁷,
and where those of R^{X1}, R^{X2}, R^{X3}, R^{X4}, R^{A5}, R^{XB}, R^{A7}, R^{XB}, R^{X13}, R^{X14}, R^{X15}, R^{X16} that do not denote a bond to L¹, L^{1′}, L², L^{2′}, L³, L³⁺, L⁴, L⁵, L⁶ or L⁷ are radicals that are each independently selected from the group consisting of
hydrogen,
(hetero)aromatic radical,
aliphatic radical optionally substituted by at least one group selected from nitro group, —NH₂, —CN, —SH, —OH, halogen and optionally having at least one group selected from ether, thioether, amino ether, carbonyl group, carboxylic ester, carboxamide group, sulfonic ester, phosphoric ester, preferably from the group consisting of hydrogen, alkyl group, halogen, cyano, phenyl, benzyl, and are more preferably all hydrogen,
and where X^{X1}, X^{A2} are each independently selected from the group consisting of O, S and are preferably each O,
and where X^{X3} is selected from the group consisting of O, S, —CH₂—, more preferably from the group consisting of O, —CH₂—, and is even more preferably —CH₂—,
and where the bond indicated in each case by (xii^{A1}) corresponds to that indicated in each case by “*”, “#”, “&”, “§” and “$” in the structures (I), (II) and (III),
and where the bond indicated in each case by (xiii^{X1}) corresponds to that which, in the structures (I), (II) and (III), in the cases in which m¹=0, m²=0, m³=0, m⁴=0 or m⁵=0, binds in each case to “**”, “##”, “&&”, “§§” or “$$” and, in the cases in which m¹>0, m²>0, m³>0, m⁴>0 or m⁵>0, binds in each case to Y¹, Y², Y³, Y⁴ or Y⁵.

### I.1.3.2

In a preferred embodiment of the aforementioned point I.1.3.1, the X¹, X², X³, X⁴, X⁵ radicals are each independently non-conjugated organic groups that are selected from the following structures (X11), (X12), (X13), (X14), (X15), preferably from the structures (X11), (X12), (X13), (X14), (X15), more preferably from the structures (X11), (X12), (X15):

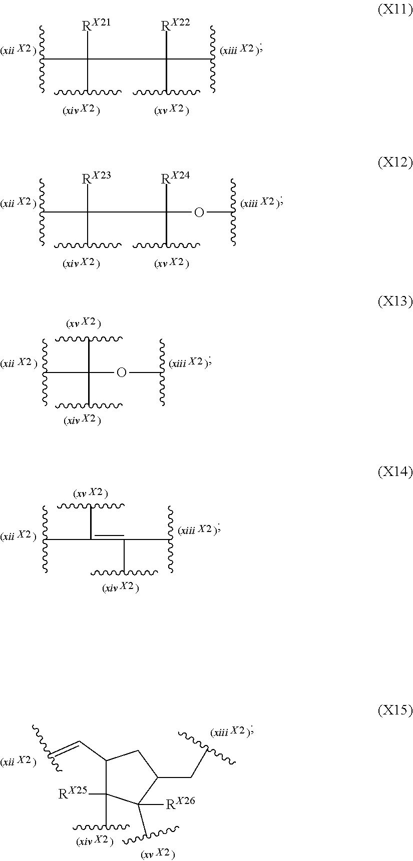

where, in the case that X¹ is selected from (X11), (X12), (X13), (X14), (X15), the bond (xiv^{X2}) in each case denotes the bond to L¹ and the bond (xv^{X2}) in each case the bond to L^{1′},
where, in the case that X² is selected from (X11), (X12), (X13), (X14), (X15), the bond (xiv^{X2}) in each case denotes the bond to L² and the bond (xv^{X2}) in each case the bond to L^{2′},
where, in the case that X³ is selected from (X11), (X12), (X13), (X14), (X15), the bond (xiv^{X2}) in each case denotes the bond to L³ and the bond (xv^{A2}) in each case the bond to L^{3′},
where, in the case that X⁴ is selected from (X11), (X12), (X13), (X14), (X15), the bond (xiv^{A2}) in each case denotes the bond to L⁴ and the bond (xv^{A2}) in each case the bond to L⁶,
where, in the case that X⁵ is selected from (X11), (X12), (X13), (X14), (X15), the bond (xiv^{X2}) in each case denotes the bond to L⁵ and the bond (xv^{A2}) in each case the bond to L⁷,
and where the R^{A21}, R^{A22}, R^{A23}, R^{A24}, R^{A25}, R^{A26} radicals are each independently selected from the group consisting of
hydrogen,
(hetero)aromatic radical,
aliphatic radical optionally substituted by at least one group selected from nitro group, —NH₂, —CN, —SH, —OH, halogen and optionally having at least one group selected from ether, thioether, amino ether, carbonyl group, carboxylic ester, carboxamide group, sulfonic ester, phosphoric ester,
preferably from the group consisting of hydrogen, alkyl group, halogen, cyano, phenyl, benzyl, and are preferably all hydrogen,
and where the bond indicated in each case by (xii^{A2}) corresponds to that indicated in each case by “*”, “#”, “&”, “§” and “$” in the structures (I), (II) and (III),
and where the bond indicated in each case by (xiii^{A2}) corresponds to that which, in the structures (I), (II) and (III), in the cases in which m¹=0, m²=0, m³=0, m⁴=0 or m⁵=0, binds in each case to “**”, “##”, “&&”, “§§” or “$$” and, in the cases in which m¹>0, m²>0, m³>0, m⁴>0 or m⁵>0, binds in each case to Y¹, Y², Y³, Y⁴ or Y⁵.

### I.1.3.3

In a more preferred embodiment of the first aspect of the present invention, the X¹, X², X³, X⁴, X⁵ radicals each independently have the structure (X11) defined in point I.1.3.2,

where, in the case that X¹ has the structure (X11), the bond (xiv^{A2}) in each case denotes the bond to L¹ and the bond (xv^{A2}) in each case the bond to L^{1′},
where, in the case that X² has the structure (X11), the bond (xiv^{X2}) in each case denotes the bond to L² and the bond (xv^{X2}) in each case the bond to L^{2′},
where, in the case that X³ has the structure (X11), the bond (xiv^{X2}) in each case denotes the bond to L³ and the bond (xv^{X2}) in each case the bond to L^{3′},
where, in the case that X⁴ has the structure (X11), the bond (xiv^{X2}) in each case denotes the bond to L⁴ and the bond (xv^{X2}) in each case the bond to L⁶,
where, in the case that X⁵ has the structure (X11), the bond (xiv^{X2}) in each case denotes the bond to L⁵ and the bond (xv^{X2}) in each case the bond to L⁷,
and where the R^{A21}, R^{A22} radicals are each independently selected from the group consisting of hydrogen, alkyl group, halogen, cyano, phenyl, benzyl,
preferably R^{A21}=hydrogen or alkyl, the most preferred alkyl being a methyl group, and R^{A22}=hydrogen, most preferably R^{A21}=R^{A22}=hydrogen,
and where the bond indicated by (xii^{A2}) corresponds to that indicated in each case by “*”, “#”, “&”, “§” and “$” in the structures (I), (II) and (III),
and where the bond indicated by (xiii^{A2}) corresponds to that which, in the structures (I), (II) and (III), in the cases in which m¹=0, m²=0, m³=0, m⁴=0 or m⁵=0, binds in each case to “§§” or “$$” and, in the cases in which m¹>0, m²>0, m³>0, m⁴>0 or m⁵>0, binds in each case to Y¹, Y², Y³, Y⁴ or Y⁵.

### I.1.4 Non-Conjugated Organic Spacer Units Y¹, Y², Y³, Y⁴, Y⁵

The non-conjugated organic spacer units selectable for Y¹, Y², Y³, Y⁴, Y⁵ in the structures (I), (II) and (III) in the first aspect of the invention are accordingly not subject to any further restriction except that no conjugation must occur in the backbone formed by these groups.

### I.1.4.1

In a preferred embodiment of the first aspect of the present invention, the Y¹, Y², Y³, Y⁴, Y⁵ radicals in the structures (I), (II) and (III) in the first aspect of the invention as defined in point I.1.α) and point I.1.β), and especially in the above-described cases A.5, B.3, C.6, C.7, D.7, E.6, G.2, G.3, G.4, H.3, J.2, are each independently non-conjugated organic spacer units that are selected from the following structures (Y1), (Y2), (Y3), (Y4), (Y5):

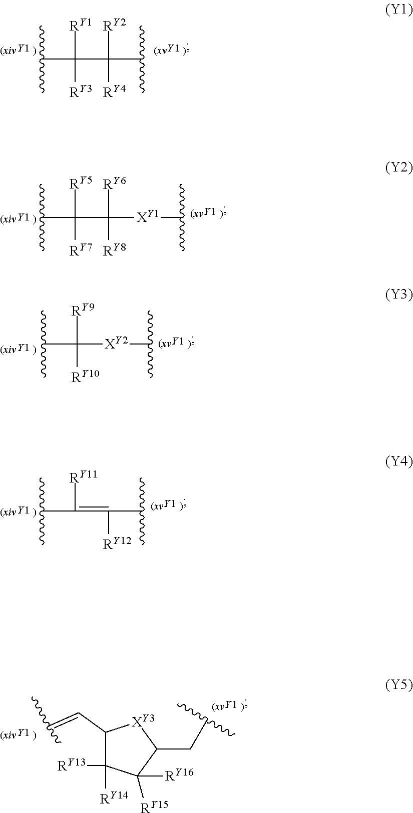

where R^{Y1}, R^{Y2}, R^{Y3}, R^{Y4}, R^{Y5}, R^{Y6}, R^{Y7}, R^{Y8}, R^{Y9}, R^{Y10}, R^{Y11}, R^{Y12}, R^{Y13}, R^{Y14}, R^{Y15}, R^{Y16} are each independently selected from the group consisting of
hydrogen,
(hetero)aromatic radical,
aliphatic radical optionally substituted by at least one group selected from nitro group, —NH₂, —ON, —SH, —OH, halogen and optionally having at least one group selected from ether, thioether, amino ether, carbonyl group, carboxylic ester,
carboxamide group, sulfonic ester, phosphoric ester,
preferably from the group consisting of hydrogen, phenyl, benzyl, (halo)alkyl group, (halo)cycloalkyl group, hydroxyl, carboxylic ester, carboxyl group, carboxamide, where the (halo)alkyl group may also have ether groups,
and where X^{Y1}, are each independently selected from the group consisting of O, S and are preferably both O, and where X™ is selected from the group consisting of O, S, —CH₂—, preferably O, —CH₂—, and more preferably —CH₂—,
and where the bonds indicated by (xv^{Y1}) correspond to those indicated by “**”, “##”, “&&”, “§§” and “$$” in the structures (I), (II) and (III),
and where the bonds indicated by (xiv^{Y1}) correspond to those which bind to X¹, X², X³, X⁴ or X⁵ in the structures (I), (II) and (III).

### I.1.4.2

In a preferred embodiment of the aforementioned point I.1.4.1, the Y¹, Y², Y³, Y⁴, Y⁵ radicals in the structures (I), (II) and (III) are each independently non-conjugated organic spacer units that are selected from the structures (Y1), (Y2), (Y3), (Y5) mentioned in point I.1.4.1, more preferably from the structures (Y1), (Y2), (Y5), even more preferably from the structures (Y1), (Y2), and most preferably have a structure (Y1),

where R^{Y1}, R^{Y2}, R^{Y3}, R^{Y4}, R^{Y5}, R^{Y6}, R^{Y7}, R^{Y8}, R^{Y9}, R^{Y10}, R^{Y13}, R^{Y14}, R^{Y15}, R^{Y16} are each independently selected from the group consisting of hydrogen, phenyl, benzyl, (halo)alkyl group, (halo)cycloalkyl group, hydroxyl, carboxylic ester, carboxamide, where the (halo)alkyl group may also have ether groups and is preferably selected from the group consisting of hydrogen, phenyl, benzyl, alkyl group, carboxylic ester, carboxamide, carboxyl group, and even more preferably from the group consisting of hydrogen, phenyl, methyl, carboxylic ester, —C(═O)—NH₂, carboxyl group, and are even more preferably all hydrogen,
and where X^{Y1}, X^{Y2} are each O, and where X^{Y3} is selected from the group consisting of O, —CH₂—, and is more preferably —CH₂—.

### I.1.4.3

In the cases in which an organic redox polymer P which is non-conjugated in the main chain and comprises at least one of the structures (I), (II) and (III) comprises a non-conjugated organic spacer unit Y¹, Y², Y³, Y⁴, Y⁵, the person skilled in the art will be able here, with the and of his art knowledge, to select this non-conjugated organic spacer unit Y¹, Y², Y³, Y⁴, Y⁵ advantageously in accordance with the X¹, X², X³, X⁴ or X⁵ group encompassed by the respective organic redox polymer P non-conjugated in the main chain.

In a preferred embodiment of the first aspect of the present invention, the X¹, X², X³, X⁴, X⁵ radicals in the structures (I), (II) and (III) are each independently selected from the structures (X1), (X2), (X3), (X4) according to the aforementioned point I.1.3.1, preferably each independently selected from the structures (X11), (X12), (X13), (X14) according to the aforementioned point I.1.3.2, and even more preferably each independently have a structure (X11) according to the aforementioned point I.1.3.3,

and the Y¹, Y², Y³, Y⁴, Y⁵ radicals are each independently selected from the structures (Y1), (Y2), (Y3), (Y4) according to the aforementioned point I.1.4.1, more preferably according to the aforementioned point I.1.4.2,
or the X¹, X², X³, X⁴, X⁵ radicals in the structures (I), (II) and (III) are each independently a structure (X5) according to the aforementioned point I.1.3.1, preferably a structure (X15) according to the aforementioned point I.1.3.2, and the Y¹, Y², Y³, Y⁴, Y⁵ radicals are each independently a structure (Y5) according to the aforementioned point I.1.4.1, more preferably according to the aforementioned point I.1.4.2.

### I.1.4.4

In an even more preferred embodiment of the first aspect of the present invention, the X¹, X², X³, X⁴, X⁵ radicals in the structures (I), (II) and (III) are each independently a structure (X1) according to the aforementioned point I.1.3.1, preferably each independently a structure (X11) according to the aforementioned point I.1.3.2, even more preferably according to the aforementioned point I.1.3.3, and the Y¹, Y², Y³, Y⁴, Y⁵ radicals are each independently a structure (Y1) according to the aforementioned point I.1.4.1, more preferably according to the aforementioned point I.1.4.2;

or the X¹, X², X³, X⁴, X⁵ radicals in the structures (I), (II) and (III) are each independently a structure (X2) according to the aforementioned point I.1.3.1, preferably each independently a structure (X12) according to the aforementioned point I.1.3.2, and the Y¹, Y², Y³, Y⁴, Y⁵ radicals are each independently a structure (Y2) according to the aforementioned point I.1.4.1, more preferably according to the aforementioned point I.1.4.2;
or the X¹, X², X³, X⁴, X⁵ radicals in the structures (I), (II) and (III) are each independently a structure (X3) according to the aforementioned point I.1.3.1, preferably each independently a structure (X13) according to the aforementioned point I.1.3.2, and the Y¹, Y², Y³, Y⁴, Y⁵ radicals are each independently a structure (Y3) according to the aforementioned point I.1.4.1, more preferably according to the aforementioned point I.1.4.2;
or the X¹, X², X³, X⁴, X⁵ radicals in the structures (I), (II) and (III) are each independently a structure (X4) according to the aforementioned point I.1.3.1, preferably each independently a structure (X14) according to the aforementioned point I.1.3.2, and the Y¹, Y², Y³, Y⁴, Y⁵ radicals are each independently a structure (Y4) according to the aforementioned point I.1.4.1, more preferably according to the aforementioned point I.1.4.2;
or the X¹, X², X³, X⁴, X⁵ radicals in the structures (I), (II) and (III) are each independently a structure (X5) according to the aforementioned point I.1.3.1, preferably each independently a structure (X15) according to the aforementioned point I.1.3.2, and the Y¹, Y², Y³, Y⁴, Y⁵ radicals are each independently a structure (Y5) according to the aforementioned point I.1.4.1, more preferably according to the aforementioned point I.1.4.2.

### I.1.5 Process for Preparing the Polymers P According to the Invention

The polymers P encompassed by the electrode material according to the invention in the first aspect of the invention can be obtained by processes known to those skilled in the art. The corresponding processes are summarized in Muench et at.

In addition, the synthesis of the polymers P comprising a redox-active aromatic imide function (A) is also described in WO 2015/003725 A1 and U.S. Pat. No. 4,898,915 A.

In addition, polymers comprising a redox-active aromatic function comprising at least one stable oxygen radical (B) and the synthesis of the corresponding polymers P are also known to the person skilled in the art from WO 2017/207325 A1, EP 1752474 A1, WO 2015/032951 A1, CN 104530424 A, CN 104530426 A, T. Suga, H. Ohshiro, S. Sugrta, K. Oyaizu, H. Nishide, Adv. Mater. 2009, 21, 1627-1630 and T. Suga, S. Sugrta, H. Ohshiro, K. Oyaizu, H. Nishide, Adv. Mater. 2011, 3, 751-754.

In addition, the synthesis of the polymers P comprising a redox-active anthraquinone/carbazole function (C) and the synthesis of the polymers P comprising a redox-active benzoquinone function (E) is also described, or is possible as a matter of routine for the person skilled in the art on the basis of his art knowledge, from WO 2015/132374 A1, WO 2015/144798 A1, EP 3279223 A1, WO 2018/024901A1, US 2017/0077518 A1, US 2017/0077517 A1, US 2017/0104214 A1, D. Schmidt, B. Häupler, C. Stotze, M. D. Hager, U.S. Schubert, J. Polym. Sd., Part A: Polym. Cham. 2015, 53, 2517-2523, M. E. Speer, M. Kolek, J. J. Jassoy, J. Heine, M. Winter, P. M. Bieker, B. Esser, Chem. Commun. 2015, 51, 15261-15264 and M. Baibarac, M. Lira-Cantú, J. Oró Sol, I. Baltog, N. Casañ-Pastor, P. Gomez-Romero, Compos. Sci. Technol. 2007, 67, 2556-2563.

In addition, the synthesis of the polymers P comprising a redox-active dialkoxybenzene function (D) is also described in WO 2017/032583 A1, EP 3136410 A1, EP 3135704 A1, WO 2017/032582 A1, P. Nesvadba, L. B. Foiger, P. Maire, P. Novak, Synth. Met. 2011, 161, 259-262; W. Weng, Z. C. Zhang, A. Abouimrane, P. C. Redfem, L. A. Curtiss, K. Amine, Adv. Fund. Mater. 2012, 22, 4485-4492.

In addition, the synthesis of the polymers P comprising a redox-active triphenylamine function (G) is also described in JP 2011-74316 A, JP 2011-74317 A.

In addition, the synthesis of the polymers P comprising a redox-active viologen function (H) is also described in CN 107118332 A.

In addition, the synthesis of the polymers P comprising a redox-active ferrocene function (J) is also described in K. Tamura, N. Akutagawa, M. Satoh, J. Wada, T. Masuda, Macromol. Rapid Commun. 2008, 29, 1944-1949.

### I.1.6 Crosslinkings

The polymers P encompassed by the electrode material according to the invention in the first aspect of the invention may be either homopolymers or copolymers. Homopolymers are polymers which have been synthesized only from one monomer. Copolymers are polymers which have been synthesized from two or more monomers. Further monomers (“co-monomers”) used may be those that have a polymerizable group, or else have two or more polymerizable groups, for example divinylbenzenes, diethynylbenzenes, diethynylthianthrenes, oligo- or polyethylene glycol di(meth)acrylates. This then leads to additional crosslinks in the polymer. This is known to the person skilled in the art (described, for example, in WO 2018/060680 A1, paragraph [0028]). The degree of crosslinking of the polymers that are then obtained can be controlled by processes known to the person skilled in the art via the amount of comonomer added or else via a time delay (for instance in that the comonomer is not added until the polymerization is at an advanced stage). If two or more monomers are used in the synthesis, the monomers of the repeat units in the polymer P, according to this invention, may be present in the polymer in random distribution, as blocks or in alternation.

Thus, the polymer P encompassed by the electrode material of the invention may also have repeat units attributable to the use of crosslinkers during the synthesis of the polymer P. It will thus be apparent that repeat units attributable to the crosslinker may also be present in the resulting polymer P between the repeat units of the structure (I), (II) and (III).

Suitable crosslinkers are compounds having more than one polymerizable group, the crosslinker preferably being selected from the group consisting of polyfunctional compounds based on (meth)acrylic acid, polyfunctional compounds based on ally) ether, polyfunctional compounds based on vinylic compounds. Polyfunctional compounds based on (meth)acrylic acid are particularly preferred.

Polyfunctional compounds based on (meth)acrylic acid are especially selected from ethylene glycol di(meth)acrylate, diethylene glycol di(meth)acrylate, triethylene glycol di(meth)acrylate, polyethylene glycol di(meth)acrylate, propane-1,3-diol di(meth)acrylate, butane-2,3-diol di(meth)acrylate, butane-1,4-diol di(meth)acrylate, pentane-1,5-diol di(meth)acrylate, hexane-1,6-diol di(meth)acrylate, heptane-1,7-diol di(meth)acrylate, octane-1,8-diol di(meth)acrylate, nonane-1,9-diol di(meth)acrylate, decane-1,10-diol di(meth)acrylate, trimethylolpropane tri(meth)acrylate, glycerol di(meth)acrylate, 2-hydroxy-3-(meth)acryloyloxypropyl (meth)acrylate.

Polyfunctional compounds based on ally) ether are especially selected from the group consisting of diethylene glycol diallyl ether, dibutylene glycol diallyl ether.

A polyfunctional compound based on vinylic compounds is especially divinylbenzene.

### I.2 Ionic Liquids

The present invention is based on the surprising finding that, in an electrode material comprising the redox-active polymer P, a distinct increase in capacity can be achieved when this electrode material also comprises an ionic liquid. The improved increase in capacity is based on the interaction of the intercalated ionic liquid with the polymer P. It is suspected that the reason for this exceptionally significant improvement lies in the specific structure of the polymer P, which assures a particularly good interaction with the ionic liquid. This is because it is an organic polymer, which has particularly good swelling capacity when it is admixed with ionic liquids. This swelling capacity is based on the organic nature of the polymer P and enables it to bind a high proportion of ionic liquid. In the case of metal-based batteries for which the intercalation of ionic liquids has been described (for example zinc-manganese dioxide batteries as described in U.S. Pat. No. 9,397,341 B1), this mechanism is not possible merely because of the metallic properties of the electrode material. The binding capacity thereof for ionic liquids is therefore much smaller, and the tendency to “bleeding” of the ionic liquid out of the electrode material is much more pronounced.

Ionic liquids as constituents of the electrode material of organic batteries that are based on a polymer P are yet to be described. The prior art (for example EP 3279223 A1) merely mentions the option of using these as electrolyte in a battery cell.

Organic batteries comprising ionic liquids within the electrode material have additionally been described only for those polymers in which the main chain is in conjugated form (WO 2017/220965 A1; WO 2018/060680 A1). Since the charges in the polymer P according to the present invention are localized onto the individual redox-active units and not “smeared” across the main chain as in prior art polymers, however, this enables a much better interaction of the ionic liquid with the redox-active units in the polymer P compared to the interaction that would be expected for the interaction of the ionic liquid with prior art conjugated polymers.

The fact that the polymer P according to the present invention would enable such advantageous interaction with the ionic liquid was accordingly completely surprising.

Accordingly, the ionic liquids usable in the first aspect of the present invention are not subject to any further restriction, and it is possible, for example, to use those described in WO 2004/016631 A1, WO 2006/134015 A1, US 2011/0247494 A1 or US 2008/0251759 A1.

In particular, the ionic liquid which is used in the electrode material in the first aspect of the invention has the structure Q⁺A⁻.

### I.2.1 Preferred Cations for the Ionic Liquids

Q⁺ here is a cation selected from the group consisting of the following structures (Q1), (Q2), (Q3), (Q4), (Q5):

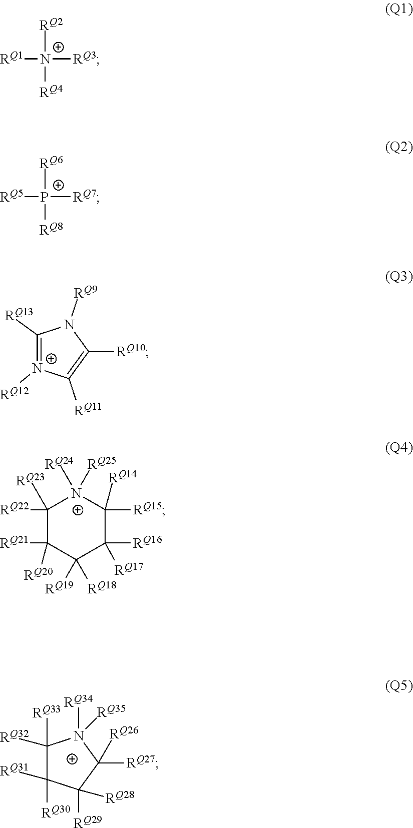

where R^{Q1}, R^{Q2}, R^{Q3}, R^{Q4}, R^{Q5}, R^{Q6}, R^{Q7}, R^{Q8} are each independently selected from the group consisting of (halo)alkyl group, cycloalkyl group,
and where R^{Q9}, R^{Q10}, R^{Q11}, R^{Q12}, R^{Q13}, R^{Q14}, R^{Q15}, R^{Q16}, R^{Q17}, R^{Q19}, R^{Q18}, R^{Q20}, R^{Q21}, R^{Q22}, R^{Q23}, R^{Q24}, R^{Q25}, R^{Q28}, R^{Q27}, R^{Q28}, R^{Q29}, R^{Q30}, R^{Q31}, R^{Q32}, R^{Q33}, R^{Q34}, R^{Q35} are each independently selected from the group consisting of hydrogen, (halo)alkyl group which may have at least one ether group, cycloalkyl group.

Preferably, Q⁺ is a cation selected from the group consisting of the structures (Q1), (Q2), (Q3), (Q4), (Q5) where R^{Q1}, R^{Q2}, R^{Q3}, R^{Q4}, R^{Q5}, R^{Q8}, R^{Q7}, R^{Q8} are each independently selected from the group consisting of alkyl group having 6 to 40, more preferably 10 to 30, carbon atoms, cycloalkyl group having 6 to 40, more preferably 10 to 30, carbon atoms,

and where R^{Q9}, R^{Q10}, R^{Q11}, R^{Q12}, R^{Q13}, R^{Q14}, R^{Q15}, R^{Q16}, R^{Q17}, R^{Q18}, R^{Q19}, R^{Q20}, R^{Q21}, R^{Q22}, R^{Q23}, R^{Q24}, R^{Q25}, R^{Q26}, R^{Q27}, R^{Q28}, R^{Q29}, R^{Q30}, R^{Q31}, R^{Q32}, R^{Q33}, R^{Q34}, R^{Q35} are each independently selected from the group consisting of hydrogen, alkyl group having 1 to 25, preferably 1 to 10, carbon atoms, which may have at least one ether group.

More preferably, Q⁺ is a cation selected from the group consisting of the structures (Q1), (Q3) where R^{Q1}, R^{Q2}, R^{Q3}, R^{Q4} are each independently selected from the group consisting of alkyl group having 6 to 30, preferably 10 to 25, carbon atoms,

where R^{Q9}, R^{Q10}, R^{Q11}, R^{Q12}, R^{Q13} are each independently selected from the group consisting of hydrogen, alkyl group having 1 to 25, preferably 1 to 10, carbon atoms and R^{Q10}, R^{Q11}, R^{Q13} are more preferably each hydrogen and R^{Q9}, R^{Q12} are each independently an alkyl radical having 1 to 6 carbon atoms.

Even more preferably, Q⁺ is a cation of the structure (Q3) where R^{Q10}, R^{Q11}, R^{Q13} are each hydrogen and R^{Q9} is selected from the group consisting of methyl, ethyl, n-propyl, iso-propyl, n-butyl, sec-butyl, tert-butyl, and R^{Q12} is selected from the group consisting of methyl, ethyl, n-propyl, iso-propyl, n-butyl, sec-butyl, tert-butyl.

Even more preferably, Q⁺ is a cation of the structure (Q3) where R^{Q10}, R^{Q11}, R^{Q13} are each hydrogen and R^{Q9} is selected from the group consisting of methyl, ethyl, n-butyl, preferably selected from the group consisting of ethyl, n-butyl, where R^{Q9} is most preferably ethyl, and R^{Q12} is selected from the group consisting of methyl, ethyl, where R^{Q12} is most preferably methyl.

Particularly preferred as Q⁺ is the 1-ethyl-3-methylimidazolium cation.

### I.2.2 Preferred Anions for the Ionic Liquids

In the aforementioned formula Q⁺A⁻, A⁻ is an anion, especially selected from the group consisting of phosphate, phosphorate, alkylphosphonate, monoalkyl phosphate, dialkylphosphate, bis[trifluoromethanesulfonyl]imide, (halo)alkylsulfonate, (halo)alkylsulfate, bis[fluorosulfonyl] imide, halide, dicyanamide, hexafluorophosphate, sulfate, tetrafluoroborate, trifluoromethanesulfonate, perchlorate, hydrogensulfate, (halo)alkylcarboxylate, formate, bisoxalatoborate, tetrachloroaluminate, dihydrogenphosphate, monoalkyl hydrogen phosphate, nitrate.

In the aforementioned formula Q⁺A⁻, A⁻ is preferably selected from the group consisting of phosphate, phosphorate, alkylphosphonate, monoalkyl phosphate, dialkylphosphate, bis[trifluoromethanesulfonyl]imide, alkylsulfonate, alkylsulfate, bis[fluorosulfonyl]imide, halide, dicyanamide, hexafluorophosphate, sulfate, tetrafluoroborate, trifluoromethanesulfonate, perchlorate, hydrogensulfate, alkylcarboxylate, formate, bisoxalatoborate, tetrachloroaluminate, dihydrogenphosphate, monoalkylhydrogenphosphate, nitrate, where the alkyl groups in alkylphosphonate, monoalkylphosphate, dialkyl phosphate, alkylsulfonate, alkylsulfate, alkylcarboxylate, monoalkylhydrogenphosphate each have 1 to 10, preferably 1 to 6, more preferably 1 to 4, carbon atoms.

In the aforementioned formula Q⁺A⁻, A⁻ is more preferably selected from the group consisting of dialkylphosphate, bis[trifluoromethanesulfonyl]imide, alkylsulfonate, bis[fluorosulfonyl]imide, chloride, dicyanamide, hexafluorophosphate, tetrafluoroborate, trifluoromethanesulfonate, perchlorate, acetate, propionate, formate, tetrachloroaluminate, monoalkylhydrogenphosphate, nitrate, where the alkyl groups in dialkylphosphate, alkylsulfonate, monoalkylhydrogenphosphate each have 1 to 10, preferably 1 to 6, more preferably 1 to 4, carbon atoms.

In the aforementioned formula Q⁺A⁻, A⁻ is even more preferably selected from the group consisting of diethylphosphate, bis[trifluoromethanesulfonyl]imide, methanesulfonate, bis[fluorosulfonyl]imide, chloride, dicyanamide, hexafluorophosphate, tetrafluoroborate, trifluoromethanesulfonate, perchlorate, acetate, propionate, formate, tetrachloroaluminate, monoethylhydrogenphosphate, nitrate.

In the aforementioned formula Q⁺A⁻, A⁻ is even more preferably selected from the group consisting of trifluoromethanesulfonate, bis[trifluoromethanesulfonyl]imide, diethylphosphate, dicyanamide, most preferably from the group consisting of trifluoromethanesulfonate, bis[trifluoromethanesulfonyl]imide, and the very most preferably trifluoromethanesulfonate.

### I.2.3 Amount of the Ionic Liquid Used

The amount of the ionic liquid used is not subject to any further restriction. However, it is preferable that the total weight of the ionic liquid encompassed by the electrode material in the first aspect of the invention, based on the total weight of the organic redox polymer P non-conjugated in the main chain which is encompassed by the electrode material, is in the range of 0.1% to 1000% by weight, more preferably in the range of 1% to 500% by weight, yet more preferably in the range of 5% to 200% by weight, even more preferably in the range of 40% to 160% by weight, even more preferably still in the range of 80% to 120% by weight, and is most preferably 100% by weight.

### I.3 Conductivity Additive

The electrode material in the first aspect of the present invention also comprises a conductivity additive.

### I.3.1 Preferred Conductivity Additives

The conductivity additive is at least one electrically conductive material, especially selected from the group consisting of carbon materials, electrically conductive polymers, metals, semimetals, (semi)metal compounds, preferably selected from carbon materials, electrically conductive polymers.

According to the invention, “(semi)metals” are selected from the group consisting of metals, semimetals, and are preferably metals.

The conductivity additive is more preferably a carbon material. Carbon materials are especially selected from the group consisting of carbon fibres, carbon nanotubes, graphite, graphene, carbon black, fullerenes.

Electrically conductive polymers are especially selected from the group consisting of polypyrroles, polyanilines, polyphenylenes, polypyrenes, polyazulenes, polynaphthylenes, polycarbazoles, polyindoles, polyazepines, polyphenylene sulfides, polythiophenes, polyacetylenes, poly(3,4-ethylenedioxythiophene) polystyrenesulfonate (=PEDOT:PSS), polyarcenes, poly-(p-phenylenevinylenes).

Metals are especially selected from the group consisting of zinc, iron, copper, silver, gold, chromium, nickel, tin, indium.

Semimetals are especially selected from silicon, germanium, gallium, arsenic, antimony, selenium, tellurium, polonium.

### I.3.2 Preferred Amount of the Conductivity Additives

The amount of the conductivity additive used is not subject to any further restriction. However, it is preferable that the total weight of the conductivity additive encompassed by the electrode material in the first aspect of the invention, based on the total weight of the redox polymer P encompassed by the electrode material, is in the range of 0.1% to 1000% by weight, preferably in the range of 10% to 500% by weight, more preferably in the range of 30% to 100% by weight, yet more preferably in the range of 40% to 80% by weight, even more preferably in the range of 50% by weight to 60% by weight, and is most preferably 58.3% by weight.

### I.4 Binder Additive

The electrode material in the first aspect of the present invention optionally also comprises a binder additive.

Binder additives are familiar to the person skilled in the art as materials having binding properties. Preference is given to polymers selected from the group consisting of polytetrafluoroethylene, polyvinylidene fluoride, polyhexafluoropropylene, polyvinyl chloride, polycarbonate, polystyrene, polyacrylate, polymethacrylate, polysulfone, cellulose derivatives, polyurethane, and the binder additive is more preferably polyvinylidene fluoride.

In the cases in which the electrode material in the first aspect of the invention comprises a binder additive, the amount thereof used is not subject to any further restriction. However, it is preferable in these cases that the total weight of the binder additive encompassed by the electrode material, based on the total weight of the organic redox polymer P encompassed by the electrode material, is in the range of 0.001% to 100% by weight, more preferably in the range of 0.083% to 90% by weight, yet more preferably in the range of 3% to 70% by weight, even more preferably in the range of 5% to 50% by weight, even more preferably still in the range of 8.3% to 20% by weight, and is most preferably 16.6% by weight.

### I.5 Electrode and Charge Storage Means

### I.5.1 Electrode

The present invention also relates to an electrode (another word “electrode element”) comprising the inventive electrode material of the first aspect of the present invention, and especially a substrate.

The substrate of the electrode element is especially selected from conductive materials, preferably metals, carbon materials, oxide substances.

Metals suitable with preference as substrate for the electrode element are selected from platinum, gold, iron, copper, aluminium, zinc or a combination of these metals. Preferred carbon materials suitable as substrate for the electrode element are selected from glassy carbon, graphite foil, graphene, carbon skins. Preferred oxide substances suitable as substrate for the electrode element are, for example, selected from the group consisting of indium tin oxide (ITO), indium zinc oxide (IZO), antimony zinc oxide (AZO), fluorine tin oxide (FTO) or antimony tin oxide (ATO), zinc oxide (ZO).

The surface layer of the electrode element comprises at least the electrode material according to the invention in the first aspect of the invention as redox-active material for charge storage.

The electrode material according to the invention in the first aspect of the invention is especially applied as electrode slurry to the substrate of the electrode element.

The electrode slurry in this case is especially a solution or suspension and comprises the polymer P according to the invention, the above-described ionic liquid and, in particular, the above-described conductivity additive and optionally the above-described binder additive.

The electrode slurry preferably comprises a solvent.

Solvents used for the electrode slurry are independently one or more solvents, preferably solvents having a high boiling point, more preferably selected from the group consisting of N-methyl-2-pyrrolidone, water, dimethyl sulfoxide, ethylene carbonate, propylene carbonate, dimethyl carbonate, methyl ethyl carbonate, γ-butyrolactone, tetrahydrofuran, dioxolane, sulfolane, N,N′-dimethylformamide, N,N′-dimethylacetamide, preferably N-methyl-2-pyrrolidone, water, more preferably N-methyl-2-pyrrolidone. The concentration of the redox-active material, especially of the redox polymer P according to the invention, for storage of electrical energy in the abovementioned electrode slurry is preferably between 1 and 100 mg/ml, more preferably between 5 and 50 mg/ml.

In the embodiment in which the electrode material according to the invention takes the form of an at least partial surface coating of electrode elements for electrical charge storage means, especially secondary batteries, an electrode element has an at least partial layer on a substrate surface. This layer especially comprises the electrode material in the first aspect of the invention, comprising at least one conductivity additive, at least one ionic liquid and at least one organic redox polymer P non-conjugated in the main chain, redox-active material for charge storage and optionally also at least one binder additive.

The application of the electrode material according to the invention in the first aspect of the invention (another expression for composition: “composite”) on the substrate is possible by means of methods known to those skilled in the art. More particularly, the electrode material according to the invention, in the first aspect of the invention, is applied as electrode slurry to the substrate by means of bar coating, slot die coating, screenprinting or stencil printing.

### I.5.2 Charge Storage Means

The present invention also relates to an electrical charge storage means, especially a secondary battery, comprising the electrode according to the invention.

In general, redox-active electrode materials for storage of electrical energy are materials that can store electrical charge and release it again, for example by accepting and releasing electrons. The electrode material according to the invention in the first aspect of the invention may accordingly be used, for example, as active electrode material in an electrical charge storage means. Such electrical charge storage means for storage of electrical energy are especially selected from the group consisting of secondary batteries (also called “accumulators”), redox flow batteries, supercapacitors, and preferably secondary batteries.

Preferably, the electrical charge storage means is a secondary battery. A secondary battery comprises a negative electrode and a positive electrode which are separated from one another by a separator, and an electrolyte which surrounds the electrodes and the separator.

The separator is a porous layer which is ion-permeable and enables the balancing of the charge. The task of the separator is to separate the positive electrode from the negative electrode and to enable balancing of charge through permeation of ions. The separator used in the secondary battery is especially a porous material, preferably a membrane consisting of a polymeric compound, for example polyolefin, polyamide or polyester. In addition, it is possible to use separators made from porous ceramic materials, glass microfibres.

The main task of the electrolyte is to assure ion conductivity, which is needed to balance the charge. The electrolyte of the secondary battery may be either a liquid or an oligomeric or polymeric compound having high ion conductivity (“gel electrolyte” or “solid state electrolyte”). Preference is given, however, to an oligomeric or polymeric compound.

If the electrolyte is liquid, it is especially composed of one or more solvents and one or more conductive salts.

The solvent of the electrolytes preferably independently comprises one or more solvents having a high boiling point and high ion conductivity but low viscosity, for example acetonitrile, dimethyl sulfoxide, ethylene carbonate, propylene carbonate, dimethyl carbonate, diethyl carbonate, methyl ethyl carbonate, γ-butyrolactone, tetrahydrofuran, dioxolane, 1,2-dimethoxyethane, 1,2-diethoxyethane, diglyme, triglyme, tetraglyme, ethyl acetate, 1,3-dioxolane or water.

The conductive salt in the electrolyte consists of a cation of the formula M^{e+} and an anion of the formula An^{f-} of the formula (M^{e+})ₐ(An^{f-})_{b} where e and f are integers depending on the charge of M and An, and a and b are integers that represent the molecular composition of the conductive salt.

Cations used in the abovementioned conductive salt are positively charged ions, preferably metals of the first and second main groups, for example lithium, sodium, potassium or magnesium, but also other metals of the transition groups, such as zinc, and organic cations, for example quaternary ammonium compounds such as tetraalkylammonium compounds.

Anions used in said conductive salt are preferably inorganic anions such as hexafluorophosphate, tetrafluoroborate, triflate, hexafluoroarsenate, hexafluoroantimonate, tetrafluoroaluminate, tetrafluoroindate, perchlorate, bis(oxalato)borate, tetrachloroaluminate, tetrachlorogallate, but also organic anions, for example N(CF₃SO₂)₂⁻, CF₃SO₃⁻, alkoxides, for example tert-butoxide or iso-propoxide, but also halides such as fluoride, chloride, bromide and iodide.

If ionic liquids are used, they can be used either as solvent of the electrolyte, as conductive salt, or else as complete electrolyte.

If the polymer P used in accordance with the invention is used as redox-active material for electrical charge storage means as the positive electrode element, the redox-active material used for electrical charge storage in the negative electrode may be a material which exhibits a redox reaction at a lower electrochemical potential than the polymer of this invention. Preference is given to those materials selected from the group consisting of carbon materials, which are especially selected from the group consisting of graphite, graphene, carbon black, carbon fibres, carbon nanotubes, metals or alloys, which are especially selected from the group consisting of lithium, sodium, magnesium, lithium-aluminium, Li—Si, Li—Sn, Li—Ti, Si, SiO, SiO₂, Si—SiO₂ complex, Zn, Sn, SnO, SnO₂, PbO, PbCh, GeO, GeCh, WO₂, MoO₂, Fe₂O₃, Nb₂O₅, TiO₂, Li₄Ti₅O₁₂, and Li₂Ti₃O₇, and organic redox-active materials. Examples of organic redox-active materials are compounds having a stable organic radical, compounds having an organosulfur unit, having a quinone structure, compounds having a dione system, conjugated carboxylic acids and salts thereof, compounds having a phthalimide or naphthalimide structure, compounds having a disulfide bond and compounds having a phenanthrene structure and derivatives thereof. If an abovementioned redox-active oligomeric or polymeric compound is used in the negative electrode, this compound may also be a composite, i.e. a composition, consisting of this oligomeric or polymeric compound, a conductivity additive and a binder additive in any ratio. The conductivity additive in this case too is especially at least one electrically conductive material, preferably selected from the group consisting of carbon materials, electrically conductive polymers, and especially carbon materials. Carbon materials are especially selected from the group consisting of carbon fibres, carbon nanotubes, graphite, carbon black, graphene, and are more preferably carbon fibres. Electrically conductive polymers are especially selected from the group consisting of polyanilines, polythiophenes, polyacetylenes, poly(3,4-ethylenedioxythiophene) polystyrenesulfonate (=“PEDOT:PSS”), polyarcenes. Binder additives in this case too are especially materials having binder properties and are preferably polymers selected from the group consisting of polytetrafluoroethylene, polyvinylidene fluoride, polyhexafluoropropylene, polyvinyl chloride, polycarbonate, polystyrene, polyacrylate, polymethacrylate, polysulfone, cellulose derivatives, polyurethane.

This composite may, as described above, be applied as a layer on a substrate by a known film-forming process with the and of an electrode slurry.

### II. Second Aspect of the Invention: Process for Producing an Electrode

The present invention also relates, in a second aspect, to a process for producing electrodes, comprising the following steps:

(a) mixing at least one organic redox polymer P non-conjugated in the main chain, at least one ionic liquid, at least one conductivity additive, optionally at least one solvent and optionally at least one binding additive to obtain a mixture M,
(b) applying the mixture M to a substrate,
(c) optionally at least partly removing the solvent.

### Step (a) of the Process According to the Invention

In step (a) of the process according to the invention,
at least one organic redox polymer P non-conjugated in the main chain;
at least one ionic liquid;
at least one conductivity additive;
optionally at least one solvent;
and optionally at least one binder additive;
   are mixed to give a mixture M.

The mixture M obtained after step (a) of the process according to the invention is especially an electrode slurry.

### II.1 Redox Polymer P Used in the Process According to the Invention

The organic redox polymer P non-conjugated in the main chain which is used in the process according to the invention for producing an electrode in the second aspect of the present invention, for the purposes of the invention, is composed of two structural features:

(1) a polymer backbone (the ‘main chain’) in which there is no conjugation,
(2) redox-active organic radicals bonded regularly or irregularly to the polymer backbone, within which there is conjugation or no conjugation.

II.1.α) For the purposes of the invention, the organic redox polymer P non-conjugated in the main chain which is used in the process according to the invention for producing an electrode in the second aspect of the present invention especially comprises n¹ mutually joined repeat units of the chemical structure (I) and/or n² mutually joined repeat units of the chemical structure (II) and/or n³ mutually joined repeat units of the chemical structure (III), preferably n¹ mutually joined repeat units of the chemical structure (I) and/or n³ mutually joined repeat units of the chemical structure (III), more preferably n¹ mutually joined repeat units of the chemical structure (I), wherein chemical structures (I), (II), and (III) as well as the respective variables are as defined in point I.1.α).

The repeat units of the chemical structure (I) within the polymer P according to point II.1.α) are the same or at least partly different from one another. The repeat units of the chemical structure (II) within the polymer P according to point II.1.α) are the same or at least partly different from one another. The repeat units of the chemical structure (III) within the polymer P according to point II.1.α) are the same or at least partly different from one another.

II.1.β) In a preferred embodiment of the second aspect of the invention as defined in point II.1.α), the organic redox polymer P non-conjugated in the main chain which is used in the process according to the invention for producing an electrode in the second aspect of the present invention comprises n¹ mutually joined repeat units of the chemical structure (I), wherein chemical structure (I) as well as the respective variables are as defined in point I.1.β).

The repeat units of the chemical structure (I) within the polymer P according to point II.1.β) are the same or at least partly different from one another.

### II.1.1 Redox-Active Groups

The organic redox-active groups selectable for R¹, R², R⁴, R⁵, R^{1′}, R^{2′}, R^{3′} in the structures (I), (II) and (III), in the second aspect of the invention, preferably as defined in point II.1.α) and more preferably in point II.1.β), are not subject to any further restriction. The person skilled in the art is aware of organic redox-active groups that can be used in organic batteries, and they are described, for example, in Muench et at, together with the synthesis of the respective polymers. As described in point II.1.α) and point II.1.β), the organic redox-active groups are preferably selected from the group consisting of redox-active aromatic imide function (A), redox-active organic function comprising at least one stable oxygen radical (B), redox-active anthraquinone/carbazole function (C), redox-active dialkoxybenzene function (D), redox-active benzoquinone function (E), redox-active triphenylamine function (G), redox-active viologen function (H), redox-active ferrocene function (J), and more preferably selected from the group consisting of redox-active aromatic imide function (A), redox-active organic function comprising at least one stable oxygen radical (B), redox-active anthraquinone/carbazole function (C), and even more preferably from the group consisting of redox-active organic function comprising at least one stable oxygen radical (B), redox-active anthraquinone/carbazole function (C), and the organic redox-active group is most preferably a redox-active organic function comprising at least one stable oxygen radical (B).

### II.1.1.1 Redox-Active Aromatic Imide Function (A)

AA.1 In the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the second aspect of the invention as defined in point II.1.α) and point II.1.β) are in each case a redox-active aromatic imide function (A), this means more particularly in accordance with the invention that the R¹, R², R⁴, R⁵, R^{1′}, R^{2′}, R^{3′} radicals or the R¹, R², R⁴, R⁵ radicals or the R¹, R^{1′} radicals or the R¹ radical may each independently have the structure (A1) defined in point I.1.1.1, A.1 and, in the case of R², R⁴, R⁵, may also each independently have the structure (A2) defined in point I.1.1.1, A.1.

AA.2 In a preferred embodiment of the afore mentioned point AA.1, Ar¹ has a structure selected from the group consisting of (A11), (A12), (A13), (A14), (A15), (A16), (A17), (A18), (A19), (A20), (A21) defined in point I.1.1.1, A.2, and Ar² has a structure selected from the group consisting of (A22), (A23), (A24), (A25), (A26), (A27), (A28), (A29), (A30), (A31), (A32) defined in point I.1.1.1, A.2.

AA.3 In a preferred embodiment of the aforementioned point AA.1 or AA.2, what is meant in accordance with the invention in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) or (III) in the second aspect of the invention as defined in point II.1.α) and point II.1.β) is in each case a redox-active aromatic imide function (A) is that R¹, R^{1′}, R^{2′}, R^{3′} are in that case each independently selected from the group consisting of the structures (A101), (A102), (A103), (A104) defined in point I.1.1.1, A.3, and R², R⁴, R⁵ in that case are each independently selected from the group consisting of the structures (A201), (A202), (A203), (A204) defined in point I.1.1.1, A.3.

AA.4 In a preferred embodiment of the aforementioned point AA.3, what is meant in accordance with the invention in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) or (III) in the second aspect of the invention as defined in point II.1.α) and point II.1.β) is in each case a redox-active aromatic imide function (A) is that the R¹, R^{1′}, R^{2′}, R^{3′} radicals or the R¹, R^{1′} radicals or the R¹ radical are in that case each independently selected from the group consisting of the structures (A101), (A103) defined in AA.3, and preferably each have a structure (A101), where the definitions of (iii^{A1}), R^{A101}, R^{A102}, R^{A103}, R^{A104}, R^{A112}, R^{A113}, R^{A114}, R^{A115}, R^{A116}, R^{A117} are defined in AA.3,

and the R², R⁴, R⁵ radicals in that case are each independently selected from the group consisting of the structures (A201), (A202) defined in AA.3, and preferably each have a structure (201), where the definitions of (v^{A2}), (vi^{A2}), X^{A202}, R^{A201}, R^{A202}, R^{A203}, R^{A204}, R^{A205}, R^{A206}, R^{A207}, R^{A208} are as defined in point AA.3.

AA.5 In a particularly preferred embodiment of the second aspect of the invention as defined in II.1.β) or point AA.4), the organic redox polymer P non-conjugated in the main chain which is used in the process according to the invention for producing an electrode in the second aspect of the present invention especially comprises n¹ mutually joined repeat units of the chemical structure (I), wherein the chemical structure (I) and the variables are as defined in point I.1.1.1, A.5.

### II.1.1.2 Redox-Active Organic Function Comprising at Least One Stable Oxygen Radical (B)

BB.1 In the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the second aspect of the invention as defined in point II.1.α) and point II.1.β) are in each case a redox-active organic function comprising at least one stable oxygen radical (B), this means more particularly in accordance with the invention that the R¹, R², R⁴, R⁵, R^{1′}, R^{2′}, R^{3′} radicals or the R¹, R², R⁴, R⁵ radicals or the R¹, R^{1′} radicals or the R¹ radical are each independently selected from one of the structures (B1), (B2) defined in point I.1.1.2, B1.

BB.2 In a preferred embodiment of the aforementioned point BB.1, the structure (B1) has a structure selected from the group consisting of the structures (B11), (B12), (B13) defined in point I.1.1.2, B2, preferably from the structure (B11) defined in point I.1.1.2, B2.

BB.3 In a particularly preferred embodiment of the second aspect of the invention as defined in II.1.β), the organic redox polymer P non-conjugated in the main chain which is used in the process according to the invention for producing an electrode in the second aspect of the present invention especially comprises n¹ mutually joined repeat units of the chemical structure (I) defined in point I.1.1.2, B3.

### II.1.1.3 Redox-Active Anthraquinone/Carbazole Function (C)

CC.1 In the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the second aspect of the invention as defined in point II.1.α) and point II.1.β) are in each case a redox-active anthraquinone/carbazole function (C), this means more particularly in accordance with the invention that the R¹, R^{1′}, R^{2′}, R^{3′} or R¹, R^{1′} or R¹ radicals are each independently selected from one of the structures (C1), (C2) defined in point I.1.1.3, C1, and the R², R⁴, R⁵ radicals are each independently selected from the group consisting of the following structures (C3), (C4) defined in point I.1.1.3, C1.

CC.2 In a preferred embodiment of the aforementioned point CC.1, what is meant in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the second aspect of the invention as defined in point II.1.α) and point II.1.β) are each a redox-active anthraquinone/carbazole function (C) is that the R¹, R², R⁴, R⁵, R^{1′}, R^{2′}, R^{3′} radicals or the R¹, R², R⁴, R⁵ radicals or the R¹, R^{1′} radicals or the R¹ radical are each independently selected from one of the structures (C11), (C12), (C13), (C14), (C15), (C16), (C17), (C18), (C19), (C20) defined in point I.1.1.3, C2.

CC.3 In a preferred embodiment of the aforementioned point CC.2, what is meant in accordance with the invention in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the second aspect of the invention as defined in point II.1.α) and point II.1.β) are each a redox-active anthraquinone/carbazole function (C) is that the R¹, R^{1′}, R^{2′}, R^{3′} radicals or the R¹, R^{1′} radicals or the R¹ radical are selected from the structures (C101), (C102), (C103), (C104), (C105), (C106), (C107), (C108), (C109), (C110), (C111), (C112), (C113), (C114) defined in point I.1.1.3, C3, preferably from the group consisting of the structures (C101), (C102), (C103), (C104), (C105), (C113) defined in point I.1.1.3, C3,

and R², R⁴, R⁵ are selected from the group consisting of the following structures (C201), (C202), (C203), (C204), (C205), (C206), (C207), (C208), (C209), (C210), (C211), (C212), (C213) defined in point I.1.1.3, C3, preferably from the group consisting of the following structures (C201), (C202), (C203), (C204), (C205) (C212) defined in point I.1.1.3, C3.

CC.4 In a more preferred embodiment of the aforementioned point CC.3, what is meant in accordance with the invention in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) or (III) in the second aspect of the invention as defined in point II.1.α) and point II.1.β) is in each case a redox-active anthraquinone/carbazole function (C) is that the R¹, R^{1′}, R^{2′}, R^{3′} radicals or the R¹, R^{1′} radicals or the R¹ radical are each independently selected from the group consisting of the structures (C301), (C302), (C303), (C304), (C305), (C306), (C307) defined in point I.1.1.3, C4, and the R², R⁴, R⁵ radicals are selected from the group consisting of the structures (C401), (C402), (C403), (C404), (C405), (C406), (C407) defined in point I.1.1.3, C4.

CC.5 In a more preferred embodiment of the aforementioned point CC.4, what is meant in accordance with the invention in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) or (III) in the second aspect of the invention as defined in point II.1.α) and point II.1.β) are each a redox-active anthraquinone/carbazole function (C) is that R¹, R^{1′}, R^{2′}, R^{3′} radicals or the R¹, R^{1′} radicals or the R¹ radical are selected from the group consisting of the structures (C301), (C302), (C303), (C304) defined in point C.4, and the R², R⁴, R⁵ radicals are selected from the group consisting of the structures (C401), (C402), (C403), (C404) defined in point C.4, where (ix^{C3}), (xi^{C4}), (xii^{C4}) and the R^{C301}, R^{C302}, R^{C303}, R^{C304}, R^{C305}, R^{C306}, R^{C307}, R^{C306}, R^{C309}, R^{C310}, R^{C311}, R^{C312}, R^{C313}, R^{C314}, R^{C315}, R^{C316}, R^{C317}, R^{C318}, R^{C319}, R^{C320}, R^{C321}, R^{C322}, R^{C323}, R^{C324}, R^{C325}, R^{C326}, R^{C327}, R^{C328}, R^{C329}, R^{C330}, R^{C331}, R^{C332}, R^{C333}, R^{C401}, R^{C402}, R^{C403}, R^{C404}, R^{C405}, R^{C406}, R^{C407}, R^{C406}, R^{C409}, R^{C410}, R^{C411}, R^{C412}, R^{C413}, R^{C414}, R^{C415}, R^{C416}, R^{C417}, R^{C418}, R^{C419}, R^{C420}, R^{C421}, R^{C422}, R^{C423}, R^{C424}, R^{C425}, R^{C426}, R^{C427}, R^{C428}, R^{C429} radicals have the definition given in point C.4.

CC.6 In a particularly preferred embodiment of the second aspect of the invention as defined in II.1.β) or point CC.5, the organic redox polymer P non-conjugated in the main chain which is used in the process according to the invention for producing an electrode in the second aspect of the present invention especially comprises n¹ mutually joined repeat units of the chemical structure (I) defined in point I.1.1.3, C6.

CC.7 In a most preferred embodiment of the aforementioned point CC.6, R^{1′} is hydrogen and R¹ is selected from the group consisting of the structures (C501), (C502) defined in point I.1.1.3, C7, even more preferably, R¹ is a compound of the structure (C501) defined in point I.1.1.3, C7.

### II.1.1.4 Redox-Active Dialkoxybenzene Function (D)

DD.1 In the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the second aspect of the invention as defined in point II.1.α) and point II.1.β) are in each case a redox-active dialkoxybenzene function (D), this means more particularly in accordance with the invention that the R¹, R^{1′}, R^{2′}, R^{3′} or R¹, R^{1′} or R¹ radicals each independently have the structure (D1) defined in point I.1.1.4, D1 and the R², R⁴, R⁵ radicals each independently have the structure (D2) defined in point I.1.1.4, D1.

DD.2 In a preferred embodiment of the aforementioned point DD.1, what is meant in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the second aspect of the invention as defined in point II.1.α) and point II.1.β) are in each case a redox-active dialkoxybenzene function (D) is that the R¹, R^{1′}, R^{2′}, R^{3′} or R¹, R^{1′} or R¹ radicals each independently have the structure (D1) defined in point I.1.1.4, D2 and the R², R⁴, R⁵ radicals each independently have the structure (D2) defined in point I.1.1.4, D2.

DD.3 In a preferred embodiment of the aforementioned point DD.2, what is meant in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the second aspect of the invention as defined in point II.1.α) and point II.1.β) are in each case a redox-active dialkoxybenzene function (D) is that the R¹, R^{1′}, R^{2′}, R^{3′} or R¹, R^{1′} or R¹ radicals each independently have the structure (D3) defined in point I.1.1.4, D3 and the R², R⁴, R⁵ radicals each independently have the structure (D4) defined defined in point I.1.1.4, D3.

DD.4 In a preferred embodiment of the aforementioned point DD.3, what is meant in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the second aspect of the invention as defined in point II.1.α) and point II.1.β) are in each case a redox-active dialkoxybenzene function (D) is that the R¹, R^{1′}, R^{2′}, R^{3′} or R¹, R^{1′} or R¹ radicals independently have the structure (D3) defined in point defined in point I.1.1.4, D4 and R², R⁴, R⁵ each independently have the structure (D4) defined in point I.1.1.4, D4.

DD.5 In a preferred embodiment of the aforementioned point DD.4, what is meant in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the second aspect of the invention as defined in point II.1.α) and point II.1.β) are in each case a redox-active dialkoxybenzene function (D) is that the R¹, R^{1′}, R^{2′}, R^{3′} or R¹, R^{1′} or R¹ radicals independently have the structure (D5) defined in point I.1.1.4, D5 and the R², R⁴, R⁵ radicals each independently have the structure (D6) defined in point I.1.1.4, D5.

DD.6 In a preferred embodiment of the aforementioned point DD.5, what is meant in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the second aspect of the invention as defined in point II.1.α) and point II.1.β) are in each case a redox-active dialkoxybenzene function (D) is that the R¹, R^{1′}, R^{2′}, R^{3′} or R¹, R^{1′} or R¹ radicals independently have the structure (D5) defined in point I.1.1.4, D6 and R², R⁴, R⁵ each independently have the structure (D6) defined in point I.1.1.4, D6.

DD.7 In a particularly preferred embodiment of the second aspect of the invention as defined in II.1.β) or point DD.6), the organic redox polymer P non-conjugated in the main chain which is used in the process according to the invention for producing an electrode in the second aspect of the present invention especially comprises n¹ mutually joined repeat units of the chemical structure (I) defined in point I.1.1.4, D7.

### II.1.1.5 Redox-Active Benzoquinone Function (E)

EE.1 In the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the second aspect of the invention as defined in point II.1.α) and point II.1.β) are in each case a redox-active benzoquinone function (E), this means more particularly in accordance with the invention that the R¹, R^{1′}, R^{2′}, R^{3′} or R¹, R^{1′} or R¹ radicals are each independently selected from the structures (E1), (E2), (E3) defined in point I.1.1.5, E1,

and the R², R⁴, R⁵ radicals are each independently selected from the group consisting of the structures (E4), (E5), (E6), (E7), (E8), (E9) defined in point I.1.1.5, E1.

EE.2 In a preferred embodiment of the aforementioned point EE.1, what is meant in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the second aspect of the invention as defined in point II.1.α) and point II.1.β) are in each case a redox-active benzoquinone function (E) is that the R¹, R^{1′}, R^{2′}, R^{3′} or R¹, R^{1′} or R¹ radicals are each independently selected from the structures (E1), (E2), (E3) defined in point I.1.1.5, E2 and the R², R⁴, R⁵ radicals are each independently selected from the structures (E4), (E5), (E6), (E7), (E8), (E9) defined in point I.1.1.5, E2.

EE.3 In a preferred embodiment of the aforementioned point EE.2, what is meant in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the second aspect of the invention as defined in point II.1.α) and point II.1.β) are in each case a redox-active benzoquinone function (E) is that the R¹, R^{1′}, R^{2′}, R^{3′} or R¹, R^{1′} or R¹ radicals are each independently selected from the structures (E1), (E2), (E3) defined in point I.1.1.5, E3 and the R², R⁴, R⁵ radicals are each independently selected from the structures (E4), (E5), (E6), (E7), (E8), (E9) defined in point I.1.1.5, E3.

EE.4 In a preferred embodiment of the aforementioned point EE.3, what is meant in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the second aspect of the invention as defined in point II.1.α) and point II.1.β) are in each case a redox-active benzoquinone function (E) is that the R¹, R^{1′}, R^{2′}, R^{3′} or R¹, R^{1′} or R¹ radicals are each independently selected from the structures (E1), (E2), (E3) defined in point I.1.1.5, E4 and the R², R⁴, R⁵ radicals are each independently selected from the structures (E4), (E5), (E6), (E8), (E9) defined in point I.1.1.5, E4.

EE.5 In a preferred embodiment of the aforementioned point EE.4, what is meant in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the second aspect of the invention as defined in point II.1.α) and point II.1.β) are in each case a redox-active benzoquinone function (E) is that the R¹, R^{1′}, R^{2′}, R^{3′} or R¹, R^{1′} or R¹ radicals are each independently selected from the structures (E1), (E2), (E3) defined in point I.1.1.5, E5 and the R², R⁴, R⁵ radicals are each independently selected from the structures (E6), (E9) defined in point I.1.1.5, E5.

EE.6 In a particularly preferred embodiment of the second aspect of the invention as defined in II.1.β), the organic redox polymer P non-conjugated in the main chain which is used in the process according to the invention for producing an electrode in the second aspect of the present invention especially comprises n¹ mutually joined repeat units of the chemical structure (I) defined in point I.1.1.5, E6.

### II.1.1.6 Redox-Active Triphenylamine Function (G)

GG.1 In the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the second aspect of the invention as defined in point II.1.α) and point II.1.β) are in each case a redox-active triphenylamine function (G), this means more particularly in accordance with the invention that the R¹, R^{1′}, R^{2′}, R^{3′} or R¹, R^{1′} or R¹ radicals each independently have the structure (G1) defined in point I.1.1.6, Gland the R², R⁴, R⁵ radicals are each independently selected from the group consisting of the structures (G2), (G3) defined in point I.1.1.6, G1.

GG.2 In a particularly preferred embodiment of the second aspect of the invention as defined in II.1.β), the organic redox polymer P non-conjugated in the main chain which is used in the process according to the invention for producing an electrode in the second aspect of the present invention especially comprises n¹ mutually joined repeat units of the chemical structure (I) defined in point I.1.1.6, G2.

GG.3 In a preferred embodiment of the aforementioned point GG.2, the redox-active triphenylamine function (G) is selected from the structures (G4), (G5), (G6) defined in point I.1.1.6, G3.

GG.4 In a preferred embodiment of the aforementioned point GG.3, the redox active triphenylamine function (G) has the structure (G4) defined in point I.1.1.6, G4.

### II.1.1.7 Redox-Active Viologen Function (H)

HH.1 In the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the second aspect of the invention as defined in point II.1.α) and point II.1.β) are in each case a redox-active viologen function (H), this means more particularly in accordance with the invention that the R¹, R^{1′}, R^{2′}, R^{3′} or R¹, R^{1′} or R¹ radicals are each independently selected from the group consisting of the structures (H1), (H2) defined in point I.1.1.7, H1,

and the R², R⁴, R⁵ radicals are each independently selected from the group consisting of the structures (H3), (H4), (H5), (H6), (H7) defined in point I.1.1.7, H1.

HH.2 In a preferred embodiment of the aforementioned point HH.1, what is meant in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the second aspect of the invention as defined in point II.1.α) and point II.1.β) are each a redox-active viologen function (H) is that the R¹, R^{1′}, R^{2′}, R^{3′} or R¹, R^{1′} or R¹ radicals each independently have the structure (H1) defined in point I.1.1.7, H2, and R², R⁴, R⁵ each independently have the structure (H7) defined in point I.1.1.7, H2.

HH.3 In a particularly preferred embodiment of the second aspect of the invention as defined in II.1.β), the organic redox polymer P non-conjugated in the main chain which is used in the process according to the invention for producing an electrode in the second aspect of the present invention especially comprises n¹ mutually joined repeat units of the chemical structure (I) defined in point I.1.1.7, H3.

### II.1.1.8 Redox-Active Ferrocene Function (J)

JJ.1 In the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the second aspect of the invention as defined in point II.1.α) and point II.1.β) are in each case a redox-active ferrocene function (J), this means more particularly in accordance with the invention that the R¹, R^{1′}, R^{2′}, R^{3′} or R¹, R^{1′} or R¹ radicals each independently have the structure (J1) defined in point I.1.1.8, J1 and the R², R⁴, R⁵ radicals are each independently selected from the group consisting of the structures (J2), (J3), (J4) defined in point I.1.1.8, J1.

JJ.2 In a particularly preferred embodiment of the second aspect of the invention as defined in II.1.β), the organic redox polymer P non-conjugated in the main chain which is used in the process according to the invention for producing an electrode in the second aspect of the present invention especially comprises n¹ mutually joined repeat units of the chemical structure (I) defined in point I.1.1.8, J2.

### II.1.2 LINKER Units

L¹, L², L³, L⁴, L⁵, L⁶, L⁷, L^{1′}, L^{2′}, L^{3′} or L¹, L^{1′}, in the second aspect of the invention as defined in point II.1.α) or point II.1.β), in the structures (I), (II) and (III) or the structure (I), are each independently selected from the group consisting of direct bond, organic linker unit. Organic linker units of this kind are not subject to any further restriction and are known to those skilled in the art.

In the cases in which L¹, L², L³, L⁴, L⁵, L⁶, L⁷, L^{1′}, L^{2′}, L^{3′} or L¹, L^{1′}, in the second aspect of the invention as defined in point II.1.α) or point II.1.β), in the structures (I), (II) and (III), are each an organic linker unit, this means more particularly in accordance with the invention that L¹, L², L³, L⁴, L⁵, L⁶, L⁷, L^{1′}, L^{2′}, L^{3′} in that case are each independently selected from the group consisting of (L11), (L12) defined in point I.1.2.

### II.1.2.1 Preferred Linker Units in Redox-Active Aromatic Imide Functions (A)

LAA.1 In a preferred embodiment, in the second aspect of the present invention, in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the second aspect of the invention as defined in point II.1.α) and point II.1.β) are each a redox-active aromatic imide function (A), and especially in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical have the structures defined in the above point AA.1, more preferably AA.2, even more preferably AA.3, even more preferably still AA.4, and also in the case in which the organic redox polymer P non-conjugated in the main chain, in the second aspect of the invention, comprises a structure as defined in point AA.5,

L¹, L², L³, L⁴, L⁵, L⁶, L⁷, L^{1′}, L^{2′} or L³¹ in that case are preferably selected from the group consisting of direct bond, (LA11), (LA12) defined in point I.1.2.1, LA.1.

LAA.2 In a preferred embodiment of the aforementioned point LAA.1, X^{LA2}, Y^{LA2}, Y^{LA5}, X^{LA1}, X^{LA3}, Y^{LA1}, Y^{LA3}, Y^{LA4}, Y^{LA6}, B^{LA1}, respectively, have the meaning defined in point I.1.2.1, LA2.

LAA.3 In a preferred embodiment of the aforementioned point LAA.2, L¹, L², L³, L⁴, L⁵, L⁶, L⁷, L^{1′}, L^{2′}, L^{3′} are as defined in point I.1.2.1, LA3.

### II.1.2.2 Preferred Linker Units for Redox-Active Organic Functions Comprising at Least One Stable Oxygen Radical (B)

LBB.1 In a preferred embodiment of the second aspect of the present invention, in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the second aspect of the invention as defined in point II.1.α) and point II.1.β) are each a redox-active organic function comprising at least one stable oxygen radical (B), and especially in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical have the structures defined in the above point BB.1, more preferably BB.2, and also in the case in which the polymer P in the second aspect of the invention comprises a structure as defined in point BB.3,

L¹, L², L³, L⁴, L⁵, L⁶, L⁷, L^{1′}, L^{2′}, L^{3′} in that case are preferably selected from the group consisting of direct bond, (LB11), (LB12) defined in point I.1.2.2, LB.1.

LBB.2 In a preferred embodiment of the aforementioned point LBB.1, X^{LB2}, Y^{LB2}, Y^{LB5}, X^{LB1}, X^{LB3}, Y^{LB1}, Y^{LB3}, Y^{LB4}, Y^{LB6}, B^{LA2}, respectively, have the meaning defined in point I.1.2.2, LB2.

LBB.3 In a preferred embodiment of the aforementioned point LBB.2, L¹, L², L³, L⁴, L⁵, L⁶, L⁷, L^{1′}, L^{2′}, L^{3′} are as defined in point I.1.2.2, LB3.

### II.1.2.3 Preferred Linker Units for Redox-Active Anthraquinone/Carbazole Function (C)

LCC.1 In a more preferred embodiment of the second aspect of the present invention, in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the second aspect of the invention as defined in point II.1.α) and point II.1.β) are each a redox-active anthraquinone/carbazole function (C), and especially in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical have the structures defined in the above point CC.1, preferably CC.2, more preferably CC.3, even more preferably CC.4, even more preferably still CC.5, and also in the case in which the organic redox polymer P non-conjugated in the main chain, in the second aspect of the invention, comprises a structure as defined in point CC.6, preferably CC.7,

L¹, L², L³, L⁴, L⁵, L⁶, L⁷, L^{1′}, L^{2′}, L^{3′} in that case are preferably selected from the group consisting of direct bond, (LC11), (LC12) defined in point I.1.2.3, LC.1.

LCC.2 In a preferred embodiment of the aforementioned point LCC.1, X^{LC2}, Y^{LC2}, Y^{LC5}, X^{LC1}, X^{LC3}, Y^{LC1}, Y^{LC3}, Y^{LC4}, Y^{LC6}, B^{LC1}, respectively, have the meaning defined in point I.1.2.3, LC.2.

LCC.3 In a preferred embodiment of the aforementioned point LCC.2, L¹, L², L³, L⁴, L⁵, L⁶, L⁷, L^{1′}, L^{2′}, L^{3′} are as defined in point I.1.2.3, LC.3.

### II.1.2.4 Preferred Linker Units for Redox-Active Dialkoxybenzene Function (D)

LDD.1 In a more preferred embodiment of the second aspect of the present invention, in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the second aspect of the invention as defined in point II.1.α) and point II.1.β) are each a redox-active phenoxy compound (D), and especially in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical have the structures defined in the above point DD.1, preferably DD.2, more preferably DD.3, even more preferably DD.4, yet more preferably DD.5, even more preferably still DD.6, and also in the case in which the organic redox polymer P non-conjugated in the main chain, in the second aspect of the invention, comprises a structure as defined in point DD.7,

L¹, L², L³, L⁴, L⁵, L⁶, L⁷, L^{1′}, L^{2′}, L^{3′} in that case are preferably selected from the group consisting of direct bond, (LD11), (LD12) as defined in point I.1.2.4, LD.1.

LDD.2 In a preferred embodiment of the aforementioned point LDD.1, X^{LC2}, Y^{LC2}, Y^{LC5}, X^{LC1}, X^{LC3}, Y^{LC1}, Y^{LC3}, Y^{LC4}, Y^{LC6}, B^{LD1}, respectively, have the meaning defined in point I.1.2.4, LD.2.

LDD.3 In a more preferred embodiment of the aforementioned point LDD.2, L¹, L², L³, L⁴, L⁵, L⁶, L⁷, L^{1′}, L^{2′}, L^{3′} are as defined in point I.1.2.4, LD.3.

LDD.4 In an even more preferred embodiment of the aforementioned point LDD.3, L¹, L², L³, L⁴, L⁵, L⁶, L⁷, L^{1′}, L^{2′}, L^{3′} are as defined in point I.1.2.4, LD.4.

### II.1.2.5 Preferred Linker Units for Redox-Active Benzoquinone Function (E)

LEE.1 In an even more preferred embodiment of the second aspect of the present invention, in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the second aspect of the invention as defined in point II.1.α) and point II.1.β) are each a redox-active benzoquinone function (E), and especially in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical have the structures defined in the above point EE.1, preferably EE.2, more preferably EE.3, even more preferably EE.4, even more preferably still EE.5, and also in the case in which the organic redox polymer P non-conjugated in the main chain, in the second aspect of the invention, comprises a structure as defined in point EE.6,

L¹, L², L³, L⁴, L⁵, L⁶, L⁷, L^{1′}, L^{2′}, L^{3′} in that case are preferably selected from the group consisting of direct bond, (LE11), (LE12) as defined in point I.1.2.5, LE.1.

LEE.2 In a preferred embodiment of the aforementioned point LEE.1, X^{L2}, Y^{LA2}, Y^{LA5}, X^{LE1}, X^{LE3}, Y^{LE1}, Y^{LE3}, Y^{LE4}, Y^{LE6}, B^{LE1}, respectively, have the meaning defined in point I.1.2.5, LE.2.

LEE.3 In a more preferred embodiment of the aforementioned point LEE.2, L¹, L², L³, L⁴, L⁵, L⁶, L⁷, L^{1′}, L^{2′}, L^{3′} are as defined in point I.1.2.5, LE.3.

### II.1.2.6 Preferred Linker Units for Redox-Active Triphenylamine Function (G)

LGG.1 In an even more preferred embodiment of the second aspect of the present invention, in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the second aspect of the invention as defined in point II.1.α) and point II.1.β) are each a redox-active triphenylamine function (G), and especially in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical have the structures defined in the above point GG.1, and also in the case in which the organic redox polymer P non-conjugated in the main chain, in the second aspect of the invention, comprises a structure as defined in point GG.2, preferably GG.3, more preferably GG.4,

L¹, L², L³, L⁴, L⁵, L⁶, L⁷, L^{1′}, L^{2′}, L^{3′} in that case are preferably selected from the group consisting of direct bond, (LG11), (LG12) as defined in point I.1.2.6, LG.1.

LGG.2 In a preferred embodiment of the aforementioned point LGG.1, X^{LG2}, Y^{LG2}, Y^{LG6}, X^{LG1}, X^{LG3}, Y^{LC1}, Y^{L63}, Y^{L64}, Y^{LC6}, B^{LG1}, respectively, have the meaning defined in point I.1.2.6, LG.2.

LGG.3 In a more preferred embodiment of the aforementioned point LGG.2, L¹, L², L³, L⁴, L⁵, L⁶, L⁷, L^{1′}, L^{2′}, L^{3′} are as defined in point I.1.2.6, LG.3.

### II.1.2.7 Preferred Linker Units for Redox-Active Viologen Function (H)

LHH.1 In an even more preferred embodiment of the second aspect of the present invention, in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the second aspect of the invention as defined in point II.1.α) and point II.1.β) are each a redox-active viologen function (H), and especially in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical have the structures defined in the above point HH.1, preferably in the above point HH.2, and also in the case in which the organic redox polymer P non-conjugated in the main chain, in the second aspect of the invention, comprises a structure as defined in point HH.3,

L¹, L², L³, L⁴, L⁵, L⁶, L⁷, L^{1′}, L^{2′}, L^{3′} in that case are preferably selected from the group consisting of direct bond, (LH11), (LH12) as defined in point I.1.2.7, LH.1.

LHH.2 In a preferred embodiment of the aforementioned point LHH.1, X^{LH2}, Y^{LH2}, Y^{LH5}, X^{LH1}, X^{LH3}, Y^{LH1}, Y^{LH3}, Y^{LH4}, Y^{LH6}, B^{LH1}, respectively, have the meaning defined in point I.1.2.7, LH.2.

LHH.3 In a more preferred embodiment of the aforementioned point LHH.2, especially when R¹, R^{1′} have the structure (H1) shown in point HH.1, L¹, L², L³, L⁴, L⁵, L⁶, L⁷, L^{1′}, L^{2′}, L^{3′} are as defined in point I.1.2.7, LH.3.

### II.1.2.8 Preferred Linker Units for Redox-Active Ferrocene Function (J)

LJJ.1 In an even more preferred embodiment of the second aspect of the present invention, in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical in the structures (I), (II) and (III) in the second aspect of the invention as defined in point II.1.α) and point II.1.β) are each a redox-active ferrocene function (J), and especially in the cases in which the R¹, R², R⁴, R⁵, R^{1′}, R^{2′}, R^{3′} radicals or the R¹, R², R⁴, R⁵ radicals or the R¹, R^{1′} radicals or the R¹ radical have the structures defined in the above point JJ.1, and also in the case in which the organic redox polymer P non-conjugated in the main chain, in the second aspect of the invention, comprises a structure as defined in point JJ.2,

L¹, L², L³, L⁴, L⁵, L⁶, L⁷, L^{1′}, L^{2′}, L^{3′} in that case are preferably selected from the group consisting of direct bond, (LJ11), (LJ12) as defined in point I.1.2.8, LJ.1.

LJJ.2 In a preferred embodiment of the aforementioned point LJJ.1, X^{LJ2}, Y^{LJ2}, Y^{LJ5}, X^{LJ1}, X^{LJ3}, Y^{LJ1}, Y^{LJ3}, Y^{LJ4}, Y^{LJ6}, B^{LJ1}, respectively, have the meaning defined in point I.1.2.8, LJ.2.

LJJ.3 In a more preferred embodiment of the aforementioned point LJJ.2, L¹, L², L³, L⁴, L⁵, L⁶, L⁷, L^{1′}, L^{2′}, L^{3′} are as defined in point I.1.2.8, LJ.3.

### II.1.2.9 Preferred Linker Units if R^{1′}, R^{2′}, R^{3′} are Each Hydrogen

LKK.1 In an even more preferred embodiment of the second aspect of the present invention, in the cases in which the R^{1′}, R^{2′}, R^{3′} radicals or the R^{1′} radical in the structures (I), (II) and (III) in the second aspect of the present invention as defined in point II.1.α) and point II.1.β), and especially in the above-described cases AA.5, BB.3, CC.6, CC.7, DD.7, EE.6, GG.2, GG.3, GG.4, HH.3, JJ.2, are each a hydrogen radical, L^{1′}, L^{2′}, L^{3′} in that case are preferably selected from the group consisting of direct bond, (LK11), (LK12) as defined in point I.1.2.9, LK.1.

LKK.2 In a preferred embodiment of the aforementioned point LKK.1, X^{LK2}, Y^{LK2}, Y^{LK5}, X^{LK1}, X^{LK3}, Y^{LK1}, Y^{LK3}, Y^{LK4}, Y^{LK6}, B^{LK1}, respectively, have the meaning defined in point I.1.2.9, LK.2.

LKK.3 In a preferred embodiment of the aforementioned points LKK.1 and LKK.2, L^{1′}, L^{2′}, L^{3′} are each a direct bond.

### II.1.3 Polymerized X¹, X², X³, X⁴, X⁵ Groups

The non-conjugated organic groups selectable for X¹, X², X³, X⁴, X⁵ in the structures (I), (II) and (III) in the second aspect of the invention as defined in point II.1.α) and point II.1.β), and especially in the above-described cases AA.5, BB.3, CC.6, CC.7, DD.7, EE.6, GG.2, GG.3, GG.4, HH.3, JJ.2, are not subject to any further restriction except that no conjugation must occur in the backbone formed by these groups. The person skilled in the art is aware of such groups. They are formed by polymerization reaction from a group consisting of an organic double bond, an organic triple bond, an oxirane or an aziridine, or are each a non-conjugated organic group which is formed by a polymer-analogous reaction. Such groups are described, for example, in WO 2015/003725 A1.

What is essential in the context of the invention is that no conjugation, i.e. no TT electron delocalization, takes place in the main chain, i.e. the polymer backbone of P. This can be assured in that only sp³ bonds are present in the main chain or sp and sp² bonds are in such isolated form that no conjugation occurs.

The person skilled in the art knows how to distinguish conjugated systems from non-conjugated systems. For example, poly(thiophene), poly(pyridine), poly(pyrrolidine), poly(imide) are conjugated within the polymer backbone and form conjugation in the main chain, and so cannot form non-conjugated organic redox polymers. It has been found that, surprisingly, poly acetylene derivatives are also usable in the polymer backbone in the context of the invention since, although there are adjacent double bonds within this backbone, no conjugation takes place owing to the Peierls distortion.

In the context of the invention, this prerequisite with regard to non-conjugation relates merely to the backbone of the polymer P which is formed in the structures (I), (II) and (III) by the X¹, X², X³, X⁴ or X⁵ radicals and, if present, the spacer units Y¹, Y², Y³, Y⁴ or Y⁵ (defined below in section 11.1.4).

Within the redox-active functions encompassed by the polymer, i.e. within the radicals represented by the R¹, R², R⁴ or R⁵ radicals in the structures (I), (II) and (III), and, if R^{1′}, R^{2′} or R^{3′} is a redox-active radical, within these as well, it is of course possible for conjugation to occur, i.e. delocalization of the TT electrons.

### II.1.3.1

In a preferred embodiment of the second aspect of the present invention, the X¹, X², X³, X⁴, X⁵ radicals in the structures (I), (II) and (III) in the second aspect of the invention as defined in point II.1.α) and point II.1.β), and especially in the above-described cases AA.5, BB.3, CC.6, CC.7, DD.7, EE.6, GG.2, GG.3, GG.4, HH.3, JJ.2, are each independently non-conjugated organic groups that are selected from the structures (X1), (X2), (X3), (X4), (X5) defined in point I.1.3.1, preferably from the structures (X1), (X2), (X3), (X5) defined in point I.1.3.1, even more preferably from the structures (X1), (X2), (X5) defined in point I.1.3.1.

### II.1.3.2

In a preferred embodiment of the aforementioned point II.1.3.1, the X¹, X², X³, X⁴, X⁵ radicals are each independently non-conjugated organic groups that are selected from the structures (X11), (X12), (X13), (X14), (X15) defined in point I.1.3.2, preferably from the structures (X11), (X12), (X13), (X14), (X15) defined in point I.1.3.2, more preferably from the structures (X11), (X12), (X15) defined in point I.1.3.2.

### II.1.3.3

In a more preferred embodiment of the second aspect of the present invention, the X¹, X², X³, X⁴, X⁵ radicals each independently have the structure (X11) defined in point I.1.3.3.

### II.1.4 Non-Conjugated Organic Spacer Units Y¹, Y², Y³, Y⁴, Y⁵

The non-conjugated organic spacer units selectable for Y¹, Y², Y³, Y⁴, Y⁵ in the structures (I), (II) and (III) in the second aspect of the invention are accordingly not subject to any further restriction except that no conjugation must occur in the backbone formed by these groups.

### II.1.4.1

In a preferred embodiment of the second aspect of the present invention, the Y¹, Y², Y³, Y⁴, Y⁵ radicals in the structures (I), (II) and (III) in the second aspect of the invention as defined in point II.1.α) and point II.1.β), and especially in the above-described cases AA.5, BB.3, CC.6, CC.7, DD.7, EE.6, GG.2, GG.3, GG.4, HH.3, JJ.2, are each independently non-conjugated organic spacer units that are selected from the structures (Y1), (Y2), (Y3), (Y4), (Y5) defined in point I.1.4.1.

### II.1.4.2

In a preferred embodiment of the aforementioned point II.1.4.1, the Y¹, Y², Y³, Y⁴, Y⁵ radicals in the structures (I), (II) and (III) are each independently non-conjugated organic spacer units that are selected from the structures (Y1), (Y2), (Y3), (Y5) defined in point I.1.4.2, more preferably from the structures (Y1), (Y2), (Y5) defined in point I.1.4.2, even more preferably from the structures (Y1), (Y2) defined in point I.1.4.2, and most preferably have a structure (Y1) defined in point I.1.4.2.

### II.1.4.3

In a preferred embodiment of the second aspect of the invention, the X¹, X², X³, X⁴, X⁵ radicals and the Y¹, Y², Y³, Y⁴, Y⁵ radicals in the structures (I), (II) and (III) are selected as defined in point I.1.4.3.

### II.1.4.4

In an even more preferred embodiment of the second aspect of the present invention, the X¹, X², X³, X⁴, X⁵ radicals and the Y¹, Y², Y³, Y⁴, Y⁵ radicals in the structures (I), (II) and (III) are selected as defined in point I.1.4.4.

### II.1.5 Process for Preparing the Polymers P According to the Invention

The polymers P usable in the process according to the invention for producing the electrodes can be obtained by processes known to those skilled in the art. The corresponding processes are summarized in Muench et at, and are additionally described in the above point I.1.5.

### II.1.6 Crosslinkings

The polymers P usable in the process according to the invention for producing the electrodes according to the second aspect of the invention may be either homopolymers or copolymers. They may be synthesized by the use of further crosslinkers as described in point I.1.6.

### II.2 Ionic Liquids

The ionic liquids usable in step (a) of the process according to the invention for producing an electrode in the second aspect of the invention are not particularly restricted and are described, for example, in WO 2004/016631 A1, WO 2006/134015 A1, US 2011/0247494 A1 or US 2008/0251759 A1.

More particularly, the ionic liquid which is used in step (a) of the process according to the invention for producing the electrode in the second aspect of the invention has the structure Q⁺A⁻.

### II.2.1 Preferred Cations for the Ionic Liquids

Q⁺ here is a cation selected from the group consisting of the structures (Q1), (Q2), (Q3), (Q4), (Q5) defined in point I.2.1.

### II.2.2 Preferred Anions for the Ionic Liquids

In the aforementioned formula Q⁺A⁻, A⁻ is an anion, especially as defined in point I.2.2.

### II.2.3 Amount of the Ionic Liquid Used

The amount of the ionic liquid used in step (a) of the process according to the invention for production of an electrode in the second aspect of the invention is not subject to any further restriction. However, it is preferable that the total weight of the ionic liquid used in step (a) of the process according to the invention for production of an electrode, based on the total weight of the organic redox polymer P non-conjugated in the main chain which is used in step (a) of the process according to the invention for production of an electrode, is in the range of 0.1% to 1000% by weight, more preferably in the range of 1% to 500% by weight, yet more preferably in the range of 5% to 200% by weight, even more preferably in the range of 40% to 160% by weight, even more preferably in the range of 80% to 120% by weight, and is most preferably 100% by weight.

### II.3 Conductivity Additive

In step (a) of the process for producing an electrode in the second aspect of the present invention, a conductivity additive is also used.

### II.3.1 Preferred Conductivity Additives

The conductivity additive used in step (a) of the process for producing an electrode in the second aspect of the present invention is as defined in point I.3.1.

### II.3.2 Preferred Amount of the Conductivity Additives

The amount of the conductivity additive used is not subject to any further restriction. However, it is preferable that the total weight of the conductivity additive used in step (a) of the process according to the invention for production of an electrode, based on the total weight of the organic redox polymer P non-conjugated in the main chain which is used in step (a) of the process according to the invention for production of an electrode, is in the range of 0.1% to 1000% by weight, preferably in the range of 10% to 500% by weight, more preferably in the range of 30% to 100% by weight, even more preferably in the range of 40% to 80% by weight, even more preferably still in the range of 50% by weight to 60% by weight, and is most preferably 58.3% by weight.

### II.4 Binder Additive

In the process according to the invention for production of an electrode in the second aspect of the present invention, a binding additive is optionally also used.

It is indeed preferable in the process according to the invention for production of an electrode in the second aspect of the present invention to use a binding additive.

These are familiar to those skilled in the art and are especially materials having binder properties and preferably polymers selected from the group consisting of polytetrafluoroethylene, polyvinylidene fluoride, polyhexafluoropropylene, polyvinyl chloride, polycarbonate, polystyrene, polyacrylate, polymethacrylate, polysulfone, cellulose derivatives, polyurethane, and the binding additive is more preferably polyvinylidene fluoride.

In the cases in which a binding additive is used in the process according to the invention for production of an electrode in the second aspect of the present invention, the amount thereof used is not subject to any further restriction. However, it is preferable in these cases that the total weight of the ionic liquid used in step (a) of the process according to the invention for production of an electrode in the second aspect of the present invention, based on the total weight of the organic redox polymer P non-conjugated in the main chain which is used in step (a) of the process according to the invention for production of an electrode, is in the range of 0.001% to 100% by weight, more preferably in the range of 0.083% to 90% by weight, even more preferably in the range of 3% to 70% by weight, yet more preferably in the range of 5% to 50% by weight, even more preferably in the range of 8.3% to 20% by weight, and is most preferably 16.6% by weight.

### II.5 Solvent

In step (a) of the process according to the invention for production of an electrode, a solvent is optionally used, which is preferably a solvent having a high boiling point. Preferably, the solvent used in step (a) of the process according to the invention for production of an electrode in the second aspect of the invention is selected from the group consisting of N-methyl-2-pyrrolidone, water, dimethyl sulfoxide, ethylene carbonate, propylene carbonate, dimethyl carbonate, methyl ethyl carbonate, γ-butyrolactone, tetrahydrofuran, dioxolane, sulfolane, N,N′-dimethylformamide, N,N′-dimethylacetamide, and is preferably N-methyl-2-pyrrolidone.

A sufficient amount of solvent is used in step (a) of the process according to the invention for production of an electrode that the concentration of the polymer P in step (a) of the process in the resulting mixture M is in the range between 10 and 1000 mg/ml, more preferably between 50 and 500 mg/ml.

This mixing can take place in a beaker or other vessels familiar to the person skilled in the art. Step (a) of the process according to the invention for production of an electrode in the second aspect of the invention preferably takes place at a temperature in the range from −20° C., to 100° C., preferably at a temperature in the range from 0° C., to 80° C., more preferably at a temperature in the range from 15° C., to 50° C., yet more preferably at 20° C., to 30° C., most preferably at 25° C.

On conclusion of step (a) of the process according to the invention, a mixture M is obtained. This comprises at least one organic redox polymer P non-conjugated in the main chain, at least one ionic liquid, at least one conductivity additive, optionally at least one solvent and optionally at least one binding additive.

The mixture M is an electrode slurry, especially when a solvent is used in step (a) of the process.

### Step (b) of the Process According to the Invention

In step (b) of the process according to the invention for production of an electrode, the mixture M obtained in step (a) is then applied to a substrate. The mixture M can be applied as electrode slurry as a layer on the substrate by a known process for film-forming, for example by bar coating, slot die coating, screenprinting, stencil printing.

Substrates used may be the materials familiar as electrode materials to the person skilled in the art; more particularly, the substrate is selected from the group consisting of conductive materials, preferably metals, carbon materials, oxide substances, preferably metals.

Metals preferentially suitable as substrate in step (b) of the process according to the invention for producing an electrode are selected from platinum, gold, iron, copper, aluminium, zinc or a combination of these metals, aluminium being the most preferred. Preferred carbon materials suitable as substrate in step (b) of the process according to the invention for producing an electrode are selected from glassy carbon, graphite film, graphene, carbon skins. Preferred oxide substances suitable as substrate in step (b) of the process according to the invention for production of an electrode are, for example, selected from the group consisting of indium tin oxide (ITO), indium zinc oxide (IZO), antimony zinc oxide (AZO), fluorine tin oxide (FTO) or antimony tin oxide (ATO), zinc oxide (ZO).

### Step (c) of the Process According to the Invention

In an optional step (c) which is preferably performed in the process according to the invention for producing an electrode, the solvent can finally be removed, for example by drying in ambient air, for example in a drying cabinet. Step (c) may be conducted either between step (a) and step (b) or after step (b), preference being given to performance after step (b).

### III. Third Aspect of the Invention: Resultant Electrode

The present invention also relates, in a further aspect, to the electrode obtained by the process according to the invention for producing an electrode in the second aspect of the invention. This electrode has the feature that it has been uniformly permeated by the ionic liquid and hence the advantages described in point I.2 can be achieved particularly efficiently.

The present invention also relates to an electrical charge storage means, especially a secondary battery, comprising the electrode obtained from the process according to the invention in the second aspect of the invention. With regard to the general description of the charge storage means, reference is made to point I.5.2.

### IV. General Terms

In the context of the invention, the terms used, unless stated otherwise, mean the following:

### IV.1 Aliphatic Radical

An aliphatic radical in the context of the invention is an acyclic or cyclic, saturated or unsaturated, unbranched or branched hydrocarbyl group which is nonaromatic.

An aliphatic radical may be monovalent or divalent. If it is monovalent, this means that it is joined to the rest of the molecule only via one of its carbon atoms.

A monovalent aliphatic radical is especially a hydrocarbyl group selected from alkyl group, alkenyl group, alkynyl group, saturated or unsaturated cycloalkyl group, preferably an alkyl group, alkenyl group, more preferably an alkyl group.

In the presence of a double bond an unsaturated cycloalkyl group is called “cycloalkenyl group”, and in the presence of a triple bond a “cycloalkynyl group”.

A divalent aliphatic radical is joined to the rest of the molecule via two bonds proceeding from the same (in which case the bond is a spiro bond) or different carbon atoms. A divalent aliphatic radical is especially a hydrocarbyl group selected from alkylene group, alkenylene group, alkynylene group, saturated or unsaturated cycloalkylene group, preferably from alkylene group, alkenylene group, and is most preferably an alkylene group.

In the presence of a double bond an unsaturated cycloalkylene group is called “cycloalkenylene group”, and in the presence of a triple bond a “cycloalkynylene group”.

When they are not referred to explicitly as divalent in this invention, the term “aliphatic radical” in the context of this invention shall be understood to mean monovalent aliphatic radicals.

### IV.2 Alkyl Group

In the context of the invention, an “alkyl group” is unbranched or branched and is a monovalent saturated hydrocarbyl radical having the general chemical structure (a)

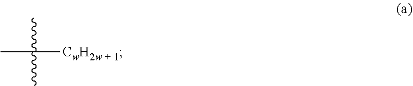

The chain of carbon atoms “—C_{w}H_{2w+1}” may be linear, in which case the group is an unbranched alkyl group. Alternatively, it may have branches, in which case it is a branched alkyl group.

In this case, w in the chemical structure (a) is an integer, especially from the range of 1 to 30, preferably from the range of 1 to 18, more preferably from the range of 1 to 12, even more preferably from the range of 1 to 10, even more preferably still from the range of 1 to 8, most preferably from the range of 1 to 6, w in an unbranched or branched alkyl group having 1 to 30 carbon atoms is selected from the range of 1 to 30, w in an unbranched or branched alkyl group having 1 to 18 carbon atoms is selected from the range of 1 to 18, w in an unbranched or branched alkyl group having 1 to 12 carbon atoms is selected from the range of 1 to 12, w in an unbranched or branched alkyl group having 1 to 10 carbon atoms is selected from the range of 1 to 10, w in an unbranched or branched alkyl group having 1 to 8 carbon atoms is selected from the range of 1 to 8, w in an unbranched or branched alkyl group having 1 to 6 carbon atoms is selected from the range of 1 to 6.

In the context of the invention, an alkyl group has especially 1 to 30, preferably 1 to 18, more preferably 1 to 12, yet more preferably 1 to 10, even more preferably 1 to 8, most preferably 1 to 6 and at the very most preferably 1 to 4 carbon atoms.

In the context of the invention, an “alkyl group having 1 to 30 carbon atoms” is especially selected from methyl, ethyl, n-propyl, iso-propyl, n-butyl, sec-butyl, iso-butyl, tert-butyl, n-pentyl, 1-methylbutyl, 2-methylbutyl, 3-methylbutyl, 1,1-dimethylpropyl, 1,2-dimethylpropyl, 2,2-dimethylpropyl, 1-ethylpropyl, n-hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethyl propyl, 1,2,2-trimethylpropyl, 1-ethyl-1-methylpropyl, 1-ethyl-2-methyl propyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-eicosyl, n-heneicosyl, n-docosyl, n-tricosyl, n-tetracosyl, n-pentacosyl, n-hexacosyl, n-heptacosyl, n-octacosyl, n-nonacosyl, n-triacontyl.

In the context of the invention, an “alkyl group having 1 to 18 carbon atoms” is especially selected from the group consisting of methyl, ethyl,

n-propyl, iso-propyl, n-butyl, sec-butyl, iso-butyl, tert-butyl, n-pentyl, 1-methylbutyl, 2-methylbutyl, 3-methylbutyl, 1,1-dimethylpropyl, 1,2-dimethylpropyl, 2,2-dimethylpropyl, 1-ethylpropyl, n-hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methyl propyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl.

In the context of the invention, an “alkyl group having 1 to 12 carbon atoms” is especially selected from the group consisting of methyl, ethyl,

n-propyl, iso-propyl, n-butyl, sec-butyl, iso-butyl, tert-butyl, n-pentyl, 1-methylbutyl, 2-methylbutyl, 3-methylbutyl, 1,1-dimethylpropyl, 1,2-dimethylpropyl, 2,2-dimethylpropyl, 1-ethylpropyl, n-hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethyl propyl, 1,2,2-trimethylpropyl, 1-ethyl-1-methylpropyl, 1-ethyl-2-methyl propyl, n-heptyl, n-octyl, n-nonyl, n-decyl, n-undecyl, n-dodecyl.

In the context of the invention, an “alkyl group having 1 to 10 carbon atoms” is especially selected from the group consisting of methyl, ethyl,

n-propyl, iso-propyl, n-butyl, sec-butyl, iso-butyl, tert-butyl, n-pentyl, 1-methylbutyl, 2-methylbutyl, 3-methylbutyl, 1,1-dimethylpropyl, 1,2-dimethylpropyl, 2,2-dimethylpropyl, 1-ethylpropyl, n-hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methyl propyl, n-heptyl, n-octyl, n-nonyl, n-decyl.

In the context of the invention, an “alkyl group having 1 to 8 carbon atoms” is especially selected from the group consisting of methyl, ethyl,

n-propyl, iso-propyl, n-butyl, sec-butyl, iso-butyl, tert-butyl, n-pentyl, 1-methylbutyl, 2-methylbutyl, 3-methylbutyl, 1,1-dimethylpropyl, 1,2-dimethylpropyl, 2,2-dimethylpropyl, 1-ethylpropyl, n-hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methyl propyl, n-heptyl, n-octyl.

In the context of the invention, an “alkyl group having 1 to 6 carbon atoms” is especially selected from the group consisting of methyl, ethyl,

n-propyl, iso-propyl, n-butyl, sec-butyl, iso-butyl, tert-butyl, n-pentyl, 1-methylbutyl, 2-methylbutyl, 3-methylbutyl, 1,1-dimethylpropyl, 1,2-dimethylpropyl, 2,2-dimethylpropyl, 1-ethylpropyl, n-hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methyl propyl.

According to the invention, an alkyl group having 1 to 30 carbon atoms is especially an alkyl group having 1 to 18, preferably 1 to 12, more preferably 1 to 10, even more preferably 1 to 8 and most preferably 1 to 6 carbon atoms.

According to the invention, an alkyl group having 1 to 6 carbon atoms is especially an alkyl group having 1 to 4 carbon atoms and more preferably selected from methyl, ethyl, n-propyl, iso-propyl, n-butyl, sec-butyl, tert-butyl, yet more preferably from methyl, ethyl, n-propyl, iso-propyl, even more preferably from methyl, ethyl, most preferably methyl.

What is meant in accordance with the invention by “where the alkyl group may in each case be substituted by at least one group selected from nitro group, —NH₂, —CN, —SH, —OH, halogen” is that the alkyl group is unsubstituted or has at least one substitution that results in a formal sense from exchange of a hydrogen radical for a group selected from nitro group, —NH₂, —CN, —SH, —OH, halogen. Most preferably, however, the alkyl group in that case is unsubstituted.

### IV.3 Alkenyl Group, Alkynyl Group

In the context of the invention, an “alkenyl group” is unbranched or branched and is obtained from an alkyl group by replacement of at least one CH—CH single bond in the alkyl group by a C═C double bond. According to the invention, an alkenyl group especially has 2 to 10 carbon atoms, preferably 2 to 6, more preferably 2 to 4, even more preferably 2 (in which case it is vinyl) or 3 (in which case it is allyl), and is most preferably vinyl.

In the context of the invention, an “alkynyl group” is unbranched or branched and is obtained from an alkyl group by replacement of at least one CH₂—CH₂ single bond in the alkyl group by a C≡C triple bond or from an alkenyl group by replacement of at least one CH═CH double bond in the alkenyl group by a CSC triple bond. According to the invention, an alkynyl group especially has 2 to carbon atoms, preferably 2 to 6, more preferably 2 to 4, even more preferably 2 (in which case it is ethynyl) or 3, and is most preferably ethynyl.

What is meant in accordance with the invention by “where the alkenyl(ene) group may in each case be substituted by at least one group selected from nitro group, —NH₂, —CN, —SH, —OH, halogen” is that the alkenyl group is unsubstituted or has at least one substitution that results in a formal sense from exchange of a hydrogen atom bonded to an sp²- or, if present, sp³-hybridized, preferably sp³-hybridized, carbon atom for a group selected from nitro group, —NH₂, —CN, —SH, —OH, halogen.

What is meant in accordance with the invention by “where the alkynyl(ene) group may in each case be substituted by at least one group selected from nitro group, —NH₂, —CN, —SH, —OH, halogen” is that the alkynyl group is unsubstituted or has at least one substitution that results in a formal sense from exchange of a hydrogen atom bonded to an sp²- or, if present, sp³-hybridized, preferably sp³-hybridized, carbon atom for a group selected from nitro group, —NH₂, —CN, —SH, —OH, halogen.

### IV.4 Cycloalkyl Group

A cycloalkyl group may be saturated or unsaturated, but is preferably saturated.

A saturated cycloalkyl group is an alkyl radical in which at least 3 carbon atoms are present within a saturated ring, and may additionally also comprise further carbon atoms not present in the ring. It may be joined to the rest of the molecule via one of these ring carbon atoms or via carbon atoms that are not within the ring. In the context of the invention, a cycloalkyl group is especially selected from cyclopropyl, cyclobutyl, cyclopropylmethyl, cyclopentyl, cyclobutylmethyl, cyclohexyl, cycloheptyl, cyclooctyl, cyclononyl, cyclodecyl, cycloundecyl, cyclododecyl, cyclotridecyl, cyclotetradecyl, cyclopentadecyl.

An unsaturated cycloalkyl group is obtained from a saturated cycloalkyl group by replacement of at least one CH—CH single bond in the saturated cycloalkyl group by at least one C═C double bond (to give the cycloalkenyl group) and/or of a CH₂—CH₂ single bond with a C≡C triple bond (to give the cycloalkynyl group).

### IV.5 Divalent Alkylene Group, Alkenylene Group, Alkynylene Group, Cycloalkenylene Group

An alkylene group in the context of the invention has especially 1 to 30, preferably 1 to 18, more preferably 1 to 12, yet more preferably 1 to 10, even more preferably 1 to 8, most preferably 1 to 6 and at the very most preferably 1 to 4 carbon atoms.

In the context of the invention, it may be branched or unbranched. “Alkylene group” in the context of the invention denotes a divalent saturated hydrocarbyl radical which can be described by the general chemical structure (b)

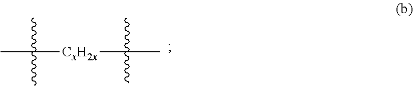

The chain of carbon atoms “—CₓH₂ₓ” may be linear, in which case the group is an unbranched alkylene group. Alternatively, it may have branches, in which case it is a branched alkylene group, x in the chemical structure (b) is an integer.

x in an unbranched or branched alkylene group having 1 to 30 carbon atoms is selected from the range of 1 to 30.

x in an unbranched or branched alkylene group having 1 to 12 carbon atoms is selected from the range of 1 to 12, x in an unbranched or branched alkylene group having 1 to 6 carbon atoms is selected from the range of 1 to 6. According to the invention, an alkylene group especially has 1 to 6 carbon atoms and preferably 1 to 4 carbon atoms and is more preferably selected from methylene, ethylene, n-propylene, n-butylene.

In the context of the invention, an “alkenylene group” is unbranched or branched and is obtained from an alkylene group by replacement of at least one CH—CH single bond in the alkylene group by a C═C double bond.

In the context of the invention, an “alkynylene group” is unbranched or branched and is obtained from an alkyl group by replacement of at least one CH₂—CH₂ single bond in the alkylene group by a C≡C triple bond or from an alkenylene group by replacement of at least one CH═CH double bond in the alkenylene group by a C≡C triple bond.

In the context of the invention, a saturated cycloalkylene group is a divalent saturated hydrocarbyl group having at least 3 and especially 3 to 30 carbon atoms and having at least one saturated ring composed of 3 to 30 carbon atoms, preferably a chemical structure (c) with

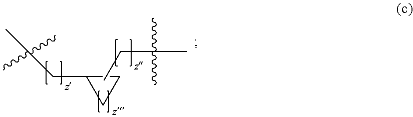

where z′ is especially an integer from 0 to 27; where z″ is especially an integer from 0 to 27; where z″ is especially an integer from 1 to 28; and where, at the same time, z′+z″+z″≤28.

In the context of the invention, an unsaturated cycloalkylene group is obtained from a saturated cycloalkylene group by replacement of at least one CH—CH single bond in the cycloalkylene group by a C═C double bond (to give the cycloalkenylene group) and/or by replacement of at least one CH₂—CH₂ single bond in the cycloalkylene group by a C≡C triple bond (to give the cycloalkynylene group).

What is meant in accordance with the invention by “where the alkenylene group may in each case be substituted by at least one group selected from nitro group, —NH₂, —CN, —SH, —OH, halogen” is that the alkenylene group is unsubstituted or has at least one substitution that results in a formal sense from exchange of a hydrogen atom bonded to an sp²- or, if present, sp³-hybridized, preferably sp³-hybridized, carbon atom for a group selected from nitro group, —NH₂, —CN, —SH, —OH, halogen.

What is meant in accordance with the invention by “where the alkynylene group may in each case be substituted by at least one group selected from nitro group, —NH₂, —CN, —SH, —OH, halogen” is that the alkynylene group is unsubstituted or has at least one substitution that results in a formal sense from exchange of a hydrogen atom bonded to an sp²- or, if present, sp³-hybridized, preferably sp³-hybridized, carbon atom for a group selected from nitro group, —NH₂, —CN, —SH, —OH, halogen.

### IV.6 Alkoxy Group

An alkoxy group has the general structure “O—C_{w}H_{2w+1}” where the “C_{w}H_{2w+1}” radical is the alkyl group described in point X.2, including the preferred embodiments specified therein for the alkyl group.

According to the invention, an alkoxy group is especially an alkyl group having 1 to 4 carbon atoms and more preferably selected from methoxy, ethoxy, n-propoxy, iso-propoxy, n-butoxy, sec-butoxy, tert-butoxy, yet more preferably from methoxy, ethoxy, n-propoxy, iso-propoxy, even more preferably from methoxy, ethoxy, most preferably methoxy.

### IV.7 (Hetero)aromatic Radical

A (hetero)aromatic radical in the context of the invention is a heteroaromatic or aromatic radical, preferably an aromatic radical.

In the context of the invention, a (hetero)aromatic radical comprises one or more (hetero)aromatic rings.

“(Hetero)aromatic” in the context of the invention means “heteroaromatic or aromatic”, preferably “aromatic”.

A (hetero)aromatic radical may be monovalent, i.e. may be bonded to the rest of the molecule via just one of its carbon atoms (in the case of an aromatic radical) or via one of its carbon atoms or heteroatoms (in the case of a heteroaromatic radical).

A (hetero)aromatic radical may alternatively be divalent, i.e. may be bonded to the rest of the molecule via two of its carbon atoms (in the case of an aromatic radical) or may be bonded to the rest of the molecule via two of its carbon atoms, two of its heteroatoms or one of its carbon atoms and one of its heteroatoms (in the case of a heteroaromatic radical).

When they are not referred to explicitly as divalent in this invention, the term “(hetero)aromatic radical” in the context of this invention shall be understood to mean monovalent (hetero)aromatic radicals.

An aromatic radical has exclusively carbon atoms and at least one aromatic ring. An aromatic radical is especially selected from aryl radical, aralkyl radical, preferably aryl radical. Aryl radicals have exclusively aromatic rings and are joined to the molecule via a carbon atom in the aromatic ring. Preferably, an aryl radical is phenyl, 9-anthryl, 9-phenanthryl, most preferably phenyl.

Aralkyl radicals are formally derived by replacement of a hydrocarbyl radical of an alkyl group with an aryl group. An aralkyl radical is preferably benzyl, phenylethyl, α-methylbenzyl.

A heteroaromatic radical is especially selected from heteroaryl radical, heteroaralkyl radical. It is a heteroaromatic radical that additionally has at least one heteroatom, especially a heteroatom selected from the group consisting of nitrogen, oxygen, sulfur, within the aromatic ring.

Preferred (hetero)aromatic radicals are selected from the group consisting of azole, imidazole, pyrrole, pyrazole, triazole, tetrazole, thiophene, furan, thiazole, thiadiazole, oxazole, oxadiazole, pyridine, pyrimidine, triazine, tetrazine, thiazine, benzofuran, purine, indole.

A divalent (hetero)aromatic radical in the context of the invention is a divalent aromatic radical or a divalent heteroaromatic radical, preferably a divalent aromatic radical.

According to the invention, a divalent aromatic radical is a divalent hydrocarbyl group having at least 6 and preferably 6 to 30 carbon atoms, of which at least 6 carbon atoms are present in an aromatic system and the other carbon atoms, if present, are saturated. The divalent aromatic radical may be joined to the rest of the molecule via carbon atoms in the aromatic system or, if present, saturated carbon atoms.

Preferably, a divalent aromatic radical is a chemical structure (d) with

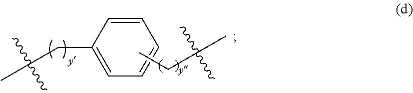

where y′ is an integer ≥0, preferably from 0 to 24; where y″ is an integer ≥0, preferably from 0 to 24; and where preferably, at the same time, y′+y″≤24.

A divalent aromatic radical in the context of the invention is preferably selected from benzylene, phenylene, most preferably phenylene.

A divalent heteroaromatic radical is a divalent aromatic radical which additionally has at least one heteroatom, especially at least one heteroatom selected from the group consisting of nitrogen, oxygen, sulfur, within or outside the aromatic ring, preferably within the aromatic ring, but is especially joined to the rest of the molecule via carbon atoms.

“Substituted or unsubstituted (hetero)aromatic radical” especially denotes unsubstituted (hetero)aromatic radical and preferably unsubstituted aromatic radical.

“Substituted (hetero)aromatic radical” in the context of the invention means more particularly that a hydrogen atom bonded to a carbon atom in the (hetero)aromatic radical in question is substituted by the substituent group specified.

What is accordingly meant by “where the (hetero)aromatic rings may each independently be substituted by at least one radical selected from the group consisting of (halo)alkyl group, alkenyl group, alkynyl group, (halo)alkoxy group, cycloalkyl group, carbonylalkyl group, —C(═O)—H, carboxylic acid radical, carboxamide, carboxylic ester, sulfonic acid, phosphoric ester, amine, mono(halo)alkylamino, di(halo)alkylamino, cyano, hydroxyl, halogen” is that the (hetero)aromatic ring is in unsubstituted form or in substituted form with a substitution which is obtained in a formal sense by exchange of a hydrogen atom on the ring for one of the radicals mentioned.

What is meant by “where the aliphatic radical may have at least one group selected from ether, thioether, amino ether, carbonyl group, carboxamide group, carboxylic ester, sulfonic ester, phosphoric ester” is:

In the case of ether, that an —O— group is present in the aliphatic radical at least between two sp³-hybridized carbon atoms of the aliphatic radical, preferably between two —CH₂— groups of the aliphatic radical, even more preferably between two —CH₂CH₂— groups of the aliphatic radical (or ring), or is absent.

In the case of thioether, that an —S— group is present in the aliphatic radical at least between two sp³-hybridized carbon atoms of the aliphatic radical, preferably between two —CH₂— groups of the aliphatic radical, even more preferably between two —CH₂CH₂— groups of the aliphatic radical (or ring), or is absent.

In the case of amino ether, that an —NR′— group with R′=H or alkyl having 1 to 10 carbon atoms group is present in the aliphatic radical at least between two sp³-hybridized carbon atoms of the aliphatic radical, preferably between two —CH₂— groups of the aliphatic radical, even more preferably between two —CH₂CH₂— groups of the aliphatic radical (or ring), or is absent.

In the case of the carbonyl group, that a —C(═O)— group is present in the aliphatic radical at least between two sp³-hybridized carbon atoms of the aliphatic radical, preferably between two —CH₂— groups of the aliphatic radical, even more preferably between two —CH₂CH₂— groups of the aliphatic radical (or ring), or is absent.

In the case of the carboxylic ester, that a —C(═O)—O— group is present in the aliphatic radical at least between two sp³-hybridized carbon atoms of the aliphatic radical, preferably between two —CH₂— groups of the aliphatic radical, even more preferably between two —CH₂CH₂— groups of the aliphatic radical (or ring), or is absent.

In the case of the carboxamide, that a —C(═O)—NH— or C(═O)—N(alkyl)- group is present in the aliphatic radical at least between two sp³-hybridized carbon atoms of the aliphatic radical, preferably between two —CH₂— groups of the aliphatic radical, even more preferably between two —CH₂CH₂— groups of the aliphatic radical (or ring), or is absent.

In the case of the sulfonic ester, that an —S(O)₂O— group is present in the aliphatic radical at least between two sp³-hybridized carbon atoms of the aliphatic radical, preferably between two —CH₂—groups of the aliphatic radical, even more preferably between two —CH₂CH₂— groups of the aliphatic radical (or ring), or is absent.

In the case of the phosphoric ester, that a group selected from —OP(═O)(O⁻(W^{d+})_{1/z})—O—, —OP(═O)(OR″)—O— is present in the aliphatic radical at least between two sp³-hybridized carbon atoms of the aliphatic radical, preferably between two —CH₂— groups of the aliphatic radical, even more preferably between two —CH₂CH₂— groups of the aliphatic radical (or ring), or is absent.

In this case, R″ is an alkyl radical, preferably having 1 to 6 carbon atoms, and W^{d+} is selected from the group consisting of alkali metal cation, where the alkali metal cation is preferably selected from the group consisting of Li⁺. Na⁺, K⁺, alkaline earth metal cation, where the alkaline earth metal cation is preferably selected from the group consisting of Mg²⁺, Ca²⁺, transition metal cation, where the transition metal cation is preferably selected from the group consisting of iron cation, zinc cation, mercury cation, nickel cation, cadmium cation, and from tetraalkylammonium cation, imidazolium cation, monoalkylimidazolium cation, dialkylimidazolium cation, where the alkyl groups in the tetraalkylammonium cation, monoalkylimidazolium cation, dialkylimidazolium cation each independently preferably have 1 to 30 carbon atoms. Moreover, d indicates the number of positive charges of W^{d+}.

Preferably, W^{d+} is selected from the group consisting of Li⁺, Na⁺, K⁺. Mg²⁺, Ca²⁺, Zn²⁺, Fe²⁺, Fe³⁺, Cd²⁺, Hg⁺, Hg²⁺, Ni²⁺, Ni³⁺, Ni⁴⁺,

where d in the case of each of Li⁺, Na⁺, K⁺, Hg⁺=1,
where d in the case of each of Mg²⁺, Ca²⁺, Zn²⁺, Cd²⁺, Hg²⁺, Ni²⁺, Fe²⁺=2,
where d in the case of each of Fe³⁺, Ni³⁺=3,
where d in the case of each of Ni⁴⁺=4.

### IV.8 Further Definitions

According to the invention, what is meant by “halogen” is especially chlorine or bromine, most preferably chlorine.

“(Halo)alkyl group” means haloalkyl group or alkyl group, preferably alkyl group.

A haloalkyl group results in a formal sense from an alkyl group via exchange of at least one carbon-bonded hydrogen atom by a halogen atom, preferably Br or Cl, more preferably Cl.

“(Halo)alkoxy group” means haloalkoxy group or alkoxy group, preferably alkoxy group.

A haloalkoxy group results in a formal sense from an alkoxy group via exchange of at least one carbon-bonded hydrogen atom by a halogen atom, preferably Br or Cl, more preferably Cl.

According to the invention, “(semi)metal compounds” means compounds of the metals and semimetals with one another or with other elements. (Semi)metal compounds are especially selected from oxides and sulfides of zinc, iron, copper, chromium, nickel, tin, indium, arsenides of germanium, gallium, or substances such as indium tin oxide (ITO), indium zinc oxide (IZO), antimony zinc oxide (AZO), fluorine tin oxide (FTO) or antimony tin oxide (ATO).

“Carboxyalkyl” is obtainable in a formal sense via exchange of a “—CH₂—”-group in an alkyl group for a “—C(═O)—” group.

### V. Examples

### V.1 Chemicals and Methods

All solvents and materials were sourced from commercial manufacturers and used without further purification. In the experiments, the following two polymers (P1) and (P2) were used:

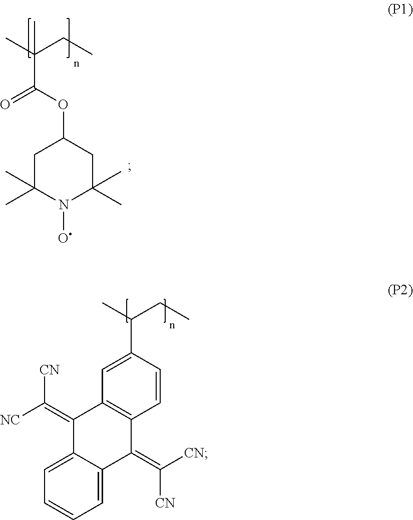

(P1) was synthesized according to WO 2018/046387 A1, with addition of triethylene glycol dimethacrylate for crosslinking in the synthesis.

(P2) was synthesized according to WO 2015/132374 A1.

The production of the carbon pastes was conducted with laboratory dissolvers (VMA Getzmann). The substrate films were coated by means of an automatic coating bar (Elcometer) and dried in an air circulation drying cabinet. Films containing electrolyte salts were stored in a glovebox. The discharge capacities reported in Table 1 were obtained by means of galvanostatic discharge on a Maccor Battery Cycler.

### V.2 Comparative Examples V1 and V2

### V.2.1 Comparative Example V1: Production of an Electrode with Polymer P1

PVDF (polyvinylidene fluoride, 140 mg) was added to NMP (N-methyl-2-pyrrolidone) and stirred by means of a laboratory dissolver for one hour. Subsequently, polymer P1 (1.68 g) and, after a further hour, Super P (carbon black, obtained from “Timcal”; 0.98 g) were added. After the addition of Super P, the dispersion was likewise stirred for one hour and then applied to aluminium foil. The resultant electrode was dried in an air circulation drying cabinet. The proportion of the active material on the electrodes was determined on the basis of the masses of dried electrodes.

### V.2.2 Comparative Example V2: Production of an Electrode with Polymer P2

PVDF (polyvinylidene fluoride, 140 mg) was added to NMP (N-methyl-2-pyrrolidone) and stirred by means of a laboratory dissolver for one hour. Subsequently, polymer P2 (1.68 g) and, after a further hour, Super P (0.98 g) were added. After the addition of Super P, the dispersion was likewise stirred for one hour and then applied to aluminium foil. The resultant electrode was dried in an air circulation drying cabinet. The proportion of the active material on the electrodes was determined on the basis of the masses of dried electrodes.

### V.3 Inventive Examples E1 and E2

### V.3.1 Inventive Example E1: Production of an Electrode with Polymer P1 and IL

PVDF (polyvinylidene fluoride, 140 mg) was added to a solution of NMP (N-methyl-2-pyrrolidone) and EMIM OTf (1-ethyl-3-methylimidazolium trifluoromethanesulfonate, 1.68 g) and stirred by means of a laboratory dissolver for one hour. Subsequently, polymer P1 (1.68 g) and, after a further hour, Super P (0.98 g) were added. After the addition of Super P, the dispersion was likewise stirred for one hour and then applied to aluminium foil. The resultant electrode was dried in an air circulation drying cabinet. The proportion of the active material on the electrodes was determined on the basis of the masses of dried electrodes.

### V.3.2 Inventive Example E2: Production of an Electrode with Polymer P2 and IL

PVDF (polyvinylidene fluoride, 140 mg) was added to a solution of NMP (N-methyl-2-pyrrolidone) and EMIM OTf (1-ethyl-3-methylimidazolium trifluoromethanesulfonate, 1.68 g) and stirred by means of a laboratory dissolver for one hour. Subsequently, polymer P2 (1.68 g) and, after a further hour, Super P (0.98 g) were added. After the addition of Super P, the dispersion was likewise stirred for one hour and then applied to aluminium foil. The resultant electrode was dried in an air circulation drying cabinet. The proportion of the active material on the electrodes was determined on the basis of the masses of dried electrodes.

### V.4 Production of Button Cells

The button cells (circular, 2032 type) were constructed under an argon atmosphere. Suitable electrodes were die-cut (diameter 15 mm). The electrode being used as anode was positioned at the base of a button cell and separated from the cathode with the and of a separator (glass microfibres, Whatman GF/A). Subsequently positioned atop the cathode were a stainless steel weight (diameter: 15.5 mm, thickness: 0.3 mm, MIT Corporation) and a stainless steel spring (diameter: 14.5 mm, thickness: 5 mm).

The button cell was filled with electrolyte (see Table 1) and covered with the lid before being closed with an electrical compression machine.

Electrolyte 1: a 1 M solution of LiPF₆ in a mixture of ethylene carbonate (“EC”)/diethylene carbonate (“DEC”) [3:7 (v/v)];

Electrolyte 2: mixture of ethylene carbonate/diethylene carbonate [3:7 (v/v)];

Electrolyte 3: ionic liquid (EMIM TFSI=1-ethyl-3-methylimidazolium bis[trifluoromethanesulfonyl]imide).

TABLE 1
Discharge capacities of button cells

Electrode combination
(cathode/anode)

| | | V1/V2 | E1/E2 |
|---|---|---|---|
| Relative | Electrolyte 1 | 100% | 110% |
| discharge | Electrolyte 2 | 0% | 90% |
| capacity | Electrolyte 3 | 15% | 75% |

The discharge capacities reported in Table 1 were obtained by means of galvanostatic discharge on a Maccor Battery Cycler. The capacity of the electrode having the lower capacity was used here as limiting capacity for the calculation of the charge/d is charge current. The values reported in Table 1 correspond to the relative discharge capacities of the first cycle. This was done using the capacity of a cell with electrodes from example V1/V2 and 1 M LiPF₆ in EC/DEC (3/7) of ˜ 0.1 mAh as reference (100%). Various electrolytes were tried.

It can be seen from the results that the electrode material according to the present invention achieves a distinctly higher discharge capacity. This is observed for various electrolytes.

1: An electrode material, comprising:
at least one conductivity additive,
at least one ionic liquid, and
at least one organic redox polymer P which is non-conjugated in the main chain of the at least one organic redox polymer P.

2: The electrode material according to claim 1, wherein the at least one organic redox polymer P comprises:
n¹ mutually joined repeat units of the chemical structure (I), and/or
n² mutually joined repeat units of the chemical structure (II), and/or
n³ mutually joined repeat units of the chemical structure (III): 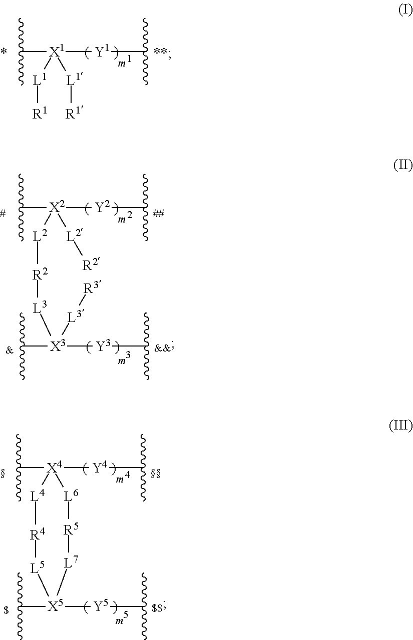
wherein n¹, n², and n³ are each independently an integer ≥4,
wherein m¹, m², m³, m⁴, and m⁵ are each independently an integer ≥0,
wherein the mutually joined repeat units of the chemical structure (I) within the at least one organic redox polymer P are the same or at least partly different from one another,
wherein the mutually joined repeat units of the chemical structure (II) within the at least one organic redox polymer P are the same or at least partly different from one another,
wherein the mutually joined repeat units of the chemical structure (III) within the at least one organic redox polymer P are the same or at least partly different from one another,
wherein the mutually joined repeat units of the chemical structure (I) within the at least one organic redox polymer P are bonded to one another in such a way that the bond indicated by “**” in a particular repeat unit is joined by the bond indicated by “*” in the adjacent repeat unit,
wherein the mutually joined repeat units of the chemical structure (II) within the at least one organic redox polymer P are joined to one another in such a way that the bond indicated by “##” in a particular repeat unit is joined by the bond indicated by “#” in the adjacent repeat unit and the bond indicated by “&&” in a particular repeat unit is joined by the bond indicated by “&” in the adjacent repeat unit,
wherein the mutually joined repeat units of the chemical structure (III) within the at least one organic redox polymer P are joined to one another in such a w ay that the bond indicated by “§§” in a particular repeat unit is joined by the bond indicated by “§” in the adjacent repeat unit and the bond indicated by “$$” in a particular repeat unit is joined by the bond indicated by “$” in the adjacent repeat unit,
wherein X¹, X², X³, X⁴, and X⁵ are each independently a non-conjugated organic group formed by polymerization reaction from die group consisting of an organic double bond, an organic triple bond, an oxirane, an aziridine, and a non-conjugated organic group which is formed by a polymer-analogous reaction,
wherein Y¹, Y², Y³, Y⁴, mid Y⁵ are each independently a non-conjugated organic spacer unit,
wherein L¹, L², L³, L⁴, L⁵, L⁶, L⁷, L^{1′}, L^{2′}, and L^{3′} are each independently selected from the group consisting of direct bond and organic linker unit, and
wherein R¹, R², R⁴, R⁵, R^{1′}, R^{2′}, and R^{3′} are each independently organic redox-active groups, and
optionally, wherein R^{1′}, R^{2′}, and R^{3′} are each independently a hydrogen radical.

3: The electrode material according to claim 2, wherein R¹, R², R⁴, R⁵, R^{1′}, R^{2′}, and R^{3′} in the chemical structure (I), the chemical structure (II), and the chemical structure (III) are independently organic redox-active groups selected from the group consisting of redox-active aromatic imide function (A), redox-active organic function comprising at least one stable oxy gen radical (B), redox-active anthraquinone/carbazole function (C), redox-active dialkoxybenzene function (D), redox-active benzoquinone function (E), redox-active triphenylamine function (G), redox-active viologen function (H), mid redox-active ferrocene function (J), and
optionally, wherein R^{1′}, R^{2′}, and R^{3′} are each independently a hydrogen radical.

4: The electrode material according to claim 3, wherein, in the cases in which the R¹, R², R⁴, R⁵, R^{1′}, R^{2′}, and R^{3′} radicals in the chemical structure (I), the chemical structure (II), and the chemical structure (III) are each a redox-active aromatic imide function (A), the R¹, R², R⁴, R⁵, R^{1′}, R^{2′}, and R^{3′} radicals each independently and optionally have the following structure (A1) and the R², R⁴, and R⁵ radicals also independently have the following structure (A2): 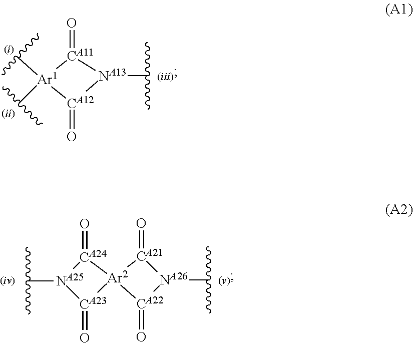
wherein the Ar¹ radical in (A1) or the Ar² radical in (A2) is in each case independently a (hetero)aromatic radical comprising one or more (hetero)aromatic rings,
optionally, wherein the one or more (hetero)aromatic rings of Ar¹ in (A1) or the one or more (hetero)aromatic rings of Ar² in (A2) are each independently substituted by at least one radical selected from the group consisting of (halo)alkyl group, alkenyl group, alkynyl group, (halo)alkoxy group, cycloalkyl group, carbonylalkyl group, —C(═O)—H, carboxylic acid radical, carboxamide, carboxylic ester, sulfonic ester, phosphoric ester, amine, mono(halo)alkylamino, di(halo)alkylamino, cyano, hydroxyl, and halogen,
wherein, in (A1), two atoms in the one or more (hetero)aromatic rings of Ar¹, in each case together with the two carbon atoms C^{AU} and C^{A12} and the nitrogen atom N^{A13}, form a five-membered ring, six-membered ring, or seven-membered ring,
wherein, in (A2), two atoms in the one or more (hetero)aromatic rings of Ar², in each case together with the two carbon atoms C^{A21} and C^{A22} and the nitrogen atom N^{A26}, form a five-membered ring, six-membered ring, or seven-membered ring, and two different atoms in the one or more (hetero)aromatic rings of Ar, in each case together with the two carbon atoms C^{An} and C^{A24} and the nitrogen atom N^{A25}, form a five-membered ring, six-membered ring, or seven-membered ring,
wherein two aromatic carbon atoms in the same one or more (hetero)aromatic rings of Ar¹ or optionally, two aromatic carbon atoms of the same one or more (hetero)aromatic rings of Ar are also bridged to one another via a divalent aliphatic radical,
wherein, in the case that the Ar¹ radical comprises multiple (hetero)aromatic rings, the multiple (hetero)aromatic rings optionally are at least partly fused to one another in Ar¹,
wherein, in the case that the Ar² radical comprises multiple (hetero)aromatic rings, the multiple (hetero)aromatic rings optionally are at least partly fused to one another in Ar²,
wherein, in the case that the Ar¹ radical comprises multiple (hetero)aromatic rings, two aromatic carbon atoms from different (hetero)aromatic rings in Ar¹ are optionally also bridged via a direct bond, or a radical, selected from the group consisting of heteroatom and divalent aliphatic radical,
wherein, in the case that the Ar² radical comprises multiple (hetero)aromatic rings, two aromatic carbon atoms from different (hetero)aromatic rings in Ar² are optionally also bridged via a direct bond, or a radical, selected from the group consisting of heteroatom and divalent aliphatic radical,
wherein the bonds (i) and (ii) proceed from aromatic carbon atoms of Ar¹, wherein,
in the case that R¹=(A1), one of the bonds indicated by (i), (ii), and (iii) is the bond to L¹,
in the case that R^{1′}=(A1), one of the bonds indicated by (i), (ii), and (iii) is the bond to L^{1′},
in the case that R^{2′}=(A1), one of the bonds indicated by (i), (ii), and (iii) is the bond to L^{2′},
in the case that R^{3′}=(A1), one of the bonds indicated by (i), (ii), and (iii) is the bond to L^{3′},
in the case that R²=(A1), one of the bonds indicated by (i), (ii), and (iii) is the bond to L² and another of the bonds indicated by (i), (ii), and (iii) is the bond to L³,
in the case that R⁴=(A1), one of the bonds indicated by (i), (ii), and (iii) is the bond to L⁴ and another of the bonds indicated by (i), (ii), and (iii) is the bond to L⁵,
in the case that R⁵=(A1), one of the bonds indicated by (i), (ii), and (iii) is the bond to L⁶ and another of the bonds indicated by (i), (ii), and (iii) is the bond to L⁷,
in the case that R²=(A2), the bond indicated by (iv) is the bond to L² and the bond indicated by (v) is the bond to L³,
in the case that R⁴=(A2), the bond indicated by (iv) is the bond to L⁴ and the bond indicated by (v) is the bond to L⁵,
in the case that R⁵=(A2), the bond indicated by (iv) is the bond to L⁶ and the bond indicated by (v) is the bond to L⁷,
wherein each of the bonds indicated by (i) and (ii) that are not a bond to L¹, L², L³, L⁴, L⁵, L⁶, L⁷, L^{1′}, L^{2′} or L^{3′} are each independently bonded to a radical selected from the group consisting of hydrogen, (halo)alkyl group, alkenyl group, alkynyl group, (halo)alkoxy group, cycloalkyl group, carbonylalkyl, —C(═O)—H, carboxylic acid radical, carboxamide, carboxy lie ester, sulfonic ester, phosphoric ester, amine, mono(halo)alkylamino, di(halo)alkylamino, cyano, hydroxyl, and halogen,
wherein the bond indicated by (iii), if it is not a bond to L¹, L², L³, L⁴, L⁵, L⁶, L⁷, L^{1′}, L^{2′}, or L^{3′}, is bonded to a radical selected from the group consisting of hydrogen, (halo)alkyl group, alkenyl group, alkynyl group, (halo)alkoxy group, cycloalkyl group, carbonylalkyl, —C(═O)—H, carboxylic acid radical, carboxamide, carboxylic ester, cyano, hydroxyl, and halogen;
wherein, in the cases in which the R¹, R², R⁴, R⁵, R^{1′}, R^{2′}, and R^{3′} radicals in the chemical structure (I), the chemical structure (II), or the chemical structure (III) are each a redox-active function comprising at least one stable oxygen radical (B), and the R¹, R², R⁴, R⁵, R^{1′}, R^{2′}, and R^{3′} radicals are each independently one of the following structures (B1) or (B2): 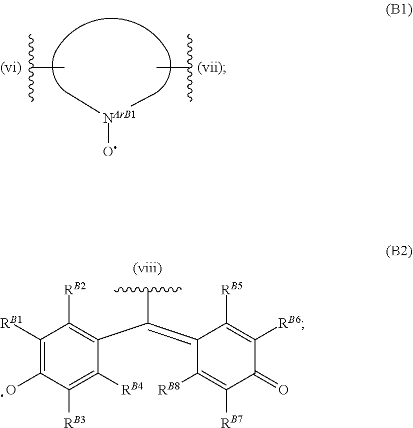
wherein, in the structure (B1), the nitrogen atom N^{ArB1} is part of an aliphatic ring Ar^{B1} which, as well as the nitrogen atom N^{ArB1}, optionally comprises further heteroatoms and groups comprising heteroatoms, and which is optionally fused to one or more further aliphatic or aromatic rings and bonded via a spiro bond to one or more further aliphatic rings, each of which in turn optionally have further heteroatoms and groups containing heteroatoms,
wherein at least one ring carbon atom of the aliphatic ring Ar^{B1} is optionally substituted by a group selected from the group consisting of (halo)alkyl group, alkenyl group, alkynyl group, (halo)alkoxy group, cycloalkyl group, carbonylalkyl, —C(═O)—H, carboxylic acid, carboxamide, carboxylic ester, sulfonic ester, phosphoric ester, amine, mono(halo)alkylamino, di(halo)alkylamino, cyano, hydroxyl, and halogen,
wherein the bonds indicated by (vi) and (vii) proceed from ring carbon atoms of the aliphatic ring Ar^{B1} and/or from ring carbon atoms of the one or more further aliphatic or aromatic rings fused to Ar^{B1} or bonded via a spiro bond,
wherein, in the case that R¹=(B1), the bond indicated by (vi) is the bond to L¹ and the bond indicated by (vii) is a bond to hydrogen,
wherein, in the case that R^{1′}=(B1), the bond indicated by (vi) is the bond to L^{1′} and the bond indicated by (vii) is a bond to hydrogen,
wherein, in the case that R^{2′}=(B1), the bond indicated by (vi) is the bond to L^{2′} and the bond indicated by (vii) is a bond to hydrogen,
wherein, in the case that R^{3′}=(B1), the bond indicated by (vi) is the bond to L^{3′} and the bond indicated by (vii) is a bond to hydrogen,
wherein, in the case that R²=(B1), the bond indicated by (vi) is the bond to L² and the bond indicated by (vii) is the bond to L³,
wherein, in the case that R⁴=(B1), the bond indicated by (vi) is the bond to L⁴ and the bond indicated by (vii) is the bond to L⁵,
wherein, in the case that R⁵=(B1), the bond indicated by (vi) is the bond to L⁶ and the bond indicated by (vii) is the bond to L⁷,
wherein, in the case that R¹, R^{1′}, R^{2′}, or R^{3′}=(B2), the bond indicated by (viii) is the bond to L¹, L^{1′}, L^{2′}, or L^{3′} and R^{B1}, R^{B2}, R^{B3}, R^{B4}, R^{B5}, R^{B6}, R^{B7}, and R^{B8} are each independently selected from the group consisting of hydrogen, (halo)alkyl group, alkenyl group, alkynyl group, (halo)alkoxy group, cycloalkyl group, carbonylalkyl, —C(═O)—H, carboxylic acid, carboxamide, carboxylic ester, sulfonic ester, phosphoric ester, amine, mono(halo)alkylamino, di(halo)alkylamino, cyano, hydroxyl, and halogen,
wherein, in the case that R², R⁴, or R⁵=(B2), the bond indicated by (viii) is the bond to L², L⁴, or L⁶ and one of the R^{B7} and R^{B8} radicals is a direct bond to L³, L⁵, or L⁷, wherein in that case the R^{B1}, R^{B2}, R^{B3}, R^{B4}, R^{B5}, and R^{B6} radicals and one of the two R^{B7} and R^{B8} radicals that is not the direct bond to L³, L⁵ or L⁷ is in each case independently selected from the group consisting of hydrogen, (halo)alkyl group, alkenyl group, alkynyl group, (halo)alkoxy group, cycloalkyl group, carbonylalkyl, —C(═O)—H, carboxylic acid, carboxamide, carboxylic ester, sulfonic ester, phosphoric ester, amine, mono(halo)alkylamino, di(halo)alkylamino, cyano, hydroxyl, and halogen;
wherein, in the cases in which the R¹, R², R⁴, R⁵, R^{1′}, R^{2′}, and R^{3′} radicals in the chemical structure (I), the chemical structure (II), and the chemical structure (III) are each a redox-active anthraquinone/carbazole function (C), the R¹, R^{1′}, R^{2′}, and R^{3′} radicals are each independently selected from the group consisting of the structures (C1) and (C2), and the R², R⁴, and R³ radicals are each independently selected from the group consisting of the structures (C3) and (C4): 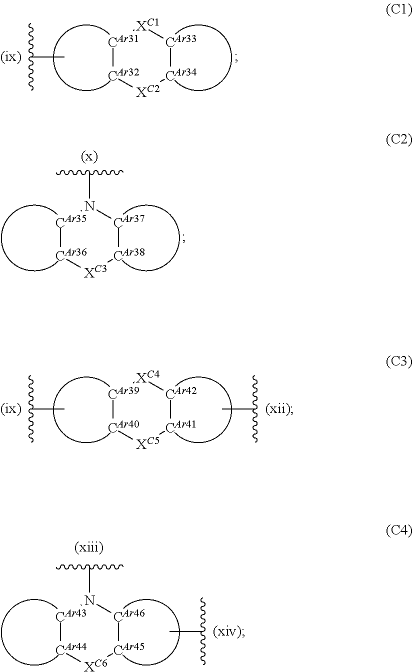
wherein, in the structure (C1), the carbon atoms represented by C^{Ar31} and C^{Ar32} are part of a (hetero)aromatic five-membered ring or six-membered ring, wherein at least one of the carbon atoms other than C^{Ar31} and C^{Ar32}, and, if present, at least one nitrogen atom in the (hetero)aromatic five-membered ring or six-membered ring is optionally may be substituted by a substituent selected from the group consisting of (halo)alkyl group, alkenyl group, alkynyl group, (halo)alkoxy group, cycloalkyl group, carbonylalkyl, —C(═O)—H, carboxylic acid, carboxamide, carboxylic ester, sulfonic ester, phosphoric ester, amine, mono(halo)alkylamino, di(halo)alkylamino, cyano, hydroxyl, and halogen,
wherein, in the structure (C1), the carbon atoms represented by C^{Ar33} and C^{Ar34} are part of a (hetero)aromatic five-membered ring or six-membered ring, wherein at least one of the carbon atoms other than C^{Ar33} and C^{Ar34} and, if present, at least one nitrogen atom in the (hetero)aromatic five-membered ring or six-membered ring is optionally may be substituted by a substituent selected from the group consisting of (halo)alkyl group, alkenyl group, alkynyl group, (halo)alkoxy group, cycloalkyl group, carbonylalkyl, —C(═O)—H, carboxylic acid, carboxamide, carboxylic ester, sulfonic ester, phosphoric ester, amine, mono(halo)alkylamino, di(halo)alkylamino, cyano, hydroxyl, and halogen,
wherein, in the structure (C2), the carbon atoms represented by C^{Ar35} and C^{Ar36} or by C^{Ar37} and C^{Ar38} are each part of a (hetero)aromatic five-membered ring or six-membered ring, wherein at least one of the carbon atoms other than C^{Ar35}, C^{Ar36}, C^{Ar37}, and C^{Ar38} and, if present, at least one nitrogen atom in the (hetero)aromatic five-membered ring or six-membered ring is optionally substituted by a substituent selected from the group consisting of (halo)alkyl group, alkenyl group, alkynyl group, (halo)alkoxy group, cycloalkyl group, carbonylalkyl, —C(═O)—H, carboxylic acid, carboxamide, carboxylic ester, sulfonic ester, phosphoric ester, amine, mono(halo)alkylamino, di(halo)alkylamino, cyano, hydroxyl, and halogen,
wherein, in the structure (C3), the carbon atoms represented by C^{Ar39} and C^{Ar40} or C^{Ar41} and C^{Ar42} are each part of a (hetero)aromatic five-membered ring or six-membered ring, wherein at least one of the carbon atoms other than C^{Ar39}, C^{Ar40}, C^{Ar41}, and C^{Ar42} and, if present, at least one nitrogen atom in the (hetero)aromatic five-membered ring or six-membered ring is optionally substituted by a substituent selected from the group consisting of (halo)alkyl group, alkenyl group, alkynyl group, (halo)alkoxy group, cycloalkyl group, carbonylalkyl, —C(═O)—H, carboxylic acid, carboxamide, carboxylic ester, sulfonic ester, phosphoric ester, amine, mono(halo)alkylamino, di(halo)alkylamino, cyano, hydroxyl, and halogen,
wherein, in the structure (C4), the carbon atoms represented by C^{Ar43} and C^{Ar44} are part of a (hetero)aromatic five-membered ring or six-membered ring, wherein at least one of the carbon atoms other than C^{Ar43} and C^{Ar44} and, if present, at least one nitrogen atom in the (hetero)aromatic five-membered ring or six-membered ring is optionally substituted by a substituent selected from the group consisting of (halo)alkyl group, alkenyl group, alkynyl group, (halo)alkoxy group, cycloalkyl group, carbonylalkyl, —C(═O)—H, carboxylic acid, carboxamide, carboxylic ester, sulfonic ester, phosphoric ester, amine, mono(halo)alkylamino, di(halo)alkylamino, cyano, hydroxyl, and halogen,
wherein, in the structure (C4), the carbon atoms represented by C^{Ar45} and C^{Ar46} are part of a (hetero)aromatic five-membered ring or six-membered ring, wherein at least one of the carbon atoms other than C^{Ar45} and C^{Ar46} and, if present, at least one nitrogen atom in the (hetero)aromatic five-membered ring or six-membered ring is optionally substituted by a substituent selected from the group consisting of (halo)alkyl group, alkenyl group, alkynyl group, (halo)alkoxy group, cycloalkyl group, carbonylalkyl, —C(═O)—H, carboxylic acid, carboxamide, carboxylic ester, sulfonic ester, phosphoric ester, amine, mono(halo)alkylamino, di(halo)alkylamino, cyano, hydroxy 1, and halogen,
wherein X^{C1}, X^{C2}, X^{C3}, X^{C4}, X^{C5}, and X^{C6} are each independently selected from the group consisting of —C(═Y^{C1})—, —O—, —S—, —NH—, —N(haloalkyl)-, and —N(alkyl)-,
wherein X^{C2}, X^{C3}, X^{C5}, and X^{C6} are optionally also each a direct bond,
wherein X^{C1} and X^{C4} are optionally also in each case a group of the general formula (α^{C1})—C(═O)—C(═O)-(β^{C1}),
wherein (α^{C1}) denotes the bond to C^{Ar31} or C^{Ar39} and (β^{C1}) indicates the bond to C^{Ar33} or C^{Ar42},
wherein Y^{C1} is selected from the group consisting of O, S, and one of the structures (Y^{C11}), (Y^{C12}), and (Y^{C3}); 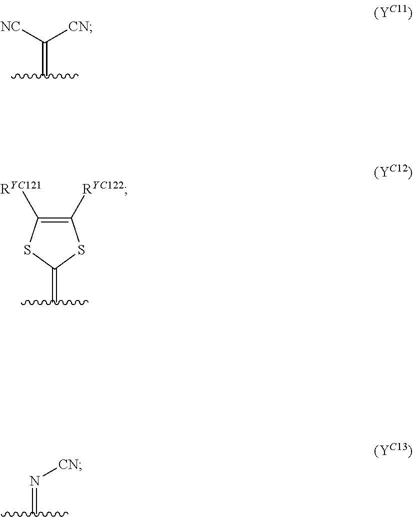
wherein R^{YC121} and R^{YC122} are each independently selected from the group consisting of hydrogen, (halo)alkyl group, alkenyl group, alkynyl group, (halo)alkoxy group, cycloalkyl group, carbonylalkyl, —C(═O)—H, carboxylic acid, carboxamide, carboxylic ester, sulfonic ester, phosphoric ester, amine, mono(halo)alkylamino, di(halo)alkylamino, cyano, hydroxyl, and halogen,
wherein the (hetero)aromatic five-membered ring or six-membered ring comprising C^{Ar31} and C^{Ar32} is optionally bridged to the (hetero)aromatic five-membered ring or six-membered ring comprising C^{Ar33} and C^{Ar34}, in addition to X^{C1} and X^{C2}, via a further divalent organic radical,
wherein the (hetero)aromatic five-membered ring or six-membered ring comprising C^{Ar39} and C^{Ar40} is optionally bridged to the (hetero)aromatic five-membered ring or six-membered ring comprising C^{Ar41} and C^{Ar42}, in addition to X^{C4} and X^{C5}, via a further divalent organic radical,
wherein the bond indicated by (ix) proceeds from one of the atoms that form the (hetero)aromatic five-membered or six-membered ring including C^{Ar31} and C^{Ar32},
wherein the bond indicated by (xi) proceeds from one of the atoms that form the (hetero)aromatic five-membered or six-membered ring including C^{Ar39} and C^{Ar40},
wherein the bond indicated by (xii) proceeds from one of the atoms that form the (hetero)aromatic five-membered or six-membered ring including C^{Ar41} and C^{Ar42},
wherein the bond indicated by (xiv) proceeds from one of the atoms that form the (hetero)aromatic five-membered or six-membered ring including C^{Ar45} and C^{Ar46},
wherein,
in the case that R¹=(C1) or (C2), the bonds indicated by (ix) or (x) are in each case the bond to L¹,
in the case that R^{1′}=(C1) or (C2), the bonds indicated by (ix) or (x) are in each case the bond to L^{1′},
in the case that R^{2′}=(C1) or (C2), the bonds indicated by (ix) or (x) are in each case the bond to L^{2′},
in the case that R^{3′}=(C1) or (C2), the bonds indicated by (ix) or (x) are in each case the bond to L^{3′},
in the case that R²=(C3) or (C4), the bonds indicated by (xi) or (xiii) are in each case the bond to L² and the bonds indicated by (xii) or (xiv) are in each case the bond to L³,
in the case that R⁴=(C3) or (C4), the bonds indicated by (xi) or (xiii) are in each case the bond to L⁴ and the bonds indicated by (xii) or (xiv) are in each case the bond to L⁵,
in the case that R⁵=(C3) or (C4), the bonds indicated by (xi) or (xiii) are in each case the bond to L⁶ and the bonds indicated by (xii) or (xiv) are in each case the bond to L⁷:
wherein, in the cases in which the R¹, R², R⁴, R⁵, R^{1′}, R^{2′}, and R^{3′} radicals in the chemical structure (I), the chemical structure (II), and the chemical structure (III) are each a redox-active dialkoxybenzene function (D), the R¹, R^{1′}, R^{2′}, and R^{3′} radicals each independently have the following structure (D1) and R², R⁴, and R⁵ each independently have the following structure (D2): 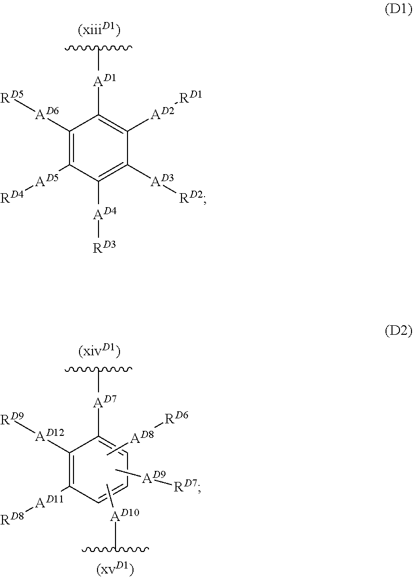
wherein,
in the case that R¹=(D1), the bond indicated by (xiii^{D1}) is the bond to L¹,
in the case that R^{1′}=(D1), the bond indicated by (xiii^{D1}) is the bond to L^{1′},
in the case that R^{2′}=(D1), the bond indicated by (xiii^{D1}) is the bond to L^{2′},
in the case that R^{3′}=(D1), the bond indicated by (xiii^{D1}) is the bond to L^{3′},
in the case that R²=(D2), the bond indicated by (xiv^{D1}) is the bond to L² and the bond indicated by (xv^{D1}) is the bond to L³,
in the case that R⁴=(D2), the bond indicated by (xiv^{D1}) is the bond to L⁴, and the bond indicated by (xv^{D1}) is the bond to L⁵,
in the case that R⁵=(D2), the bond indicated by (xiv^{D1}) is the bond to L⁶, and the bond indicated by (xv^{D1}) is the bond to L⁷,
wherein at least two of the A^{D1}, A^{D2}, A^{D3}, A^{D4}, A^{D5}, and A^{D6} radicals are each independently selected from the group consisting of —O— and —S— and the others of the A^{D1}, A^{D2}, A^{D3}, A^{D4}, A^{D5}, and A^{D6} radicals are each a direct bond,
wherein at least two of the A^{D7}, A^{D8}, A^{D9}, A^{D10}, A^{D11}, and A^{D12} radicals are each independently selected from the group consisting of —O— and —S— and the others of the A^{D7}, A^{D8}, A^{D9}, A^{D10}, A^{D11}, and A^{D12} radicals are each a direct bond,
wherein the R^{D1}, R^{D2}, R^{D3}, R^{D4}, R^{D5}, R^{D6}, R^{D7}, R^{D8}, and R^{D9} radicals are each independently selected from the group consisting of hydrogen, (hetero)aromatic radical, alkyl group, alkenyl group, alkynyl group, and cycloalkyl group,
optionally, wherein the (hetero)aromatic radical, the alkyl group, the alkenyl group, the alkynyl group, and the cycloalkyl group arg each substituted by at least one radical selected from the group consisting of nitro group, —NH₂, —CN, —SH, —OH, and halogen,
wherein the alkyl group, the alkenyl group, the alkynyl group, and the cycloalkyl group optionally have at least one group selected from the group consisting of ether, thioether, amino ether, carbonyl group, carboxylic ester, carboxamide group, sulfonic ester, and phosphoric ester,
wherein at least two radicals of the R^{D1}, R^{D2}, R^{D3}, R^{D4}, and R^{D5} radicals or of the R^{D6}, R^{D7}, R^{D8}, and R^{D9} radicals are optionally each also bridged by a divalent aliphatic radical, wherein the aliphatic radical is optionally may be substituted by at least one group selected from the group consisting of nitro group, —NH₂, —CN, —SH, —OH, halogen, and alkyl group and optionally have at least one group selected from the group consisting of ether, thioether, amino ether, carbonyl group, carboxylic ester, carboxamide group, sulfonic ester, and phosphoric ester,
wherein the R^{D1} radical in the case that A^{D2}=direct bond, the R^{D2} radical in the case that A^{D3}=direct bond, the R^{D3} radical in the case that A^{D4}=direct bond, the R^{D4} radical in the case that A^{D5}=direct bond, the R^{D5} radical in the case that A^{D6}=direct bond, the R^{D6} radical in the case that A^{D8}=direct bond, the R^{D7} radical in the case that A^{D9}=direct bond, the R^{D8} radical in the case that A^{D11}=direct bond, and the R^{D9} radical in the case that A^{D12}=direct bond optionally are each independently selected from the group consisting of nitro group, —CN, —F, —Cl, —Br, —I, —C(═O)NHR^{D13}, —NR^{D14}R^{D15}, —COOR^{D16}, and —COR^{D17},
wherein R^{D13}, R^{D14}, R^{D15}, R^{D16}, and R^{D17} are each independently selected from the group consisting of hydrogen, (hetero)aromatic radical, and aliphatic radical, optionally substituted by at least one group selected from the group consisting of nitro group, —NH₂, —CN, —SH, —OH, and halogen, and optionally having at least one group selected from the group consisting of ether, thioether, amino ether, carbonyl group, carboxylic ester, carboxamide group, sulfonic ester, and phosphoric ester;
wherein, in the cases in which the R¹, R², R⁴, R⁵, R^{1′}, R^{2′}, and R^{3′} radicals in the chemical structure (I), the chemical structure (II), and the chemical structure (III) are each a redox-active benzoquinone function (E), the R¹, R^{1′}, R^{2′}, and R^{3′} radicals are each independently selected from the structures (E1), (E2), and (E3): 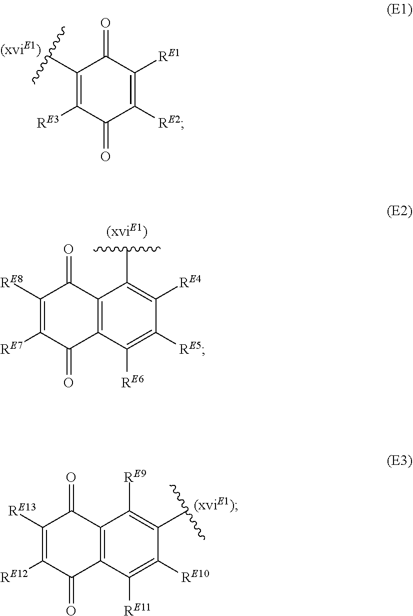
and the R², R⁴, and R⁵ radicals are each independently selected from the group consisting of the structures (E4), (E5), (E6), (E7), (E8), and (E9); 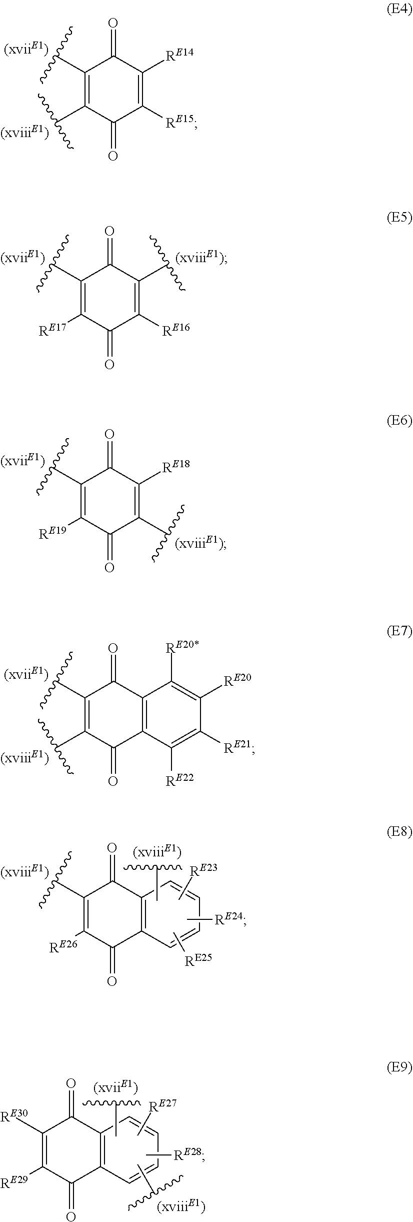
wherein,
in the case that R¹=(E1), (E2) or (E3), the bond indicated by (xvi^{E1}) is the bond to L¹,
in the case that R^{1′}=(E1), (E2) or (E3), the bond indicated by (xvi^{E1}) is the bond to L^{1′},
in the case that R^{2′}=(E1), (E2) or (E3), the bond indicated by (xvi^{E1}) is the bond to L^{2′},
in the case that R^{3′}=(E1), (E2) or (E3), the bond indicated by (xvi^{E1}) is the bond to L^{3′},
in the case that R²=(E4), (E5), (E6), (E7), (E8) or (E9), the bond indicated by (xvii^{E1}) is the bond to L² and the bond indicated by (xviii^{E1}) is the bond to L³,
in the case that R⁴=(E4), (E5), (E6), (E7), (E8) or (E9), the bond indicated by (xvii^{E1}) is the bond to L⁴ and the bond indicated by (xviii^{E1}) is the bond to L⁵,
in the case that R⁵=(E4), (E5), (E6), (E7), (E8) or (E9), the bond indicated by (xvii^{E1}) is the bond to L⁶ and the bond indicated by (xviii^{E1}) is the bond to L⁷,
wherein the R^{E1}, R^{E2}, R^{E3}, R^{A4}, R^{E5}, R^{E6}, R^{E7}, R^{E8}, R^{E9}, R^{E10}, R^{E11}, R^{E12}, R^{E13}, R^{E14}, R^{E15}, R^{E16}, R^{E17}, R^{E18}, R^{E19}, R^{E20}, R^{E20*}, R^{E21}, R^{E22}, R^{E23}, R^{E24}, R^{E25}, R^{E26}, R^{E27}, R^{E28}, R^{E29}, and R^{E30} radicals are selected from the group consisting of hydrogen, —OH, —SH, nitro group, —CN, —F, —Cl, —Br, —I, —C(═O)NHR^{E31}, —NR^{E32}R^{E33}, —COOR^{E34}, —COR^{E35}, sulfonic ester, phosphoric ester, (hetero)aromatic radical, alkyl group, alkenyl group, and alkynyl group,
wherein the (hetero)aromatic radical, the alkyl group, the alkenyl group, and the alkynyl group are optionally each substituted by at least one group selected from the group consisting of nitro group, —NH₂, —CN, —SH, —OH, and halogen, wherein the alkyl group, the alkenyl group, and the alkynyl group optionally have at least one group selected from the group consisting of ether, thioether, amino ether, carbonyl group, carboxylic ester, carboxamide group, sulfonic ester, mid phosphoric ester,
wherein R^{E31}, R^{E32}, R^{E33}, R^{E34}, and R^{E35} are each independently selected from the group consisting of hydrogen, (hetero)aromatic radical, and aliphatic radical, optionally substituted by at least one group selected from the group consisting of nitro group, —NH₂, —CN, —SH, —OH, and halogen, and optionally having at least one group selected from the group consisting of ether, thioether, amino ether, carbonyl group, carboxylic ester, carboxamide group, sulfonic ester, and phosphoric ester,
wherein two radicals in ortho positions to one another among the R^{E1}, R^{E2}, R^{E4}, R^{E5}, R^{E6}, R^{E7}, R^{E8}, R^{E10}, R^{E11}, R^{E12}, R^{E13}, R^{E14}, R^{E15}, R^{E20}, R^{E20*}, R^{E21}, R^{E22}, R^{E23}, R^{E24}, R^{E25}, R^{E27}, R^{E28}, R^{E29}, and R^{E30} radicals are optionally bridged by a divalent aliphatic radical optionally substituted by at least one group selected from the group consisting of nitro group, —NH₂, —CN, —SH, —OH, halogen, and alkyl group, and optionally having at least one group selected from the group consisting of ether, thioether, amino ether, carbonyl group, carboxylic ester, carboxamide group, sulfonic ester, mid phosphoric ester;
wherein, in the cases in which the R¹, R², R⁴, R⁵, R^{1′}, R^{2′}, and R^{3′} radicals in the chemical structure (I), the chemical structure (II), and the chemical structure (III) me each a redox-active triphenylamine function (G), the R¹, R^{1′}, R^{2′}, and R^{3′} radicals each independently have the structure (G1) and the R², R and R⁵ radicals are each independently selected from the group consisting of the structures (G2) and (G3): 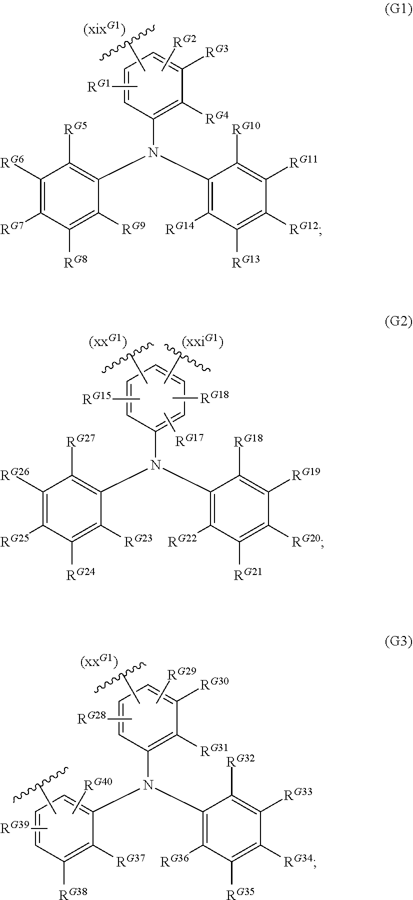
wherein,
in the case that R¹=(G1), the bond indicated by (xix^{G1}) is the bond to L¹,
in the case that R^{1′}=(G1), the bond indicated by (xix^{G1}) is the bond to L^{1′},
in the case that R^{2′}=(G1), the bond indicated by (xix^{G1}) is the bond to L^{2′},
in the case that R″=(G1), the bond indicated by (xix^{G1}) is the bond to L^{3′},
in the case that R²=(G2) or (G3), the bond indicated by (xx^{G1}) is the bond to L² and the bond indicated by (xxi^{G1}) is the bond to L³,
in the case that R⁴=(G2) or (G3), the bond indicated by (xx^{G1}) is the bond to L⁴ and the bond indicated by (xxi^{G1}) is the bond to L⁵,
in the case that R⁵=(G2) or (G3), the bond indicated by (xx^{G1}) is the bond to L⁶ and the bond indicated by (xxi^{G1}) is the bond to L⁷,
wherein the R^{G1}, R^{G2}, R^{G3}, R^{G4}, R^{G5}, R^{G6}, R^{G7}, R^{G8}, R^{G9}, R^{G10}, R^{G11}, R^{G12}, R^{G13}, R^{G14}, R^{G15}, R^{G16}, R^{G17}, R^{G18}, R^{G19}, R^{G20}, R^{G21}, R^{G22}, R^{G23}, R^{G24}, R^{G25}, R^{G26}, R^{G27}, R^{G28}, R^{G29}, R^{G30}, R^{G31}, R^{G32}, R^{G33}, R^{G34}, R^{G35}, R^{G36}, R^{G37}, R^{G38}, R^{G39}, and R^{G40} radicals are each independently selected from the group consisting of hydrogen, (halo)alkyl group, alkenyl group, alkynyl group, (halo)alkoxy group, cycloalkyl group, carbonyl alkyl, —C(═O)—H, carboxylic acid, carboxamide, carboxylic ester, sulfonic ester, phosphoric ester, amine, mono(halo)alkylamino, di(halo)alkylamino, cyano, hydroxyl, halogen, and (hetero)aromatic radical, wherein the (hetero)aromatic radical is optionally substituted by at least one group selected from the group consisting of halogen, (halo)alkyl, (halo)alkoxy, cyano, and carboxylic ester;
wherein, in the cases in which the R¹, R², R⁴, R⁵, R^{1′}, R^{2′}, and R^{3′} radicals in the chemical structure (I), the chemical structure (II), and the chemical structure (III) are each a redox-active viologen function (H), the R¹, R^{1′}, R^{2′}, and R^{3′} radicals are each independently selected from the group consisting of the structures (H1) and (H2), and the R², R⁴, and R⁵ radicals are each independently selected from the group consisting of the structures (H3), (H4), (H5), (H6), and (H7): 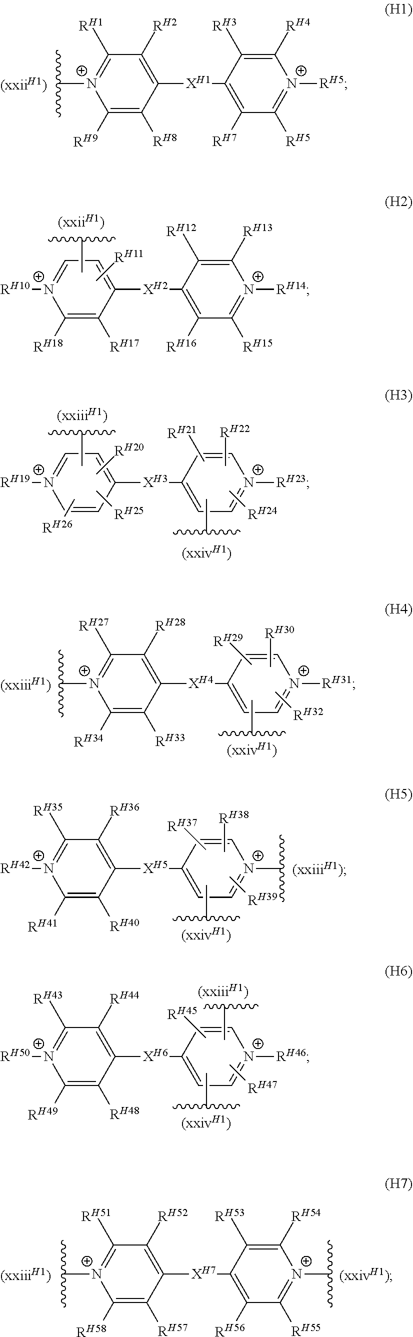
wherein,
in the case that R¹=(H1) or (H2), the bond indicated by (xxii^{H1}) is the bond to L¹,
in the case that R^{1′}=(H1) or (H2), the bond indicated by (xxii^{H1}) is the bond to L^{1′},
in the case that R^{2′}=(H1) or (H2), the bond indicated by (xxii^{H1}) is the bond to L^{2′},
in the case that R^{3′}=(H1) or (H2), the bond indicated by (xxii^{H1}) is the bond to L^{3′},
in the case that R²=(H3), (H4), (H5), (H6) or (H7), the bond indicated by (xxiii^{H1}) is the bond to L² and the bond indicated by (xxiv^{H1}) is the bond to L³,
in the case that R⁴=(H3), (H4), (H5), (H6) or (H7), the bond indicated by (xxiii^{H1}) is the bond to L⁴ and the bond indicated by (xxiv^{H1}) is the bond to L⁵,
in the case that R⁵=(H3), (H4), (H5), (H6) or (H7), the bond indicated by (xxiii^{H1}) is the bond to L⁶ and the bond indicated by (xxiv^{H1}) is the bond to L⁷,
wherein the R^{H1}, R^{H2}, R^{H3}, R^{H4}, R^{H6}, R^{H7}, R^{H8}, R^{H9}, R^{H11}, R^{H12}, R^{H13}, R^{H15}, R^{H16}, R^{H17}, R^{H18}, R^{H20}, R^{H21}, R^{H22}, R^{H24}, R^{H25}, R^{H26}, R^{H27}, R^{H28}, R^{H29}, R^{H30}, R^{H32}, R^{H33}, R^{H34}, R^{H35}, R^{H36}, R^{H37}, R^{H38}, R^{H39}, R^{H40}, R^{H41}, R^{H43}, R^{H44}, R^{H45}, R^{H47}, R^{H48}, R^{H49}, R^{H51}, R^{H52}, R^{H53}, R^{H54}, R^{H55}, R^{H56}, R^{H57}, and R^{H58} radicals are each independently selected from the group consisting of hydrogen, (halo)alkyl group, alkenyl group, alkynyl group, (halo)alkoxy group, cycloalkyl group, carbonylalkyl, —C(═O)—H, carboxylic acid, carboxamide, carboxylic ester, sulfonic ester, phosphoric ester, amine, mono(halo)alkylamino, di(halo)alkylamino, cyano, hydroxyl, and halogen,
wherein the R^{H5}, R^{H10}, R^{H14}, R^{H19}, R^{H23}, R^{H31}, R^{H42}, R^{H46}, and R^{H50} radicals are each independently selected from the group consisting of hydrogen, (halo)alkyl group, alkenyl group, alkynyl group, (halo)alkoxy group, cycloalkyl group, and carbonylalkyl, wherein the X^{H1}, X^{H2}, X^{H3}, X^{H4}, X^{H5}, X^{H6}, and X^{H7} radicals are each independently selected from the group consisting of direct bond, divalent conjugated aliphatic radical, and divalent conjugated (hetero)aromatic radical;
wherein, in the cases in which the R¹, R², R⁴, R⁵, R^{1′}, R^{2′}, and R^{3′} radicals in the chemical structure (I), the chemical structure (II), and the chemical structure (III) are each a redox-active ferrocene function (J), the R¹, R^{1′}, R^{2′}, and R^{3′} radicals each independently have the following structure (J1) and the R², R⁴, and R⁵ radicals are each independently selected from the group consisting of the structures (J2), (J3), and (J4): 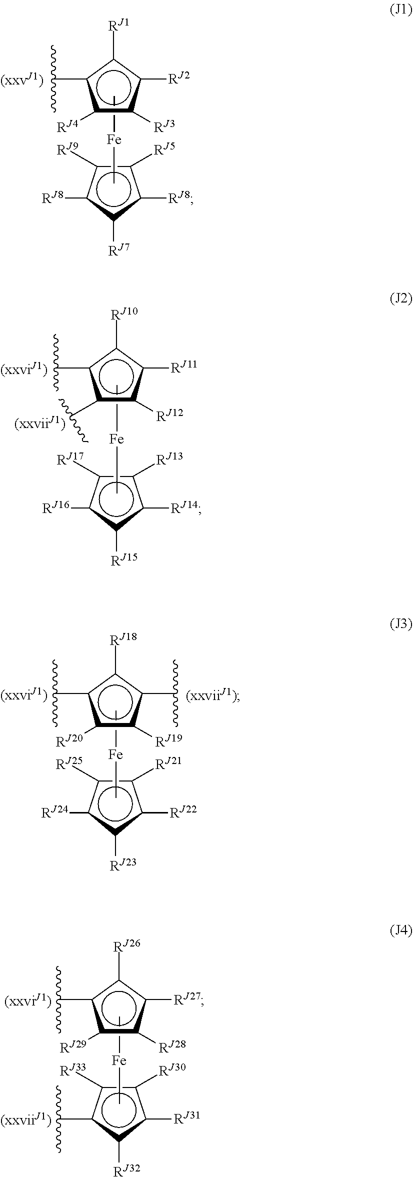
wherein,
in the case that R¹=(J1), the bond indicated by (xxv^{J1}) is the bond to L¹,
in the case that R^{1′}=(J1), the bond indicated by (xxv^{J1}) is the bond to L^{1′},
in the case that R^{2′}=(J1), the bond indicated by (xxv^{J1}) is the bond to L^{2′},
in the case that R^{3′}=(J1), the bond indicated by (xxv^{J1}) is the bond to L^{3′},
in the case that R²=(J2), (J3), or (J4), the bond indicated by (xxvi^{J1}) is the bond to L² and the bond indicated by (xxvii¹¹) is the bond to L³,
in the case that R⁴=(J2), (J3)₄ or (J4), the bond indicated by (xxvi^{J1}) is the bond to L⁴ and the bond indicated by (xxvii^{J1}) is the bond to L⁵,
in the case that R⁵=(J2), (J3), or (J4), the bond indicated by (xxvi^{J1}) is the bond to L⁶ and the bond indicated by (xxvii^{J1}) is the bond to L⁷,
wherein the R^{J1}, R^{J2}, R^{J3}, R^{J4}, R^{J5}, R^{J6}, R^{J7}, R^{J8}, R^{J9}, R^{J10}, R^{J11}, R^{J12}, R^{J13}, R^{J14}, R^{J15}, R^{J16}, R^{J17}, R^{J18}, R^{J19}, R^{J20}, R^{J21}, R^{J22}, R^{J23}, R^{J24}, R^{J25}, R^{J26}, R^{J27}, R^{J28}, R^{J29}, R^{J30}, R^{J31}, R^{J32}, and R^{J33} radicals are each independently selected from the group consisting of hydrogen, (halo)alkyl group, alkenyl group, alkynyl group, (halo)alkoxy group, cycloalkyl group, carbonylalkyl, —C(═O)—H, carboxylic acid, carboxamide, carboxylic ester, sulfonic ester, phosphoric ester, amine, mono(halo)alkylamino, di(halo)alkylamino, cyano, hydroxyl, and halogen.

5: The electrode material according to claim 2, wherein L¹, L², L³, L⁴, L⁵, L⁶, L⁷, L^{1′}, L^{2′}, and L^{3′} in the chemical structure (I), the chemical structure (II), and the chemical structure (III) are each independently selected from the group consisting of direct bond, (L11) and (L12): [symbol]
-(X^{L1})ₚ₁—[C═X^{L2}]ₚ₂—(X^{L3})ₚ₃-B^{L1}-(Y^{L1})_{q1}—[C═Y^{L2}]_{q2}—(Y^{L3})_{q3}- [symbol] , and (L11): [symbol]
-(Y^{L4})_{q4}—[C═Y^{L5}]_{q5}—(Y^{L6})_{q6}- [symbol] , (L12):
wherein p1, p2, and p3 are each 0 or 1, excluding the case that p2=0, p1=p3=1,
wherein q1, q2, and q3 are each 0 or 1, excluding the case that q2=0, q1=q3=1,
wherein q4, q5, and q6 are each 0 or 1, wherein at least one of q4, q5, and q6=1 and excluding the case that q5=0, q4=q6=1,
wherein X^{L2}, Y^{L2}, and Y^{L5} are each independently selected from the group consisting of O and S,
wherein X^{L1}, X^{L3}, Y^{L1}, Y^{L3}, Y^{L5}, and Y^{L6} are each independently selected from the group consisting of O, S, NH, and N[(halo)alkyl],
wherein B^{L1} is selected from the group consisting of divalent (hetero)aromatic radical and divalent aliphatic radical, optionally substituted by at least one group selected from the group consisting of nitro group, —NH₂, —CN, —SH, —OH, and halogen, and optionally having at least one group selected from the group consisting of ether, thioether, amino ether, carbonyl group, carboxylic ester, carboxamide group, sulfonic ester, and phosphoric ester,
wherein, in the cases in which L¹, L², L³, L⁴, L⁵, L⁶, L⁷, L^{1′}, L^{2′} or L^{3′} binds to a non-carbon atom in the respective redox-active R¹, R², R⁴, R⁵, R^{1′}, R^{2′} or R^{3′} group, for the structure (Lit) an additional condition is applicable that q3=0, q2=1, q1=1 or q3=q2=q1=0 or q3=0, q2=1, q1=0, and for the structure (L12) an additional condition is applicable that q6=0, q5=1, q4=1 or q6=0, q5=1, q4=0,
wherein “ [symbol] ” for L¹ denotes the bond pointing toward R¹, for L^{1′} denotes the bond pointing toward R^{1′}, for L² denotes the bond pointing toward R², for L^{2′} denotes the bond pointing toward R^{2′}, for L³ denotes the bond pointing toward R², for L^{3′} denotes the bond pointing toward R^{3′}, for L⁴ denotes the bond pointing toward R⁴, for L⁵ denotes the bond pointing toward R⁴, for L⁶ denotes the bond pointing toward R and for L⁷ denotes the bond pointing toward R⁵,
wherein “ [symbol] ” for L¹ denotes the bond pointing toward X¹, for L^{1′} denotes the bond pointing toward X^{1′}, for L² denotes the bond pointing toward X², for L^{2′} denotes the bond pointing toward X^{2′}, for L³ denotes the bond pointing toward X³, for L^{3′} denotes the bond pointing toward X^{3′}, for L⁴ denotes the bond pointing toward X⁴, for L⁵ denotes the bond pointing toward X⁵, for L⁶ denotes the bond pointing toward X⁴, and, for L⁷ denotes the bond pointing toward X⁵.

6: The electrode material according to claim 2, wherein the X¹, X², X³, X⁴, and X⁵ radicals in the chemical structure (I), the chemical structure (II), and the chemical structure (III) are independently non-conjugated organic groups selected from the group consisting of the following structures (X1), (X2), (X3), (X4), and (X5): 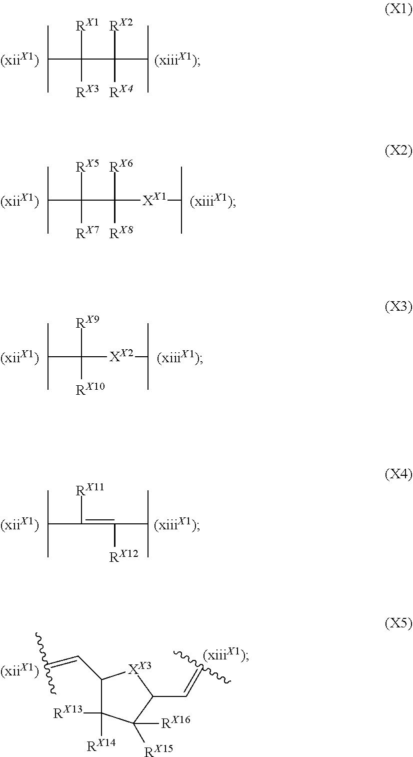
wherein, in the case that (X1)=X¹, one of R^{X1}, R^{X2}, R^{X3}, and R^{X4} denotes the bond to L¹ and another of R^{X1}, R^{X2}, R^{X3}, and R^{X4} denotes the bond to L^{1′},
wherein, in the case that (X1)=X², one of R^{X1}, R^{X2}, R^{X3}, and R^{X4} denotes the bond to L² and another of R^{X1}, R^{X2}, R^{X3}, and R^{X4} denotes the bond to L^{2′},
wherein, in the case that (X1)=X³, one of R^{X1}, R^{X2}, R^{X3}, and R^{X4} denotes the bond to L³ and another of R^{X1}, R^{X2}, R^{X3}, and R^{X4} denotes the bond to L^{3′},
wherein, in the case that (X1)=X⁴, one of R^{X1}, R^{X2}, R^{X3}, and R^{X4} denotes the bond to L⁴ and another of R^{X1}, R^{X2}, R^{X3}, and R^{X4} denotes the bond to L⁶,
wherein, in the case that (X1)=X⁵, one of R^{X1}, R^{X2}, R^{X3}, and R^{X4} denotes the bond to L⁵ and another of R^{X1}, R^{X2}, R^{X3}, and R^{X4} denotes the bond to L⁷,
wherein, in the case that (X2)=X¹, one of R^{X5}, R^{X6}, R^{X7}, and R^{X8} denotes the bond to L¹ and another of R^{X5}, R^{X6}, R^{X7}, and R^{X8} denotes the bond to L^{1′},
wherein, in the case that (X2)=X², one of R^{X5}, R^{X6}, R^{X7}, and R^{X8} denotes the bond to L² and another of R^{X5}, R^{X6}, R^{X7}, and R^{X8} denotes the bond to L^{2′},
wherein, in the case that (X2)=X³, one of R^{X5}, R^{X6}, R^{X7}, and R^{X8} denotes the bond to L³ and another of R^{X5}, R^{X6}, R^{X7}, and R^{X8} denotes the bond to L^{3′},
wherein, in the case that (X2)=X⁴, one of R^{X5}, R^{X6}, R^{X7}, and R^{X8} denotes the bond to L⁴ and another of R^{X5}, R^{X6}, R^{X7}, and R^{X8} denotes the bond to L⁶,
wherein, in the case that (X2)=X⁵, one of R^{X5}, R^{X6}, R^{X7}, and R^{X8} denotes the bond to L⁵ and another of R^{X5}, R^{X6}, R^{X7}, and R^{X8} denotes the bond to L⁷,
wherein, in the case that (X3)=X¹, R^{X9} denotes the bond to L¹ and R^{X10} denotes the bond to L^{1′},
wherein, in the case that (X3)=X², R^{X9} denotes the bond to L² and R^{X10} denotes the bond to L^{2′},
wherein, in the case that (X3)=X³, R^{X9} denotes the bond to L³ and R^{X10} denotes the bond to L^{3′},
wherein, in the case that (X3)=X⁴, R^{X9} denotes the bond to L⁴ and R^{X10} denotes the bond to L⁶,
wherein, in the case that (X3)=X⁵, R^{X9} denotes the bond to L⁵ and R^{X10} denotes the bond to L⁷,
wherein, in the case that (X4)=X¹, one of R^{X11} and R^{X12} denotes the bond to L¹ and the other of R^{X11} and R^{X12} denotes the bond to L^{1′},
wherein, in the case that (X4)=X², one of R^{X1} and R^{X12} denotes the bond to L² and the other of R^{X11} and R^{X12} denotes the bond to L^{2′},
wherein, in the case that (X4)=X³, one of R^{X11} and R^{X12} denotes the bond to L³ and the other of R^{X11} and R^{X12} denotes the bond to L^{3′},
wherein, in the case that (X4)=X⁴, one of R^{X11} and R^{X12} denotes the bond to L⁴ and the other of R^{X11} and R^{X12} denotes the bond to L⁶,
wherein, in the case that (X4)=X⁵, one of R^{X11} and R^{X12} denotes the bond to L⁵ and the other of R^{X11} and R^{X12} denotes the bond to L⁷,
wherein, in the case that (X5)=X¹, one of R^{X13}, R^{X14}, R^{X15}, and R^{X16} denotes the bond to L¹ and another of R^{X13}, R^{X14}, R^{X15}, and R^{X16} denotes the bond to L^{1′},
wherein, in the case that (X5)=X², one of R^{X13}, R^{X14}, R^{X15}, and R^{X16} denotes the bond to L² and another of R^{X13}, R^{X14}, R^{X15}, and R^{X16} denotes the bond to L^{2′},
wherein, in the case that (X5)=X³, one of R^{X13}, R^{X14}, R^{X15}, and R^{X16} denotes the bond to L³ and another of R^{X13}, R^{X14}, R^{X15}, and R^{X16} denotes the bond to L^{3′},
wherein, in the case that (X5)=X⁴, one of R^{X13}, R^{X14}, R^{X15}, and R^{X16} denotes the bond to L⁴ and another of R^{X13}, R^{X14}, R^{X15}, and R^{X16} denotes the bond to L⁶,
wherein, in the case that (X5)=X⁵, one of R^{X13}, R^{X14}, R^{X15}, and R^{X16} denotes the bond to L⁵ and another of R^{X13}, R^{X14}, R^{X15}, and R^{X16} denotes the bond to L⁷,
wherein those of R^{X1}, R^{X2}, R^{X3}, R^{X4}, R^{X5}, R^{X6}, R^{X7}, R^{X8}, R^{X13}, R^{X14}, R^{X15}, or R^{X16} that do not denote a bond to L¹, L^{1′}, L², L^{2′}, L³, L^{3′}, L⁴, L⁵, L⁶ or L⁷ are radicals that are each independently selected from the group consisting of hydrogen, (hetero)aromatic radical, and aliphatic radical, optionally substituted by at least one group selected from the group consisting of nitro group, —NH₂, —CN, —SH, —OH, and halogen, and optionally having at least one group selected from the group consisting of ether, thioether, amino ether, carbonyl group, carboxylic ester, carboxamide group, sulfonic ester, and phosphoric ester,
wherein X^{X1} and X^{X2} are each independently selected from the group consisting of O and S, wherein X^{X3} is selected from the group consisting of O, S, and —CH₂—,
wherein the bond indicated in each case by xii^{X1} corresponds to “*”, “#”, “&”, “§”, and “$” in the chemical structure (I), the chemical structure (II), and the chemical structure (III), and
wherein the bond indicated in each case by xiii^{X1} corresponds to the bond which, in the chemical structure (I), the chemical structure (II), and the chemical structure (III), in the cases in which m¹=0, m²=0, m³=0, m⁴=0, or m⁵=0, binds in each case to “**”, “&&”, or “§§”, or “$$” and, in the cases in which m¹>0, m²>0, m³>0, m⁴>0, or m⁵>0, binds in each case to Y¹, Y², Y³, Y⁴, or Y⁵.

7: The electrode material according to claim 2, wherein Y¹, Y², Y³, Y⁴, and Y⁵ in the chemical structure (I), Ae chemical structure (II), and the chemical structure (III) are each independently non-conjugated spacer units selected from the group consisting of the following structures (Y1), (Y2), (Y3), (Y4), and (Y5): 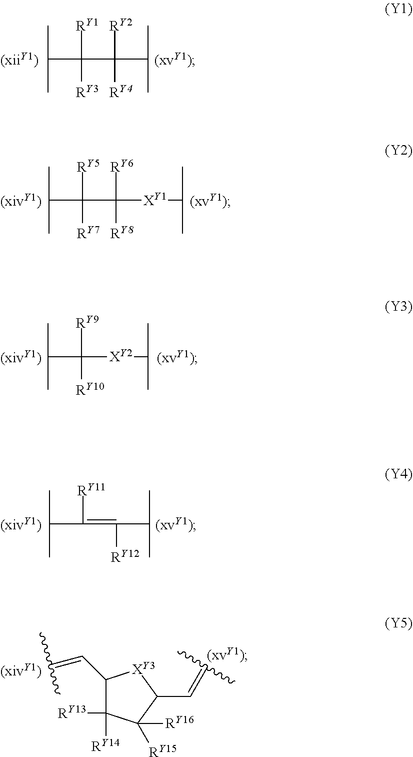
wherein R^{Y1}, R^{Y2}, R^{Y3}, R^{Y4}, R^{Y5}, R^{Y6}, R^{Y7}, R^{Y8}, R^{Y9}, R^{Y10}, R^{Y11}, R^{Y12}, R^{Y13}, R^{Y14}, R^{Y15}, and R^{Y16} are each independently selected from the group consisting of hydrogen, (hetero)aromatic radical, and aliphatic radical, optionally substituted by at least one group selected from the group consisting of nitro group, —NH₂, —CN, —SH, —OH, and halogen, and optionally having at least one group selected from the group consisting of ether, thioether, amino ether, carbonyl group, carboxylic ester, carboxamide group, sulfonic ester, and phosphoric ester,
wherein X^{Y1} and X^{Y2} are each independently selected from the group consisting of O and S, wherein X^{Y3} is selected from the group consisting of O, S, and —CH₂—,
wherein the bond indicated in each case by (xv^{Y1}) corresponds to “**”, “##”, “&&”, “§§” and “$$” in the chemical structure (I), the chemical structure (II), and the chemical structure (III), and
wherein the bond indicated in each case by (xiv^{Y1}) corresponds to the bond which binds to X¹, X², X³, X⁴, or X⁵ in the chemical structure (I), the chemical structure (II), and the chemical structure (III).

8: The electrode material according to claim 1, wherein the at least one ionic liquid has a structure Q⁺A⁻ in which Q⁺ is a cation selected from the group consisting of the structures (Q1), (Q2), (Q3), (Q4), and (Q5): 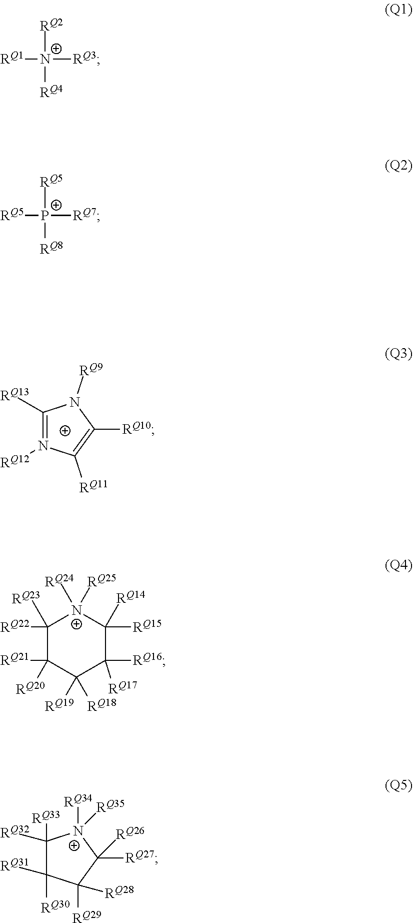
wherein R^{Q1}, R^{Q2}, R^{Q3}, R^{Q4}, R^{Q5}, R^{Q6}, R^{Q7}, and R^{Q8} are each independently selected from the group consisting of (halo)alkyl group and cycloalkyl group,
wherein R^{C9}, R^{Q10}, R^{QU}, R^{Q12}, R^{Q1}R^{Q14}, R^{Q1}R^{Q16}, R^{Q17}, R^{QI8}, R^{Q19}, R^{Q20}, R^{Q21}, R^{Q22}, R^{Q23}, R^{Q24}, R^{Q25}, R^{Q26}, R^{Q27}, R^{Q28}, R^{Q29}, R^{Q30}, R^{Q31}, R^{Q32}, R^{Q33}, R^{Q34}, and R^{Q35} are each independently selected from the group consisting of hydrogen, (halo)alkyl group which optionally have at least one ether group, and cycloalkyl group, and
wherein A⁻ is an anion.

9: The electrode material according to claim 1, wherein a total weight of the at least one ionic liquid encompassed by the electrode material, based on a total weight of the at least one organic redox polymer P non-conjugated in the main chain which is encompassed by the electrode material, is in a range of 0.1% to 1000% by weight.

10: The electrode material according to claim 1, wherein the at least one conductivity additive is selected from the group consisting of carbon materials, electrically conductive polymers, metals, semimetals, and (semi)metal compounds.

11: The electrode material according to claim 1, wherein a total weight of the at least one conductivity additive encompassed by the electrode material, based on a total weight of the at least one organic redox polymer P encompassed by the electrode material, is in a range of 0.1% to 1000% by weight.

12: The electrode material according to claim 1, further comprising a binder additive.

13: The electrode material according to claim 12, wherein a total weight of the binder additive encompassed by the electrode material, based on a total weight of the at least one organic redox polymer P encompassed by the electrode material, is in a range of 0.001% to 100% by weight.

14: An electrode comprising:
the electrode material according to claim 1, and
a substrate.

15: A charge storage, comprising:
the electrode according to claim 14.

16: A process for producing an electrode, comprising:
(a) mixing at least one organic redox polymer P non-conjugated in the main chain of the at least one organic redox polymer P, at least one ionic liquid, at least one conductivity additive, optionally at least one solvent, and optionally at least one binder additive to obtain a mixture M,
(b) applying the mixture M to a substrate, and
(c) optionally at least partly removing the solvent.

17: The process according to claim 16, wherein in step (a), the at least one organic redox polymer P comprises:
n¹ mutually joined repeat units of the chemical structure (I),
n² mutually joined repeat units of the chemical structure (II), and/or
n³ mutually joined repeat units of the chemical structure (III) 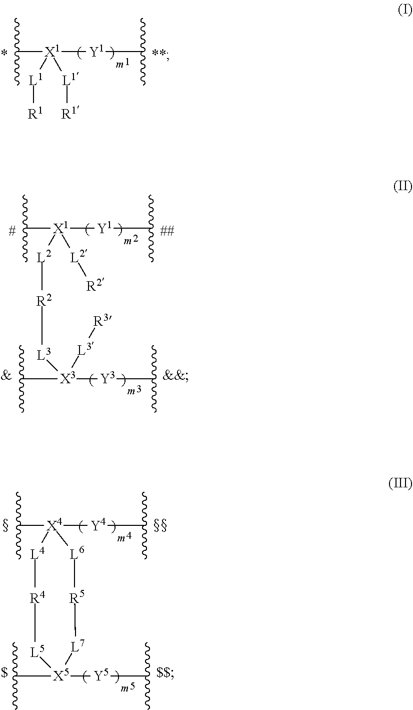
wherein n¹, n², and n³ are each independently an integer ≥4,
wherein m¹, m², m³, m⁴, and m⁵ are each independently an integer ≥0,
wherein the mutually joined repeat units of the chemical structure (I) within the at least one organic redox polymer P are the same or at least partly different from one another,
wherein the mutually joined repeat units of the chemical structure (II) within the at least one organic redox polymer P are the same or at least partly different from one another,
wherein the mutually joined repeat units of the chemical structure fill) within the at least one organic redox polymer P are the same or at least partly different from one another,
wherein the mutually joined repeat units of the chemical structure (I) within the at least one organic redox polymer P are bonded to one another in such a wav that the bond indicated by “**” in a particular repeat unit is joined by the bond indicated by “*” in the adjacent repeat unit,
wherein the mutually joined repeat units of the chemical structure (II) within the at least one organic redox polymer P are joined to one another in such a wav that the bond indicated by “##” in a particular repeat unit is joined by the bond indicated by “#” in the adjacent repeat unit and the bond indicated by “&&” in a particular repeat unit is joined by the bond indicated by “&” in the adjacent repeat unit,
wherein the mutually joined repeat units of the chemical structure (III) within the at least one organic redox polymer P are joined to one another in such a wav that the bond indicated by “§§” in a particular repeat unit is joined by the bond indicated by “§” in the adjacent repeat unit and the bond indicated by “$$” in a particular repeat unit is joined by the bond indicated by “$” in the adjacent repeat unit,
wherein X¹, X², X³, X⁴, and X⁵ are each independently a non-conjugated organic group formed by polymerization reaction from the group consisting of an organic double bond, an organic triple bond, an oxirane, an aziridine, and a non-conjugated organic group which is formed by a polymer-analogous reaction,
wherein Y¹, Y², Y³, Y⁴, and Y⁵ are each independently a non-conjugated organic spacer unit,
wherein L¹, L², L³, L⁴, L⁵, L⁶, L⁷, L^{1′}, L^{2′}, and L^{3′} are each independently selected from the group consisting of direct bond and organic linker unit, and
wherein R¹, R², R⁴, R⁵, R^{1′}, R^{2′}, and R^{3′} are each independently organic redox-active groups and R^{1′}, R^{2′}, and R^{3′} are optionally each a hydrogen radical.

18: The process according to claim 16, wherein the at least one ionic liquid in step (a) has a structure Q⁺A⁻ in which Q⁺ is a cation selected from the group consisting of the structures (Q1), (Q2), (Q3), (Q4), and (Q5): 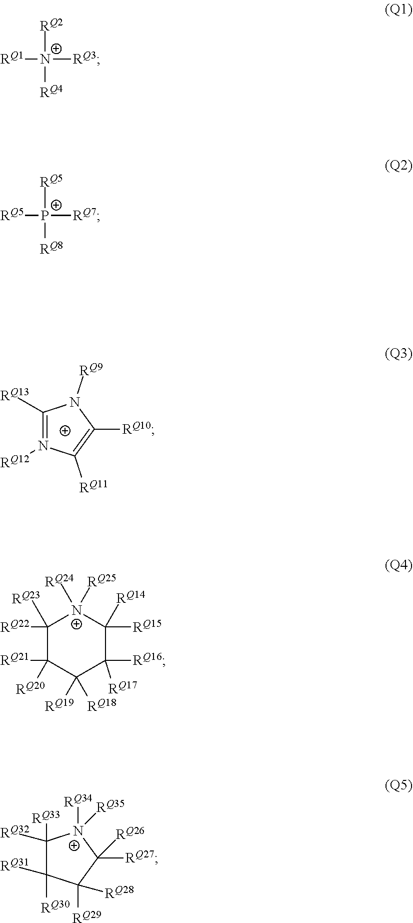
wherein R^{Q1}, R^{Q2}, R^{Q3}, R^{Q4}, R^{Q5}, R^{Q6}, R^{Q7}, and R^{Q8} are each independently selected from the group consisting of a (halo)alkyl group and a cycloalkyl group,
wherein R^{Q9}, R^{Q10}, R^{Q11}, R^{Q12}, R^{Q13}, R^{Q14}, R^{Q15}, R^{Q16}, R^{Q17}, R^{Q18}, R^{Q19}, R^{Q20}, R^{Q21}, R^{Q22}, R^{Q23}, R^{Q24}, R^{Q25}, R^{Q26}, R^{Q27}, R^{Q28}, R^{Q29}, R^{Q30}, R^{Q31}, R^{Q32}, R^{Q33}, R^{Q34}, and R^{Q35} are each independently selected from the group consisting of a hydrogen, a (halo)alkyl group which optionally have at least one ether group, and a cycloalkyl group, and
wherein A⁻ is an anion.

19: The process according to claim 16, wherein a total weight of the at least one ionic liquid in step (a), based on a total weight of the at least one organic redox polymer P non-conjugated in the main chain in step (a), is in a range of 0.1% to 1000% by weight.

20: The process according to claim 16, wherein the at least one conductivity additive in step (a) is selected from the group consisting of carbon materials, electrically conductive polymers, metals, semimetals, and (semi)metal compounds.

21: The process according to claim 16, wherein a total weight of the at least one conductivity additive in step (a), based on a total weight of the at least one organic redox polymer P non-conjugated in the main chain in step (a), is in a range of 0.1% to 1000% by weight.

22: The process according to claim 16, wherein the at least one binder additive is mixed in step (a).

23: The process according to claim 22, wherein a total weight of the at least one binder additive in step (a), based on a total weight of the at least one organic redox polymer P non-conjugated in the main chain in step (a), is in a range of 0.001% to 100% by weight.

24: The process according to claim 16, wherein the at least one solvent is mixed in step (a).

25: The process according to claim 24, wherein a sufficient amount of the at least one solvent is mixed in step (a) that a concentration of the at least one organic redox polymer P in the mixture M obtained is in a range between 10 and 1000 mg/ml.

26: The process according to claim 16, wherein the substrate in step (b) is selected from the group consisting of metals, carbon materials, and oxide substances.

27: An electrode obtainable by the process according to claim 16.

28: A charge storage, comprising:
the electrode according to claim 27.
